(19) United States
(12) Patent Application Publication
(10) Pub. No.: US 2024/0079988 A1
(43) Pub. Date: Mar. 7, 2024

(54) INFRARED LIGHT RECYCLING THERMOPHOTOVOLTAIC HYDROGEN ELECTRICAL POWER GENERATOR

(71) Applicant: BRILLIANT LIGHT POWER, INC., Cranbury, NJ (US)

(72) Inventor: Randell L. Mills, Cranbury, NJ (US)

(73) Assignee: BRILLIANT LIGHT POWER, INC., Cranbury, NJ (US)

(21) Appl. No.: 18/260,229

(22) PCT Filed: Mar. 8, 2022
(86) PCT No.: PCT/IB2022/052016

§ 371 Date: Jun. 30, 2023

Related U.S. Application Data
(60) Provisional application No. 63/158,349, filed on Mar. 8, 2021.
(60) Provisional application No. 63/167,110, filed on Mar. 28, 2021.
(60) Provisional application No. 63/176,054, filed on Apr. 16, 2021.
(60) Provisional application No. 63/214,236, filed on Jun. 23, 2021.
(60) Provisional application No. 63/233,199, filed on Aug. 13, 2021.
(60) Provisional application No. 63/236,198, filed on Aug. 23, 2021.
(60) Provisional application No. 63/246,282, filed on Sep. 20, 2021.
(60) Provisional application No. 63/254,589, filed on Oct. 12, 2021.
(60) Provisional application No. 63/270,537, filed on Oct. 21, 2021.
(60) Provisional application No. 63/291,342, filed on Dec. 17, 2021.
(60) Provisional application No. 63/298,190, filed on Jan. 10, 2022.

(51) Int. Cl. H02S 10/30; H05H 1/24

(52) U.S. Cl. CPC H02S 10/30; H05H 1/4697

(57) ABSTRACT

A power generator is described that provides at least one of electrical and thermal power comprising (i) at least one reaction cell for reactions involving atomic hydrogen products identifiable by unique analytical and spectroscopic signatures, (ii) a molten metal injection system comprising at least one pump such as an electromagnetic pump that provides a molten metal stream to the reaction cell and at least one reservoir that receives the molten metal stream, and (iii) an ignition system comprising an electrical power source that provides low-voltage, high-current electrical energy to the at least one steam of molten metal to ignite a plasma to initiate rapid kinetics of the reaction and an energy gain. In some embodiments, the power generator may comprise: (v) a source of H₂ and O₂ supplied to the plasma, (vi) a molten metal recovery system, and (vii) a power converter capable of (a) converting the high-power light output from a blackbody radiator of the cell into electricity using concentrator thermophotovoltaic cells with light recycling or (b) converting the energetic plasma into electricity using a magnetohydrodynamic converter.

### CROSS REFERENCE TO RELATED APPLICATIONS

The present application claims priority to U.S. Ser. No. 63/158,349, filed Mar. 8, 2021; U.S. Ser. No. 63/167,110, filed Mar. 28, 2021; U.S. Ser. No. 63/176,054, filed Apr. 16, 2021; U.S. Ser. No. 63/214,236, filed Jun. 23, 2021; U.S. Ser. No. 63/233,199, filed Aug. 13, 2021; U.S. Ser. No. 63/236,198, filed Aug. 23, 2021; U.S. Ser. No. 63/246,282, filed Sep. 20, 2021; U.S. Ser. No. 63/254,589, filed Oct. 12, 2021; U.S. Ser. No. 63/270,537, filed Oct. 21, 2021; U.S. Ser. No. 63/291,342, filed Dec. 17, 2021; and U.S. Ser. No. 63/298,190, filed Jan. 10, 2022; each of which is hereby incorporated by reference in its entirety.

### FIELD OF DISCLOSURE

The present disclosure relates to the field of power generation and, in particular, to systems, devices, and methods for the generation of power. More specifically, embodiments of the present disclosure are directed to power generation devices and systems, as well as related methods, which produce optical power, plasma, and thermal power and produces electrical power via a magnetohydrodynamic power converter, an optical to electric power converter, plasma to electric power converter, photon to electric power converter, or a thermal to electric power converter. In addition, embodiments of the present disclosure describe systems, devices, and methods that use the ignition of a water or water-based fuel source to generate optical power, mechanical power, electrical power, and/or thermal power using photovoltaic power converters. These and other related embodiments are described in detail in the present disclosure.

### BACKGROUND

Power generation can take many forms, harnessing the power from plasma. Successful commercialization of plasma may depend on power generation systems capable of efficiently forming plasma and then capturing the power of the plasma produced.

Plasma may be formed during ignition of certain fuels. These fuels can include water or water-based fuel source. During ignition, a plasma cloud of electron-stripped atoms is formed, and high optical power may be released. The high optical power of the plasma can be harnessed by an electric converter of the present disclosure. The ions and excited state atoms can recombine and undergo electronic relaxation to emit optical power. The optical power can be converted to electricity with photovoltaics.

Leveraging plasmas for power generation is often difficult to sustain and achieve. Not only are the plasma reactions difficult to sustain, but the high energies created by plasma have profound effect on the surrounding system often causing break down of components used to create and maintain these plasmas. Furthermore, conversion of light output from plasmas is often associated with energy losses where, for example, low energy light (e.g., infrared light) is below the bandgap of photovoltaics and therefore lost, to the system. Moreover, plasma light output to photovoltaic is often impeded by a window between reaction cells and the photovoltaic that is susceptible to certain deformations and material accumulation thereon resulting in lower delivery of light to the photovoltaic and energy loss from the system.

### SUMMARY

The present disclosure is directed to power systems that generates at least one of electrical energy and thermal energy comprising:
at least one vessel capable of a maintaining a pressure below atmospheric;
reactants capable of undergoing a reaction that produces enough energy to form a plasma in the vessel comprising:
   a) a mixture of hydrogen gas and oxygen gas, and/or
      water vapor, and/or
      a mixture of hydrogen gas and water vapor;
   b) a molten metal;
a mass flow controller to control the flow rate of at least one reactant into the vessel;
a vacuum pump to maintain the pressure in the vessel below atmospheric pressure when one or more reactants are flowing into the vessel;
a molten metal injector system comprising at least one reservoir that contains some of the molten metal, a molten metal pump system (e.g., one or more electromagnetic pumps) configured to deliver the molten metal in the reservoir and through an injector tube to provide a molten metal stream, and at least one non-injector molten metal reservoir for receiving the molten metal stream;
at least one ignition system comprising a source of electrical power or ignition current to supply electrical power to the at least one stream of molten metal to ignite the reaction when the hydrogen gas and/or oxygen gas and/or water vapor are flowing into the vessel;
a reactant supply system to replenish reactants that are consumed in the reaction;
a power converter or output system to convert a portion of the energy produced from the reaction (e.g., light and/or thermal output from the plasma) to electrical power and/or thermal power.

Power systems (herein referred to as “SunCells”) of the present disclosure may comprise:
a) at least one vessel capable of a maintaining a pressure below atmospheric comprising a reaction chamber;
b) two electrodes configured to allow a molten metal flow therebetween to complete a circuit;
c) a power source connected to said two electrodes to apply an ignition current therebetween when said circuit is closed;
d) a plasma generation cell (e.g., glow discharge cell) to induce the formation of a first plasma from a gas delivered thereto; wherein effluence of the plasma generation cell is directed towards the circuit (e.g., the molten metal, the anode, the cathode, an electrode submerged in a molten metal reservoir);
   wherein when current is applied across the circuit, the effluence of the plasma generation cell undergoes a reaction to producing a second plasma and reaction products; and
e) a power adapter comprising a thermophotovoltaic converter configured to convert and/or transfer energy from the second plasma into mechanical, thermal, and/or electrical energy;
   wherein energy from the second plasma is absorbed in a blackbody radiator to produce blackbody radiation and said blackbody radiation is converted in the thermophotovoltaic converter. In some embodiments, the power adapter is a plurality of thermophotovoltaic adapters. The thermophotovoltaic adapter may comprise a photovoltaic converter in a geodesic dome, wherein the photovoltaic converter may comprise a receiver array (e.g., a dense receiver array) comprised of triangular elements; and
   wherein each triangular element comprises a plurality of concentrator photovoltaic cells capable of converting the blackbody radiation into electricity. In some embodiments, the positively biased electrode of the two electrodes is, comprises, or is connected to the blackbody radiator. In various implementations, the photons produced from the plasma having an energy less than the bandgap of the photovoltaic cells (e.g., infrared) are reflected back towards the plasma generation cell (e.g., towards the blackbody radiator).

Typically, light output from the reaction cell and/or blackbody radiator is collected in a photovoltaic for electrity generation and/or a blackbody radiator which outputs energy thermally and optically, each of which may be individually collected. In some embodiments, the system may comprise a PV window between a reaction cell comprising the second plasma and the thermophotovoltaic converter. In order to maintain energy generation, the molten metal (e.g., tin) may not wet the PV window by levarging materials, systems, and methods of the present disclosure. In some embodiments, the gas may be a reaction mixture that does not oxidize tin or provides minimal oxidation to tin (e.g., less than 10% or less than 5% or less than 1% of the molten metal in the system is not oxidized with the gas provided to the system for 12 hours). In various implementations, the PV window may comprise (or predominantly comprises) flat surfaces, the power adapter comprises a photovoltaic (PV) converter, and the PV converter comprises a flat dense receiver array panel to receive the plasma emission through the PV window with a geometry matching the PV window. These configurations may minimize reflectance of low energy light not absorbed by the photovoltaic but directed back towards the reaction cell for light recycling. In some embodiments, the PV window comprises at least one of quartz, sapphire, aluminum oxynitride, and MgF₂.

The high intensity environment generated by the system has profound effect on the system components. Relative dimensions, geometries, and placements of each component are all implicated in the creation of steady state plasmas. These components should be balanced in order to keep the system capable of generating the first and second plasmas. Typically, the each electrode of the two electrodes comprises a molten metal reservoir and an electrical feedthrough to supply the current only to the molten metal therein and thereby supply the ignition current. In various implementations, the system may comprise a reaction cell chamber connected to the reservoirs wherein the walls of at least one of the reservoirs and the reaction cell chamber are electrically isolated by at least one of a ceramic coating and a liner. In some embodiments, at least one of the reservoirs and the reaction cell chamber are thermally insulated by a liner. The liner may be or comprise carbon and/or tungsten optionally coated a ceramic coating. In other embodiments, the reservoirs are electrically isolated from each other by an electrical break in at least one of the reservoirs.

The molten metal flowing between the two electrodes may be formed from dual molten metal injection systems independently in fluid communication with one or more molten metal reservoirs comprising the molten metal;
wherein each molten metal injection system comprises an electromagnetic pump and a nozzle, wherein each electromagnetic pump flows molten metal through the nozzle to form a stream of molten metal;
wherein said electrodes are in communication with the molten metal streams thereby forming dual molten metal streams of opposite polarity; and
wherein said complete circuit is formed by intersection the dual molten metal streams. The reservoirs may comprise an electrical break to electrically isolate the electrodes from each other. Alignment of the molten metal stream, and in particular, alignment during operation is important to maintain plasma generation. To achieve such alignment, the system may comprise a flexible element and at least one actuator to tilt the injector electrode of the reservoir to cause alignment of the molten metal streams. In various implementations, a reservoir may comprise a baseplate supported by a plurality of supports wherein the at least one actuator to tilt the injector electrode of the reservoir lengthens or shortens at least one support. In certain aspects, the flexible element may comprise a stationary frame on one end and a moveable frame one the opposite end, and further comprises at least one actuator attached to the movable frame and the frame wherein the actuators contract on one side and expand on opposing sides of the flexible element to cause the injector to tilt. The flexible element may comprise a bellows.

Plasma generation involving molten metal often results in coating the PV window (e.g., with molten metal, with an oxide of the molten metal) thereby preventing optical transmission to the photovoltaic converter. By minimizing this accumulation, the systems of the present disclosure may be used for many applications aside from photovoltaic conversion. For example, in some embodiments, the dual molten streams may intersect in a chamber comprising a window and light produced from the second plasma or the blackbody radiation exits the window to heat a load. The load may be an oven chamber (or air/water/steam therein) heated by the light produced from the second plasma or the blackbody radiation. In some embodiments, the second plasma reaction occurs in a reaction chamber comprising a PV window;
the molten metal or oxidized molten metal is removed from the PV and:
   a) the PV window comprises at least one of quartz, sapphire, aluminum oxynitride, CaF₂, and MgF₂;
   b) the PV window is heated above the melting point of an oxide of the molten metal (e.g., tin oxide);
   c) hydrogen reduction of the oxide of the molten metal occurs by flowing hydrogen gas into the reaction chamber at a pressure sufficient to achieve said hydrogen reduction; and/or
   d) the PV window has molten metal injected onto its surface during generation of the second plasma (e.g., from an electromagnetic pump).
      In some embodiments, the system comprises a PV window and at least one thermal absorber wherein optical power from the second plasma reaction is transferred through the PV window to the thermal absorber by radiative power transfer, and said thermal absorber transmits thermal power from said radiative power transfer. In some embodiments, the system comprises or is a water boiler heated by the thermal power from the thermal absorber. In some embodiments, the system comprises an air heat exchanger heated by the thermal power from the thermal absorber. In some embodiments, the system is surrounded by an outer chamber, which may be filled a load such as water. During operation, energy from the second plasma may be transferred to the load thermally and/or optically.

Systems for removing a molten metal oxide (e.g., tin oxide) from a PV window are also provided. These systems may comprise;
a source of a deaccumulation material, wherein said deaccumulation material is directed towards said PV window; and
said deaccumulation material is hydrogen gas or molten metal of the molten metal oxide.

Methods are also provided. The method may, for example, generate power or produce light, or product a plasma. In some embodiments, the method comprises:
a) electrically biasing a molten metal;
b) directing the effluence of a plasma generation cell (e.g., a glow discharge cell) to interact with the biased molten metal and induce the formation of a plasma. In certain implementations, the effluence of the plasma generation cell is generated from a hydrogen (H₂) and oxygen (O₂) gas mixture passing through the plasma generation cell during operation.

Methods are also provided. For example, the method may comprise:
a) forming a first plasma in a glow discharge cell from a gas directed thereto;
b) creating an electrically biased molten metal stream;
c) directing the effluence from the glow discharge cell towards the electrically biased molten metal stream to form a second plasma that produces ultraviolet, visible, and/or infrared light.
   The light may be used to heat a load and/or in a photovoltaic converter to generate electricity. In some embodiments, the gas in the plasma generation cell comprises a mixture of hydrogen (H₂) and oxygen (O₂).

The disclosure also embraces methods for removing a molten metal oxide (e.g., tin oxide) from a PV window. The method may comprise, for example, directing a deaccumulation material towards said PV window;
wherein said deaccumulation material is hydrogen gas or molten metal of the molten metal oxide. In some embodiments, the deaccumulation material is molten metal (e.g., tin) wherein the window is exposed a plasma and the molten metal is directed onto the window at a rate to prevent or decrease structural deformations of the window associated with overheating (e.g., warping, cracking, decreases in transparency) or undergoing any structural deformations associated with overheating (e.g., warping, cracking).

In some embodiments, the gas in the plasma generation cell is a mixture of hydrogen (H₂) and oxygen (O₂). For example, the relative molar ratio of oxygen to hydrogen is from 0.01-50 (e.g. from 0.1-20, from 0.1-15, less than 10, less than 5, less than 2, etc.). In some embodiments, the relative flow rate of oxygen to hydrogen is from 0.01-50 by volume at room temperature (e.g. from 0.1-20, from 0.1-15, less than 10, less than 5, less than 2, etc.). In certain implementations, the molten metal is gallium or tin. In some embodiments, the reaction products have at least one spectroscopic signature as described herein (e.g., those described herein and in the Appendix or SubAppendix of U.S. App. No. 62/236,198, filed Aug. 23, 2021, which is hereby incorporated by reference in its entirety and, in particular, the spectroscopic measurements therein such as EPR and Raman of material produced by systems of the present disclosure and collected following thereof). In various aspects, the second plasma is formed in a reaction cell, and the walls of said reaction cell comprise a liner having increased resistance to alloy formation with the molten metal and the liner and the walls of the reaction cell have a high permability to the reaction products (e.g. stainless-steel such as 347 SS such as 4130 alloy SS or Cr—Mo SS, nickel, Ti, niobium, vanadium, iron, W, Re, Ta, Mo, niobium, and Nb(94.33 wt %)-Mo(4.86 wt %)-Zr(0.81 wt %)). The liner may be made of a crystalline material (e.g., SiC, BN, quartz) and/or a refractory metal such as at least one of Nb, Ta, Mo, or W. In certain embodiments, the second plasma is formed in a reaction cell, wherein the walls reaction cell chamber comprise a first and a second section, the first section composed of stainless steel such as 347 SS such as 4130 alloy SS or Cr—Mo SS, nickel, Ti, niobium, vanadium, iron, W, Re, Ta, Mo, niobium, and Nb(94.33 wt %)-Mo(4.86 wt %)-Zr(0.81 wt %);
the second section comprising a refractory metal different than the metal in the first section;
wherein the union between the different metals is formed by a lamination material (e.g., a ceramic such as BN).

The power system may comprise a gas mixer for mixing the hydrogen and oxygen gases and/or water molecules and a hydrogen and oxygen recombiner and/or a hydrogen dissociator. In some embodiments, the hydrogen and oxygen recombiner comprises a plasma cell. The plasma cell may comprise a center positive electrode and a grounded tubular body counter electrode wherein a voltage (e.g., a voltage in the range of 50 V to 1000 V) is applied across the electrodes to induce the formation of a plasma from a hydrogen (H₂) and oxygen (O₂) gas mixture. In some embodiments, the hydrogen and oxygen recombiner comprises a recombiner catalytic metal supported by an inert support material. In certain implementations, the gas mixture supplied to the plasma generation cell to produce the first plasma comprises a non-stoichiometric H₂/O₂ mixture (e.g., an H₂/O₂ mixture having less than ⅓ mole % O₂ or from 0.01% to 30%, or from 0.1% to 20%, or less than 10%, or less than 5%, or less than 3% O₂ by mole percentage of the mixture) that is flowed through the plasma cell (e.g., a glow discharge cell) to create a reaction mixture capable of undergoing the reaction with sufficient exothermicity to produce the second plasma. A non-stoichiometric H₂/O₂ mixture may pass through the glow discharge to produce an effluence of atomic hydrogen and nascent H₂O (e.g., a mixture having water at a concentration and with an internal energy sufficient to prevent formation of hydrogen bonds);
the glow discharge effluence is directed into a reaction chamber where the ignition current is supplied between two electrodes (e.g., with a molten metal passed therebetween), and upon interaction of the effluence with the biased molten metal (e.g., gallium or tin), the reaction between the nascent water and the atomic hydrogen is induced, for example, upon the formation of arc current.

The power system may comprise at least one of the reaction chamber (e.g. where the nascent water and atomic hydrogen undergo the second plasma forming reaction) and/or reservoir comprising at least one refractory material liner that is resistant to forming an alloy with the molten metal. The inner wall of the reaction chamber may comprise a ceramic coating, a carbon liner lined with a W, Nb, or Mo liner, lined with W plates. In some embodiments, the reservoir comprises a carbon liner and the carbon is covered by the molten metal contained therein. In various implementations, the reaction chamber wall comprises a material that is highly permeable to the reaction product gas. In various embodiments, the reaction chamber wall comprises at least one of stainless steel (e.g., Mo—Cr stainless steel), niobium, molybdenum, or tungsten.

The power system may comprise a condenser to condense molten metal vapor and metal oxide particles and vapor and returns them to the reaction cell chamber. In some embodiments, the power system may further comprise a vacuum line wherein the condenser comprises a section of the vacuum line from the reaction cell chamber to the vacuum pump that is vertical relative to the reaction cell chamber and comprises an inert, high-surface area filler material that condenses the molten metal vapor and metal oxide particles and vapor and returns them to the reaction cell chamber while permitting the vacuum pump to maintain a vacuum pressure in the reaction cell chamber.

The power system may comprise a blackbody radiator and a window to output light from the blackbody radiator. Such embodiments may be used to generate light (e.g., used for lighting).

In some embodiments, the power system may further comprise a gas mixer for mixing the hydrogen and oxygen gases and a hydrogen and oxygen recombiner and/or a hydrogen dissociator. For example, the power system may comprise a hydrogen and oxygen recombiner wherein the hydrogen and oxygen recombiner comprises a recombiner catalytic metal supported by an inert support material.

The power system may be operated with parameters that maximize reactions, and specifically, reactions capable of outputting enough energy to sustain plasma generation and net energy output. For example, in some embodiments, the pressure of the vessel during operation is in the range of 0.1 Torr to 50 Torr. In certain implementations, the hydrogen mass flow rate exceeds that of the oxygen mass flow rate by a factor in the range of 1.5 to 1000. In some embodiments, the pressure may be over 50 Torr and may further comprise a gas recirculation system.

In some embodiments, an inert gas (e.g., argon) is injected into the vessel. The inert gas may be used to prolong the lifetime of certain in situ formed reactants (such as nascent water).

The power system may comprise a water micro-injector configured to inject water into the vessel such that the plasma produced from the energy output from the reaction comprises water vapor. In some embodiments, the micro-injector injects water into the vessel. In some embodiments, water is flowed towards the biased crossing molten streams as a vapor. In some embodiments, water is produced in the glow discharge cell. In some embodiments, water vapor is present in the gas mixture. In some embodiments, humid air is used in gas resulting in delivery of water to the reaction cell. In some embodiments, the H₂ molar percentage for generation of the second plasma is in the range of 1.5 to 1000 times the molar percent of the water vapor (e.g., the water vapor injected by the micro-injector, the water present in the effluence of the glow discharge cell).

The power system may further comprise a heater to melt a metal (e.g., tin or gallium or silver or copper or combinations thereof) to form the molten metal. The power system may further comprise a molten metal recovery system configured to recover molten metal after the reaction comprising a molten metal overflow channel which collects overflow from the non-injector molten metal reservoir.

The molten metal injection system may further comprise electrodes in the molten metal reservoir and the non-injection molten metal reservoir; and the ignition system comprises a source of electrical power or ignition current to supply opposite voltages to the injector and non-injector reservoir electrodes; wherein the source of electrical power supplies current and power flow through the stream of molten metal to cause the reaction of the reactants to form a plasma inside of the vessel.

The source of electrical power typically delivers a current electrical energy sufficient to cause the reactants to react to form the second plasma. In certain embodiments, the source of electrical power comprises at least one supercapacitor. In various implementations, the current from the molten metal ignition system power is in the range of 10 A to 50,000 A.

Typically, the molten metal pump system is configured to pump molten metal from a molten metal reservoir to a non-injection reservoir, wherein a stream of molten metal is created therebetween. In some embodiments, the molten metal pump system is one or more electromagnetic pumps and each electromagnetic pump comprises one of a
a) DC or AC conduction type comprising a DC or AC current source supplied to the molten metal through electrodes and a source of constant or in-phase alternating vector-crossed magnetic field, or
b) induction type comprising a source of alternating magnetic field through a shorted loop of molten metal that induces an alternating current in the metal and a source of in-phase alternating vector-crossed magnetic field.
   In some embodiments, the circuit of the molten metal ignition system is closed by the molten metal stream to cause ignition to further cause ignition (e.g., with an ignition frequency less than 10,000 Hz). The injector reservoir may comprise an electrode in contact with the molten metal therein, and the non-injector reservoir comprises an electrode that makes contact with the molten metal provided by the injector system.

In various implementations, the non-injector reservoir is aligned above (e.g., vertically with) the injector and the injector is configured to produce the molten stream orientated towards the non-injector reservoir such that molten metal from the molten metal stream may collect in the reservoir and the molten metal stream makes electrical contact with the non-injector reservoir electrode; and wherein the molten metal pools on the non-injector reservoir electrode. In certain embodiments, the ignition current to the non-injector reservoir may comprise:
a) a hermitically sealed, high-temperature capable feed though that penetrates the vessel;
b) an electrode bus bar, and
c) an electrode.

The ignition current density may be related to the vessel geometry for at least the reason that the vessel geometry is related to the ultimate plasma shape. In various implementations, the vessel may comprise an hourglass geometry (e.g., a geometry wherein a middle portion of the internal surface area of the vessel has a smaller cross section than the cross section within 20% or 10% or 5% of each distal end along the major axis) and oriented in a vertical orientation (e.g., the major axis approximately parallel with the force of gravity) in cross section wherein the injector reservoir is below the waist and configured such that the level of molten metal in the reservoir is about proximal to the waist of the hourglass to increase the ignition current density. In some embodiments, the vessel is symmetric about the major longitudinal axis. In some embodiments, the vessel may an hourglass geometry and comprise a refractory metal liner. In some embodiments, the injector reservoir of the vessel having an hourglass geometry may comprise the positive electrode for the ignition current.

The molten metal may comprise at least one of tin, silver, gallium, silver-copper alloy, copper, or combinations thereof. In some embodiments, the molten metal has a melting point below 700° C. For example, the molten metal may comprise at least one of bismuth, lead, tin, indium, cadmium, gallium, antimony, or alloys such as Rose's metal, Cerrosafe, Wood's metal, Field's metal, Cerrolow 136, Cerrolow 117, Bi—Pb—Sn—Cd—In—Tl, and Galinstan. In certain aspects, at least one of component of the power generation system that contacts that molten metal (e.g., reservoirs, electrodes) comprises, is clad with, or is coated with one or more alloy resistant material that resists formation of an alloy with the molten metal. Exemplary alloy resistant materials are W, Ta, Mo, Nb, Nb(94.33 wt %)-Mo(4.86 wt %)-Zr(0.81 wt %), Os, Ru, Hf, Re, 347 SS, Cr—Mo SS, silicide coated, carbon, and a ceramic such as BN, quartz, Si3N4, Shapal, AlN, Sialon, Al₂O₃, ZrO₂, or HfO₂. In some embodiments, at least a portion of the vessel is composed of a ceramic and/or a metal. The ceramic may comprise at least one of a metal oxide, quartz, alumina, zirconia, magnesia, hafnia, silicon carbide, zirconium carbide, zirconium diboride, silicon nitride, and a glass ceramic. In some embodiments, the metal of the vessel comprises at least one of a stainless steel and a refractory metal.

In some embodiments, the power generation system generates a water/hydrogen mixture to be directed towards the molten metal cell through a plasma generation cell. In these embodiments, the plasma generation cell such as a glow discharge cell induce the formation of a first plasma from a gas (e.g., a gas comprising a mixture oxygen and hydrogen); wherein effluence of the plasma generation cell is directed towards the any part of the molten metal circuit (e.g., the molten metal, the anode, the cathode, an electrode submerged in a molten metal reservoir). Upon interaction of the biased molten metal with this effluence, a second plasma (more energetic than that created by the plasma generation cell) may be formed. In these embodiments, the plasma generation cell may be fed hydrogen (H₂) and oxygen mixtures (O₂) having a molar excess of hydrogen such that the effluence comprises atomic hydrogen (H) and water (H₂O). The water in the effluence may be in the form of nascent water, water sufficiently energized and at a concentration such that it is not hydrogen bonded to other components in the effluence. This effluence may proceed in a second more energetic reaction involving the H and HOH that forms a plasma that intensifies upon interaction with the molten metal and a supplied external current through at least one of the molten metal and the plasma that may produce additional atomic hydrogen (from the H₂ in the effluence) to further propagate the second energetic reaction.

In some embodiments, the power system may further comprise at least one heat exchanger (e.g., a heat exchanger coupled to a wall of the vessel wall, a heat exchanger which may transfer heat to or from the molten metal or to or from the molten metal reservoir). In some embodiments, the heat exchanger comprises one of a (i) plate, (ii) block in shell, (iii) SiC annular groove, (iv) SiC polyblock, and (v) shell and tube heat exchanger. In certain implementations, the shell and tube heat exchanger comprises conduits, manifolds, distributors, a heat exchanger inlet line, a heat exchanger outlet line, a shell, an external coolant inlet, an external coolant outlet, baffles, at least one pump to recirculate the hot molten metal from the reservoir through the heat exchanger and return the cool molten metal to the reservoir, and one or more a water pumps and water coolant or one or more air blowers and air coolant to flow cold coolant through the external coolant inlet and shell wherein the coolant is heated by heat transfer from the conduits and exists the external coolant outlet. In some embodiments, the shell and tube heat exchanger comprise conduits, manifolds, distributors, a heat exchanger inlet line, and a heat exchanger outlet line comprising carbon that line and expand independently of conduits, manifolds, distributors, a heat exchanger inlet line, a heat exchanger outlet line, a shell, an external coolant inlet, an external coolant outlet, and baffles comprising stainless steel. The external coolant of the heat exchanger comprises air, and air from a microturbine compressor or a microturbine recuperator forces cool air through the external coolant inlet and shell wherein the coolant is heated by heat transfer from the conduits and exists the external coolant outlet, and the hot coolant output from the external coolant outlet flows into a microturbine to convert thermal power to electricity.

In some embodiments, the power system comprises at least one power converter or output system of the reaction power output comprises at least one of the group of a thermophotovoltaic converter, a photovoltaic converter, a photoelectronic converter, a magnetohydrodynamic converter, a plasmadynamic converter, a thermionic converter, a thermoelectric converter, a Sterling engine, a supercritical CO₂ cycle converter, a Brayton cycle converter, an external-combustor type Brayton cycle engine or converter, a Rankine cycle engine or converter, an organic Rankine cycle converter, an internal-combustion type engine, and a heat engine, a heater, and a boiler. The vessel may comprise a light transparent photovoltaic (PV) window to transmit light from the inside of the vessel to a photovoltaic converter and at least one of a vessel geometry and at least one baffle comprising a spinning window. The spinning window comprises a system to reduce gallium or tin oxide comprising at least one of a hydrogen reduction system and an electrolysis system. In some embodiments the spinning window comprises or is composed of quartz, sapphire, aluminum oxynitride, magnesium fluoride, or combinations thereof. In several implementations, the spinning window is coated with a coating that suppresses adherence of at least one of gallium or tin and gallium or tin oxide. The spinning window coating may comprise at least one of diamond like carbon, carbon, boron nitride, and an alkali hydroxide. In some embodiments, the positive ignition electrode (e.g., the top ignition electrode, the electrode displaced above the other electrode) is closer to the window (e.g., as compared to the negative ignition electrode) and the positive electrode emits blackbody radiation through the photovoltaic to the photovoltaic converter.

The power converter or output system may comprise a magnetohydrodynamic (MHD) converter comprising a nozzle connected to the vessel, a magnetohydrodynamic channel, electrodes, magnets, a metal collection system, a metal recirculation system, a heat exchanger, and optionally a gas recirculation system. In some embodiments, the molten metal may comprise silver. In embodiments with a magnetohydrodynamic converter, the magnetohydrodynamic converter may be delivered oxygen gas to form silver particles nanoparticles (e.g., of size in the molecular regime such as less than about 10 nm or less than about 1 nm) upon interaction with the silver in the molten metal stream, wherein the silver nanoparticles are accelerated through the magnetohydrodynamic nozzle to impart a kinetic energy inventory of the power produced from the reaction. The reactant supply system may supply and control delivery of the oxygen gas to the converter. In various implementations, at least a portion of the kinetic energy inventory of the silver nanoparticles is converted to electrical energy in a magnetohydrodynamic channel. Such version of electrical energy may result in coalescence of the nanoparticles. The nanoparticles may coalesce as molten metal which at least partially absorbs the oxygen in a condensation section of the magnetohydrodynamic converter (also referred to herein as an MHD condensation section) and the molten metal comprising absorbed oxygen is returned to the injector reservoir by a metal recirculation system. In some embodiments, the oxygen may be released from the metal by the plasma in the vessel. In some embodiments, the plasma is maintained in the magnetohydrodynamic channel and metal collection system to enhance the absorption of the oxygen by the molten metal.

The molten metal pump system may comprise a first stage electromagnetic pump and a second stage electromagnetic pump, wherein the first stage comprises a pump for a metal recirculation system, and the second stage that comprises the pump of the metal injector system.

The reaction induced by the reactants produces enough energy in order to initiate the formation of a plasma in the vessel. These measurable spectroscopic signatures and reaction may be used to identify the nature of the second plasma. For example, the reactions may produce a hydrogen product characterized as one or more of:
a) a molecular hydrogen product H₂ (e.g., H₂(1/p) (p is an integer greater than 1 and less than or equal to 137) comprising an unpaired electron) which produces an electron paramagnetic resonance (EPR) spectroscopy signal;
b) a molecular hydrogen product H₂ (e.g., H₂(¼)) having an EPR spectrum comprising a principal peak with a g-factor of 2.0046386 that is optionally split into a series of pairs of peaks with members separated by spin-orbital coupling energies that are a function of the corresponding electron spin-orbital coupling quantum numbers wherein
   (i) the unpaired electron magnetic moment induces a diamagnetic moment in the paired electron of the H₂(¼) molecular orbital based on the diamagnetic susceptibility of H₂(¼);
   (ii) the corresponding magnetic moments of the intrinsic paired-unpaired current interactions and those due to relative rotational motion about the internuclear axis give rise to the spin-orbital coupling energies;
   (iii) each spin-orbital splitting peak is further sub-split into a series of equally spaced peaks that matched integer fluxon energies that are a function of the electron fluxon quantum number corresponding to the number of angular momentum components involved in the transition, and
   (iv) additionally, the spin-orbital splitting increases with spin-orbital coupling quantum number on the downfield side of the series of pairs of peaks due to magnetic energies that increased with accumulated magnetic flux linkage by the molecular orbital.
c) for an EPR frequency of 9.820295 GHz,
   (i) the downfield peak positions B_{S/Ocombined}^{downfield} due to the combined shifts due to the magnetic energy and the spin-orbital coupling energy of H₂(¼) are

$${B}_{S / O combined}^{downfield} = ( 0.3 5001 - m 3.99427 \times {10}^{- 4} - ( 0.5 ) \frac{{( 2 π m 3.99427 \times {10}^{- 4} )}^{2}}{0.1750} ) T ;$$

(ii) the upfield peak positions B_{S/O}^{upfield} with quantized spin-orbital splitting energies E_{S/O} and electron spin-orbital coupling quantum numbers m=0.5, 1, 2, 3, 5 . . . are

$${B}_{S / O}^{upfield} = 0 \text{.35001} ( 1 + m [ \frac{7 \text{.426} \times {10}^{- 27} J}{h 9.82 \; 0295 GHz} ] ) T = ( 0.35001 + m 3.99427 \times {10}^{- 4} ) T ,$$

and/or
   (iii) the separations ΔB_{Φ} of the integer series of peaks at each spin-orbital peak position are

$$Δ {B}_{Φ}^{downfield} = \begin{matrix}( 0.35001 - m 3.99427 \times {10}^{- 4} - ( 0.5 ) \frac{{( 2 π m 3.99427 \times {10}^{- 4} )}^{2}}{0.1750} ) \\ [ \frac{{m}_{Φ} 5.783 \times {10}^{- 28} J}{h 9.82 \; 0295 GHz} ] \times {10}^{4} G\end{matrix}$$

$$and$$

$$Δ {B}_{Φ}^{upfield} = ( 0.35001 + m 3.9 \; 9427 \times {10}^{- 4} ) [ \frac{{m}_{Φ} 5.783 \times {10}^{- 28} J}{h 9.82 \; 0295 GHz} ] \times {10}^{4} G for electron$$

fluxon quantum numbers m_{Φ}=1, 2, 3;
d) a hydride ion H⁻ (e.g., H⁻(1/p)) comprising a paired and unpaired electron in a common atomic orbital that demonstrates flux linkage in quantized units of h/2e observed on H⁻(½) by high-resolution visible spectroscopy in the 400-410 nm range;
e) flux linkage in quantized units of h/2e observed when the rotational energy levels of H₂(¼) were excited by laser irradiation during Raman spectroscopy and by collisions of high energy electrons from an electron beam with H₂(¼);
f) molecular hydrino (e.g., H₂(1/p)) having Raman spectral transitions of the spin-orbital coupling between the spin magnetic moment of the unpaired electron and the orbital magnetic moment due to molecular rotation wherein
   (i) the energies of the rotational transitions are shifted by these spin-orbital coupling energies as a function of the corresponding electron spin-orbital coupling quantum numbers;
   (ii) molecular rotational peaks shifted by spin-orbital energies are further shifted by fluxon linkage energies with each energy corresponding to its electron fluxon quantum number dependent on the number of angular momentum components involved in the rotational transition, and/or
   (iii) the observed sub-splitting or shifting of Raman spectral peaks is due to flux linkage in units of the magnetic flux quantum h/2e during the spin-orbital coupling between spin and molecular rotational magnetic moments while the rotational transition occurs;
g) H₂(¼) having exemplary Raman spectral transitions comprising
   (i) either the pure H₂ (¼) J=0 to J′=3 rotational transition with spin-orbital coupling and fluxon coupling:

E_{Raman}=ΔE_{J=0→J′}+E_{S/O,rot}+E_{Φ,rot}=11701 cm⁻¹+m528 cm⁻¹+m_{Φ}31 cm⁻¹,
(ii) the concerted transitions comprising the J=0 to J′=2, 3 rotational transitions with the J=0 to J 1 spin rotational transition:

E_{Raman}=ΔE_{J=0→J′}+E_{S/O,rot}+E_{Φ,rot}=7801 cm⁻¹(13,652 cm⁻¹)+m528 cm⁻¹+m_{Φ3/2}46 cm⁻¹,
or
   (iii) the double transition for final rotational quantum numbers J′ₚ=2 and J′_{c}=1; J′ₚ=3 and J′_{c}=2:

$$\begin{matrix}{E}_{Raman} = Δ {E}_{J = 0 \to {J}_{p}^{′} = 2} + Δ {E}_{J = 0 \to {J}_{c}^{′} = 1} + {E}_{S / O , r o t} + {E}_{Φ , r o t} \\ = 9751 ( 19 , 502 ) {cm}^{- 1} + m 528 {cm}^{- 1} + {m}_{Φ} 31 {cm}^{- 1} + {m}_{Φ 3 / 2} 46 {cm}^{- 1}\end{matrix}$$

$$wherein the$$

corresponding spin-orbital coupling and fluxon coupling were also observed with the pure, concerted, and double transitions;
h) H₂(¼) UV Raman peaks (e.g., as recorded on the complex GaOOH:H₂(¼):H₂O and Ni foils exposed to the reaction plasma observed in the 12,250-15,000 cm⁻¹ region wherein the exemplary lines match the concerted pure rotational transition ΔJ=3 and ΔJ=1 spin transition with spin-orbital coupling and fluxon linkage splittings:

E_{Raman}=ΔE_{J=0→3}+ΔE_{J=0→1}+E_{S/O,rot}+E_{Φ,rot}=13,652 cm⁻¹+m528 cm⁻¹+m_{Φ}31 cm⁻¹);
i) the rotational energies of the HD(¼) Raman spectrum shifted by a factor of ¾ relative to that of H₂(¼);
j) the exemplary rotational energies of the HD(¼) Raman spectrum match those of
   (i) either the pure HD(¼) J=0 to J′=3, 4 rotational transition with spin-orbital coupling and fluxon coupling:

E_{Raman}=ΔE_{J=0→J′}+E_{S/O,rot}+E_{Φ,rot}=8776 cm⁻¹(14,627 cm⁻¹)+m528 cm⁻¹+m_{Φ}31 cm⁻¹,
(ii) the concerted transitions comprising the J=0 to J′=3 rotational transitions with the J=0 to J 1 spin rotational transition:

E_{Raman}=ΔE_{J=0→J′}+E_{S/O,rot}+E_{Φ,rot}=10,239 cm⁻¹+m528 cm⁻¹+m_{Φ3/2}46 cm⁻¹,
or
   (iii) the double transition for final rotational quantum numbers J′ₚ=3; J′_{c}=1:

$$\begin{matrix}{E}_{Raman} = Δ {E}_{J = 0 \to {J}_{p}^{′} = 2} + Δ {E}_{J = 0 \to {J}_{c}^{′} = 1} + {E}_{S / O , r o t} + {E}_{Φ , r o t} \\ = 11 , 701 {cm}^{- 1} + m 528 {cm}^{- 1} + {m}_{Φ} 31 {cm}^{- 1} + {m}_{Φ 3 / 2} 46 {cm}^{- 1}\end{matrix}$$

wherein spin-orbital coupling and fluxon coupling are also observed with both the pure and concerted transition;
k) H₂(¼)-noble gas mixtures irradiated with high energy electrons of an electron beam show equal, 0.25 eV spaced line emission in the ultraviolet (150-180 nm) region with a cutoff at 8.25 eV that match the H₂(¼) v=1 to v=0 vibrational transition with a series of rotational transitions corresponding to the H₂(¼) P-branch wherein
   (i) the spectral fit is a good match to 4²0.515 eV−4² (J+1)0.01509; J=0, 1, 2, 3 . . . wherein 0.515 eV and 0.01509 eV are the vibrational and rotational energies of ordinary molecular hydrogen, respectively,
   (ii) small satellite lines are observed that match the rotational spin-orbital splitting energies that are also observed by Raman spectroscopy, and (iii) the rotational spin-orbital splitting energy separations match m528 cm⁻¹ m=1, 1.5 wherein 1.5 involves the m=0.5 and m=1 splittings;
l) the spectral emission of the H₂(¼) P-branch rotational transitions with the v=1 to v=0 vibrational transition are observed by electron beam excitation of H₂(¼) trapped in a KCl crystalline matrix wherein
   (i) the rotational peaks match that of a free rotor;
   (ii) the vibrational energy is shifted by the increase in the effective mass due to interaction of the vibration of H₂(¼) with the KCl matrix;
   (iii) the spectral fit is a good match to 5.8 eV−4²(J+1)0.01509; J=0, 1, 2, 3 . . . comprising peaks spaced at 0.25 eV, and
   (iv) relative magnitude of the H₂(¼) vibrational energy shift match the relative effect on the ro-vibrational spectrum caused by ordinary H₂ being trapped in KCl;
m) the Raman spectrum with a HeCd energy laser shows a series of 1000 cm⁻¹ (0.1234 eV) equal-energy spaced in the 8000 cm⁻¹ to 18,000 cm⁻¹ region wherein conversion of the Raman spectrum into the fluorescence or photoluminescence spectrum reveals a match as the second order ro-vibrational spectrum of H₂(¼) corresponding to the e-beam excitation emission spectrum of H₂(¼) in a KCl matrix given by 5.8 eV−4² (J+1)0.01509; J=0, 1, 2, 3 . . . and comprising the matrix shifted v=1 to v=0 vibrational transition with 0.25 eV energy-spaced rotational transition peaks;
n) infrared rotational transitions of H₂(¼) are observed in an energy region higher than 4400 cm⁻¹ wherein the intensity increases with the application of a magnetic field in addition to an intrinsic magnetic field, and rotational transitions coupling with spin-orbital transitions are also observed;
o) the allowed double ionization of H₂(¼) by the Compton effect corresponding to the total energy of 496 eV is observed by X-ray photoelectron spectroscopy (XPS);
p) H₂(¼) is observed by gas chromatography that shows a faster migration rate than that of any known gas considering that hydrogen and helium have the fastest prior known migration rates and corresponding shortest retention times;
q) extreme ultraviolet (EUV) spectroscopy records extreme ultraviolet continuum radiation with a 10.1 nm cutoff (e.g., as corresponding to the hydrino reaction transition H to H(¼) catalyzed by nascent HOH catalyst);
r) proton magic-angle spinning nuclear magnetic resonance spectroscopy (¹H MAS NMR) records an upfield matrix-water peak in the −4 ppm to −5 ppm region;
s) bulk magnetism such as paramagnetism, superparamagnetism and even ferromagnetism when the magnetic moments of a plurality of hydrogen product molecules interact cooperatively wherein superparamagnetism (e.g., as observed using a vibrating sample magnetometer to measure the magnetic susceptibility of compounds comprising reaction products);
t) time of flight secondary ion mass spectroscopy (ToF-SIMS) and electrospray time of flight secondary ion mass spectroscopy (ESI-ToF) recorded on K₂CO₃ and KOH exposed to a molecular gas source from the reaction products showing complexing of reaction products (e.g., H₂(¼) gas) to the inorganic compounds comprising oxyanions by the unique observation of M+2 multimer units (e.g., K⁺[H₂:K₂CO₃]ₙ and K⁺[H₂:KOH]ₙ wherein n is an integer) and an intense H⁻ peak due to the stability of hydride ion, and
u) reaction products consisting of molecular hydrogen nuclei behaving like organic molecules as evidenced by a chromatographic peak on an organic molecular matrix column that fragments into inorganic ions. In various implementations, the reaction produces energetic signatures characterized as one or more of:
   (i) extraordinary Doppler line broadening of the H Balmer a line of over 100 eV in plasmas comprising H atoms and nascent HOH or H based catalyst such as argon-H₂, H₂, and H₂O vapor plasmas,
   (ii) H excited state line inversion,
   (iii) anomalous H plasma afterglow duration,
   (iv) shockwave propagation velocity and the corresponding pressure equivalent to about 10 times more moles of gunpowder with only about 1% of the power coupling to the shockwave,
   (v) optical power of up to 20 MW from a 10 μl hydrated silver shot, and
   (vi) calorimetry of the SunCell power system validated at a power level of 340,000 W.

These reactions may produce a hydrogen product characterized as one or more of:
a) a hydrogen product with a Raman peak at one or more range of 1900 to 2200 cm⁻¹, 5500 to 6400 cm⁻¹, and 7500 to 8500 cm⁻¹, or an integer multiple of a range of 1900 to 2200 cm⁻¹;
b) a hydrogen product with a plurality of Raman peaks spaced at an integer multiple of 0.23 to 0.25 eV;
c) a hydrogen product with an infrared peak at a range of an integer multiple of 1900 to 2000 cm⁻¹;
d) a hydrogen product with a plurality of infrared peaks spaced at an integer multiple of 0.23 to 0.25 eV;
e) a hydrogen product with at a plurality of UV fluorescence emission spectral peaks in the range of 200 to 300 nm having a spacing at an integer multiple of 0.23 to 0.3 eV;
f) a hydrogen product with a plurality of electron-beam emission spectral peaks in the range of 200 to 300 nm having a spacing at an integer multiple of 0.2 to 0.3 eV;
g) a hydrogen product with a plurality of Raman spectral peaks in the range of 5000 to 20,000 cm⁻¹ having a spacing at an integer multiple of 1000±200 cm⁻¹;
h) a hydrogen product with a X-ray photoelectron spectroscopy peak at an energy in the range of 490 to 525 eV;
i) a hydrogen product that causes an upfield MAS NMR matrix shift;
j) a hydrogen product that has an upfield MAS NMR or liquid NMR shift of greater than −5 ppm relative to TMS;
m) a hydrogen product comprising at least one of a metal hydride and a metal oxide further comprising hydrogen wherein the metal comprises at least one of Zn, Fe, Mo, Cr, Cu, and W;
o) a hydrogen product comprising an inorganic compound MₓX_{y} and H₂ wherein M is a cation and X in an anion having at least one of electrospray ionization time of flight secondary ion mass spectroscopy (ESI-ToF) and time of flight secondary ion mass spectroscopy (ToF-SIMS) peaks of M(MₓX_{y}H₂)n wherein n is an integer;
p) a hydrogen product comprising at least one of K₂CO₃H₂ and KOHH₂ having at least one of electrospray ionization time of flight secondary ion mass spectroscopy (ESI-ToF) and time of flight secondary ion mass spectroscopy (ToF-SIMS) peaks of K(K₂H₂CO₃)ₙ⁺ and K(KOHH₂)ₙ⁺, respectively;
q) a magnetic hydrogen product comprising at least one of a metal hydride and a metal oxide further comprising hydrogen wherein the metal comprises at least one of Zn, Fe, Mo, Cr, Cu, W, and a diamagnetic metal;
r) a hydrogen product comprising at least one of a metal hydride and a metal oxide further comprising hydrogen wherein the metal comprises at least one of Zn, Fe, Mo, Cr, Cu, W, and a diamagnetic metal that demonstrates magnetism by magnetic susceptometry;
s) a hydrogen product comprising a metal that is not active in electron paramagnetic resonance (EPR) spectroscopy wherein the EPR spectrum comprises at least one of a g factor of about 2.0046±20%, a splitting of the EPR spectrum into a series of peaks with a separation of about 1 to 10 G wherein each main peak is sub-split into a series of peaks with spacing of about 0.1 to 1 G;
t) a hydrogen product comprising a metal that is not active in electron paramagnetic resonance (EPR) spectroscopy wherein the EPR spectrum comprises at least an electron spin-orbital coupling splitting energy of about m₁×7.43λ10⁻²⁷ J±20%, and fluxon splitting of about m₂×5.78×10⁻²⁸ J±20%, and a dimer magnetic moment interaction splitting energy of about 1.58×10⁻²³ J±20%;
v) a hydrogen product comprising a gas having a negative gas chromatography peak with hydrogen or helium carrier;
w) a hydrogen product having a quadrupole moment/e of

$$\frac{1.70127 {a}_{0}^{2}}{{p}^{2}} \pm 10 \%$$

wherein p is an integer;
x) a protonic hydrogen product comprising a molecular dimer having an end over end rotational energy for the integer J to J+1 transition in the range of (J+1)44.30 cm⁻¹ 20 cm⁻¹ wherein the corresponding rotational energy of the molecular dimer comprising deuterium is ½ that of the dimer comprising protons;
y) a hydrogen product comprising molecular dimers having at least one parameter from the group of (i) a separation distance of hydrogen molecules of 1.028 Å±10%, (ii) a vibrational energy between hydrogen molecules of 23 cm⁻¹±10%, and (iii) a van der Waals energy between hydrogen molecules of 0.0011 eV±10%;
z) a hydrogen product comprising a solid having at least one parameter from the group of (i) a separation distance of hydrogen molecules of 1.028 Å±10%, (ii) a vibrational energy between hydrogen molecules of 23 cm⁻¹ 10%, and (iii) a van der Waals energy between hydrogen molecules of 0.019 eV±10%;
aa) a hydrogen product having FTIR and Raman spectral signatures of (i) (J+1)44.30 cm⁻¹±20 cm⁻¹, (ii) (J+1)22.15 cm⁻¹±10 cm⁻¹ and (iii) 23 cm⁻¹±10% and/or an X-ray or neutron diffraction pattern showing a hydrogen molecule separation of 1.028 Å±10% and/or a calorimetric determination of the energy of vaporization of 0.0011 eV±10% per molecular hydrogen;
bb) a solid hydrogen product having FTIR and Raman spectral signatures of (i) (J+1)44.30 cm⁻¹±20 cm⁻¹, (ii) (J+1)22.15 cm⁻¹±10 cm⁻¹ and (iii) 23 cm⁻¹±10% and/or an X-ray or neutron diffraction pattern showing a hydrogen molecule separation of 1.028 Å±10% and/or a calorimetric determination of the energy of vaporization of 0.019 eV±10% per molecular hydrogen.
cc) a hydrogen product comprising a hydrogen hydride ion that is magnetic and links flux in units of the magnetic in its bound-free binding energy region, and
dd) a hydrogen product wherein the high pressure liquid chromatography (HPLC) shows chromatographic peaks having retention times longer than that of the carrier void volume time using an organic column with a solvent comprising water wherein the detection of the peaks by mass spectroscopy such as ESI-ToF shows fragments of at least one inorganic compound.
   In various implementations, the hydrogen product may be characterized similarly as products formed from various hydrino reactors such as those formed by wire detonation in an atmosphere comprising water vapor. Such products may:
a) comprise at least one of a metal hydride and a metal oxide further comprising hydrogen wherein the metal comprises at least one of Zn, Fe, Mo, Cr, Cu, and W and the hydrogen comprises H;
b) comprise an inorganic compound MₓX_{y} and H₂ wherein M is a metal cation and X is an anion and at least one of the electrospray ionization time of flight secondary ion mass spectrum (ESI-ToF) and the time of flight secondary ion mass spectrum (ToF-SIMS) comprises peaks of M(MₓX_{y}H(¼)₂)n wherein n is an integer;
c) be magnetic and comprise at least one of a metal hydride and a metal oxide further comprising hydrogen wherein the metal comprises at least one of Zn, Fe, Mo, Cr, Cu, W, and a diamagnetic metal, and the hydrogen is H(¼), and
d) comprise at least one of a metal hydride and a metal oxide further comprising hydrogen wherein the metal comprises at least one of Zn, Fe, Mo, Cr, Cu, W, and a diamagnetic metal and H is H(¼) wherein the product demonstrates magnetism by magnetic susceptometry.

In some embodiments, the hydrogen product formed by the reaction comprises the hydrogen product complexed with at least one of (i) an element other than hydrogen, (ii) an ordinary hydrogen species comprising at least one of H⁺, ordinary H₂, ordinary H⁻, and ordinary H₃⁺, an organic molecular species, and (iv) an inorganic species. In some embodiments, the hydrogen product comprises an oxyanion compound. In various implementations, the hydrogen product (or a recovered hydrogen product from embodiments comprising a getter) may comprise at least one compound having the formula selected from the group of:
a) MH, MH₂, or M₂H₂, wherein M is an alkali cation and H or H₂ is the hydrogen product;
b) MHₙ wherein n is 1 or 2, M is an alkaline earth cation and H is the hydrogen product;
c) MHX wherein M is an alkali cation, X is one of a neutral atom such as halogen atom, a molecule, or a singly negatively charged anion such as halogen anion, and H is the hydrogen product;
d) MHX wherein M is an alkaline earth cation, X is a singly negatively charged anion, and H is H is the hydrogen product;
e) MHX wherein M is an alkaline earth cation, X is a double negatively charged anion, and H is the hydrogen product;
f) M₂HX wherein M is an alkali cation, X is a singly negatively charged anion, and H is the hydrogen product;
g) MHₙ wherein n is an integer, M is an alkaline cation and the hydrogen content Hₙ of the compound comprises at least one of the hydrogen products;
h) M₂Hₙ wherein n is an integer, M is an alkaline earth cation and the hydrogen content Hₙ of the compound comprises at least of the hydrogen products;
i) M₂XHₙ wherein n is an integer, M is an alkaline earth cation, X is a singly negatively charged anion, and the hydrogen content Hₙ of the compound comprises at least one of the hydrogen products;
j) M₂X₂Hₙ wherein n is 1 or 2, M is an alkaline earth cation, X is a singly negatively charged anion, and the hydrogen content Hₙ of the compound comprises at least one of the hydrogen products;
k) M₂X₃H wherein M is an alkaline earth cation, X is a singly negatively charged anion, and H is the hydrogen product;
l) M₂XHₙ wherein n is 1 or 2, M is an alkaline earth cation, X is a double negatively charged anion, and the hydrogen content Hₙ of the compound comprises at least one of the hydrogen products;
m) M₂XX′H wherein M is an alkaline earth cation, X is a singly negatively charged anion, X′ is a double negatively charged anion, and H is the hydrogen product;
n) MM¹Hₙ wherein n is an integer from 1 to 3, M is an alkaline earth cation, M′ is an alkali metal cation and the hydrogen content Hₙ of the compound comprises at least one of the hydrogen products;
o) MM′XHₙ wherein n is 1 or 2, M is an alkaline earth cation, M′ is an alkali metal cation, X is a singly negatively charged anion and the hydrogen content Hₙ of the compound comprises at least one of the hydrogen products;
p) MM′XH wherein M is an alkaline earth cation, M′ is an alkali metal cation, X is a double negatively charged anion and H is the hydrogen products;
q) MM′XX′H wherein M is an alkaline earth cation, M′ is an alkali metal cation, X and X′ are singly negatively charged anion and H is the hydrogen product;
r) MXX′Hₙ wherein n is an integer from 1 to 5, M is an alkali or alkaline earth cation, X is a singly or double negatively charged anion, X′ is a metal or metalloid, a transition element, an inner transition element, or a rare earth element, and the hydrogen content Hₙ of the compound comprises at least one of the hydrogen products;
s) MHₙ wherein n is an integer, M is a cation such as a transition element, an inner transition element, or a rare earth element, and the hydrogen content Hₙ of the compound comprises at least one of the hydrogen products;
t) MXHₙ wherein n is an integer, M is an cation such as an alkali cation, alkaline earth cation, X is another cation such as a transition element, inner transition element, or a rare earth element cation, and the hydrogen content Hₙ of the compound comprises at least one of the hydrogen products;
u) (MHₘMCO₃) wherein M is an alkali cation or other+1 cation, m and n are each an integer, and the hydrogen content Hₘ of the compound comprises at least one of the hydrogen products;
v) (MHₘMNO₃)ₙ⁺nX⁻ wherein M is an alkali cation or other+1 cation, m and n are each an integer, X is a singly negatively charged anion, and the hydrogen content Hₘ of the compound comprises at least one of the hydrogen products;
w) (MHMNO₃)ₙ wherein M is an alkali cation or other+1 cation, n is an integer and the hydrogen content H of the compound comprises at least one of the hydrogen products;
x) (MHMOH)ₙ wherein M is an alkali cation or other+1 cation, n is an integer, and the hydrogen content H of the compound comprises at least one of the hydrogen products;
y) (MHₘM′X)ₙ wherein m and n are each an integer, M and M′ are each an alkali or alkaline earth cation, X is a singly or double negatively charged anion, and the hydrogen content Hₘ of the compound comprises at least one of the hydrogen products; and
z) (MHₘM′X′)ₙ⁺nX⁻ wherein m and n are each an integer, M and M′ are each an alkali or alkaline earth cation, X and X′ are a singly or double negatively charged anion, and the hydrogen content Hₘ of the compound comprises at least one of the hydrogen products.
   The anion of the hydrogen product formed by the reaction may be one or more singly negatively charged anions including a halide ion, a hydroxide ion, a hydrogen carbonate ion, a nitrate ion, a double negatively charged anions, a carbonate ion, an oxide, and a sulfate ion. In some embodiments, the hydrogen product is embedded in a crystalline lattice (e.g., with the use of a getter such as K₂CO₃ located, for example, in the vessel or in an exhaust line). For example, the hydrogen product may be embedded in a salt lattice. In various implementations, the salt lattice may comprise an alkali salt, an alkali halide, an alkali hydroxide, alkaline earth salt, an alkaline earth halide, an alkaline earth hydroxide, or combinations thereof.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure. In the drawings:

FIG. 1 is schematic drawings showing details of the SunCell® thermal power generator comprising a single EM pump injector in an injector reservoir and an inverted pedestal as liquid electrodes in accordance with an embodiment of the present disclosure.

FIGS. 2-4 are schematic drawings showing details of the SunCell® thermal power generator comprising a single EM pump injector in an injector reservoir and a partially inverted pedestal as liquid electrodes and a tapered reaction cell chamber to suppress metallization of a PV window in accordance with an embodiment of the present disclosure.

FIG. 5 is a schematic drawing showing details of the SunCell® thermal power generator comprising a single EM pump injector in an injector reservoir, a partially inverted pedestal as liquid electrodes, an induction ignition system, and a PV window in accordance with an embodiment of the present disclosure.

FIG. 6 is a schematic drawing showing details of the SunCell® thermal power generator comprising a cube-shaped reaction cell chamber with a liner and a single EM pump injector in an injector reservoir and an inverted pedestal as liquid electrodes in accordance with an embodiment of the present disclosure.

FIG. 7A is a schematic drawing showing details of the SunCell® thermal power generator comprising an hour-glass-shaped reaction cell chamber liner and a single EM pump injector in an injector reservoir and an inverted pedestal as liquid electrodes in accordance with an embodiment of the present disclosure.

FIG. 7B is schematic drawing showing details of the SunCell® thermal power generator comprising a single EM pump injector in an injector reservoir and an inverted pedestal as electrodes in accordance with an embodiment of the present disclosure.

FIG. 7C is schematic drawing showing details of the SunCell® thermal power generator comprising a single EM pump injector in an injector reservoir and an inverted pedestal as electrodes wherein the EM pump tube comprises an assembly of a plurality of parts that are resistant to at least one of gallium or tin alloy formation and oxidation in accordance with an embodiment of the present disclosure.

FIGS. 7D-H are schematic drawings showing details of the SunCell® pumped-molten metal-to-air heat exchanger in accordance with an embodiment of the present disclosure.

FIGS. 8A-B are schematic drawings of a ceramic SunCell® power generator comprising dual reservoirs and DC EM pump injectors as liquid electrodes having reservoirs that join to form the reaction cell chamber in accordance with an embodiment of the present disclosure.

FIGS. 8C-D are schematic drawings of an inverted Y geometry SunCell® power generator comprising dual reservoirs and DC EM pump injectors. These form the liquid electrodes having reservoirs wherein the corresponding injected molten metal streams join to form a circuit in a reaction cell chamber. The chamber is connected to a PV window in accordance with an embodiment of the present disclosure.

FIG. 8E is a schematic drawing of a photovoltaic converter and an inverted Y geometry SunCell® power generator comprising dual reservoirs and DC EM pump injectors as liquid electrodes having reservoirs that join to form the reaction cell chamber that is connected to a PV window in accordance with an embodiment of the present disclosure. The PV window is surrounded by a network of photovoltaic cells for collection and conversion of light from the second plasma.

FIGS. 8F-8G are schematic drawings of a thermophotovoltaic SunCell® power generator comprising dual EM pump injectors as liquid electrodes showing a tilted electromagnetic pump assembly with an inlet riser, inner and outer PV windows, and one reservoir or two comprising an electrical break and a bellows in accordance with an embodiment of the present disclosure. FIG. 8G provides an internal cross-sectional view of thermophotovoltaic SunCell®.

FIGS. 8H-8L are schematic drawings of a thermophotovoltaic SunCell® power generator comprising dual EM pump injectors as liquid electrodes with each showing a tilted electromagnetic pump assembly having an inlet riser, an inner PV window, an outer PV window, at least one reservoir comprising an electrical break, and at least one reservoir comprising a bellows in accordance with an embodiment of the present disclosure. In FIG. 8L, the intersecting trajectories of the molten metal streams, which intersect to form a closed circuit can be seen.

FIGS. 9A-C are schematics of a SunCell® hydrino power generator comprising at least one electromagnetic pump injector and electrode in an injector reservoir electrode, at least one vertically aligned counter electrode, and a glow discharge cell connected to a top flange to form HOH catalyst and atomic H. A. Exterior view of one-electrode pair embodiment. B. Cross sectional view of one-electrode pair embodiment. C. Cross sectional view of two-electrode pair embodiment.

FIGS. 9D-E are schematics of a SunCell® hydrino power generator and boiler in accordance with an embodiment of the present disclosure.

FIG. 9F is a schematic of a SunCell® hydrino power generator and boiler for a steam and hot water to air heat exchanger in accordance with an embodiment of the present disclosure.

FIGS. 9G-H are schematics of a SunCell® hydrino power generator and direct heat pipe heat exchanger in accordance with an embodiment of the present disclosure.

FIG. 9I is a schematic of a SunCell® hydrino power generator with at least one window that serves as a thermal radiation source of at least one absorber and air heat exchanger in accordance with an embodiment of the present disclosure.

FIG. 9J is a schematic of a SunCell® hydrino power generator with a window that serves as a thermal radiation source of an oven in accordance with an embodiment of the present disclosure.

FIG. 9K is a schematic of a SunCell® hydrino power generator with a window that serves as a thermal radiation source of a boiler in accordance with an embodiment of the present disclosure.

FIG. 10 is a schematic drawing of a SunCell® power generator showing details of an optical distribution and the photovoltaic converter system in accordance with an embodiment of the present disclosure.

FIG. 11 is a schematic drawing of a triangular element of the geodesic dense receiver array of the photovoltaic converter or heat exchanger in accordance with an embodiment of the present disclosure.

FIGS. 12-13 are schematic drawings of a thermophotovoltaic SunCell® power generator comprising dual EM pump injectors as liquid electrodes showing a tilted electromagnetic pump assembly with an inlet riser and a PV converter of increased radius to decrease the blackbody light intensity in accordance with an embodiment of the present disclosure.

FIG. 14 is an emission spectrum measured on the plasma formed from interaction of glow discharge efflux produced from a mixture of hydrogen and oxygen gas with electrically biased dual tin molten streams.

FIG. 15 is an emission spectrum of the plasma formed following a decrease in nascent water and atomic hydrogen concentrations in the reaction cell.

### DETAILED DESCRIPTION

Disclosed herein are power generation systems and methods of power generation which convert the energy output from reactions involving atomic hydrogen into electrical and/or thermal energy. These reactions may involve catalyst systems which release energy from atomic hydrogen to form lower energy states wherein the electron shell is at a closer position relative to the nucleus. The released power is harnessed for power generation and additionally new hydrogen species and compounds are desired products. These energy states are predicted by classical physical laws and require a catalyst to accept energy from the hydrogen in order to undergo the corresponding energy-releasing transition.

A theory which may explain the exothermic reactions produced by the power generation systems of the present disclosure involves a nonradiative transfer of energy from atomic hydrogen to certain catalysts (e.g., nascent water). Classical physics gives closed-form solutions of the hydrogen atom, the hydride ion, the hydrogen molecular ion, and the hydrogen molecule and predicts corresponding species having fractional principal quantum numbers. Atomic hydrogen may undergo a catalytic reaction with certain species, including itself, that can accept energy in integer multiples of the potential energy of atomic hydrogen, m·27.2 eV, wherein m is an integer. The predicted reaction involves a resonant, nonradiative energy transfer from otherwise stable atomic hydrogen to the catalyst capable of accepting the energy. The product is H(1/p), fractional Rydberg states of atomic hydrogen called “hydrino atoms,” wherein n=½, ⅓, ¼, . . . , 1/p (p<137 is an integer) replaces the well-known parameter n=integer in the Rydberg equation for hydrogen excited states. Each hydrino state also comprises an electron, a proton, and a photon, but the field contribution from the photon increases the binding energy rather than decreasing it corresponding to energy desorption rather than absorption. Since the potential energy of atomic hydrogen is 27.2 eV, m H atoms serve as a catalyst of m·27.2 eV for another (m+1)th H atom [R. Mills, The Grand Unified Theory of Classical Physics; September 2016 Edition, posted at https://brilliantlightpower.com/book-download-and-streaming/ (“Mills GUTCP”)]. For example, a H atom can act as a catalyst for another H by accepting 27.2 eV from it via through-space energy transfer such as by magnetic or induced electric dipole-dipole coupling to form an intermediate that decays with the emission of continuum bands with short wavelength cutoffs and energies of

$${m}^{2} \cdot 13.6 eV ( \frac{91.2}{{m}^{2}} nm ) .$$

In addition to atomic H, a molecule that accepts m·27.2 eV from atomic H with a decrease in the magnitude of the potential energy of the molecule by the same energy may also serve as a catalyst. The potential energy of H₂O is 81.6 eV. Then, by the same mechanism, the nascent H₂O molecule (not hydrogen bonded in solid, liquid, or gaseous state) formed by a thermodynamically favorable reduction of a metal oxide is predicted to serve as a catalyst to form H (¼) with an energy release of 204 eV, comprising an 81.6 eV transfer to HOH and a release of continuum radiation with a cutoff at 10.1 nm (122.4 eV).

In the H-atom catalyst reaction involving a transition to the

$$H [ \frac{{a}_{H}}{p = m + 1} ]$$

state, m H atoms serve as a catalyst of m·27.2 eV for another (m+1)th H atom. Then, the reaction between m+1 hydrogen atoms whereby m atoms resonantly and nonradiatively accept m·27.2 eV from the (m+1)th hydrogen atom such that mH serves as the catalyst is given by

$$m \cdot 27.2 eV + m H + H \to m {H}_{fast}^{+} + m {e}^{-} + H * [ \frac{{a}_{H}}{m + 1} ] + m \cdot 27.2 eV \qquad ( 1 )$$

$$H * [ \frac{{a}_{H}}{m + 1} ] \to H [ \frac{{a}_{H}}{m + 1} ] + [ {( m + 1 )}^{2} - {1}^{2} ] \cdot 13.6 eV - m \cdot 27.2 eV \qquad ( 2 )$$

$$m {H}_{fast}^{+} + {me}^{-} \to m H + m \cdot 27.2 eV \qquad ( 3 )$$

And, the overall reaction is

$$H \to H [ \frac{{a}_{H}}{p = m + 1} ] + [ {( m + 1 )}^{2} - {1}^{2} ] \cdot 13.6 eV \qquad ( 4 )$$

The catalysis reaction (m=3) regarding the potential energy of nascent H₂O [R. Mills, The Grand Unified Theory of Classical Physics; September 2016 Edition, posted at https.//brilliantlightpower.com/book-download-and-streaming/] is

$$81.6 eV + {H}_{2} O + H [ {a}_{H} ] \to 2 {H}_{fast}^{+} + {O}^{-} + {e}^{-} + H * [ \frac{{a}_{H}}{4} ] + 81.6 eV \qquad ( 5 )$$

$$H * [ \frac{{a}_{H}}{4} ] \to H [ \frac{{a}_{H}}{4} ] + 1 22.4 eV \qquad ( 6 )$$

$$2 {H}_{fast}^{+} + {O}^{-} + {e}^{-} \to {H}_{2} O + 81.6 eV \qquad ( 7 )$$

And, the overall reaction is

$$H [ {a}_{H} ] \to H [ \frac{{a}_{H}}{4} ] + 81.6 eV + 122.4 eV \qquad ( 8 )$$

After the energy transfer to the catalyst (Eqs. (1) and (5)), an intermediate

$${H}^{*} [ \frac{{a}_{H}}{m + 1} ]$$

is formed having the radius of the H atom and a central field of m+1 times the central field of a proton. The radius is predicted to decrease as the electron undergoes radial acceleration to a stable state having a radius of 1/(m+1) the radius of the uncatalyzed hydrogen atom, with the release of m²·13.6 eV of energy. The extreme-ultraviolet continuum radiation band due to the

$$H * [ \frac{{a}_{H}}{m + 1} ]$$

intermediate (e.g. Eq. (2) and Eq. (6)) is predicted to have a short wavelength cutoff and energy

$${E}_{( H \to H [ \frac{{a}_{H}}{p = m + 1} ] )}$$

given by

$${E}_{( H \to H [ \frac{{a}_{H}}{p = m + 1} ] )} = {m}^{2} \cdot 13.6 eV ; {λ}_{( H \to H [ \frac{{a}_{H}}{p = m + 1} ] )} = \frac{91.2}{{m}^{2}} nm \qquad ( 9 )$$

and extending to longer wavelengths than the corresponding cutoff Here the extreme-ultraviolet continuum radiation band due to the decay of the H*[a_{H}/4] intermediate is predicted to have a short wavelength cutoff at E=m₂·13.6=9·13.6=122.4 eV (10.1 nm) [where p=m+1=4 and m=3 in Eq. (9)] and extending to longer wavelengths. The continuum radiation band at 10.1 nm and going to longer wavelengths for the theoretically predicted transition of H to lower-energy, so called “hydrino” state H(¼), was observed only arising from pulsed pinch gas discharges comprising some hydrogen. Another observation predicted by Eqs. (1) and (5) is the formation of fast, excited state H atoms from recombination of fast H⁺. The fast atoms give rise to broadened Balmer α emission. Greater than 50 eV Balmer α line broadening that reveals a population of extraordinarily high-kinetic-energy hydrogen atoms in certain mixed hydrogen plasmas is a well-established phenomenon wherein the cause is due to the energy released in the formation of hydrinos. Fast H was previously observed in continuum-emitting hydrogen pinch plasmas.

Additional catalyst and reactions to form hydrino are possible. Specific species (e.g. He⁺, Ar⁺, Sr⁺, K, Li, HCl, and NaH, OH, SH, SeH, nascent H₂O, nH (n=integer)) identifiable on the basis of their known electron energy levels are required to be present with atomic hydrogen to catalyze the process. The reaction involves a nonradiative energy transfer followed by q·13.6 eV continuum emission or q·13.6 eV transfer to H to form extraordinarily hot, excited-state H and a hydrogen atom that is lower in energy than unreacted atomic hydrogen that corresponds to a fractional principal quantum number. That is, in the formula for the principal energy levels of the hydrogen atom:

$${E}_{n} = - \frac{{e}^{2}}{{n}^{2} 8 π {ε}_{o} {a}_{H}} = - \frac{13.598 eV}{{n}^{2}} . \qquad ( 10 )$$

$$n = 1 , 2 , 3 , … \qquad ( 11 )$$

where a_{H} is the Bohr radius for the hydrogen atom (52.947 pm), e is the magnitude of the charge of the electron, and εₒ is the vacuum permittivity, fractional quantum numbers:

$$n = 1 , \frac{1}{2} , \frac{1}{3} , \frac{1}{4} , … , \frac{1}{p} ; where p \leq 137 is an integer \qquad ( 12 )$$

replace the well known parameter n=integer in the Rydberg equation for hydrogen excited states and represent lower-energy-state hydrogen atoms called “hydrinos.” The n=1 state of hydrogen and the

$$n = \frac{1}{integer}$$

states of hydrogen are nonradiative, but a transition between two nonradiative states, say n=1 to n=½, is possible via a nonradiative energy transfer. Hydrogen is a special case of the stable states given by Eqs. (10) and (12) wherein the corresponding radius of the hydrogen or hydrino atom is given by

$$r = \frac{{a}_{H}}{p} , \qquad ( 13 )$$

where p=1,2,3, . . . . In order to conserve energy, energy must be transferred from the hydrogen atom to the catalyst in units of an integer of the potential energy of the hydrogen atom in the normal n=1 state, and the radius transitions to

$$\frac{{a}_{H}}{m + p} .$$

Hydrinos are formed by reacting an ordinary hydrogen atom with a suitable catalyst having a net enthalpy of reaction of

m·27.2 eV (14)

where m is an integer. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

The catalyst reactions involve two steps of energy release: a nonradiative energy transfer to the catalyst followed by additional energy release as the radius decreases to the corresponding stable final state. Thus, the general reaction is given by

$$m \cdot 27.2 eV + C a {t}^{q +} + H [ \frac{{a}_{H}}{p} ] \to {Cat}^{( q + r ) +} + r {e}^{-} + H * [ \frac{{a}_{H}}{( m + p )} ] + m \cdot 27.2 eV \qquad ( 15 )$$

$$H * [ \frac{{a}_{H}}{( m + p )} ] \to H [ \frac{{a}_{H}}{( m + p )} ] + [ {( p + m )}^{2} - {p}^{2} ] \cdot 13.6 eV - m \cdot 27.2 eV \qquad ( 16 )$$

$${Cat}^{( q + r ) +} + {re}^{-} \to {Cat}^{q +} + m \cdot 27.2 eV and the overall reaction is \qquad ( 17 )$$

$$H [ \frac{{a}_{H}}{p} ] \to H [ \frac{{a}_{H}}{( m + p )} ] + [ {( p + m )}^{2} - {p}^{2} ] \cdot 13.6 eV \qquad ( 18 )$$

q, r, m, and p are integers.

$$H * [ \frac{{a}_{H}}{( m + p )} ]$$

has the radius of the hydrogen atom (corresponding to the 1 in the denominator) and a central field equivalent to (m+p) times that of a proton, and

$$H [ \frac{{a}_{H}}{( m + p )} ]$$

is the corresponding stable state with the radius of

$$\frac{1}{( m + p )} that of H .$$

The catalyst product, H(1/p), may also react with an electron to form a hydrino hydride ion H⁻ (1/p), or two H(1/p) may react to form the corresponding molecular hydrino H₂ (1/p). Specifically, the catalyst product, H(1/p), may also react with an electron to form a novel hydride ion H⁻ (1/p) with a binding energy E_{B}:

$${E}_{B} = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) \qquad ( 19 )$$

where p=integer>1, s=½, ℏ is Planck's constant bar, μₒ is the permeability of vacuum, mₑ is the mass of the electron, μₑ is the reduced electron mass given by

$${μ}_{e} = \frac{{m}_{e} {m}_{p}}{\frac{{m}_{e}}{\sqrt{\frac{3}{4}}} + {m}_{p}}$$

where mₚ is the mass of the proton, aₒ is the Bohr radius, and the ionic radius is

$${r}_{1} = \frac{{a}_{0}}{p} ( 1 + \sqrt{s ( s + 1 )} ) .$$

From Eq. (19), the calculated ionization energy of the hydride ion is 0.75418 eV, and the experimental value is 6082.99±0.15 cm⁻¹ (0.75418 eV). The binding energies of hydrino hydride ions may be measured by X-ray photoelectron spectroscopy (XPS).

Upfield-shifted NMR peaks are direct evidence of the existence of lower-energy state hydrogen with a reduced radius relative to ordinary hydride ion and having an increase in diamagnetic shielding of the proton. The shift is given by the sum of the contributions of the diamagnetism of the two electrons and the photon field of magnitude p (Mills GUTCP Eq. (7.87)).

$$\frac{Δ {B}_{T}}{B} = - {μ}_{0} \frac{p {e}^{2}}{12 {m}_{e} {a}_{0} ( 1 + \sqrt{s ( s + 1 )} )} ( 1 + p {α}^{2} ) = - ( p 29.9 + {p}^{2} 1.59 \times {10}^{- 3} ) ppm \qquad ( 20 )$$

where the first term applies to H⁻ with p=1 and p=integer>1 for H⁻ (1/p) and a is the fine structure constant. The predicted hydrino hydride peaks are extraordinarily upfield shifted relative to ordinary hydride ion. In an embodiment, the peaks are upfield of TMS. The NMR shift relative to TMS may be greater than that known for at least one of ordinary H⁻, H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 relative to a bare proton, may be −(p29.9+p²2.74) ppm (Eq. (20)) within a range of about at least one of ±5 ppm, ±10 ppm, ±20 ppm, ±30 ppm, ±40 ppm, ±50 ppm, ±60 ppm, ±70 ppm, ±80 ppm, ±90 ppm, and ±100 ppm. The range of the absolute shift relative to a bare proton may be −(p29.9+p²1.59×10⁻³) ppm (Eq. (20)) within a range of about at least one of about 0.10% to 99%, 1% to 50%, and 1% to 10%. In another embodiment, the presence of a hydrino species such as a hydrino atom, hydride ion, or molecule in a solid matrix such as a matrix of a hydroxide such as NaOH or KOH causes the matrix protons to shift upfield. The matrix protons such as those of NaOH or KOH may exchange. In an embodiment, the shift may cause the matrix peak to be in the range of about −0.1 ppm to −5 ppm relative to TMS. The NMR determination may comprise magic angle spinning ¹H nuclear magnetic resonance spectroscopy (MAS ¹H NMR).

H(1/p) may react with a proton and two H (1/p) may react to form H₂(1/p)⁺ and H₂ (1/p), respectively. The hydrogen molecular ion and molecular charge and current density functions, bond distances, and energies were solved from the Laplacian in ellipsoidal coordinates with the constraint of nonradiation.

$$( η - ζ ) {R}_{ξ} \frac{\partial }{\partial ξ} ( {R}_{ξ} \frac{\partial ϕ}{\partial ξ} ) + ( ζ - ξ ) {R}_{η} \frac{\partial }{\partial η} ( {R}_{η} \frac{\partial ϕ}{\partial η} ) + ( ξ - η ) {R}_{ζ} \frac{\partial }{\partial ζ} ( {R}_{ζ} \frac{\partial ϕ}{\partial ζ} ) = 0 \qquad ( 21 )$$

The total energy E_{T} of the hydrogen molecular ion having a central field of +pe at each focus of the prolate spheroid molecular orbital is

$$\begin{matrix}{E}_{T} = - {p}^{2} \{ \begin{matrix}\frac{{e}^{2}}{8 π {ε}_{o} {a}_{H}} ( 4 ln 3 - 1 - 2 ln 3 ) [ 1 + p \sqrt{\frac{2 ℏ \sqrt{\frac{\frac{2 {e}^{2}}{4 π {{ε}_{o} ( 2 {a}_{H} )}^{3}}}{{m}_{e}}}}{{m}_{e} {c}^{2}}} ] \\ - \frac{1}{2} ℏ \sqrt{\frac{\frac{p {e}^{2}}{4 π {{ε}_{o} ( \frac{2 {a}_{H}}{p} )}^{3}} - \frac{p {e}^{2}}{8 π {{ε}_{o} ( \frac{3 {a}_{H}}{p} )}^{3}}}{μ}}\end{matrix} \} \\ = - {p}^{2} 16.1 \; 3392 eV - {p}^{3} 0.11 \; 8755 eV\end{matrix} \qquad ( 22 )$$

where p is an integer, c is the speed of light in vacuum, and p is the reduced nuclear mass. The total energy of the hydrogen molecule having a central field of +pe at each focus of the prolate spheroid molecular orbital is

$$\begin{matrix}{E}_{T} = - {p}^{2} \{ \begin{matrix}\frac{{e}^{2}}{8 {πε}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 h \sqrt{\frac{\frac{{e}^{2}}{4 π {ε}_{o} {a}_{0}^{3}}}{{m}_{e}}}}{{m}_{e} {c}^{2}}} ] \\ - \frac{1}{2} ℏ \sqrt{\frac{\frac{p {e}^{2}}{8 {πε}_{o} {{a}_{0} ( \frac{{a}_{0}}{p} )}^{3}} - \frac{p {e}^{2}}{8 {{πε}_{o} ( \frac{( 1 + \frac{1}{\sqrt{2}} ) {a}_{0}}{p} )}^{3}}}{μ}}\end{matrix} \} \\ = - {p}^{2} 31.3 \; 51 eV - {p}^{3} 0.32 \; 6469 eV\end{matrix} \qquad ( 23 )$$

The bond dissociation energy, E_{D}, of the hydrogen molecule H₂(1/p) is the difference between the total energy of the corresponding hydrogen atoms and E_{T}

E_{D}=E(2H(1/p))−E_{T} (24)

where

$$E ( 2 H ( 1 / p ) ) = - {p}^{2} 27.2 eV \qquad ( 25 )$$

$${E}_{D} is given by Eqs . ( 23 - 25 ) :$$

$$\begin{matrix}{E}_{D} = - {p}^{2} 27.2 eV - {E}_{T} \\ = - {p}^{2} 27.2 eV - ( - {p}^{2} 31.351 eV - {p}^{3} 0.326469 eV ) \\ = {p}^{2} 4.1 \; 51 eV + {p}^{3} 0.326469 eV\end{matrix} \qquad ( 26 )$$

H₂ (1/p) may be identified by X-ray photoelectron spectroscopy (XPS) wherein the ionization product in addition to the ionized electron may be at least one of the possibilities such as those comprising two protons and an electron, a hydrogen (H) atom, a hydrino atom, a molecular ion, hydrogen molecular ion, and H₂ (1/p) wherein the energies may be shifted by the matrix.

The NMR of catalysis-product gas provides a definitive test of the theoretically predicted chemical shift of H₂ (1/p). In general, the ¹H NMR resonance of H₂ (1/p) is predicted to be upfield from that of H₂ due to the fractional radius in elliptic coordinates wherein the electrons are significantly closer to the nuclei. The predicted shift,

$$\frac{Δ {B}_{T}}{B} ,$$

for H₂ (1/p) is given by the sum of the contributions of the diamagnetism of the two electrons and the photon field of magnitude p (Mills GUTCP Eqs. (11.415-11.416)):

$$\frac{Δ {B}_{T}}{B} = - {μ}_{0} ( 4 - \sqrt{2} ln \frac{\sqrt{2} + 1}{\sqrt{2} - 1} ) \frac{p {e}^{2}}{36 {a}_{0} {m}_{e}} ( 1 + p {α}^{2} ) \qquad ( 27 )$$

$$\frac{Δ {B}_{T}}{B} = - ( p 28.01 + {p}^{2} 1.49 \times {10}^{- 3} ) ppm \qquad ( 28 )$$

where the first term applies to H₂ with p=1 and p=integer>1 for H₂ (1/p). The experimental absolute H₂ gas-phase resonance shift of −28.0 ppm is in excellent agreement with the predicted absolute gas-phase shift of −28.01 ppm (Eq. (28)). The predicted molecular hydrino peaks are extraordinarily upfield shifted relative to ordinary H₂. In an embodiment, the peaks are upfield of TMS. The NMR shift relative to TMS may be greater than that known for at least one of ordinary H⁻, H, H₂, or H⁺ alone or comprising a compound. The shift may be greater than at least one of 0, −1, −2, −3, −4, −5, −6, −7, −8, −9, −10, −11, −12, −13, −14, −15, −16, −17, −18, −19, −20, −21, −22, −23, −24, −25, −26, −27, −28, −29, −30, −31, −32, −33, −34, −35, −36, −37, −38, −39, and −40 ppm. The range of the absolute shift relative to a bare proton, wherein the shift of TMS is about −31.5 ppm relative to a bare proton, may be −(p28.01+p²2.56) ppm (Eq. (28)) within a range of about at least one of 5 ppm, +10 ppm, +20 ppm, +30 ppm, +40 ppm, +50 ppm, +60 ppm, +70 ppm, +80 ppm, +90 ppm, and +100 ppm. The range of the absolute shift relative to a bare proton may be −(p28.01+p²1.49×10⁻³) ppm (Eq. (28)) within a range of about at least one of about 0.1% to 99%, 1% to 50%, and 1% to 10%.

The vibrational energies, E_{vib}, for the ν=0 to ν=1 transition of hydrogen-type molecules H₂ (1/p) are

E_{vib}=p²0.515902 eV (29)

where p is an integer.

The rotational energies, Eᵣₒₜ, for the J to J+1 transition of hydrogen-type molecules H₂(1/p) are

$${E}_{r o t} = {E}_{J + 1} - {E}_{J} = \frac{{ℏ}^{2}}{I} [ J + 1 ] = {p}^{2} ( J + 1 ) 0.0 \; 1509 eV \qquad ( 30 )$$

where p is an integer and I is the moment of inertia. Ro-vibrational emission of H₂ (¼) was observed on e-beam excited molecules in gases and trapped in solid matrix.

The p² dependence of the rotational energies results from an inverse p dependence of the internuclear distance and the corresponding impact on the moment of inertia I. The predicted internuclear distance 2c′ for H₂ (1/p) is

$$2 {c}^{′} = \frac{{a}_{o} \sqrt{2}}{p} \qquad ( 31 )$$

At least one of the rotational and vibration energies of H₂(1/p) may be measured by at least one of electron-beam excitation emission spectroscopy, Raman spectroscopy, and Fourier transform infrared (FTIR) spectroscopy. H₂(1/p) may be trapped in a matrix for measurement such as in at least one of MOH, MX, and M₂CO₃ (M=alkali; X=halide) matrix.

In an embodiment, the molecular hydrino product is observed as an inverse Raman effect (IRE) peak at about 1950 cm⁻¹. The peak is enhanced by using a conductive material comprising roughness features or particle size comparable to that of the Raman laser wavelength that supports a Surface Enhanced Raman Scattering (SERS) to show the IRE peak.

I. Catalysts

In the present disclosure the terms such as hydrino reaction, H catalysis, H catalysis reaction, catalysis when referring to hydrogen, the reaction of hydrogen to form hydrinos, and hydrino formation reaction all refer to the reaction such as that of Eqs. (15-18) of a catalyst defined by Eq. (14) with atomic H to form states of hydrogen having energy levels given by Eqs. (10) and (12). The corresponding terms such as hydrino reactants, hydrino reaction mixture, catalyst mixture, reactants for hydrino formation, reactants that produce or form lower-energy state hydrogen or hydrinos are also used interchangeably when referring to the reaction mixture that performs the catalysis of H to H states or hydrino states having energy levels given by Eqs. (10) and (12).

The catalytic lower-energy hydrogen transitions of the present disclosure require a catalyst that may be in the form of an endothermic chemical reaction of an integer m of the potential energy of uncatalyzed atomic hydrogen, 27.2 eV, that accepts the energy from atomic H to cause the transition. The endothermic catalyst reaction may be the ionization of one or more electrons from a species such as an atom or ion (e.g. m=3 for Li→Li²⁺) and may further comprise the concerted reaction of a bond cleavage with ionization of one or more electrons from one or more of the partners of the initial bond (e.g. m=2 for NaH→Na²⁺+H). He⁺ fulfills the catalyst criterion-a chemical or physical process with an enthalpy change equal to an integer multiple of 27.2 eV since it ionizes at 54.417 eV, which is 2·27.2 eV. An integer number of hydrogen atoms may also serve as the catalyst of an integer multiple of 27.2 eV enthalpy. catalyst is capable of accepting energy from atomic hydrogen in integer units of one of about 27.2 eV±0.5 eV and

$$\frac{27.2}{2} eV \pm 0.5 eV .$$

In an embodiment, the catalyst comprises an atom or ion M wherein the ionization of t electrons from the atom or ion M each to a continuum energy level is such that the sum of ionization energies of the t electrons is approximately one of m·27.2 eV and

$$m \cdot \frac{27.2}{2} eV$$

where m is an integer.

In an embodiment, the catalyst comprises a diatomic molecule MH wherein the breakage of the M-H bond plus the ionization of t electrons from the atom M each to a continuum energy level is such that the sum of the bond energy and ionization energies of the t electrons is approximately one of m·27.2 eV and

$$m \cdot \frac{27.2}{2} eV$$

where m is an integer.

In an embodiment, the catalyst comprises atoms, ions, and/or molecules chosen from molecules of AlH, AsH, BaH, BiH, CdH, ClH, CoH, GeH, InH, NaH, NbH, OH, RhH, RuH, SH, SbH, SeH, SiH, SnH, SrH, TlH, C₂, N₂, O₂, CO₂, NO₂, and NO₃ and atoms or ions of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, Pt, Kr, 2K⁺, He⁺, Ti²⁺, Na⁺, Rb⁺, Sr⁺, Fe³⁺, Mo²⁺, Mo⁴⁺, In³⁺, He⁺, Ar⁺, Xe⁺, Ar²⁺ and H⁺, and Ne⁺ and H⁺.

In other embodiments, MH⁻ type hydrogen catalysts to produce hydrinos provided by the transfer of an electron to an acceptor A, the breakage of the M-H bond plus the ionization of t electrons from the atom M each to a continuum energy level such that the sum of the electron transfer energy comprising the difference of electron affinity (EA) of MH and A, M-H bond energy, and ionization energies of the t electrons from M is approximately m·27.2 eV where m is an integer. MH⁻ type hydrogen catalysts capable of providing a net enthalpy of reaction of approximately m·27.2 eV are OH⁻, SiH⁻, CoH⁻, NiH, and SeH⁻

In other embodiments, MH⁺ type hydrogen catalysts to produce hydrinos are provided by the transfer of an electron from a donor A which may be negatively charged, the breakage of the M-H bond, and the ionization of t electrons from the atom M each to a continuum energy level such that the sum of the electron transfer energy comprising the difference of ionization energies of MH and A, bond M-H energy, and ionization energies of the t electrons from M is approximately m·27.2 eV where m is an integer.

In an embodiment, at least one of a molecule or positively or negatively charged molecular ion serves as a catalyst that accepts about m·27.2 eV from atomic H with a decrease in the magnitude of the potential energy of the molecule or positively or negatively charged molecular ion by about m·27.2 eV. Exemplary catalysts are H₂O, OH, amide group NH₂, and H₂S.

O₂ may serve as a catalyst or a source of a catalyst. The bond energy of the oxygen molecule is 5.165 eV, and the first, second, and third ionization energies of an oxygen atom are 13.61806 eV, 35.11730 eV, and 54.9355 eV, respectively. The reactions O₂→O+O²⁺, O₂→O+O³⁺, and 2O→2O⁺ provide a net enthalpy of about 2, 4, and 1 times Eₕ, respectively, and comprise catalyst reactions to form hydrino by accepting these energies from H to cause the formation of hydrinos.

II. Hydrinos

A hydrogen atom having a binding energy given by

$${E}_{B} = \frac{13.6 eV}{{( 1 / p )}^{2}}$$

where p is an integer greater than 1, preferably from 2 to 137, is the product of the H catalysis reaction of the present disclosure. The binding energy of an atom, ion, or molecule, also known as the ionization energy, is the energy required to remove one electron from the atom, ion or molecule. A hydrogen atom having the binding energy given in Eqs. (10) and (12) is hereafter referred to as a “hydrino atom” or “hydrino.” The designation for a hydrino of radius

$$\frac{{a}_{H}}{p} ,$$

where a_{H} is the radius of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

According to the present disclosure, a hydrino hydride ion (H⁻) having a binding energy according to Eq. (19) that is greater than the binding of ordinary hydride ion (about 0.75 eV) for p=2 up to 23, and less for p=24 (H⁻) is provided. For p=2 to p=24 of Eq. (19), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. Exemplary compositions comprising the novel hydride ion are also provided herein.

Exemplary compounds are also provided comprising one or more hydrino hydride ions and one or more other elements. Such a compound is referred to as a “hydrino hydride compound.”

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule, 15.3 eV (“ordinary hydrogen molecule”); (d) hydrogen molecular ion, 16.3 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further embodiment of the present disclosure, a compound is provided comprising at least one increased binding energy hydrogen species such as (a) a hydrogen atom having a binding energy of about

$$\frac{13.6 eV}{{( \frac{1}{p} )}^{2}} ,$$

such as within a range of about 0.9 to 1.1 times

$$\frac{13.6 eV}{{( \frac{1}{p} )}^{2}}$$

where p is an integer from 2 to 137; (b) a hydride ion (H⁻) having a binding energy of about

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} ) ,$$

such as within a range of about 0.9 to 1.1 times

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2}} ( \frac{1}{{a}_{H}^{3}} + \frac{{2}^{2}}{{{a}_{0}^{3} [ \frac{1 + \sqrt{s ( s + 1 )}}{p} ]}^{3}} )$$

where p is an integer from 2 to 24; (c) H₄⁺(1/p); (d) a trihydrino molecular ion, H₃⁺(1/p), having a binding energy of about

$$\frac{22.6}{{( \frac{1}{p} )}^{2}} eV$$

such as within a range of about 0.9 to 1.1 times

$$\frac{22.6}{{( \frac{1}{p} )}^{2}} eV$$

where p is an integer from 2 to 137; (e) a dihydrino having a binding energy of about

$$\frac{15.3}{{( \frac{1}{p} )}^{2}} eV$$

such as within a range of about 0.9 to 1.1 times

$$\frac{15.3}{{( \frac{1}{p} )}^{2}} eV$$

where p is an integer from 2 to 137; (f) a dihydrino molecular ion with a binding energy of about

$$\frac{16.3}{{( \frac{1}{p} )}^{2}} eV$$

such as within a range of about 0.9 to 1.1 times

$$\frac{16.3}{{( \frac{1}{p} )}^{2}} eV$$

where p is an integer, preferably an integer from 2 to 137.

According to a further embodiment of the present disclosure, a compound is provided comprising at least one increased binding energy hydrogen species such as (a) a dihydrino molecular ion having a total energy of about

$$\begin{matrix}{E}_{T} = - {p}^{2} \{ \begin{matrix}\frac{{e}^{2}}{8 {πε}_{o} {a}_{H}} ( 4 ln 3 - 1 - 2 ln 3 ) [ 1 + p \sqrt{\frac{2 ℏ \sqrt{\frac{\frac{2 {e}^{2}}{4 {{πε}_{o} ( 2 {a}_{H} )}^{3}}}{{m}_{e}}}}{{m}_{e} {c}^{2}}} ] \\ - \frac{1}{2} ℏ \sqrt{\frac{\frac{p {e}^{2}}{{4 {πε}_{o} [ \frac{2 {a}_{H}}{p} )}^{3}} - \frac{p {e}^{2}}{8 {{πε}_{o} ( \frac{3 {a}_{H}}{p} )}^{3}}}{μ}}\end{matrix} \} \\ = - {p}^{2} 16.1 \; 3392 eV - {p}^{3} 0.1 \; 18755 eV\end{matrix}$$

such as within a range of about 0.9 to 1.1 times

$$\begin{matrix}{E}_{T} = - {p}^{2} \{ \begin{matrix}\frac{{e}^{2}}{8 {πε}_{o} {a}_{H}} ( 4 ln 3 - 1 - 2 ln 3 ) [ 1 + p \sqrt{\frac{2 ℏ \sqrt{\frac{\frac{2 {e}^{2}}{4 {{πε}_{o} ( 2 {a}_{H} )}^{3}}}{{m}_{e}}}}{{m}_{e} {c}^{2}}} ] \\ - \frac{1}{2} ℏ \sqrt{\frac{\frac{p {e}^{2}}{{4 {πε}_{o} [ \frac{2 {a}_{H}}{p} )}^{3}} - \frac{p {e}^{2}}{8 {{πε}_{o} ( \frac{3 {a}_{H}}{p} )}^{3}}}{μ}}\end{matrix} \} \\ = - {p}^{2} 16.1 \; 3392 eV - {p}^{3} 0.1 \; 18755 eV\end{matrix}$$

where p is an integer, ℏ is Planck's constant bar, m, is the mass of the electron, c is the speed of light in vacuum, and μ is the reduced nuclear mass, and (b) a dihydrino molecule having a total energy of about

$$\begin{matrix}{E}_{T} = - {p}^{2} \{ \begin{matrix}\frac{{e}^{2}}{8 {πε}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 ℏ \sqrt{\frac{\frac{{e}^{2}}{4 {πε}_{o} {a}_{0}^{3}}}{{m}_{e}}}}{{m}_{e} {c}^{2}}} ] \\ - \frac{1}{2} ℏ \sqrt{\frac{\frac{p {e}^{2}}{8 {{πε}_{o} ( \frac{{a}_{0}}{p} )}^{3}} - \frac{p {e}^{2}}{8 {{πε}_{o} ( \frac{( 1 + \frac{1}{\sqrt{2}} ) {a}_{0}}{p} )}^{3}}}{μ}}\end{matrix} \} \\ = - {p}^{2} 31.351 eV - {p}^{3} 0.326469 eV\end{matrix}$$

such as within a range of about 0.9 to 1.1 times

$$\begin{matrix}{E}_{T} = - {p}^{2} \{ \begin{matrix}\frac{{e}^{2}}{8 {πε}_{o} {a}_{0}} [ ( 2 \sqrt{2} - \sqrt{2} + \frac{\sqrt{2}}{2} ) ln \frac{\sqrt{2} + 1}{\sqrt{2} - 1} - \sqrt{2} ] [ 1 + p \sqrt{\frac{2 ℏ \sqrt{\frac{\frac{{e}^{2}}{4 {πε}_{o} {a}_{0}^{3}}}{{m}_{e}}}}{{m}_{e} {c}^{2}}} ] \\ - \frac{1}{2} ℏ \sqrt{\frac{\frac{p {e}^{2}}{8 {{πε}_{o} ( \frac{{a}_{0}}{p} )}^{3}} - \frac{p {e}^{2}}{8 {{πε}_{o} ( \frac{( 1 + \frac{1}{\sqrt{2}} ) {a}_{0}}{p} )}^{3}}}{μ}}\end{matrix} \} \\ = - {p}^{2} 31.351 eV - {p}^{3} 0.326469 eV\end{matrix}$$

where p is an integer and aₒ is the Bohr radius.

According to one embodiment of the present disclosure wherein the compound comprises a negatively charged increased binding energy hydrogen species, the compound further comprises one or more cations, such as a proton, ordinary H₂⁺, or ordinary H₃⁺.

A method is provided herein for preparing compounds comprising at least one hydrino hydride ion. Such compounds are hereinafter referred to as “hydrino hydride compounds.” The method comprises reacting atomic hydrogen with a catalyst having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}} \qquad ( 1 )$$

where p is an integer, preferably an integer from 2 to 137. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

In an embodiment, at least one of very high power and energy may be achieved by the hydrogen undergoing transitions to hydrinos of high p values in Eq. (18) in a process herein referred to as disproportionation as given in Mills GUTCP Chp. 5 which is incorporated by reference. Hydrogen atoms H(1/p) p=1, 2, 3, . . . 137 can undergo further transitions to lower-energy states given by Eqs. (10) and (12) wherein the transition of one atom is catalyzed by a second that resonantly and nonradiatively accepts m·27.2 eV with a concomitant opposite change in its potential energy. The overall general equation for the transition of H (1/p) to H (1/(p+m)) induced by a resonance transfer of m·27.2 eV to H (1/p′) given by Eq. (32) is represented by

H(1/p′)+H(1/p)→H+H(1/(p+m))+[2pm+m²−p′²+1]·13.6 eV (32)

The EUV light from the hydrino process may dissociate the dihydrino molecules and the resulting hydrino atoms may serve as catalysts to transition to lower energy states. An exemplary reaction comprises the catalysis H to H( 1/17) by H(¼) wherein H(¼) may be a reaction product of the catalysis of another H by HOH. Disproportionation reactions of hydrinos are predicted to given rise to features in the X-ray region. As shown by Eqs. (5-8) the reaction product of HOH catalyst is

$$H [ \frac{{a}_{H}}{4} ] .$$

Consider a likely transition reaction in hydrogen clouds containing H₂O gas wherein the first hydrogen-type atom

$$H [ \frac{{a}_{H}}{p} ]$$

is an H atom and the second acceptor hydrogen-type atom

$$H [ \frac{{a}_{H}}{{p}^{′}} ]$$

serving as a catalyst is

$$H [ \frac{{a}_{H}}{4} ] .$$

Since the potential energy of

$$H [ \frac{{a}_{H}}{4} ]$$

is 4²·27.2 eV=16·27.2 eV 435.2 eV, the transition reaction is represented by

$$16 \cdot 27.2 eV + H [ \frac{{a}_{H}}{4} ] + H [ \frac{{a}_{H}}{1} ] \to {H}_{fast}^{+} + {e}^{-} + H * [ \frac{{a}_{H}}{17} ] + 16 \cdot 27.2 eV \qquad ( 33 )$$

$${H}^{*} [ \frac{{a}_{H}}{17} ] \to H [ \frac{{a}_{H}}{17} ] + 3481.6 eV \qquad ( 34 )$$

$${H}_{fast}^{+} + {e}^{-} \to H [ \frac{{a}_{H}}{1} ] + 231.2 eV \qquad ( 35 )$$

And, the overall reaction is

$$H [ \frac{{a}_{H}}{4} ] + H [ \frac{{a}_{H}}{1} ] \to H [ \frac{{a}_{H}}{1} ] + H [ \frac{{a}_{H}}{17} ] + 3 712.8 eV \qquad ( 36 )$$

The extreme-ultraviolet continuum radiation band due to the

$$H * [ \frac{{a}_{H}}{p + m} ]$$

intermediate (e.g. Eq. (16) and Eq. (34)) is predicted to have a short wavelength cutoff and energy

$${E}_{( H \to H [ \frac{{a}_{H}}{p + m} ] )}$$

given by

$${E}_{( H \to H [ \frac{{a}_{H}}{p + m} ] )} = [ {( p + m )}^{2} - {p}^{2} ] \cdot 13.6 eV - m \cdot 27.2 eV \qquad ( 37 )$$

$${λ}_{( H \to H [ \frac{{a}_{H}}{p + m} ] )} = \frac{91.2}{[ {( p + m )}^{2} - {p}^{2} ] \cdot 136 eV - m \cdot 27.2 eV} nm$$

and extending to longer wavelengths than the corresponding cutoff. Here the extreme-ultraviolet continuum radiation band due to the decay of the

$${H}^{*} [ \frac{{a}_{H}}{17} ]$$

intermediate is predicted to have a short wavelength cutoff at E=3481.6 eV; 0.35625 nm and extending to longer wavelengths. A broad X-ray peak with a 3.48 keV cutoff was observed in the Perseus Cluster by NASA's Chandra X-ray Observatory and by the XMM-Newton [E. Bulbul, M. Markevitch, A. Foster, R. K. Smith, M. Loewenstein, S. W. Randall, “Detection of an unidentified emission line in the stacked X-Ray spectrum of galaxy clusters,” The Astrophysical Journal, Volume 789, Number 1, (2014); A. Boyarsky, O. Ruchayskiy, D. Iakubovskyi, J. Franse, “An unidentified line in X-ray spectra of the Andromeda galaxy and Perseus galaxy cluster,” (2014),arXiv:1402.4119 [astro-ph.CO]] that has no match to any known atomic transition. The 3.48 keV feature assigned to dark matter of unknown identity by BulBul et al. matches the

$$H [ \frac{{a}_{H}}{4} ] + H [ \frac{{a}_{H}}{1} ] \to H [ \frac{{a}_{H}}{17} ]$$

transition and further confirms hydrinos as the identity of dark matter.

The novel hydrogen compositions of matter can comprise:
(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and
(b) at least one other element. Typically, the hydrogen products described herein are increased binding energy hydrogen species.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising
(a) at least one neutral, positive, or negative hydrogen species (hereinafter “increased binding energy hydrogen species”) having a total energy
(i) greater than the total energy of the corresponding ordinary hydrogen species, or
(ii) greater than the total energy of any hydrogen species for which the corresponding ordinary hydrogen species is unstable or is not observed because the ordinary hydrogen species' total energy is less than thermal energies at ambient conditions, or is negative; and
(b) at least one other element.

The total energy of the hydrogen species is the sum of the energies to remove all of the electrons from the hydrogen species. The hydrogen species, such as those produced during generation of the second plasma, according to the present disclosure may have a total energy greater than the total energy of a corresponding hydrogen species that has not undergone a reaction with the nascent water as described herein. The hydrogen species having an increased total energy according to the present disclosure is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (19) for p=24 has a first binding energy that is less than the first binding energy of ordinary hydride ion, while the total energy of the hydride ion of Eq. (19) for p=24 is much greater than the total energy of the corresponding ordinary hydride ion.

Also provided herein are novel compounds and molecular ions comprising
(a) a plurality of neutral, positive, or negative hydrogen species having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and
(b) optionally one other element. The compounds of the present disclosure may be referred to as “increased binding energy hydrogen compounds.” Various spectroscopic signatures as described herein may identify these species.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising
(a) a plurality of neutral, positive, or negative hydrogen species having a total energy
   (i) greater than the total energy of ordinary molecular hydrogen, or
   (ii) greater than the total energy of any hydrogen species for which the corresponding ordinary hydrogen species is unstable or is not observed because the ordinary hydrogen species' total energy is less than thermal energies at ambient conditions or is negative; and
(b) optionally one other element.

In an embodiment, a compound is provided comprising at least one increased binding energy hydrogen species chosen from (a) hydride ion having a binding energy according to Eq. (19) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.3 eV (“increased binding energy hydrogen molecule” or “dihydrino”); and (d) molecular hydrogen ion having a binding energy greater than about 16.3 eV (“increased binding energy molecular hydrogen ion” or “dihydrino molecular ion”). In the disclosure, increased binding energy hydrogen species and compounds is also referred to as lower-energy hydrogen species and compounds. Hydrinos comprise an increased binding energy hydrogen species or equivalently a lower-energy hydrogen species.

III. Chemical Reactor

The present disclosure is also directed to other reactors for producing increased binding energy hydrogen species and compounds of the present disclosure, such as dihydrino molecules and hydrino hydride compounds. Further products of the catalysis are power and optionally plasma and light depending on the cell type. Such a reactor is hereinafter referred to as a “hydrogen reactor” or “hydrogen cell.” The hydrogen reactor comprises a cell for making hydrinos. The cell for making hydrinos may take the form of a chemical reactor or gas fuel cell such as a gas discharge cell, a plasma torch cell, or microwave power cell, and an electrochemical cell. In an embodiment, the catalyst is HOH and the source of at least one of the HOH and H is ice. The ice may have a high surface area to increase at least one of the rates of the formation of HOH catalyst and H from ice and the hydrino reaction rate. The ice may be in the form of fine chips to increase the surface area. In an embodiment, the cell comprises an arc discharge cell and that comprises ice at least one electrode such that the discharge involves at least a portion of the ice.

In an embodiment, the arc discharge cell comprises a vessel, two electrodes, a high voltage power source such as one capable of a voltage in the range of about 100 V to 1 MV and a current in the range of about 1 A to 100 kA, and a source of water such as a reservoir and a means to form and supply H₂O droplets. The droplets may travel between the electrodes. In an embodiment, the droplets initiate the ignition of the arc plasma. In an embodiment, the water arc plasma comprises H and HOH that may react to form hydrinos. The ignition rate and the corresponding power rate may be controlled by controlling the size of the droplets and the rate at which they are supplied to the electrodes. The source of high voltage may comprise at least one high voltage capacitor that may be charged by a high voltage power source. In an embodiment, the arc discharge cell further comprises a means such as a power converter such as one of the present invention such as at least one of a PV converter and a heat engine to convert the power from the hydrino process such as light and heat to electricity.

Exemplary embodiments of the cell for making hydrinos may take the form of a liquid-fuel cell, a solid-fuel cell, a heterogeneous-fuel cell, a CIHT cell, and an SF-CIHT or SunCell® cell. Each of these cells comprises: (i) reactants including a source of atomic hydrogen; (ii) at least one catalyst chosen from a solid catalyst, a molten catalyst, a liquid catalyst, a gaseous catalyst, or mixtures thereof for making hydrinos; and (iii) a vessel for reacting hydrogen and the catalyst for making hydrinos. As used herein and as contemplated by the present disclosure, the term “hydrogen,” unless specified otherwise, includes not only proteum (¹H), but also deuterium (²H) and tritium (³H). Exemplary chemical reaction mixtures and reactors may comprise SF-CIHT, CIHT, or thermal cell embodiments of the present disclosure. Additional exemplary embodiments are given in this Chemical Reactor section. Examples of reaction mixtures having H₂O as catalyst formed during the reaction of the mixture are given in the present disclosure. Other catalysts may serve to form increased binding energy hydrogen species and compounds. The reactions and conditions may be adjusted from these exemplary cases in the parameters such as the reactants, reactant wt %'s, H₂ pressure, and reaction temperature. Suitable reactants, conditions, and parameter ranges are those of the present disclosure. Hydrinos and molecular hydrino are shown to be products of the reactors of the present disclosure by predicted continuum radiation bands of an integer times 13.6 eV, otherwise unexplainable extraordinarily high H kinetic energies measured by Doppler line broadening of H lines, inversion of H lines, formation of plasma without a breakdown fields, and anomalously plasma afterglow duration as reported in Mills Prior Publications. The data such as that regarding the CIHT cell and solid fuels has been validated independently, off site by other researchers. The formation of hydrinos by cells of the present disclosure was also confirmed by electrical energies that were continuously output over long-duration, that were multiples of the electrical input that in most cases exceed the input by a factor of greater than 10 with no alternative source. The predicted molecular hydrino H₂(¼) was identified as a product of CIHT cells and solid fuels by MAS H NMR that showed a predicted upfield shifted matrix peak of about −4.4 ppm, ToF-SIMS and ESI-ToFMS that showed H₂(¼) complexed to a getter matrix as m/e=M+n2 peaks wherein M is the mass of a parent ion and n is an integer, electron-beam excitation emission spectroscopy and photoluminescence emission spectroscopy that showed the predicted rotational and vibration spectrum of H₂(¼) having 16 or quantum number p=4 squared times the energies of H₂, Raman and FTIR spectroscopy that showed the rotational energy of H₂(¼) of 1950 cm¹, being 16 or quantum number p=4 squared times the rotational energy of H₂, XPS that showed the predicted total binding energy of H₂(¼) of 500 eV, and a ToF-SIMS peak with an arrival time before the m/e=1 peak that corresponded to H with a kinetic energy of about 204 eV that matched the predicted energy release for H to H(¼) with the energy transferred to a third body H as reported in Mills Prior Publications and in R. Mills X Yu, Y. Lu, G Chu, J. He, J. Lotoski, “Catalyst Induced Hydrino Transition (CIHT) Electrochemical Cell”, International Journal of Energy Research, (2013) and R. Mills, J. Lotoski, J. Kong, G Chu, J. He, J. Trevey, “High-Power-Density Catalyst Induced Hydrino Transition (CIHT) Electrochemical Cell” (2014) which are herein incorporated by reference in their entirety.

Using both a water flow calorimeter and a Setaram DSC 131 differential scanning calorimeter (DSC), the formation of hydrinos by cells of the present disclosure such as ones comprising a solid fuel to generate thermal power was confirmed by the observation of thermal energy from hydrino-forming solid fuels that exceed the maximum theoretical energy by a factor of 60 times. The MAS H NMR showed a predicted H₂(¼) upfield matrix shift of about −4.4 ppm. A Raman peak starting at 1950 cm¹ matched the free space rotational energy of H₂(¼) (0.2414 eV). These results are reported in Mills Prior Publications and in R. Mills, J. Lotoski, W. Good, J. He, “Solid Fuels that Form HOH Catalyst”, (2014) which is herein incorporated by reference in its entirety.

IV. SunCell and Power Converter

Power systems (also referred to herein as “SunCell”) that generate at least one of electrical energy and thermal energy may comprise:
a) at least one vessel capable of a maintaining a pressure below atmospheric comprising a reaction chamber;
b) two electrodes configured to allow a molten metal flow therebetween to complete a circuit;
c) a power source connected to said two electrodes to apply an ignition current therebetween when said circuit is closed;
d) a plasma generation cell (e.g., glow discharge cell) to induce the formation of a first plasma from a gas delivered thereto; wherein effluence of the plasma generation cell is directed towards the circuit (e.g., the molten metal, the anode, the cathode, an electrode submerged in a molten metal reservoir);
   wherein when current is applied across the circuit, the effluence of the plasma generation cell undergoes a reaction to producing a second plasma and reaction products; and
e) a power adapter comprising a thermophotovoltaic converter configured to convert and/or transfer energy from the second plasma into mechanical, thermal, and/or electrical energy;
   wherein optical energy (e.g. one or more of ultraviolet, visible, and infrared light) from the second plasma is converted in the thermophotovoltaic converter. Alternatively, energy from the second plasma is absorbed in a blackbody radiator to produce blackbody radiation and said blackbody radiation is converted in the thermophotovoltaic converter. In some embodiments, the power adapter is a plurality of thermophotovoltaic adapters. The thermophotovoltaic adapter may comprise a photovoltaic converter in a geodesic dome, wherein the photovoltaic converter may comprise a receiver array (e.g., a dense receiver array) comprised of triangular elements; and
wherein each triangular element comprises a plurality of concentrator photovoltaic cells capable of converting the blackbody radiation into electricity. In some embodiments, the positively biased electrode of the two electrodes is, comprises, or is connected to the blackbody radiator. In various implementations, the photons produced from the plasma having an energy less than the bandgap of the photovoltaic cells (e.g., infrared) are reflected back towards the plasma generation cell (e.g., towards the blackbody radiator). In some embodiments, the effluence comprises (or consists of) nascent water and atomic hydrogen. In some embodiments, the effluence comprises (or consists of) nascent water, and molecular hydrogen. In some embodiments, the effluence comprises (or consists of) nascent water, atomic hydrogen, and molecular hydrogen. In some embodiments, the effluence further comprises a noble gas (e.g., argon). In particularly embodiments, the gas that is sent to the glow discharge cell is a mixture of oxygen gas (O₂) and hydrogen (H₂) in a noble gas such as argon. The molar ratio of oxygen to hydrogen may be, for example, less than (or from 0.1 to) 10, less than 5, or less than 2.

The converter may be one given in Mills Prior Publications and Mills Prior Applications. The hydrino reactants such as H sources and HOH sources and SunCell® systems may comprise those of the present disclosure or in prior US Patent Applications such as Hydrogen Catalyst Reactor, PCT/US08/61455, filed PCT Apr. 24, 2008; Heterogeneous Hydrogen Catalyst Reactor, PCT/US09/052072, filed PCT Jul. 29, 2009; Heterogeneous Hydrogen Catalyst Power System, PCT/US10/27828, PCT filed Mar. 18, 2010; Electrochemical Hydrogen Catalyst Power System, PCT/US11/28889, filed PCT Mar. 17, 2011; H₂O-Based Electrochemical Hydrogen-Catalyst Power System, PCT/US12/31369 filed Mar. 30, 2012; CIHT Power System, PCT/US13/041938 filed May 21, 2013; Power Generation Systems and Methods Regarding Same, PCT/IB2014/058177 filed PCT Jan. 10, 2014; Photovoltaic Power Generation Systems and Methods Regarding Same, PCT/US14/32584 filed PCT Apr. 1, 2014; Electrical Power Generation Systems and Methods Regarding Same, PCT/US2015/033165 filed PCT May 29, 2015; Ultraviolet Electrical Generation System Methods Regarding Same, PCT/US2015/065826 filed PCT Dec. 15, 2015; Thermophotovoltaic Electrical Power Generator, PCT/US16/12620 filed PCT Jan. 8, 2016; Thermophotovoltaic Electrical Power Generator Network, PCT/US2017/035025 filed PCT Dec. 7, 2017; Thermophotovoltaic Electrical Power Generator, PCT/US2017/013972 filed PCT Jan. 18, 2017; Extreme and Deep Ultraviolet Photovoltaic Cell, PCT/US2018/012635 filed PCT Jan. 5, 2018; Magnetohydrodynamic Electric Power Generator, PCT/US18/17765 filed PCT Feb. 12, 2018; Magnetohydrodynamic Electric Power Generator, PCT/US2018/034842 filed PCT May 29, 2018; Magnetohydrodynamic Electric Power Generator, PCT/IB2018/059646 filed PCT Dec. 5, 2018; Magnetohydrodynamic Electric Power Generator, PCT/IB2020/050360 filed PCT Jan. 16, 2020; and Magnetohydrodynamic Hydrogen Electrical Power Generator, PCT/US21/17148 filed Feb. 8, 2021 (“Mills Prior Applications”) herein incorporated by reference in their entirety.

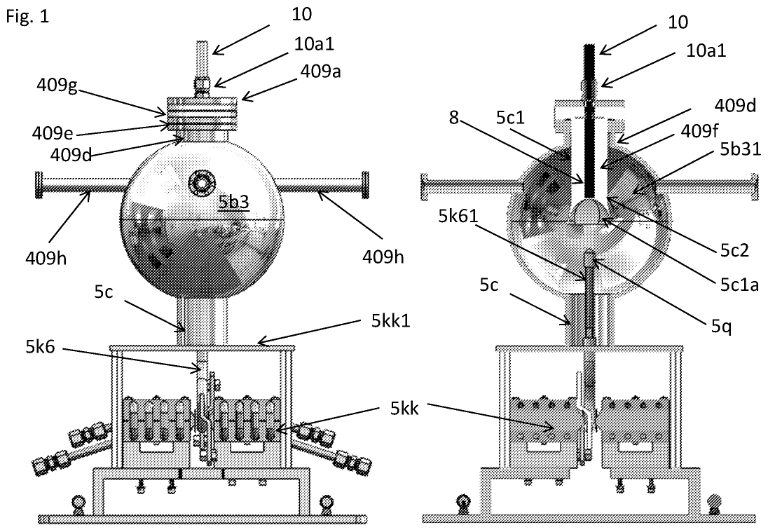

In an embodiment, the EM pump magnets 5k4 are oriented along the same axis as the injected molten metal stream that connects two electrodes that may be opposed along the same axis as shown in FIGS. 1-30 and 7A-C. The magnets may be located on opposite sides of the EM pump tube 5k6 with one positioned in the opposite direction as the other along the injection axis. The EM pump bus bars 5k2 may each be oriented perpendicular to the injection axis and oriented in the direction away from the side of the closest magnet. The EM pump magnets may each further comprise and L-shaped yoke to direct magnetic flux from the corresponding vertically oriented magnet in the transverse direction relative to the EM pump tube 5k6 and perpendicular to both the direction of the molten metal flow in the tube and the direction on the EM pump current. The ignition system may comprise one that has a time varying waveform comprising voltage and current such as an AC waveform such as a 60 Hz waveform. The vertical orientation of the magnets may protect them from being demagnetized by the time-varying ignition current.

In an embodiment, the transfer of energy from atomic hydrogen catalyzed to a hydrino state results in the ionization of the catalyst. The electrons ionized from the catalyst may accumulate in the reaction mixture and vessel and result in space charge build up. The space charge may change the energy levels for subsequent energy transfer from the atomic hydrogen to the catalyst with a reduction in reaction rate. In an embodiment, the application of the high current removes the space charge to cause an increase in hydrino reaction rate. In another embodiment, the current applied across the molten metal circuit such as an arc current causes the reactants such as water to be extremely elevated in temperature. The high temperature may give rise to the thermolysis of the water to at least one of H and HOH catalyst. In an embodiment, the reaction mixture of the SunCell® comprises a source of H and a source of catalyst such as at least one of nH (n is an integer) and HOH. The at least one of nH and HOH may be formed by the thermolysis or thermal decomposition of at least one physical phase of water such as at least one of solid, liquid, and gaseous water. The thermolysis may occur at high temperature such as a temperature in at least one range of about 500K to 10,000K, 1000K to 7000K, and 1000K to 5000K. In an exemplary embodiment, the reaction temperature is about 3500 to 4000K such that the mole fraction of atomic H is high as shown by J. Lede, F. Lapicque, and J Villermaux [J. Lédé, F. Lapicque, J. Villermaux, “Production of hydrogen by direct thermal decomposition of water”, International Journal of Hydrogen Energy, 1983, V8, 1983, pp. 675-679; H. H. G. Jellinek, H. Kachi, “The catalytic thermal decomposition of water and the production of hydrogen”, International Journal of Hydrogen Energy, 1984, V9, pp. 677-688; S. Z. Baykara, “Hydrogen production by direct solar thermal decomposition of water, possibilities for improvement of process efficiency”, International Journal of Hydrogen Energy, 2004, V29, pp. 1451-1458; S. Z. Baykara, “Experimental solar water thermolysis”, International Journal of Hydrogen Energy, 2004, V29, pp. 1459-1469 which are herein incorporated by reference]. The thermolysis may be assisted by a solid surface such as one of the cell components. The solid surface may be heated to an elevated temperature by the input power and by the plasma maintained by the hydrino reaction. The thermolysis gases such as those down stream of the ignition region may be cooled to prevent recombination or the back reaction of the products into the starting water. The reaction mixture may comprise a cooling agent such as at least one of a solid, liquid, or gaseous phase that is at a lower temperature than the temperature of the product gases. The cooling of the thermolysis reaction product gases may be achieved by contacting the products with the cooling agent. The cooling agent may comprise at least one of lower temperature steam, water, and ice.

In an embodiment, the reactants present in the gas may comprise at least one of a source of H, H₂, a source of catalyst, a source of H₂O, and H₂O. Suitable reactants may comprise a conductive metal matrix and a hydrate such as at least one of an alkali hydrate, an alkaline earth hydrate, and a transition metal hydrate. The hydrate may comprise at least one of MgCl₂·6H₂O, BaI₂·2H₂O, and ZnCl₂·4H₂O. Alternatively, the reactants may comprise at least one of silver, tin, copper, hydrogen gas, oxygen gas, and water.

In an embodiment, the reaction cell chamber 5b31, which is where the reactants may undergo the plasma forming reaction, may be operated under low pressure to achieve high gas temperature. Then the pressure may be increased by a reaction mixture gas source and controller to increase reaction rate wherein the high temperature maintains nascent HOH and atomic H by thermolysis of at least one of H bonds of water dimers and H₂ covalent bonds. An exemplary threshold gas temperature to achieve thermolysis is about 3300° C. A plasma having a higher temperature than about 3300° C. may break H₂O dimer bonds to form nascent HOH to serve as the hydrino catalyst. At least one of the reaction cell chamber H₂O vapor pressure, H₂ pressure, and O₂ pressure may be in at least one range of about 0.01 Torr to 100 atm, 0.1 Torr to 10 atm, and 0.5 Torr to 1 atm. The EM pumping rate may be in at least one range of about 0.01 ml/s to 10,000 ml/s, 0.1 ml/s to 1000 ml/s, and 0.1 ml/s to 100 ml/s. In embodiment, at least one of a high ignition power and a low pressure may be maintained initially to heat the plasma and the cell to achieve thermolysis.

In an embodiment, the ignition power may be at an initial power level and waveform of the disclosure and may be switched to a second power level and waveform when the reaction cell chamber achieves a desired temperature. In an embodiment, the second power level may be less than the initial. The second power level may be about zero. The condition to switch at least one of the power level and waveform is the achievement of a reaction cell chamber temperature above a threshold wherein the hydrino reaction kinetics may be maintained within 20% to 100% of the initial rates while operating at the second power level. In an embodiment, the temperature threshold may be in at least one range of about 800° C. to 3000° C., 900° C. to 2500° C., and 1000° C. to 2000° C.

In an embodiment, the reaction cell chamber is heated to a temperature that will sustain the second plasma in the absence of ignition power. In an embodiment, the EM pumping may or may not be maintained following termination of the ignition power wherein the suppling of hydrino reactants such as at least one of H₂, O₂, and H₂O is maintained during the ignition-off operation of the SunCell®. In an exemplary embodiment, the SunCell® shown in FIG. 1 was well insulated with silica-alumina fiber insulation, 2500 sccm H₂ and 250 sccm O₂ gases were flowed over Pt/Al₂O₃ beads, and the SunCell® was heated to a temperature in the range of 900° C. to 1400° C. With continued maintenance of the H₂ and O₂ flow and EM pumping, the hydrino reaction self-sustained in the absence of ignition power as evidenced by an increase in the temperature over time in the absence of the input ignition power.

### Ignition System

In an embodiment, the ignition system comprises a switch to at least one of initiate the current and interrupt the current once ignition is achieved. The flow of current may be initiated by the contact of the molten metal streams. The switching may be performed electronically by means such as at least one of an insulated gate bipolar transistor (IGBT), a silicon-controlled rectifier (SCR), and at least one metal oxide semiconductor field effect transistor (MOSFET). Alternatively, ignition may be switched mechanically. The current may be interrupted following ignition in order to optimize the output hydrino generated energy relative to the input ignition energy. The ignition system may comprise a switch to allow controllable amounts of energy to flow into the fuel to cause detonation and turn off the power during the phase wherein plasma is generated. In an embodiment, the source of electrical power to deliver a short burst of high-current electrical energy comprises at least one of the following:
a voltage selected to cause a high AC, DC, or an AC-DC mixture of current that is in the range of at least one of 100 A to 1,000,000 A, 1 kA to 100,000 A, 10 kA to 50 kA;
a DC or peak AC current density in the range of at least one of 1 A/cm² to 1,000,000 A/cm², 1000 A/cm² to 100,000 A/cm², and 2000 A/cm² to 50,000 A/cm²;
wherein the voltage is determined by the conductivity of the solid fuel wherein the voltage is given by the desired current times the resistance of the solid fuel sample;
the DC or peak AC voltage is in the range of at least one of 0.1 V to 500 kV, 0.1 V to 100 kV, and 1 V to 50 kV, and
the AC frequency is in range of at least one of 0.1 Hz to 10 GHz, 1 Hz to 1 MHz, 10 Hz to 100 kHz, and 100 Hz to 10 kHz.

The system may further comprise a startup power/energy source such as a battery such as a lithium ion battery. Alternatively, external power such as grid power may be provided for startup through a connection from an external power source to the generator. The connection may comprise the power output bus bar. The startup power energy source may at least one of supply power to the heater to maintain the molten metal conductive matrix, power the injection system, and power the ignition system.

The SunCell® may comprise a high-pressure water electrolyzer such as one comprising a proton exchange membrane (PEM) electrolyzer having water under high pressure to provide high-pressure hydrogen. Each of the H₂ and O₂ chambers may comprise a recombiner to eliminate contaminant O₂ and H₂, respectively. The PEM may serve as at least one of the separator and salt bridge of the anode and cathode compartments to allow for hydrogen to be produced at the cathode and oxygen at the anode as separate gases. The cathode may comprise a dichalcogenide hydrogen evolution catalyst such as one comprising at least one of niobium and tantalum that may further comprise sulfur. The cathode may comprise one known in the art such as Pt or Ni. The hydrogen may be produced at high pressure and may be supplied to the reaction cell chamber 5b31 directly or by permeation through a hydrogen permeable membrane. The SunCell® may comprise an oxygen gas line from the anode compartment to the point of delivery of the oxygen gas to a storage vessel or a vent. In an embodiment, the SunCell® comprises sensors, a processor, and an electrolysis current controller.

In another embodiment, hydrogen fuel may be obtained from electrolysis of water, reforming natural gas, at least one of the syngas reaction and the water-gas shift reaction by reaction of steam with carbon to form H₂ and CO and CO₂, and other methods of hydrogen production known by those skilled in the art.

In another embodiment, the hydrogen may be produced by thermolysis using supplied water and the heat generated by the SunCell®. The thermolysis cycle may comprise one of the disclosure or one known in the art such as one that is based on a metal and its oxide such as at least one of SnO/Sn and ZnO/Zn. In an embodiment wherein the inductively coupled heater, EM pump, and ignition systems only consume power during startup, the hydrogen may be produced by thermolysis such that the parasitic electrical power requirement is very low. The SunCell® may comprise batteries such as lithium ion batteries to provide power to run systems such as the gas sensors and control systems such as those for the reaction plasma gases.

### Molten Metal Stream Generation

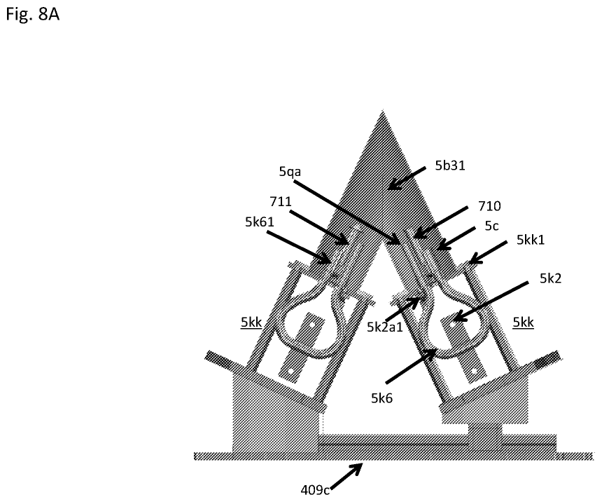

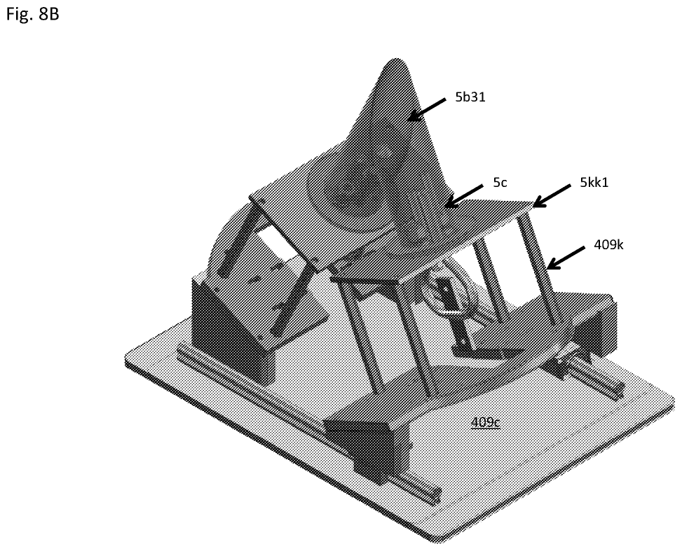

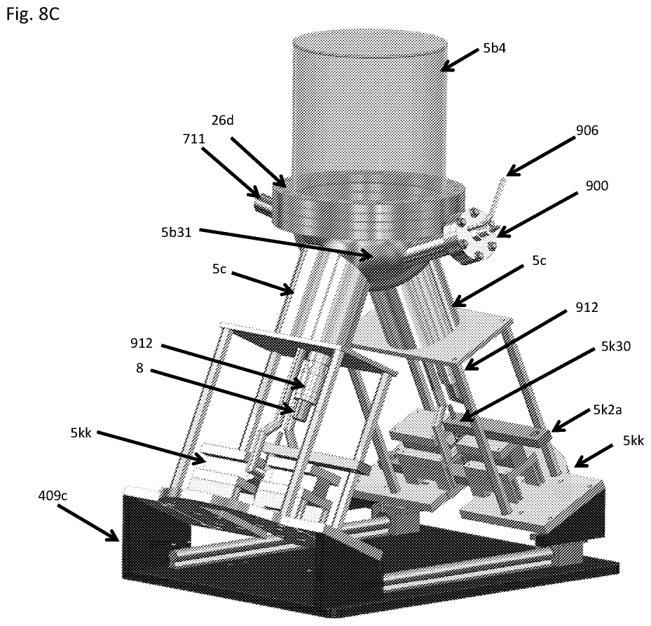

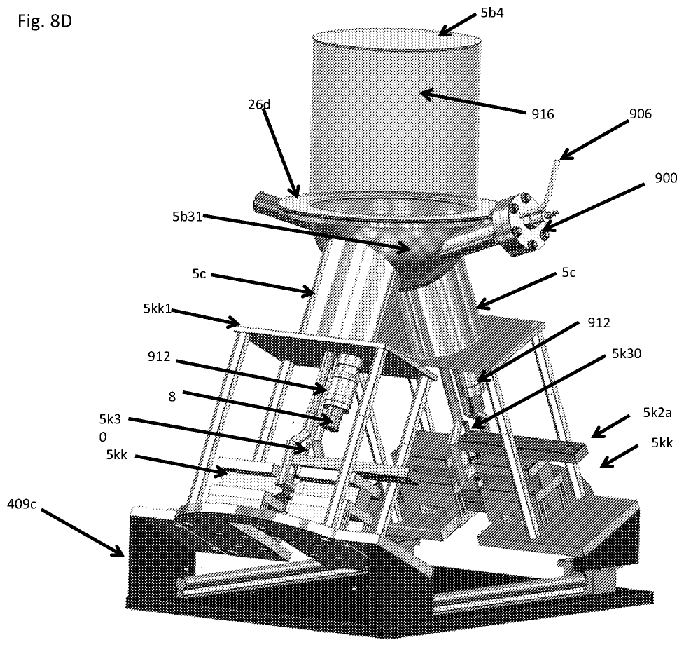

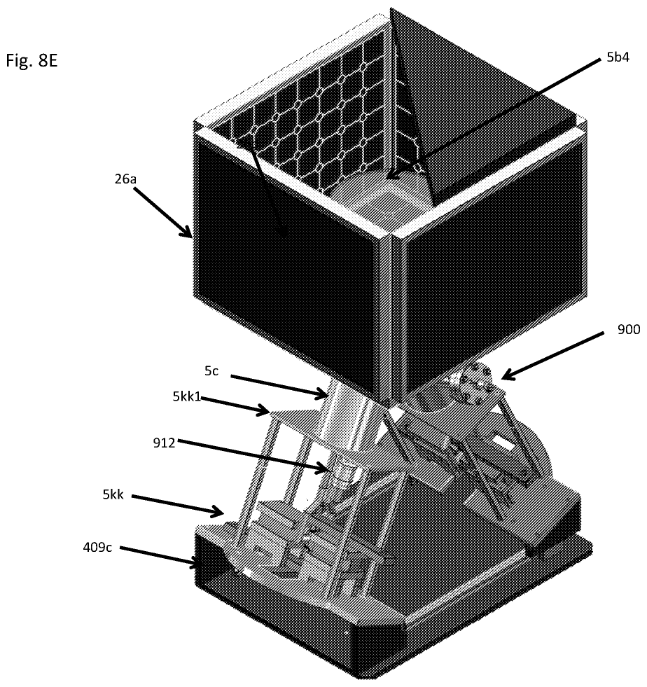

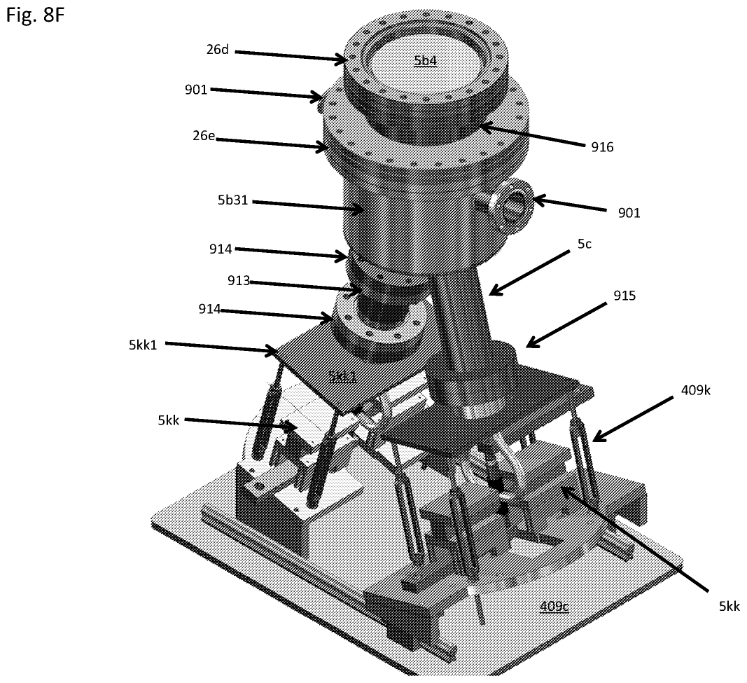

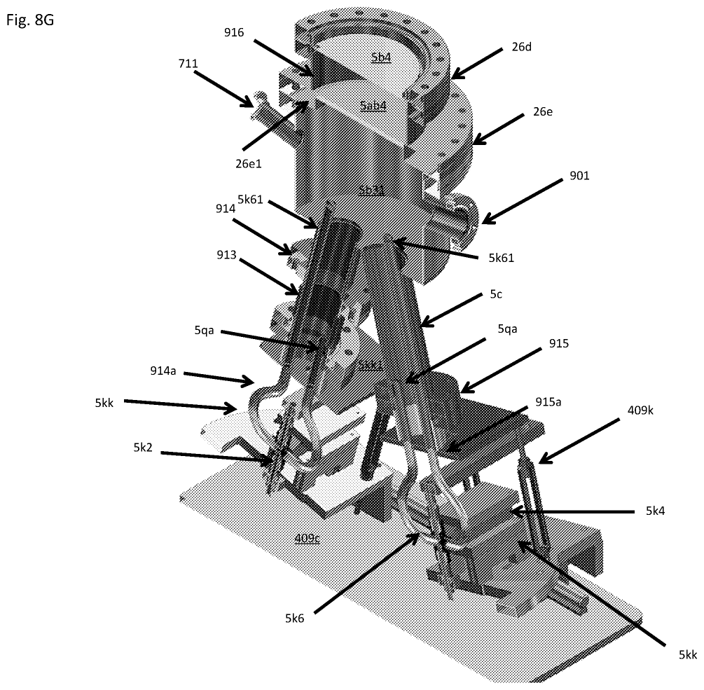

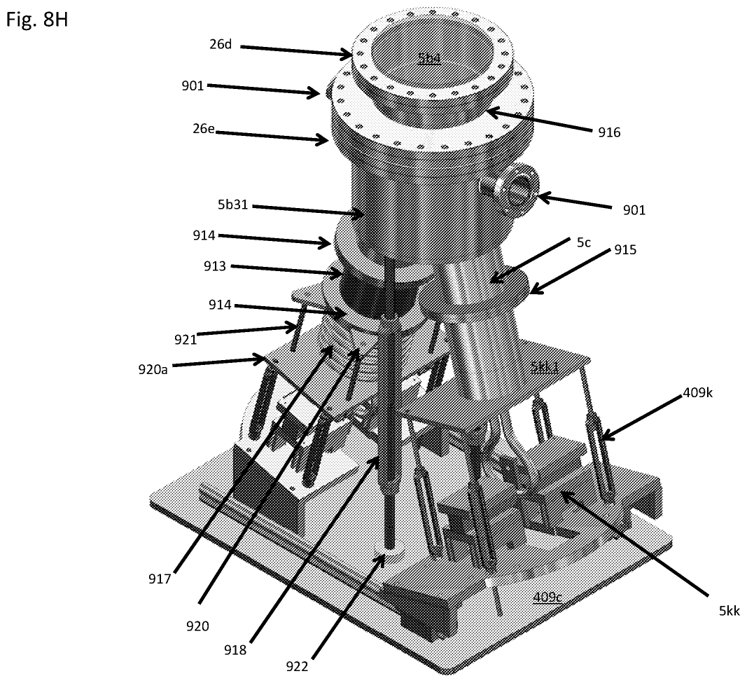

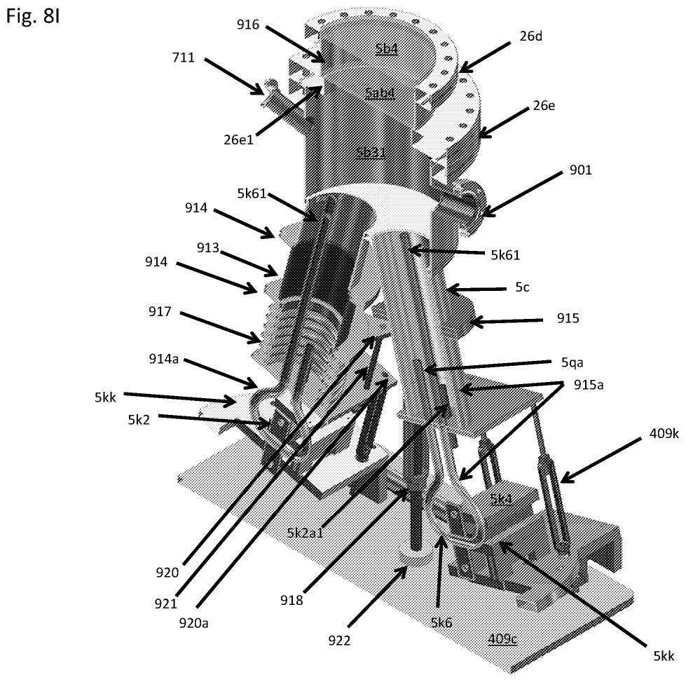

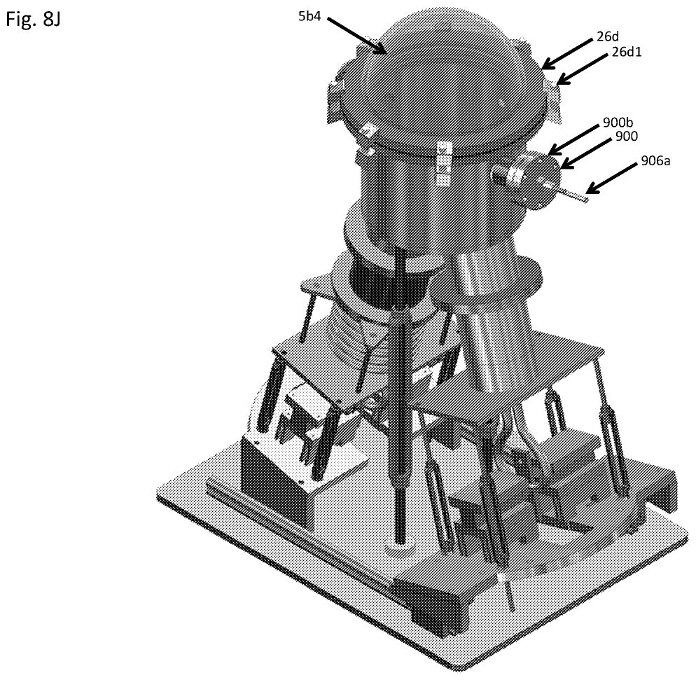

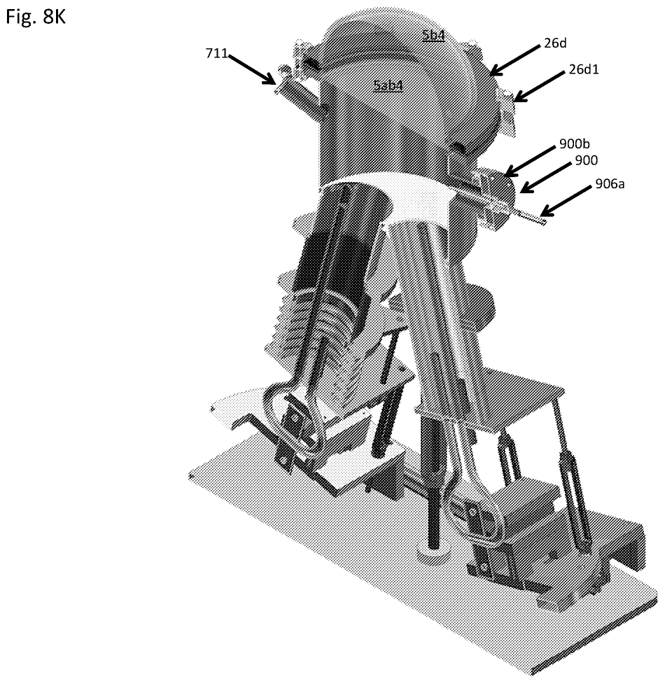

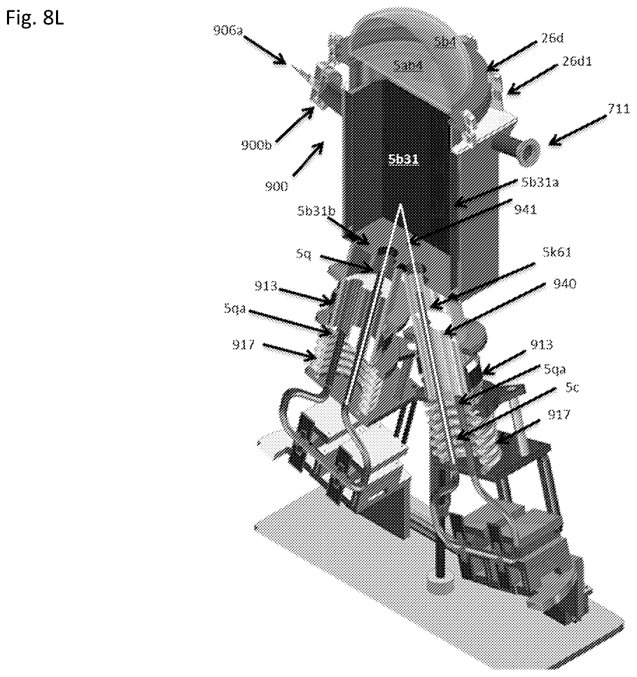

In an embodiment, such as one shown in FIGS. 8A-B, the SunCell® comprises a two reservoirs 5c, each comprising an electromagnetic (EM) pump such as a DC, AC, or another EM pump of the disclosure and injector that also serves as the ignition electrode and a reservoir inlet riser for leveling the molten metal level in the reservoir. The molten metal may comprise silver, silver-copper alloy, gallium or tin, Galinstan, or another of the disclosure. The SunCell® may further comprise a reaction cell chamber 5b31, electrically isolating flanges between the reservoirs and the reaction cell chamber such as electrically isolating Conflat flanges, and a drip edge at the top of each reservoir to electrically isolate the reservoirs and EM pumps from each other wherein the ignition current flows with contact of intersecting molten metal streams of the two EM pump injectors. In an embodiment, at least one of each reservoir 5c, the reaction cell chamber 5b31, and the inside of the EM pump tube 5k6 are coated with a ceramic or comprise a ceramic liner such as such as one of BN, quartz, titania, alumina, yttria, hafnia, zirconia, silicon carbide, or mixtures such as TiO₂-Yr₂O₃—Al₂O₃, or another of the disclosure. In an embodiment, the SunCell® further comprises an external resistive heater such as heating coils such as Kanthal wire wrapped on the outer surface of at least one SunCell® component. In an embodiment, the outer surface of at least one component of the SunCell such as the reaction cell 5b3, reservoir 5c, and EM pump tube 5k6 is coated with a ceramic to electrically isolate the resistive heater coil such as Kanthal wire wrapped on the surface. In an embodiment, the SunCell® may further comprise at least one of a heat exchanger and thermal insulation that may be wrapped on the surface of at least one SunCell® component. At least one of the heat exchanger and heater may be encased in the thermal insulation.

In an embodiment, the resistive heater may comprise a support for the heating element such as a heating wire. The support may comprise carbon that is hermetically sealed. The sealant may comprise a ceramic such as SiC. The SiC may be formed by reaction of Si with carbon at high temperature in the vacuum furnace.

The SunCell® heater 415 may be a resistive heater or an inductively coupled heater. An exemplary SunCell® heater 415 comprises Kanthal A-1 (Kanthal) resistive heating wire, a ferritic-chromium-aluminum alloy (FeCrAl alloy) capable of operating temperatures up to 1400° C. and having high resistivity and good oxidation resistance. Additional FeCrAl alloys for suitable heating elements are at least one of Kanthal APM, Kanthal AF, Kanthal D, and Alkrothal. The heating element such as a resistive wire element may comprise a NiCr alloy that may operate in the 1100° C. to 1200° C. range such as at least one of Nikrothal 80, Nikrothal 70, Nikrothal 60, and Nikrothal 40. Alternatively, the heater 415 may comprise molybdenum disilicide (MoSi₂) such as at least one of Kanthal Super 1700, Kanthal Super 1800, Kanthal Super 1900, Kanthal Super RA, Kanthal Super ER, Kanthal Super HT, and Kanthal Super NC that is capable of operating in the 1500° C. to 1800° C. range in an oxidizing atmosphere. The heating element may comprise molybdenum disilicide (MoSi₂) alloyed with Alumina. The heating element may have an oxidation resistant coating such as an Alumina coating. The heating element of the resistive heater 415 may comprise SiC that may be capable of operating at a temperature of up to 1625° C.

The electromagnetic pumps may each comprise one of two main types of electromagnetic pumps for liquid metals: an AC or DC conduction pump in which an AC or DC magnetic field is established across a tube containing liquid metal, and an AC or DC current is fed to the liquid through electrodes connected to the tube walls, respectively; and induction pumps, in which a travelling field induces the required current, as in an induction motor wherein the current may be crossed with an applied AC electromagnetic field. The induction pump may comprise three main forms: annular linear, flat linear, and spiral. The pumps may comprise others know in the art such as mechanical and thermoelectric pumps. The mechanical pump may comprise a centrifugal pump with a motor driven impeller. The power to the electromagnetic pump may be constant or pulsed to cause a corresponding constant or pulsed injection of the molten metal, respectively. The pulsed injection may be driven by a program or function generator. The pulsed injection may maintain pulsed plasma in the reaction cell chamber. The EM pump may comprise a multistage pump.

In an embodiment, the EM pump tube 5k6 comprises a flow chopper to cause intermittent or pulsed molten metal injection. The chopper may comprise a valve such as an electronically controlled valve that further comprises a controller. The valve may comprise a solenoid valve. Alternatively, the chopper may comprise a rotating disc with at least one passage that rotates periodically to intersect the flow of molten metal to allow the molten metal to flow through the passage wherein the flow in blocked by sections of the rotating disc that do not comprise a passage.

The molten metal pump may comprise a moving magnet pump (MMP). An exemplary commercial AC EM pump is the CMI Novacast CA15 wherein the heating and cooling systems may be modified to support pumping molten metal.

In an embodiment, the EM pump may comprise an AC, inductive type wherein the Lorentz force on the molten metal is produced by a time-varying electric current through the molten metal and a crossed synchronized time-varying magnetic field. The time-varying electric current through the molten metal may be created by Faraday induction of a first time-varying magnetic field produced by an EM pump transformer winding circuit. The source of the first time-varying magnetic field may comprise a primary transformer winding, and the molten metal may serve as a secondary transformer winding such as a single turn shorted winding comprising an EM pump tube section of a current loop and a EM pump current loop return section.

In an embodiment wherein the molten metal injector comprising at least one EM pump comprising a current source and magnets to cause a Lorentz pumping force, the EM pump magnets 5k4 may comprise permanent or electromagnets such as DC or AC electromagnets. In the case that the magnets are permanent magnets or DC electromagnets, the EM pump current source comprises a DC power source. In the case that the magnets 5k4 comprise AC electromagnets, the EM pump current source for the EM bus bars 5k2 comprises an AC power source that provides current that is in phase with AC EM pump electromagnet field applied to the EM pump tube 5k6 to produce a Lorentz pumping force. In an embodiment wherein the magnet such as an electromagnet is immersed in a coolant that is corrosive such as a water bath, the magnet such as an electromagnet may be hermetically sealed in a sealant such as a thermoplastic, a coating, or a housing that may be non-magnetic such as a stainless-steel housing.

In another embodiment, the ignition system comprises an induction system wherein the source of electricity applied to the conductive molten metal to cause ignition of the hydrino reaction provides an induction current, voltage, and power. The ignition system may comprise an electrode-less system wherein the ignition current is applied by induction by an induction ignition transformer assembly. The induction current may flow through the intersecting molten metal streams from the plurality of injectors maintained by the pumps such as the EM pumps. In an embodiment, the reservoirs 5c may further comprise a ceramic cross connecting channel such as a channel between the bases of the reservoirs 5c. The induction ignition transformer assembly may comprise an induction ignition transformer winding and an induction ignition transformer yoke that may extend through the induction current loop formed by the reservoirs 5c, the intersecting molten metal streams from the plurality of molten metal injectors, and the cross-connecting channel. The induction ignition transformer assembly may be similar to that of the EM pump transformer winding circuit.

In an embodiment, the heater to melt the molten metal comprises a resistive heater such as one comprising wire such as Kanthal or other of the disclosure. The resistive heater may comprise a refractory resistive filament or wire that may be wrapped around the components to be heated. Exemplary resistive heater elements and components may comprise high temperature conductors such as carbon, Nichrome, 300 series stainless steels, Incoloy 800 and Inconel 600, 601, 718, 625, Haynes 230, 188, 214, Nickel, Hastelloy C, titanium, tantalum, molybdenum, TZM, rhenium, niobium, and tungsten. The filament or wire may be potted in a potting compound to protect it from oxidation. The heating element as filament, wire, or mesh may be operated in vacuum to protect it from oxidation. An exemplary heater comprises Kanthal A-1 (Kanthal) resistive heating wire, a ferritic-chromium-aluminum alloy (FeCrAl alloy) capable of operating temperatures up to 1400° C. and having high resistivity and good oxidation resistance. Another exemplary filament is Kanthal APM that forms a non-scaling oxide coating that is resistant to oxidizing and carburizing environments and can be operated to 1475° C. The heat loss rate at 1375 K and an emissivity of 1 is 200 kW/m² or 0.2 W/cm². Commercially available resistive heaters that operate to 1475 K have a power of 4.6 W/cm². The heating may be increased using insulation external to the heating element.

An exemplary heater 415 comprises Kanthal A-1 (Kanthal) resistive heating wire, a ferritic-chromium-aluminum alloy (FeCrAl alloy) capable of operating temperatures up to 1400° C. and having high resistivity and good oxidation resistance. Additional FeCrAl alloys for suitable heating elements are at least one of Kanthal APM, Kanthal A F, Kanthal D, and Alkrothal. The heating element such as a resistive wire element may comprise a NiCr alloy that may operate in the 1100° C. to 1200° C. range such as at least one of Nikrothal 80, Nikrothal 70, Nikrothal 60, and Nikrothal 40. Alternatively, the heater 415 may comprise molybdenum disilicide (MoSi₂) such as at least one of Kanthal Super 1700, Kanthal Super 1800, Kanthal Super 1900, Kanthal Super RA, Kanthal Super ER, Kanthal Super HT, and Kanthal Super NC that is capable of operating in the 1500° C. to 1800° C. range in an oxidizing atmosphere. The heating element may comprise molybdenum disilicide (MoSi₂) alloyed with Alumina. The heating element may have an oxidation resistant coating such as an Alumina coating. The heating element of the resistive heater 415 may comprise SiC that may be capable of operating at a temperature of up to 1625° C. The heater may comprise insulation to increase at least one of its efficiency and effectiveness. The insulation may comprise a ceramic such as one known by those skilled in the art such as an insulation comprising alumina-silicate. The insulation may be at least one of removable or reversible.

The insulation may be removed following startup to more effectively transfer heat to a desired receiver such as ambient surroundings or a heat exchanger. The insulation may be mechanically removed. The insulation may comprise a vacuum-capable chamber and a pump, wherein the insulation is applied by pulling a vacuum, and the insulation is reversed by adding a heat transfer gas such as a noble gas such as helium. A vacuum chamber with a heat transfer gas such as helium that can be added or pumped off may serve as adjustable insulation.

The ignition current may be time varying such as about 60 Hz AC, but may have other characteristics and waveforms such as a DC or AC waveform having a frequency in at least one range of 1 Hz to 1 MHz, 10 Hz to 10 kHz, 10 Hz to 1 kHz, and 10 Hz to 100 Hz, a peak current in at least one range of about 1 A to 100 MA, 10 A to 10 MA, 100 A to 1 MA, 100 A to 100 kA, and 1 kA to 100 kA, and a peak voltage in at least one range of about 1 V to 1 MV, 2 V to 100 kV, 3 V to 10 kV, 3 V to 1 kV, 2 V to 100 V, and 3 V to 30 V wherein the waveform may comprise a sinusoid, a square wave, a triangle, or other desired waveform that may comprise a duty cycle such as one in at least one range of 1% to 99%, 5% to 75%, and 10% to 50%. To minimize the skin effect at high frequency, the windings of the ignition system may comprise at least one of braided, multiple-stranded, and Litz wire. In an embodiment, the ignition power waveform such as a periodic square wave of ignition current, as well as the frequency and duty cycle are selected to optimize at least one of the output power and power gain given by the ratio of the power output and the ignition power. An exemplary frequency square wave waveform is in the range of 1 to 500 Hz. In another exemplary embodiment, the ignition power comprises a repeated pattern of different currents over time such as square waves that alternative between a high current such as 1500 A and a low current such as 500 A wherein the square wave widths of high and low currents may be the same or different.

### Power System and Configuration

In an exemplary embodiment, the SunCell® having a pedestal electrode shown in FIG. 1 comprises (i) an injector reservoir 5c, EM pump tube 5k6 and nozzle 5q, a reservoir base plate 409a, and a spherical reaction cell chamber 5b31 dome, (ii) a non-injector reservoir comprising a sleeve reservoir 409d that may comprise SS welded to the lower hemisphere 5b41 with a sleeve reservoir flange 409e at the end of the sleeve reservoir 409d, (iii) an electrical insulator insert reservoir 409f comprising a pedestal 5c1 at the top and an insert reservoir flange 409g at the bottom that mates to the sleeve reservoir flange 409e wherein the insert reservoir 409f, pedestal 5c that may further comprise a drip edge 5c1a, and insert reservoir flange 409g may comprise a ceramic such as boron nitride, stabilized BN such as BN—CaO or BN—ZrO₂, silicon carbide, alumina, zirconia, hafnia, or quartz, or a refractory material such as a refractory metal, carbon, or ceramic with a protective coating such as SiC or ZrB₂ such as one comprising SiC or ZrB₂ carbon and (iv) a reservoir base plate 409a such as one comprising SS having a penetration for the ignition bus bar 10al and an ignition bus bar 10 wherein the baseplate bolts to the sleeve reservoir flange 409e to sandwich the insert reservoir flange 409g. In an embodiment the SunCell® may comprise a vacuum housing enclosing and hermetically sealing the joint comprising the sleeve reservoir flange 409e, the insert reservoir flange 409g, and the reservoir baseplate 409a wherein the housing is electrically isolated at the electrode bus bar 10. In an embodiment the nozzle 5q may be threaded onto a nozzle section of the electromagnetic pump tube 5k61. The nozzle may comprise a refractory metal such as W, Ta, Re, or Mo. The nozzle may be submerged.

In an embodiment shown in FIG. 1, an inverted pedestal 5c2 and ignition bus bar and electrode 10 are at least one of oriented in about the center of the cell 5b3 and aligned on the negative z-axis wherein at least one counter injector electrode 5k61 injects molten metal from its reservoir 5c in the positive z-direction against gravity where applicable. The injected molten stream may maintain a coating or pool of liquid metal in the pedestal 5c2 against gravity where applicable. The pool or coating may at least partially cover the electrode 10. The pool or coating may protect the electrode from damage such as corrosion or melting. In the latter case, the EM pumping rate may be increased to increase the electrode cooling by the flowing injected molten metal. The electrode area and thickness may also be increased to dissipate local hot spots to prevent melting. The pedestal may be positively biased and the injector electrode may be negatively biased. In another embodiment, the pedestal may be negatively biased and the injector electrode may be positively biased wherein the injector electrode may be submerged in the molten metal. The molten metal such as gallium or tin may fill a portion of the lower portion of the reaction cell chamber 5b31. In addition to the coating or pool of injected molten metal, the electrode 10 such as a W electrode may be stabilized from corrosion by the applied negative bias. In an embodiment, the electrode 10 may comprise a coating such as an inert conductive coating such as a rhenium coating to protect the electrode from corrosion. In an embodiment the electrode may be cooled. The cooling of the electrode may reduce at least one of the electrode corrosion rate and the rate of alloy formation with the molten metal (e.g., as compared to operation without electrode cooling). The cooling may be achieved by means such as centerline water cooling. In an embodiment, the surface area of the inverted electrode is increased by increasing the size of the surface in contact with at least one of the plasma and the molten metal stream from the injector electrode. In an exemplary embodiment, a large plate or cup is attached to the end of the electrode 10. In another embodiment, the injector electrode may be submerged to increase the area of the counter electrode. FIG. 1 shows an exemplary spherical reaction cell chamber. Other geometries such a rectangular, cubic, cylindrical, and conical are within the scope of the disclosure. In an embodiment, the base of the reaction cell chamber where it connects to the top of the reservoir may be sloped such as conical. Such configurations may facilitate mixing of the molten metal as it enters the inlet of the EM pump. In an embodiment, at least a portion of the external surface of the reaction cell chamber may be clad in a material with a high heat transfer coefficient such as copper to avoid hot spots on the reaction cell chamber wall. In an embodiment, the SunCell® comprises a plurality of pumps such as EM pumps to inject molten metal on the reaction cell chamber walls to maintain molten metal walls to prevent the plasma in the reaction cell chamber from melting the walls. In another embodiment, the reaction cell chamber wall comprises a liner 5b31a such as a BN, fused silica, or quartz liner to avoid hot spots. An exemplary reaction cell chamber comprises a cubic upper section lined with quartz plates and lower spherical section comprising an EM pump at the bottom wherein the spherical section promotes molten metal mixing.

In an embodiment, the sleeve reservoir 409d may comprise a tight-fitting electrical insulator of the ignition bus bar and electrode 10 such that molten metal is contained about exclusively in a cup or drip edge 5c1a at the end of the inverted pedestal 5c2. The insert reservoir 409f having insert reservoir flange 409g may be mounted to the cell chamber 5b3 by reservoir baseplate 409a, sleeve reservoir 409d, and sleeve reservoir flange 409e. The electrode may penetrate the reservoir baseplate 409a through electrode penetration 10al. The electrode may penetrate the reservoir baseplate 409a through electrode penetration 10al. In an embodiment, the insert reservoir 409f may comprise a coating on the electrode bus bar 10. In an embodiment at least one SunCell® component such as the insert reservoir 409f, a reaction cell chamber liner or coating, and a bus bar liner or coating may comprise a ceramic such as BN, quartz, titania, alumina, yttria, hafnia, zirconia, silicon carbide, Mullite, or mixtures such as ZrO₂—TiO₂—Y₂O₃, TiO₂-Yr₂O₃—Al₂O₃, or another of the disclosure, or one comprising at least one of SiO₂, Al₂O₃, ZrO₂, HfO₂, TiO₂, MgO, BN, BN—ZrO₂, BN—B₂O₃, and a ceramic that serves to bind to the metal of the component and then to BN or another ceramic. Exemplary composite coatings comprising BN by Oerlikon are Ni 13Cr 8Fe 3.5Al 6.5BN, ZrO₂ 9.5Dy₂O₃ 0.7BN, ZrO₂ 7.5Y₂O₃ 0.7BN, and Co 25Cr 5Al 0.27Y 1.75Si 15hBN. In an embodiment, a suitable metal, ceramic, or carbon coated with BN may serve as the liner or coating. A suitable metal or ceramic is capable of operating at the temperature of the SunCell® with the adherence of the BN coating. In an embodiment, binder in a SunCell® component such as the sleeve reservoir 409d, a reaction cell chamber liner or coating, or a bus bar liner or coating may be baked out by at least one of heating and running under a vacuum. Alternatively, a passivated coating may be formed or applied to the ceramic. In an exemplary embodiment, BN is oxidized to form a B₂O₃ passivation coating.

The EM pump tube 5k6 may comprise a material, liner, or coating that is resistant to forming an alloy with gallium or tin such as at least one of W, Ta, Re, Mo, BN, Alumina, Mullite, silica, quartz, zirconia, hafnia, titania, or another of the disclosure. In an embodiment, the pump tube, liner or coating comprises carbon. The carbon may be applied by a suspension means such as a spray or liquid coating that is cured and degassed. In an exemplary embodiment, carbon suspension is poured into the pump tube to fill it, the carbon suspension is cured, and a channel is then machined through the tube to form a carbon liner on the walls. In an embodiment, the carbon coated metal such as Ni may be resistant to forming a carbide at high temperature. In an embodiment, the EM pump tube 5k6 may comprise a metallic tube that is filled with a liner or coating material such as BN that is bored out to form the pump tube. The EM pump tube may comprise an assembly comprising a plurality of parts. The parts may comprise a material or a liner or coating that is resistant to forming an alloy with gallium or tin. In an embodiment, the parts may be separately coated and assembled. The assembly may comprise at least one of a housing that contains two opposing bus bars 5k2, a liquid metal inlet, and a liquid metal outlet, and a means to seal the housing such as Swageloks. In an embodiment, the EM pump bus bars 5k2 may comprise a conductive portion in contact with the gallium or tin inside of the EM pump tube that is resistant to forming an alloy with gallium or tin. The conductive portion may comprise an alloy-resistant material such as Ta, W, Re, Ir, or Mo, or an alloy-resistant cladding or coating on another metal such as SS such as one comprising Ta, W, Re, Ir, or Mo.

In an embodiment, the SunCell® comprises an inlet riser tube 5qa to prevent hot gallium or tin flow to the reservoir base 5kk 1 and suppress gallium or tin or tin alloy formation. The reservoir base 5kk1 may comprise a liner, cladding, or coating to suppress gallium or tin alloy formation.

In an embodiment to permit good electrical contact between the EM pump bus bars 5k2 and the molten metal in the EM pump tube 5k6, the coating is applied before the EM pump bus bars are attached by means such as welding. Alternatively, any coating may be removed from the bus bars penetrating into the molten metal before operation by means known in the art such as abrasion, ablation, or etching.

In another embodiment, the insert reservoir flange 409g may be replaced with a feedthrough mounted in the reservoir baseplate 409a that electrically isolates the bus bar 10 of the feedthrough and pedestal 5c1 or insert reservoir 409f from the reservoir baseplate 409a. The feedthrough may be welded to the reservoir baseplate. An exemplary feedthrough comprising the bus bar 10 is Solid Sealing Technology, Inc. #FA10775. The bus bar 10 may be joined to the electrode 8 or the bus bar 10 and electrode 8 may comprise a single piece. The reservoir baseplate may be directly joined to the sleeve reservoir flange. The union may comprise Conflat flanges that are bolted together with an intervening gasket. The flanges may comprise knife edges to seal a soft metallic gasket such as a copper, silver-plated copper, or tantalum gasket or O-ring. The flanges may be coated with a coating such as Flameproof paint, alumina, CrC, TiN, Ta, or another of the disclosure that prevents alloy formation with the molten metal. The gasket or O-ring such as Ta ones may be alloy-formation resistant. In an embodiment, the flanges may be replaced by flat metal plates (no bolt holes) such as annuluses around the perimeter of each joined component. The plates may be welded together on the outer edges to form a seam. The seam may be cut or ground off to separate the two plates. The ceramic pedestal 5c1 comprising the insert reservoir 409f may be counter sunk into a counter bored reservoir baseplate 409a wherein the union between the pedestal and the reservoir baseplate may be sealed with a gasket such as a carbon gasket or another of the disclosure. The electrode 8 and bus bar 10 may comprise an endplate at the end where plasma discharge occurs. Pressure may be applied to the gasket to seal the union between the pedestal and the reservoir baseplate by pushing on the disc that in turn applies pressure to the gasket. The discs may be threaded on to the end of the electrode 8 such that turning the disc applies pressure to the gasket. The feedthrough may comprise an annular collar that connects to the bus bar and to the electrode. The annular collar may comprise a threshed set screw that when tightened locks the electrode into position. The position may be locked with the gasket under tension applied by the end disc pulling the pedestal upwards. The pedestal 5c1 may comprise a shaft for access to the set screw. The shaft may be threaded so that it can be sealed on the outer surface of the pedestal with a nonconductive set screw such a ceramic one such as a BN one wherein the pedestal may comprise BN such as BN—ZrO₂. In another embodiment, the bus bar 10 and electrode 8 may comprise rods that may butt-end connect. In an embodiment, the pedestal 5c1 may comprise two or more threaded metal shafts each with a set screw that tightens against the bus bar 10 or electrode 8 to lock them in place under tension. The tension may provide at least one of connection of the bus bar 10 and electrode 8 and pressure on the gasket. Alternatively, the counter electrode comprises a shortened insulating pedestal 5c1 wherein at least one of the electrode 8 and bus bar 10 comprise male threads, a washer and a matching female nut such that the nut and washer tighten against the shortened insulating pedestal 5c1. Alternatively, the electrode 8 may comprise male threads on an end that threads into matching female threads at an end of the bus bar 10, and the electrode 8 further comprises a fixed washer that tightens the shortened insulating pedestal 5c1 against the pedestal washer and the reservoir baseplate 409a that may be counter sunk. The counter electrode may comprise other means of fasting the pedestal, bus bar, and electrode that are known to those skilled the art.

In another embodiment, at least one seal such as (i) one between the insert reservoir flange 409g and the sleeve reservoir flange 409e, and (ii) one between the reservoir baseplate 409a and the sleeve reservoir flange 409e may comprise a wet seal (FIG. 1). In the latter case, the insert reservoir flange 409g may be replaced with a feedthrough mounted in the reservoir baseplate 409a that electrically isolates the bus bar 10 of the feedthrough and pedestal 5c1 from the reservoir baseplate 409a, and the wet seal may comprise one between the reservoir baseplate 409a and the feedthrough. Since gallium or tin forms an oxide with a melting point of 1900° C., the wet seal may comprise solid gallium or tin oxide.

In an embodiment, hydrogen may be supplied to the cell through a hydrogen permeable membrane such as a structurally reinforced Pd—Ag or niobium membrane. The hydrogen permeation rate through the hydrogen permeable membrane may be increased by maintaining plasma on the outer surface of the permeable membrane. The SunCell® may comprise a semipermeable membrane that may comprise an electrode of a plasma cell such as a cathode of a plasma cell (e.g., a glow discharge cell). The SunCell® such as one shown in FIG. 1 may further comprise an outer sealed plasma chamber comprising an outer wall surrounding a portion of the wall of cell 5b3 wherein a portion of the metal wall of the cell 5b3 comprises an electrode of the plasma cell. The sealed plasma chamber may comprise a chamber around the cell 5b3 such as a housing wherein the wall of cell 5b3 may comprise a plasma cell electrode and the housing or an independent electrode in the chamber may comprise the counter electrode. The SunCell® may further comprise a plasma power source, and plasma control system, a gas source such as a hydrogen gas supply tank, a hydrogen supply monitor and regular, and a vacuum pump.

The system may operate via the production of two plasmas. An initial reaction mixture such as a non-stoichiometric H₂/O₂ mixture (e.g., an H₂/O₂ having less than 20% or less than 10% or less than 5% or less than 3% O₂ by mole percentage of the mixture) may pass through a plasma cell such as a glow discharge to create a reaction mixture capable of undergoing the catalytic reactions with sufficient exothermicity to produce a plasma as described herein. For example, a non-stoichiometric H₂/O₂ mixture may pass through a glow discharge to produce an effluence of atomic hydrogen and nascent H₂O (e.g., a mixture having water at a concentration and with an internal energy sufficient to prevent formation of hydrogen bonds). The glow discharge effluence may be directed into the reaction chamber where a current is supplied between two electrodes (e.g., with a molten metal passed therebetween). Upon interaction of the effluence with the biased molten metal (e.g., gallium or tin), the catalytic reaction between the nascent water and the atomic hydrogen is induced, for example, upon the formation of arc current. The power system may comprise:
a) a plasma cell (e.g., glow discharge cell);
b) a set of electrodes in electrical contact with one another via a molten metal flowing therebetween such that an electrical bias may be applied molten metal;
c) a molten metal injection system which flows the molten metal between the electrodes;
   wherein the effluence of the plasma cell is oriented towards the biased molten metal (e.g., the positive electrode or anode).

In an embodiment, the SunCell® comprises at least one a ceramic reservoir 5c and reaction cell chamber 5b31 such as one comprising quartz. The SunCell® may comprise two cylindrical reaction cell chambers 5b31 each comprising a reservoir at a bottom section wherein the reaction cell chambers are fused at the top along a seam where the two intersect as shown in FIGS. 8A-B. In an embodiment, the apex formed by the intersection of the reaction cell chambers 5b31 may comprise a gasketed seal such as two flanges that bolt together with an intervening gasket such as a graphite gasket to absorb thermal expansion and other stresses. Each reservoir may comprise a means such as an inlet riser 5qa to maintain a time-averaged level of molten metal in the reservoir. The bottom of the reservoirs may each comprise a reservoir flange 5k17 that may be sealed to a baseplate 5kk1 comprising an EM pump assembly 5kk comprising an EM pump 5ka with inlet and injection tube 5k61 penetrations and further comprising the EM magnets 5k4 and EM pump tube 5k6 under each baseplate. In an embodiment, permanent EM pump magnets 5k4 (FIGS. 8A-B) may be replaced with electromagnets such as DC or AC electromagnets. In the case that the magnets 5k4 comprise AC electromagnets, the EM pump current source for the EM bus bars 5k2 comprises an AC power source that provides current that is in phase with AC EM pump electromagnet field applied to the EM pump tube 5k6 to produce a Lorentz pumping force. Each EM pump assembly 5kk may attach to the reservoir flange at the same angle as the corresponding reservoir 5c such that the reservoir flange may be perpendicular to the slanted reservoir. The EM pump assembly 5kk may be mounted to a slide table 409c (FIGS. 8B-G) with supports 409k to mount and align the corresponding slanted EM pump assemblies 5kk and reservoirs 5c. In an embodiment, each EM pump assembly 5kk may comprise a plurality of EM pump stages such as two stages, each one comprising magnets 5k4 such as permanent or electromagnets and EM bus bars 5k2 that may be assembled on a common EM pump tube 5k6 of a reservoirs 5c. The EM pump stages may be in series or parallel connection between pump inlet and outlet. In an exemplary embodiment, the EM pumps each comprise two stages wherein the EM bus bars 5k2 of the two stages may be wired in parallel or series, and the EM pumps may be powered by separate power supplies or by the same power supply through a series connection between the EM pumps that may each comprise a plurality of stages such as two stages. The SunCell supports 409k, may comprise turnbuckles that are adjustable to any height and may lock with locknuts. The baseplate may seal to the reservoir by a wet seal. In an embodiment, the wet seal comprises an alloy of the molten metal and at least one other metal. The alloy may have a higher melting point than the molten metal. The alloy may be formed by applying the at least one other metal to area of the desired wet seal. Alternatively, a wet seal of the disclosure may be replaced by an adhesive or glue joint such as one between quartz, carbon, or a ceramic and metal or coated metal wherein the coating may comprise one of the disclosure such as one of Flameproof paint, Resbond 907GF, 940HT, 940LE, 940HE, 940SS, 903 HP, 908, or 904 zirconia adhesive, and a zirconium oxide coating such as Aremco Ultra-Temp 516 comprising ZrO₂— ZrSiO₄. Exemplary adhesives are Cotronics Resbond 907GF, 940HT, 940LE, 940HE, 940SS, 903 HP, 908, or 904 zirconia adhesive, a zirconium oxide coating such as Aremco Ultra-Temp 516 comprising ZrO₂— ZrSiO₄, and Durabond as such as RK454. The baseplate may further comprise penetrations each with a tube for evacuating or supplying gases to the reaction cell chamber 5b31 comprising the region wherein the reservoirs are fused. The reservoir may further comprise at least one of a gas injection tube 710 and a reservoir vacuum tube 711 wherein at least one tube may extend above the molten metal level. At least one of the gas injection line 710 and the vacuum line 711 may comprise a cap such as a carbon cap or a cover such as a carbon cover with side openings to allow gas flow while at least partially blocking molten metal entry into the tube. In another embodiment, at least one of the gas injection line 710 and the vacuum line 711 may comprise a U shape at the reaction cell chamber opening end and optionally a frit or packing at the opening to permit gas flow while preventing molten metal from entering. In another design, the fused reservoir section may be horizontally cutaway and a vertical cylinder may be attached at the cutaway section. The cylinder may further comprise a sealing top plate such as a quartz plate or may join to a converging diverging nozzle of the MHD converter or a cavity comprising a PV window. Alternatively, the vertical cylindrical PV window may comprise another geometry such as a rectangular or polyhedron cavity. The top plate may comprise at least one penetration for lines such as vacuum and gas supply lines. In an embodiment, the quartz may be housed in a tight-fitting casing that provides support against outward deformation of the quartz due to operation at high temperature and pressure. The casing may comprise at least one of carbon, and ceramic, and a metal that has a high melting point and resists deformation at high temperature. Exemplary casings comprise at least one of stainless steel, C, W, Re, Ta, Mo, Nb, Ir, Ru, Hf, Tc, Rh, V, Cr, Zr, Pa, Pt, Th, Lu, Ti, Pd, Tm, Sc, Fe, Y, Er, Co, Ho, Ni, and Dy. At least one seal to a SunCell component such as one to the reservoirs 5c, the reaction cell chamber 5b31, the converging-diverging nozzle or MHD nozzle section 307, the MHD expansion or generation section 308, the MHD condensation section 309, MHD electrode penetrations, the electromagnetic pump bus bar 5k2, and an ignition reservoir bus bar 5k2a1 such as a rod penetrating the reservoir baseplate or a connection to the reservoir baseplate that supplies ignition power to the molten metal of the reservoir may comprise a wet seal. In an exemplary embodiment, the reservoir flange 5k17 comprises a wet seal with the baseplate 5kk1 wherein the outer perimeter of the flange may be cooled by a cooling loop 5k18 such as a water-cooling loop.

In another exemplary embodiment, the EM pump tube comprises a liner such as a BN liner and at least one of the electromagnetic pump bus bar 5k2 and the ignition reservoir bus bar 5k2al comprises a wet seal. In an embodiment such as one comprising a PV window, the EM pump tube 5k6 may comprise a material such as tantalum that resists alloy formation with the molten metal such as tin or gallium. The EM bus bar may comprise welded-in parts such as welded-in Ta bus bars 5k2. The EM pump tube 5k6 such as a Ta one may be connected to the baseplate 5kk1 by a union such as a Swagelok or bonded to the baseplate 5kk1 by a weld such as one formed by diffusion bonding. In an exemplary embodiment, the diffusion bonding between a stainless-steel baseplate and a Ta EM pump may comprise a pure metal insert such as one comprising Cu, Ni, or Fe. The diffusion bonding may be performed using an oven, a laser, or other method known in the art. The bonding area may be coated or lined to protect it against alloy formation with the molten metals. In another exemplary embodiment, the Ta EM pump tube comprising welded-in Ta EM bus bars is bonded to a Kovar tube and then bonded to a stainless-steel tube that connects with the reservoir baseplate. The connection may comprise a braze such as one with PdNiAu alloy (AMS 4785 M.P.=1135° C.) or Paloro or a similar braze such as one at the link: https://www.morganbrazealloys.com/en-gb/products/brazing-alloys/precious-brazing-filler-metals/. The coating or liner may comprise one from the disclosure. In an exemplary embodiment, the coating may comprise carbon paste (e.g., Aramco Graphibond 551) or VHT Flameproof paint.

In an embodiment shown in FIGS. 8F-G, at least one of the break reservoir EM pump assembly 914a comprising the reservoir 5c below the electrical break flange 914 and the corresponding electromagnetic pump assembly 5kk and the reservoir EM pump assembly 915a comprising the reservoir below the reservoir flange 915 and corresponding electromagnetic pump assembly 5kk may comprise a material or be plated or clad with a material such as W, Ta, or carbon that is resistant to forming an alloy with the molten metal such as gallium or tin. An exemplary carbon coating may comprise Aremco Products Graphitic Bond 551RN. The seal of at least one of the electric break flanges 914 or reservoir flanges 915 may comprise a gasket such as Conflat flange gasket such as a copper or silver-plated copper one, a graphite gasket, a wet seal, and another seal of the disclosure.

In a further embodiment, each EM pump bus bar 5k2 may comprise an electrical feedthrough such as one that may be capable of high temperature such as 450° C. to 2000° C. An exemplary EM bus bar feedthrough is MPF A0106-5-W (https://mpfpi.com/shop/power-feedthroughs/watercooled/12kv/a0106-5-w/). The feedthrough may be cooled such as at least one of forced air, water, conduction, and convection cooled using a heat exchanger. To protect the feedthrough from thermal failure, the feedthrough may comprise a standoff between the EM pump tube 5k6 and a ceramic brazed to a feedthrough body wherein the ceramic electrically isolates a conductor that passes through the ceramic at the center of the feedthrough. The EM bus bar feedthrough conductor may comprise a metal or a coated metal such as W, Ta, or coated stainless steel such as carbide or nitride coated SS such as TiN, CrN, WC, CrC, or chromium coated stainless steel or carbon coated stainless steel that is conductive and resistant to forming an alloy with the molten metal. The braze may have a high melting point such a greater than 600° C. Exemplary brazes are Cu(72)-Ag(28) alloy, copper, ABA, gold ABA, PdNiAu alloy (AMS 4785 M.P.=1135° C.) or Paloro or a similar braze such as one at the link: https://www.morganbrazealloys.com/en-gb/products/brazing-alloys/precious-brazing-filler-metals/.

In an embodiment, a ceramic SunCell® such as a quartz one is mounted on a metal baseplate 5kk1 (FIG. 8B) wherein a wet seal comprises a penetration into the reservoir 5c that allows molten metal such a silver in the reservoir to contact solidified molten metal on the baseplate 5kk1 of each EM pump assembly to form the wet seal. Each baseplate may be connected to a terminal of the ignition power source such as a DC or AC power source such that the wet seal may also serve as a bus bar for the ignition power. The EM pump may comprise an induction AC type. The ceramic SunCell® may comprise a plurality of components such as the EM pumps, reservoirs, reaction cell chamber, and thermophotovoltaic (TPV) components that are sealed with flanged gasketed unions that may be bolted together. The gasket may comprise carbon or a ceramic such as Thermiculite.

Rhenium (MP 3185° C.) is resistant to attack from gallium or tin, Galinstan, silver, and copper and is resistant to oxidation by oxygen and water and the hydrino reaction mixture such as one comprising oxygen and water; thus, it may serve as a coating for metal components such as those of the EM pump assembly 5kk such as the baseplate 5kk1, EM pump tube 5k6, EM pump bus bars 5k2, EM pump injectors 5k61, EM pump nozzle 5q, inlet risers 5qa, gas lines 710, and vacuum line 711. The component may be coated with rhenium by electroplating, vacuum deposition, chemical deposition, and other methods known in the art. In an embodiment, a bus bar or electrical connection at a penetration such the EM pump bus bars 5k2 or the penetrations for MHD electrodes in the MHD generator channel 308 may comprise solid rhenium sealed by a wet seal at the penetration.

In an embodiment (FIGS. 8A-B), the heater to melt the metal to form the molten metal comprises a resistive heater such as a Kanthal wire heater around the reservoirs 5c and reaction cell chamber 5b31 such as ones comprising quartz. The EM pump 5kk may comprise heat transfer blocks to transfer heat from the reservoirs 5c to the EM pump tube 5k6. In an exemplary embodiment, the heater comprises a Kanthal wire coil wrapped about the reservoirs and reaction cell chamber wherein graphite heat transfer blocks with ceramic heat transfer paste attached to the EM pump tubes 5k6 transfer heat to the tubes to melt the metal therein. Larger diameter EM pump tubes may be used to better transfer heat to the EM pump tube to cause melting in EM pump tube. The components containing molten metal may be well thermally insulated with an insulation such as ceramic fiber or other high temperature insulation known in the art. The components may be heated slowly to avoid thermal shock.

In an embodiment, the SunCell® comprises a heater such as a resistive heater. The heater may comprise a kiln or furnace that is positioned over at least one of the reaction cell chambers, the reservoirs, and the EM pump tubes. In the embodiment wherein the EM pump tubes are inside of the kiln, the EM pump magnets and the wet seal may be selectively thermally insulated and cooled by a cooling system such as a water-cooling system. In an embodiment, each reservoir may comprise a thermal insulator at the baseplate at the base of the molten metal such as a ceramic insulator. The insulator may comprise BN or a moldable ceramic such as one comprising alumina, magnesia, silica, zirconia, or hafnia. The ceramic insulator at the base of the molten metal may comprise penetrations for the EM pump inlet and injector, gas and vacuum lines, thermocouple, and ignition bus bar that makes direct contact with the molten metal. In an embodiment, the thermal insulator permits the molten metal to melt at the base of the reservoir by reducing heat loss to the baseplate and wet seal cooling. The diameter of the EM pump inlet penetration may be enlarged to increase the heat transfer from molten metal in the reservoir to that in the EM pump tube. The EM pump tube may comprise heat transfer blocks to transfer heat from the inlet penetration to the EM pump tube.

In an embodiment, the baseplate 5kk1 may comprise a refractory material or metal such as stainless steel, C, W, Re, Ta, Mo, Nb, Ir, Ru, Hf, Tc, Rh, V, Cr, Zr, Pa, Pt, Th, Lu, Ti, Pd, Tm, Sc, Fe, Y, Er, Co, Ho, Ni, and Dy that may be coated with a liner or coating such as one of the disclosure that is resistant to at least one of corrosion with at least one of O₂ and H₂O and alloy formation with the molten metal such as gallium, tin, or silver. In an embodiment, the EM pump tube may be lined or coated with a material that prevents corrosion or alloy formation. The EM bus bars may comprise a conductor that is resistant to at least one of corrosion or alloy formation. Exemplary EM pump bus bars wherein the molten metal is gallium or tin are Ta, W, Re, and Ir. Exemplary EM pump bus bars wherein the molten metal is silver are W, Ta, Re, Ni, Co, and Cr. In an embodiment, the EM bus bars may comprise carbon or a metal with a high melting point that may be coated with an electrically conductive coating that resists alloy formation with the molten metal such as at least one of gallium or tin and silver. Exemplary coatings comprise a carbide or diboride such as those of titanium, zirconium, and hafnium.

In an embodiment wherein the molten metal such as copper, gallium, or tin may form an alloy with the baseplate such as one comprising stainless steel, the baseplate comprises a liner or is coated with an material that does not form an alloy such as Ta, W, Re, or a ceramic such as BN, Mullite, or zirconia-titania-yttria.

In an embodiment of the SunCell® shown in FIGS. 8A-B, the molten metal comprises gallium, tin, or Galinstan, the seals at the baseplate 5kk1 comprise gaskets such as Viton O rings or carbon (Graphoil) gaskets, and the diameter of the inlet riser tubes 5qa is sufficiently large such that the levels of the molten metal in the reservoirs 5c are maintained about even with a near steady stream of injected molten metal from both reservoirs. The diameter of each inlet riser tube be larger than that of the silver molten metal embodiment, to overcome the higher viscosity of gallium, tin, and Galinstan. The inlet riser tube diameter may be in the range of about 3 mm to 2 cm. The baseplate 5kk1 may be stainless steel maintained below about 500° C. or may be ceramic coated to prevent gallium or tin alloy formation. Exemplary baseplate coatings are Mullite and ZTY.

In an embodiment, the wet seal of a penetration may comprise a nipple through which the molten silver partially extends to be continuous with a solidified silver electrode. In an exemplary embodiment, the EM pump bus bars 5k2 comprise a wet seal comprising an inside ceramic coated EM pump tube 5k6 having opposing nipples through which the molten silver passes to contact a solidified section that comprises the EM pump power connector, and at least one bus bar may optionally further comprise a connector to one lead of the ignition power supply.

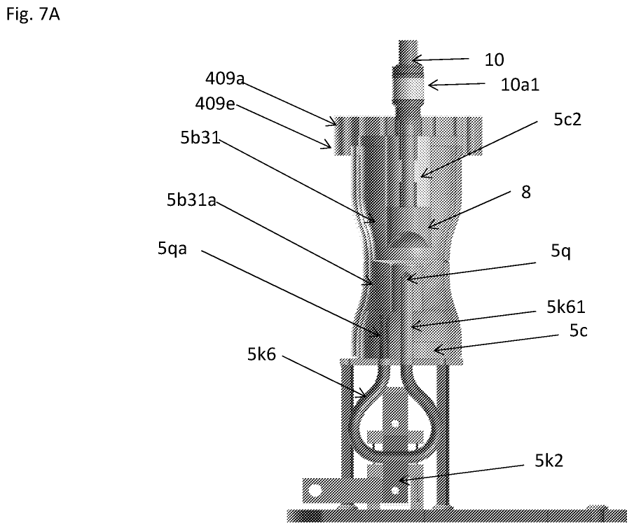

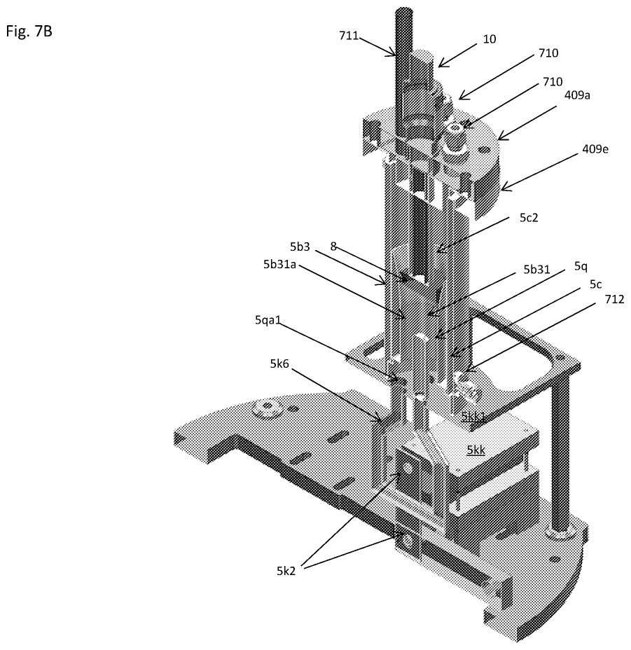

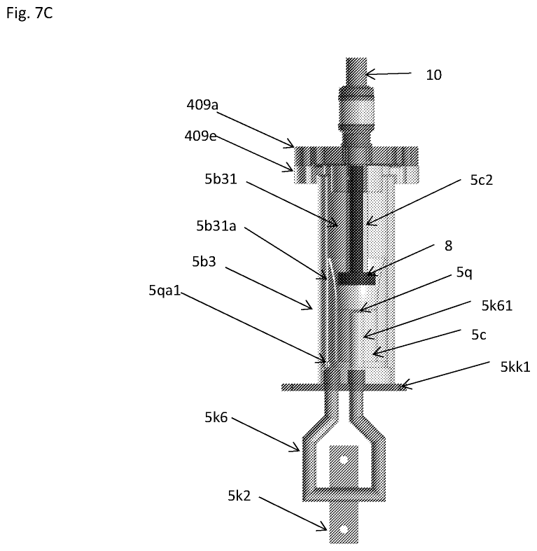

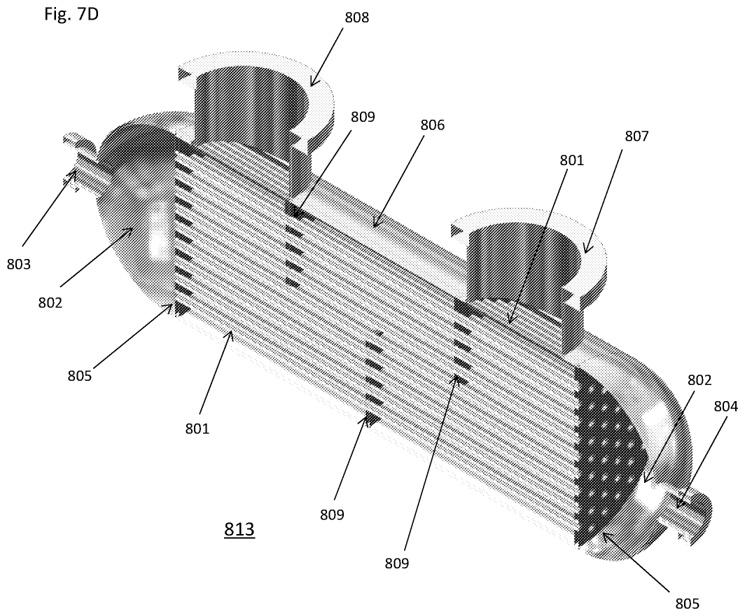

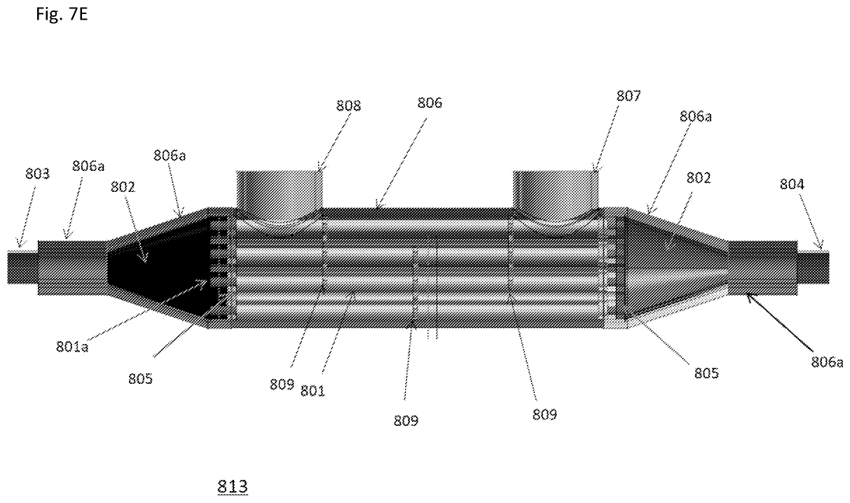

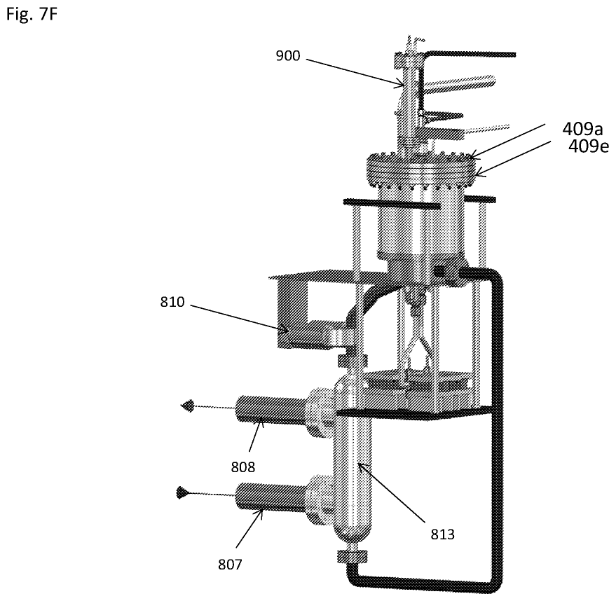

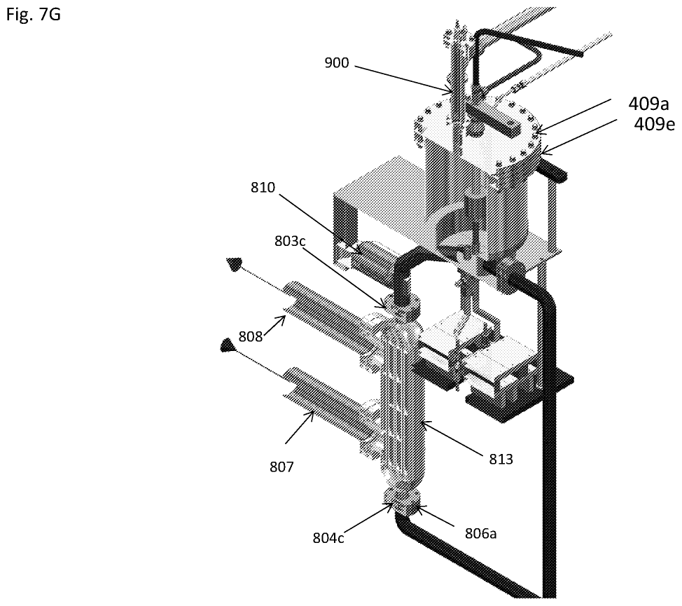

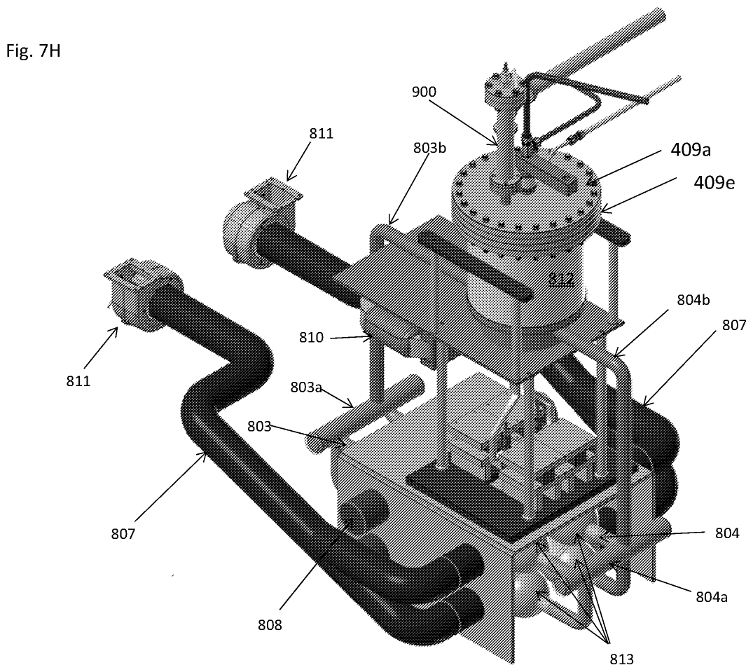

The EM pump tube 5k6 may comprise a material, liner, or coating that is resistant to forming an alloy with gallium, tin, or silver such as at least one of W, Ta, Re, Ir, Mo, BN, Alumina, Mullite, silica, quartz, zirconia, hafnia, titania, or another of the disclosure. In an embodiment, the pump tube, liner or coating comprises carbon. The carbon may be applied by a suspension means such as a spray or liquid coating that is cured and degassed. In an embodiment, the carbon-coated metal such as Ni may be resistant to forming a carbide at high temperature. In an embodiment, the EM pump tube 5k6 may comprise a metallic tube that is filled with a liner or coating material such as BN that is bored out to form the pump tube. The EM pump tube may be segmented or comprise an assembly comprising a plurality of parts (FIG. 7C). The parts may comprise a material such as Ta or a liner or coating that is resistant to forming an alloy with gallium or tin. In an embodiment, the parts may be separately coated and assembled. The assembly may comprise at least one of a housing that contains two opposing bus bars 5k2, a liquid metal inlet, and a liquid metal outlet, and a means to seal the housing such as Swageloks. In an embodiment, the EM pump bus bars 5k2 may comprise a conductive portion in contact with the gallium or tin inside of the EM pump tube that is resistant to forming an alloy with gallium or tin. The conductive portion may comprise an alloy-resistant material such as Ta, W, Re, or Mo, or an alloy-resistant cladding or coating on another metal such as SS such as one comprising Ta, W, Re, Ir, or Mo. In an embodiment, the exterior or the EM pump tube such as one comprising Ta or W may be coated or clad with a coating of cladding of the disclosure to protect the exterior from oxidation. In exemplary embodiments, a Ta EM pump tube may be coated with Re, ZTY, or Mullite or clad with stainless steel (SS) wherein the cladding to the exterior of the Ta EM pump tube may comprise SS pieces adhered together using welds or an extreme-temperature-rated SS glue such as J-B Weld 37901.

An embodiment, the liner may comprise a thin-wall, flexible metal that is resistant to alloying with gallium or tin such as a W, Ta, Re, Ir, Mo, or Ta tube liner that may be inserted into an EM pump tube 5k6 comprising another metal such as stainless steel. The liner may be inserted in a preformed EM pump tube or a straight tube that is then bent. The EM pump bus bars 5k2 may be attached by means such as welding after the liner is installed in the formed EM pump tube. The EM pump tube liner may form a tight seal with the EM pump bus bars 5k2 by a compression fitting or sealing material such as carbon or a ceramic sealant.

In an embodiment wherein at least one of the molten metal and any alloy formed from the molten metal may off gas to produce a gas boundary layer that interferes with EM pumping by at least partially blocking the Lorentz current, the EM pump tube 5k6 at the position of the magnets 5k4 may be vertical to break up the gas boundary layer.

In an embodiment, the SunCell® comprises an interference eliminator comprising a means to mitigate or eliminate any interference between the source of electrical power to the ignition circuit and the source of electrical power to the EM pump 5kk. The interference eliminator may comprise at least one of, one or more circuit elements and one or more controllers to regulate the relative voltage, current, polarity, waveform, and duty cycle of the ignition and EM pump currents to prevent interference between the two corresponding supplies.

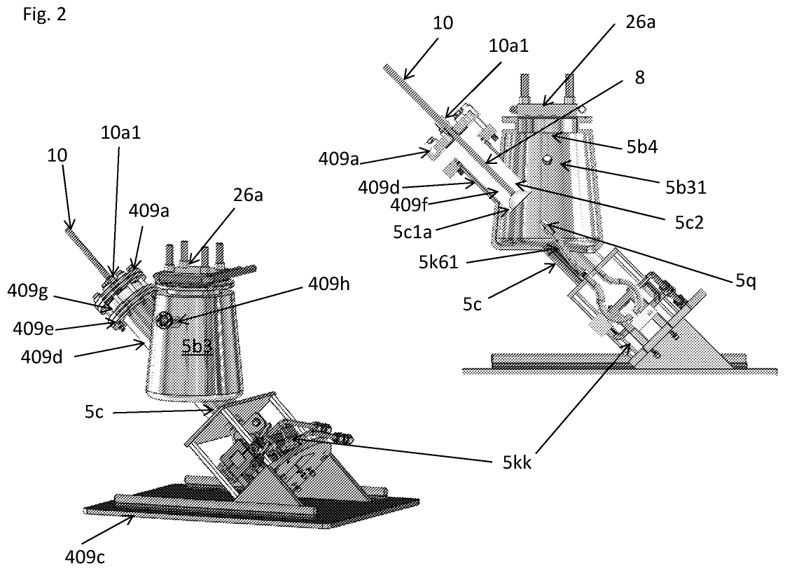

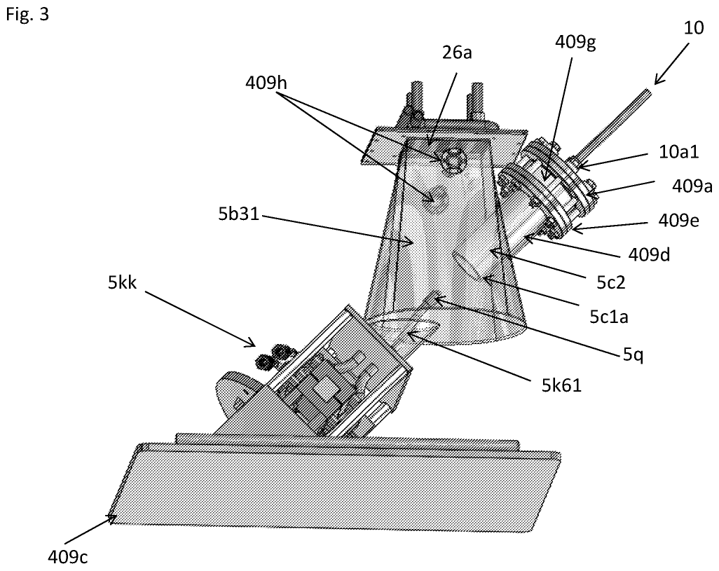

The SunCell® may further comprise a photovoltaic (PV) converter and a window to transmit light to the PV converter. In an embodiment shown in FIGS. 2-3, the SunCell® comprises a reaction cell chamber 5b31 with a tapering cross section along the vertical axis and a PV window 5b4 at the apex of the taper. The window with a mating taper may comprise any desired geometry that accommodates the PV array 26a such as circular (FIG. 2) or square or rectangular (FIG. 3). The taper may suppress metallization of the PV window 5b4 to permit efficient light to electricity conversion by the photovoltaic (PV) converter 26a. The PV converter 26a may comprise a dense receiver array of concentrator PV cells such as PV cells of the disclosure and may further comprise a cooling system such as one comprising microchannel plates. The PV window 5b4 may comprise a coating that suppresses metallization. The PV window may be cooled to prevent thermal degradation of the PV window coating. The SunCell® may comprise at least one partially inverted pedestal 5c2 having a cup or drip edge 5c1a at the end of the inverted pedestal 5c2 similar to one shown in FIG. 1 except that the vertical axis of each pedestal and electrode 10 may be oriented at an angle with respect to the vertical or z-axis. The angle may be in the range of 1° to 90°. In an embodiment, at least one counter injector electrode 5k61 injects molten metal from its reservoir 5c obliquely in the positive z-direction against gravity where applicable. The injection pumping may be provided by EM pump assembly 5kk mounted on EM pump assembly slide table 409c. In exemplary embodiments, the partially inverted pedestal 5c2 and the counter injector electrode 5k61 are aligned on an axis at 135° to the horizontal or x-axis as shown in FIG. 2 or aligned on an axis at 450 to the horizontal or x-axis as shown in FIG. 3. The insert reservoir 409f having insert reservoir flange 409g may be mounted to the cell chamber 5b3 by reservoir baseplate 409a, sleeve reservoir 409d, and sleeve reservoir flange 409e. The electrode may penetrate the reservoir baseplate 409a through electrode penetration 10al. The nozzle 5q of the injector electrode may be submerged in the liquid metal such as liquid gallium or tin contained in the bottom of the reaction cell chamber 5b31 and reservoir 5c. Gases may be supplied to the reaction cell chamber 5b31, or the chamber may be evacuated through gas ports such as 409h.

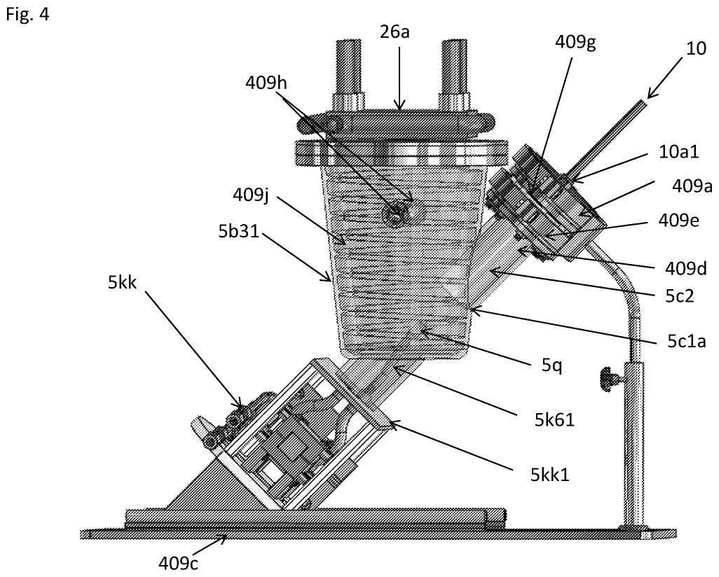

In an alternative embodiment shown in FIG. 4, the SunCell® comprises a reaction cell chamber 5b31 with a tapering cross section along the negative vertical axis and a PV window 5b4 at the larger diameter-end of the taper comprising the top of the reaction cell chamber 5b31, the opposite taper of the embodiment shown in FIGS. 2-3. In an embodiment, the SunCell® comprises a reaction cell chamber 5b31 comprising a right cylinder geometry. The injector nozzle and the pedestal counter electrode may be aligned on the vertical axis at opposite ends of the cylinder or along a line at a slant to the vertical axis.

In an embodiment shown in FIGS. 2 and 3, the electrode 10 and PV panel 26a may interchange locations and orientations such that the molten metal injector 5k6 and nozzle 5q inject molten metal vertically to the counter electrode 10, and the PV panel 26a receives light from the plasma side-on.

The SunCell may comprise a transparent window to serve as a light source of wavelengths transparent to the window. The SunCell may comprise a blackbody radiator 5b4c that may serve as a blackbody light source. In an embodiment, the SunCell® comprises a light source (e.g., the plasma from the reaction) wherein the hydrino plasma light emitted through the window is utilized in a desired lighting application such as room, street, commercial, or industrial lighting or for heating or processing such as chemical treatment or lithography.

In an embodiment the top electrode comprises the positive electrode. The SunCell may comprise an optical window and a photovoltaic (PV) panel behind the positive electrode. The positive electrode may serve as a blackbody radiator to provide at least one of heat, light, and illumination of a PV panel. In the latter case, the illumination of the PV panel generates electricity from the incident light. In an embodiment, the optical window may comprise a vacuum-tight outer window and an inner spinning window to prevent molten metal from adhering to the inner window and opacifying the window. In an embodiment, the positive electrode may heat a blackbody radiator which emits light through the PV window to the PV panel. The blackbody radiator may connect to the positive electrode to receive heat from it by conduction as well as radiation. The blackbody radiation may comprise a refractory metal such as a refractory metal such as tungsten (M.P.=3422° C.) or tantalum (M.P.=3020° C.), or a ceramic such as one of the disclosure such as one or more of the group of graphite (sublimation point=3642° C.), borides, carbides, nitrides, and oxides such as a metal oxide such as alumina, zirconia, yttria stabilized zirconia, magnesia, hafnia, or thorium dioxide (ThO₂); transition metals diborides such as hafnium boride (HfB₂), zirconium diboride (ZrB₂), or niobium boride (NbB₂); a metal nitride such as hafnium nitride (HfN), zirconium nitride (ZrN), titanium nitride (TiN), and a carbide such as tungsten carbide (WC), titanium carbide (TiC), zirconium carbide, or tantalum carbide (TaC) and their associated composites. Exemplary ceramics having a desired high melting point are magnesium oxide (MgO) (M.P.=2852° C.), zirconium oxide (ZrO) (M.P.=2715° C.), boron nitride (BN) (M.P.=2973° C.), zirconium dioxide (ZrO₂) (M.P.=2715° C.), hafnium boride (HfB₂) (M.P.=3380° C.), tungsten carbide (WC) (M.P.=2785° C.-2830° C.), hafnium carbide (HfC) (M.P.=3900° C.), Ta₄HfC₅(M.P.=4000° C.), Ta₄HfC₅TaX₄HfCX₅(4215° C.), hafnium nitride (HfN) (M.P.=3385° C.), zirconium diboride (ZrB₂) (M.P.=3246° C.), zirconium carbide (ZrC) (M.P.=3400° C.), zirconium nitride (ZrN) (M.P.=2950° C.), titanium boride (TiB₂) (M.P.=3225° C.), titanium carbide (TiC) (M.P.=3100° C.), titanium nitride (TiN) (M.P.=2950° C.), silicon carbide (SiC) (M.P.=2820° C.), tantalum boride (TaB₂) (M.P.=3040° C.), tantalum carbide (TaC) (M.P.=3800° C.), tantalum nitride (TaN) (M.P.=2700° C.), niobium carbide (NbC) (M.P.=3490° C.), niobium nitride (NbN) (M.P.=2573° C.), vanadium carbide (VC) (M.P.=2810° C.), and vanadium nitride (VN) (M.P.=2050° C.).

The electrode emitter may have a diameter less than that of the reaction chamber wall or liner to prevent electrical shorting to the wall. The reaction cell chamber wall or liner may comprise a non-conducting annulus such as a quartz or ceramic annulus behind the electrode emitter to block molten metal from the window while allowing light to pass to the window through at least one of the annulus and the open center of the annulus. In the former case, the annulus may be transparent.

In an embodiment, the SunCell® comprises an induction ignition system with a cross connecting channel of reservoirs 414, a pump such as an induction EM pump, a conduction EM pump, or a mechanical pump in an injector reservoir, and a non-injector reservoir that serves as the counter electrode. The cross-connecting channel of reservoirs 414 may comprise restricted flow means such that the non-injector reservoir may be maintained about filled. In an embodiment, the cross-connecting channel of reservoirs 414 may contain a conductor that does not flow such as a solid conductor such as solid silver.

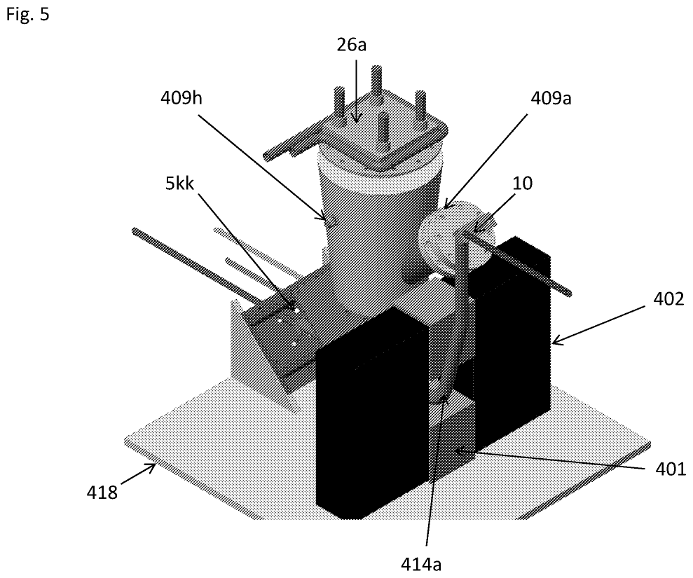

In an embodiment (FIG. 5), the SunCell® comprises a current connector or reservoir jumper cable 414a between the cathode and anode bus bars or current connectors. The cell body 5b3 may comprise a non-conductor, or the cell body 5b3 may comprise a conductor such as stainless steel wherein at least one electrode is electrically isolated from the cell body 5b3 such that induction current is forced to flow between the electrodes. The current connector or jumper cable may connect at least one of the pedestal electrode 8 and at least one of the electrical connectors to the EM pump and the bus bar in contact with the metal in the reservoir 5c of the EM pump. The cathode and anode of the SunCell® such as ones shown in FIGS. 1-4 comprising a pedestal electrode such as an inverted pedestal 5c2 or a pedestal 5c2 at an angle to the z-axis may comprise an electrical connector between the anode and cathode that form a closed current loop by the molten metal stream injected by the at least one EM pump 5kk. The metal stream may close an electrically conductive loop by contacting at least one of the molten metal EM pump injector 5k61 and 5q or metal in the reservoir 5c and the electrode of the pedestal. The SunCell® may further comprise an ignition transformer 401 having its yoke 402 in the closed conductive loop to induce a current in the molten metal of the loop that serves as a single loop shorted secondary. The transformer 401 and 402 may induce an ignition current in the closed current loop. In an exemplary embodiment, the primary may operate in at least one frequency range of 1 Hz to 100 kHz, 10 Hz to 10 kHz, and 60 Hz to 2000 Hz, the input voltage may operate in at least one range of about 10 V to 10 MV, 50 V to 1 MV, 50 V to 100 kV, 50 V to 10 kV, 50 V to 1 kV, and 100 V to 480 V, the input current may operate in at least one range of about 1 A to 1 MA, 10 A to 100 kA, 10 A to 10 kA, 10 A to 1 kA, and 30 A to 200 A, the ignition voltage may operate in at least one range of about 0.1 V to 100 kV, 1 V to 10 kV, 1 V to 1 kV, and 1 V to 50 V, and the ignition current may be in the range of about 10 A to 1 MA, 100 A to 100 kA, 100 A to 10 kA, and 100 A to 5 kA. In an embodiment, the plasma gas may comprise any gas such as at least one of a noble gas, hydrogen, water vapor, carbon dioxide, nitrogen, oxygen and air. The gas pressure may be in at least one range of about 1 microTorr to 100 atm, 1 milliTorr to 10 atm, 100 milliTorr to 5 atm, and 1 Torr to 1 atm.

The transformer was powered by a 1000 Hz AC power supply. In an embodiment, the ignition transformer may be powered by a variable frequency drive such as a single-phase variable frequency drive (VFD). In an embodiment, the VFD input power is matched to provide the output voltage and current that further provides the desired ignition voltage and current wherein the number of turns and wire gauge are selected for the corresponding output voltage and current of the VFD. The induction ignition current may be in at least one range of about 10 A to 100 kA, 100 A to 10 kA, and 100 A to 5 kA. The induction ignition voltage may be in at least one range of 0.5 V to 1 kV, 1 V to 100 V, and 1 V to 10 V. The frequency may be in at least one range of about 1 Hz to 100 kHz, 10 Hz to 10 kHz, and 10 Hz to 1 kHz. An exemplary VFD is the ATO 7.5 kW, 220 V to 240 V output single phase 500 Hz VFD.

Another exemplary tested embodiment comprised a Pyrex SunCell® with one EM pump injector electrode and a pedestal counter electrode with a connecting jumper cable 414a between them such as the SunCell® shown in FIG. 5. The molten metal injector comprising an DC-type electromagnetic pump, pumped a Galinstan stream that connected with the pedestal counter electrode to close a current loop comprising the stream, the EM pump reservoir, and the jumper cable connected at each end to the corresponding electrode bus bar and passing through a 60 Hz transformer primary. The loop served as a shorted secondary to the 60 Hz transformer primary. The induced current in the secondary maintained a plasma in atmospheric air at low power consumption. The induction ignition system is enabling of a silver, gallium, or tin-based-molten-metal SunCell® power generator of the disclosure wherein hydrino reactants are supplied to the reaction cell chamber according to the disclosure. Specifically, (i) the primary loop of the ignition transformer operated at 60 Hz, (ii) the input voltage was 300 V peak, and (iii) the input current was 29 A peak. The maximum induction plasma ignition current was 1.38 kA.

In an embodiment, the source of electrical power or ignition power source comprises a non-direct current (DC) source such as a time dependent current source such as a pulsed or alternating current (AC) source. The peak current may be in at least one range such as 10 A to 100 MA, 100 A to 10 MA, 100 A to 1 MA, 100 A to 100 kA, 100 A to 10 kA, and 100 A to 1 kA. The peak voltage may be in at least one range of 0.5 V to 1 kV, 1 V to 100 V, and 1 V to 10 V. In an embodiment, the EM pump power source and AC ignition system may be selected to avoid inference that would result in at least one of ineffective EM pumping and distortion of the desired ignition waveform.

In an embodiment, the source of electrical power to supply the ignition current or ignition power source may comprise at least one of a DC, AC, and DC and AC power supply such as one that is powered by at least one of AC, DC, and DC and AC electricity such as a switching power supply, a variable frequency drive (VFD), an AC to AC converter, a DC to DC converter, and AC to DC converter, a DC to AC converter, a rectifier, a full wave rectifier, an inverter, a photovoltaic array generator, magnetohydrodynamic generator, and a conventional power generator such as a Rankine or Brayton-cycle-powered generator, a thermionic generator, and a thermoelectric generator. The ignition power source may comprise at least one circuit element such as a transition, IGBT, inductor, transformer, capacitor, rectifier, bridge such as an H-bridge, resistor, operation amplifier, or another circuit element or power conditioning device known in the art to produce the desired ignition current. In an exemplary embodiment, the ignition power source may comprise a full wave rectified high frequency source such as one that supplies positive square wave pulses at about 50% duty cycle or greater. The frequency may be in the range of about 60 Hz to 100 kHz. An exemplary supply provides about 30-40 V and 3000-5000 A at a frequency in the range of about 10 kHz to 40 kHz. In an embodiment, the electrical power to supply the ignition current may comprise a capacitor bank charged to an initial offset voltage such as one in the range of 1 V to 100 V that may be in series with an AC transformer or power supply wherein the resulting voltage may comprise DC voltage with AC modulation. The DC component may decay at a rate dependent on its normal discharge time constant, or the discharge time may be increased or eliminated wherein the ignition power source further comprises a DC power supply that recharges the capacitor bank. The DV voltage component may assist to initiate the plasma wherein the plasma may thereafter be maintained with a lower voltage. The ignition power supply such as a capacitor bank may comprise a fast switch such as one controlled by a servomotor or solenoid to connect and disconnect ignition power to electrodes.

The hydrino reaction rate may increase with current; however sustained current and power may thermally damage the SunCell. The SunCell ignition power source may comprise a charging power supply, a capacitor bank such as one comprised of a plurality of supercapacitors, a voltage sensor, a controller, and an ignition switch. To avoid the thermal damage while achieving high hydrino reaction kinetics, high current may be applied intermittently. This intermittent application of ignition current may be achieved by continuously charging a capacitor bank with a power supply such as a DC power supply.

Activation of the ignition switch may discharge the and then discharging the capacitor bank by activating the ignition switch to discharge from a first voltage set point to a second lower voltage set point controlled by the controller in response to the voltage sensor. For example, the first and second voltage setpoints may be chosen such that wherein the peak ignition current during capacitor discharge is greater than the charging current provided by the DC power supply.

In an embodiment, at least one of the hydrino plasma and ignition current may comprise an arc current. An arc current may have the characteristic that the higher the current, the lower the voltage. In an embodiment, at least one of the reaction cell chamber walls and the electrodes are selected to form and support at least one of a hydrino plasma current and an ignition current that comprises an arc current, one with a very low voltage at very high current. The current density may be in at least one range of about 1 A/cm² to 100 MA/cm², 10 A/cm² to 10 MA/cm², 100 A/cm² to 10 MA/cm², and 1 kA/cm² to 1 MA/cm².

In an embodiment, the ignition system may apply a high starting power to the plasma and then decrease the ignition power after the resistance drops. The resistance may drop due to at least one of an increase in conductivity due to reduction of any oxide in the ignition circuit such as on the electrodes or the molten metal stream, and formation of a plasma. In an exemplary embodiment, the ignition system comprises a capacitor bank in series with AC to produce AC modulation of high-power DC wherein the DC voltage decays with discharge of the capacitors and only lower AC or DC power remains.

In an embodiment, the pedestal electrode 8 may be recessed in the insert reservoir 409f wherein the pumped molten metal fills a pocket such as 5c1a to dynamically form a pool of molten metal in contact with the pedestal electrode 8. The pedestal electrode 8 may comprise a conductor that does not form an alloy with the molten metal such as gallium or tin at the operating temperature of the SunCell®. An exemplary pedestal electrode 8 comprises tungsten, tantalum, stainless steel, or molybdenum wherein Mo does not form an alloy such as Mo₃Ga with gallium below an operating temperature of 600° C. In an embodiment, the inlet of the EM pump may comprise a filter 5qa1 such as a screen or mesh that blocks alloy particles while permitting gallium or tin to enter. To increase the surface area, the filter may extend at least one of vertically and horizontally and connect to the inlet. The filter may comprise a material that resists forming an alloy with gallium or tin such as stainless steel (SS), tantalum, or tungsten. An exemplary inlet filter comprises a SS cylinder having a diameter equal to that of the inlet but vertically elevated. The filter many be cleaned periodically as part of routine maintenance.

In an embodiment, the non-injector elector electrode may be intermittently submerged in the molten metal in order to cool it. In an embodiment, the SunCell® comprises an injector EM pump and its reservoir 5c and at least one additional EM pump and may comprise another reservoir for the additional EM pump. Using the additional reservoir, the additional EM pump may at least one of (i) reversibly pump molten metal into the reaction cell chamber to intermittently submerge the non-injector electrode in order to cool it and (ii) pump molten metal onto the non-injector electrode in order to cool it. The SunCell® may comprise a coolant tank with coolant, a coolant pump to circulate coolant through the non-injector electrode, and a heat exchanger to reject heat from the coolant. In an embodiment, the non-injector electrode may comprise at a channel or cannula for coolant such as water, molten salt, molten metal, or another coolant known in the art to cool the non-injector electrode.

In an inverted embodiment shown in FIG. 1, the SunCell® is rotated by 180° such that the non-injector electrode is at the bottom of the cell and the injector electrode is at the top of the reaction cell chamber such that the molten metal injection is along the negative z-axis. At least one of the noninjector electrode and injector electrode may be mounted in a corresponding plate and may be connected to the reaction cell chamber by a corresponding flange seal. The seal may comprise a gasket that comprises a material that does not form an alloy with gallium or tin such as Ta, W, or a ceramic such as one of the disclosure or known in the art. The reaction cell chamber section at the bottom may serve as the reservoir, the former reservoir may be eliminated, and the EM pump may comprise an inlet riser in the new bottom reservoir that may penetrate the bottom base plate, connect to an EM pump tube, and provide molten metal flow to the EM pump wherein an outlet portion of the EM pump tube penetrates the top plate and connects to the nozzle inside of the reaction cell chamber. During operation, the EM pump may pump molten metal from the bottom reservoir and inject it into the non-injector electrode 8 at the bottom of the reaction cell chamber. The inverted SunCell® may be cooled by a high flow of gallium or tin injected by the injector electrode for the top of the cell. The non-injector electrode 8 may comprise a concave cavity to pool the gallium or tin to better cool the electrode. In an embodiment, the non-injector electrode may serve as the positive electrode; however, the opposite polarity is also an embodiment of the disclosure.

In an embodiment, the electrode 8 may be cooled by emitting radiation. To increase the heat transfer, the radiative surface area may be increased. In an embodiment, the bus bar 10 may comprise attached radiators such as vane radiators such as planar plates. The plates may be attached by fasting the face of an edge along the axis of the bus bar 10. The vanes may comprise a paddle wheel pattern. The vanes may be heated by conductive heat transfer from the bus bar 10 that may be heated by at least one of resistively by the ignition current and heated by the hydrino reaction. The radiators such as vanes may comprise a refractory metal such as Ta, Re, or W.

In an embodiment, the PV window may comprise an electrostatic precipitator (ESP) in front of the PV window to block oxide particles such as metal oxide. The ESP may comprise a tube with a central coronal discharge electrode such as a central wire, and a high voltage power supply to cause a discharge such as a coronal discharge at the wire. The discharge may charge the oxide particles which may be attracted by and migrate to the wall of the ESP tube where they may be at least one of collected and removed. The ESP tube wall may be highly polished to reflect light from the reaction cell chamber to the PV window and a PV converter such as a dense receiver array of concentrator PV cells.

In an embodiment, a PV window system comprises at least one of a transparent rotating baffle in front of a stationary sealed window, both in the xy-plane for light propagating along the z-axis and a window that may rotate in the xy-plane for light propagating along the z-axis. An exemplary embodiment comprises a spinning transparent disc such as a clear view screen https://en.wikipedia.org/wiki/Clear_view_screen) that may comprise at least one of the baffle and the window. In an embodiment, the SunCell® comprises a corona discharge system comprising a negative electrode, a counter electrode, and a discharge power source. In an exemplary embodiment, the negative electrode may comprise a pin, needle, or wire that may be in proximity of the PV baffle or widow such as a spinning one. The cell body may comprise the counter electrode. A coronal discharge may be maintained near the PV window to charge at least one of particles formed during power generation operation such as metal oxide and the PV baffle or window negatively such that the particles are repelled by the PV baffle or window.

### Maintaining Plasma Generation

In an embodiment, the SunCell® comprises a vacuum system comprising an inlet to a vacuum line, a vacuum line, a trap, and a vacuum pump. The vacuum pump may comprise one with a high pumping speed such as a root pump, scroll, or multi-lobe pump and may further comprise a trap for water vapor that may be in series or parallel connection with the vacuum pump such as in series connection preceding the vacuum pump. In an embodiment, the vacuum pump such as a multi-lobe pump, or a scroll or root pump comprising stainless steel pumping components may be resistant to damage by gallium or tin alloy formation. The water trap may comprise a water absorbing material such as a solid desiccant or a cryotrap. In an embodiment, the pump may comprise at least one of a cryopump, cryofilter, or cooler to at least one of cool the gases before entering the pump and condense at least one gas such as water vapor. To increase the pumping capacity and rate, the pumping system may comprise a plurality of vacuum lines connected to the reaction cell chamber and a vacuum manifold connected to the vacuum lines wherein the manifold is connected to the vacuum pump. In an embodiment, the inlet to vacuum line comprises a shield for stopping molten metal particles in the reaction cell chamber from entering the vacuum line. An exemplary shield may comprise a metal plate or dome over the inlet but raised from the surface of the inlet to provide a selective gap for gas flow from the reaction cell chamber into the vacuum line. The vacuum system that may further comprise a particle flow restrictor to the vacuum line inlet such as a set of baffles to allow gas flow while blocking particle flow.

The vacuum system may be capable of at least one of ultrahigh vacuum and maintaining a reaction cell chamber operating pressure in at least one low range such as about 0.01 Torr to 500 Torr, 0.1 Torr to 50 Torr, 1 Torr to 10 Torr, and 1 Torr to 5 Torr. The pressure may be maintained low in the case of at least one of (i) H₂ addition with trace HOH catalyst supplied as trace water or as O₂ that reacts with H₂ to form HOH and (ii) H₂O addition. In the case that noble gas such as argon is also supplied to the reaction mixture, the pressure may be maintained in at least one high operating pressure range such as about 100 Torr to 100 atm, 500 Torr to 10 atm, and 1 atm to 10 atm wherein the argon may be in excess compared to other reaction cell chamber gases. The argon pressure may increase the lifetime of at least one of HOH catalyst and atomic H and may prevent the plasma formed at the electrodes from rapidly dispersing so that the plasma intensity is increased.

In an embodiment, the reaction cell chamber comprises a means to control the reaction cell chamber pressure within a desired range by changing the volume in response to pressure changes in the reaction cell chamber. The means may comprise a pressure sensor, a mechanical expandable section, an actuator to expand and contract the expandable section, and a controller to control the differential volume created by the expansion and contraction of the expandable section. The expandable section may comprise a bellows. The actuator may comprise a mechanical, pneumatic, electromagnetic, piezoelectric, hydraulic, and other actuators known in the art.

In an embodiment, the SunCell® may comprise a (i) gas recirculation system with a gas inlet and an outlet, (ii) a gas separation system such as one capable of separating at least two gases of a mixture of at least two of a noble gas such as argon, O₂, H₂, H₂O, air, a volatile species of the reaction mixture such as GaX₃ (X=halide) or NₓO_{y} (x, y=integers), and hydrino gas, (iii) at least one noble gas, O₂, H₂, and H₂O partial pressure sensors, (iv) flow controllers, (v) at least one injector such as a microinjector such as one that injects water, (vi) at least one valve, (vii) a pump, (viii) an exhaust gas pressure and flow controller, and (ix) a computer to maintain at least one of the noble gas, argon, O₂, H₂, H₂O, and hydrino gas pressures. The recirculation system may comprise a semipermeable membrane to allow at least one gas such as molecular hydrino gas to be removed from the recirculated gases. In an embodiment, at least one gas such as the noble gas may be selectively recirculated while at least one gas of the reaction mixture may flow out of the outlet and may be exhausted through an exhaust. The noble gas may at least one of increase the hydrino reaction rate and increase the rate of the transport of at least one species in the reaction cell chamber out the exhaust. The noble gas may increase the rate of exhaust of excess water to maintain a desired pressure. The noble gas may increase the rate that hydrinos are exhausted. In an embodiment, a noble gas such as argon may be replaced by a noble-like gas that is at least one of readily available from the ambient atmosphere and readily exhausted into the ambient atmosphere. The noble-like gas may have a low reactivity with the reaction mixture. The noble-like gas may be acquired from the atmosphere and exhausted rather than be recirculated by the recirculation system. The noble-like gas may be formed from a gas that is readily available from the atmosphere and may be exhausted to the atmosphere. The noble gas may comprise nitrogen that may be separated from oxygen before being flowed into the reaction cell chamber. Alternatively, air may be used as a source of noble gas wherein oxygen may be reacted with carbon from a source to form carbon dioxide. At least one of the nitrogen and carbon dioxide may serve as the noble-like gas. Alternatively, the oxygen may be removed by reaction with the molten metal such as gallium or tin. The resulting gallium or tin oxide may be regenerated in a gallium or tin regeneration system such as one that forms sodium gallate by reaction of aqueous sodium hydroxide with gallium oxide and electrolyzes sodium gallate to gallium metal and oxygen that is exhausted.

In an embodiment, the SunCell® may be operated prominently closed with addition of at least one of the reactants H₂, O₂, and H₂O wherein the reaction cell chamber atmosphere comprises the reactants as well as a noble gas such as argon. The noble gas may be maintained at an elevated pressure such as in the range of 10 Torr to 100 atm. The atmosphere may be at least one of continuously and periodically or intermittently exhausted or recirculated by the recirculation system. The exhausting may remove excess oxygen. The addition of reactant O₂ with H₂ may be such that O₂ is a minor species and essentially forms HOH catalyst as it is injected into the reaction cell chamber with excess H₂. A torch may inject the H₂ and O₂ mixture that immediately reacts to form HOH catalyst and excess H₂ reactant. In an embodiment, the excess oxygen may be at least partially released from gallium or tin oxide by at least one of hydrogen reduction, electrolytic reduction, thermal decomposition, and at least one of vaporization and sublimation due to the volatility of Ga₂O. In an embodiment, at least one of the oxygen inventory may be controlled and the oxygen inventory may be at least partially permitted to form HOH catalyst by intermittently flowing oxygen into the reaction cell chamber in the presence of hydrogen. In an embodiment, the oxygen inventory may be recirculated as H₂O by reaction with the added H₂. In another embodiment, excess oxygen inventor may be removed as Ga₂O₃ and regenerated by means of the disclosure such as by at least one of the skimmer and electrolysis system of the disclosure. The source of the excess oxygen may be at least one of O₂ addition and H₂O addition.

In an embodiment, the gas pressure in the reaction cell chamber may be at least partially controlled by controlling at least one of the pumping rate and the recirculation rate. At least one of these rates may be controlled by a valve controlled by a pressure sensor and a controller. Exemplary valves to control gas flow are solenoid valves that are opened and closed in response to an upper and a lower target pressure and variable flow restriction vales such as butterfly and throttle valves that are controlled by a pressure sensor and a controller to maintain a desired gas pressure range.

In an embodiment, the SunCell® comprises a means to vent or remove molecular hydrino gas from the reaction cell chamber 5b31. In an embodiment, at least one of the reaction cell liner and walls of the reaction cell chamber have a high permeation rate for molecular hydrino such as H₂(¼). To increase the permeation rate, at least one of the wall thickness may be minimized and the wall operating temperature maximized. In an embodiment, the thickness of at least one of the reservoir 5c wall and the reaction cell chamber 5b31 wall may be in the range of 0.05 mm to 5 mm thick. In an embodiment, the reaction cell chamber wall is thinner in at least one region relative to another region to increase the diffusion or permeation rate of molecular hydrino product from the reaction cell chamber 5b31. In an embodiment, the upper side wall section of the reaction cell chamber wall such as the one just below the sleeve reservoir flange 409e of FIGS. 7A-C, and 7F-H is thinned. The thinning may also be desirable to decrease heat conduction to the sleeve reservoir flange 409e. The degree of thinning relative to other wall regions may be in the range of 5% to 90% (e.g., the thinned area has a cross sectional width that is from 5% to 90% of the cross sectional width of non-thinned sections such as the lower side wall section of the reaction chamber proximal to and below electrode 8).

The SunCell® may comprise temperature sensors, a temperature controller, and a heat exchanger such as water jets to controllably maintain the reaction cell chamber walls at a desired temperature such as in the range of 300° C. to 1000° C. to provide a desired high molecular hydrino permeation rate.

At least one of the wall and liner material may be selected to increase the permeation rate. Various liners and liner thicknesses may be chosen in order to maintain certain operating temperatures in order to match the blackbody emission with the energy collection mechanism such as a dense receiver array of concentrated photovoltaic cells. In an embodiment, the reaction cell chamber 5b31 may comprise a plurality of materials such as one or more that contact gallium or tin and one or more that is separated from gallium or tin by a liner, coating, or cladding such as a liner, coating, or cladding of the disclosure. At least one of the separated or protected materials may comprise one that has increased permeability to molecular hydrino relative to a material that is not separated or protected from gallium or tin contact. In an exemplary embodiment, the reaction cell chamber material may comprise one or more of stainless steel such as 347 SS such as 4130 alloy SS or Cr—Mo SS, nickel, Ti, niobium, vanadium, iron, W, Re, Ta, Mo, niobium, and Nb(94.33 wt %)-Mo(4.86 wt %)-Zr(0.81 wt %). Crystalline material such as SiC may be more permeable to hydrinos than amorphous materials such as Sialon or quartz such that crystalline material are exemplary liners.

A different reaction cell chamber wall such as one that is highly permeable to hydrinos may replace the reaction cell chamber wall of a SunCell® (FIG. 7B) comprising another metal that is less permeable such one comprising 347 or 304 SS. The wall section may be a tubular one. The replacement section may be welded, soldered, or brazed to the balance of the SunCell® by methods known in the art such as ones involving the use of metals of different coefficients of thermal expansion to match expansion rates of joined materials. In an embodiment, the replacement section comprising a refractory metal such as Ta, W, Nb, or Mo may be bonded to a different metal such as stainless steel by an adhesive such as one by Coltronics such as Resbond or Durabond 954. In an embodiment, the union between the different metals may comprise a lamination material such as a ceramic lamination between the bonded metals wherein each metal is bonded to one face of the lamination. The ceramic may comprise one of the disclosure such as BN, quartz, alumina, hafnia, or zirconia. An exemplary union is Ta/Durabond 954/BN/Durabond 954/SS. In an embodiment, the flange 409e and baseplate 409a may be sealed with a gasket or welded.

In an embodiment, the reaction cell chamber comprising a carbon liner comprises at least one of walls that have a high heat transfer capability, a large diameter, and a highly capable cooling system wherein the heat transfer capability, the large diameter, and the cooling system are sufficient to maintain the temperature of the carbon liner below a temperature at which it would react with at least one component of the hydrino reaction mixture such as water or hydrogen. An exemplary heat transfer capability may be in the range of about 10 W/cm² to 10 kW/cm² wall area; an exemplary diameter may be in the range of about 2 cm to 100 cm, an exemplary cooling system is an external water bath; an exemplary desired liner temperature may be about below 700-750° C. The reaction cell chamber wall may further be highly permeable to molecular hydrino. The liner may be in contact with the wall to improve heat transfer from the liner to the cooling system to maintain the desired temperature.

In an embodiment, the SunCell® comprises a gap between the liner and at least one reaction cell chamber wall and a vacuum pump wherein the gap comprises a chamber that is evacuated by the vacuum pump to remove molecular hydrino. The liner may be porous. In an exemplary embodiment, the liner comprises porous ceramic such as porous BN, SiC-coated carbon, or quartz to increase the permeation rate. In an embodiment, the SunCell® may comprise insulation. The insulation may be highly permeable for hydrino. In another embodiment, the SunCell® comprises a molecular hydrino getter such as iron nanoparticles at least one internal and external to the reaction cell chamber wherein the getter binds molecular hydrino to remove it from the reaction cell chamber. In an embodiment, the molecular hydrino gas may be pumped out of the reaction cell chamber. The reaction mixture gas such as one comprising H₂O and hydrogen or another of the disclosure may comprise a flushing gas such as a noble gas to assist in removing molecular hydrino gas by evacuation. The flushing gas may be vented to atmosphere or circulated by a recirculator of the disclosure.

In an embodiment, the liner may comprise a hydrogen dissociator such as niobium. The liner may comprise a plurality of materials such as a material the resists gallium or tin alloy formation in the hottest zones of the reaction cell chamber and another material such as a hydrogen dissociator in at least one zone that operates at a temperature below the gallium or tin alloy formation temperature of the another material.

The electrostatic precipitator (ESP) may further comprise a means to precipitate at least one desired species from the gas stream from the reaction cell chamber and return it to the reaction cell chamber. The precipitator may comprise a transport mean such as an auger, conveyor belt, pneumatic, electromechanical, or other transport means of the disclosure or known in the art to transport particles collected by the precipitator back to the reaction cell chamber. The precipitator may be mounted in a portion of the vacuum line that comprises a refluxer that returns desired particles to the reaction cell chamber by gravity flow wherein the particles may be precipitated and flow back to the reaction cell chamber by gravity flow such as flow in the vacuum line. The vacuum line may be oriented vertically in at least one portion that allows the desired particles to undergo gravity return flow.

In an embodiment, an electrostatic precipitator (ESP) system comprises an ESP and a source of trace oxygen such as air to form an oxide coat on molten metal particles such as gallium or tin or tin particles such that the particles can be removed by the ESP. The source may comprise a flow regulator that may supply the oxygen to at least one of the ESP system and a vacuum line to a vacuum pump that evacuates the reaction cell chamber. The source may comprise air that may also serve as a purge gas to improve the evacuation of the reaction cell chamber.

In an embodiment, the reaction chamber and at least one component in direct contact with the reaction cell chamber such as a vacuum line to a vacuum pump are at a positive electrical polarity relative to the top electrode that is negative. The vacuum line may comprise a filter or trap to catch metal and metal oxide particles. The filter may serve as a positive electrode of an ESP. The filter may further comprise a gas jet to at least intermittently backflow a reactant gas such as hydrogen, oxygen, or steam or an inert gas such as argon to remove collected particles from the filter. The reactant gas may flow through the discharge cell 900 of the disclosure before flowing through the gas jet. In an exemplary embodiment, the filter comprises a W or Ta mesh at the input to the vacuum line that protrudes into the reaction cell chamber. The filter may further comprise a gas jet. The tungsten or tantalum mesh filter that may avoid melting and avoid alloy formation and wetting by the molten metal such as gallium or tin. The filter mesh size may be selected such that the particles will not go through or that a majority of particles are prevented from passing through the mesh, but gasses will. The vacuum line may be electrically connected to the positive reaction cell chamber such that metal oxide particle may stick by an electrostatic precipitation effect. The particles may fall back into the reaction cell chamber. The filter may be periodically or continuously back flushed with an H₂ or argon gas jet stream to force the particles off the mesh and into the reaction cell chamber.

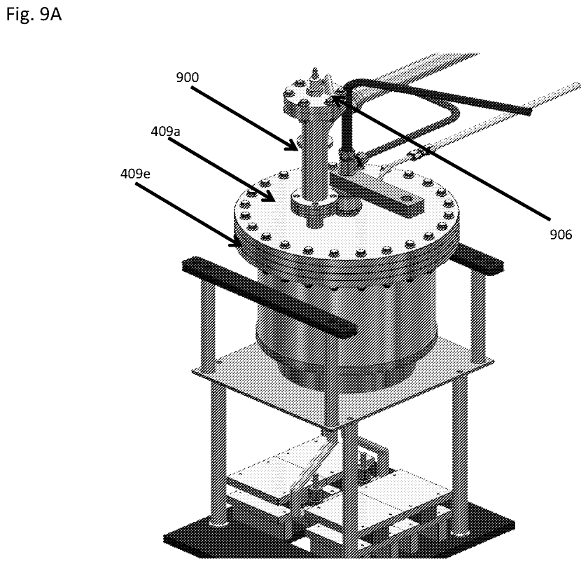

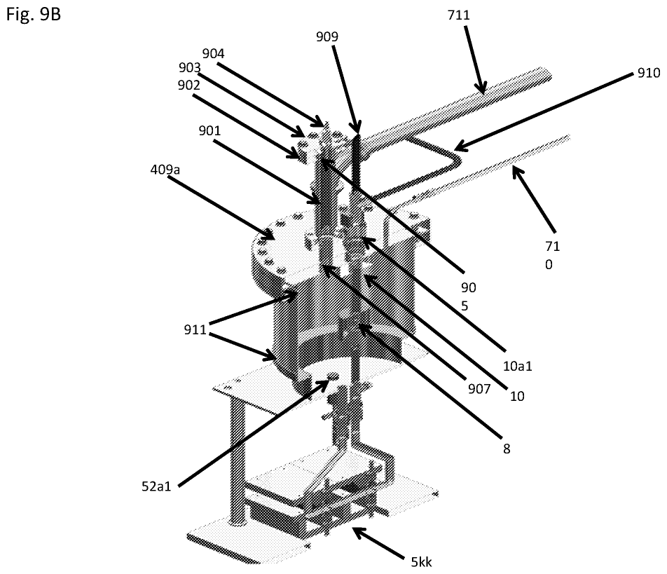

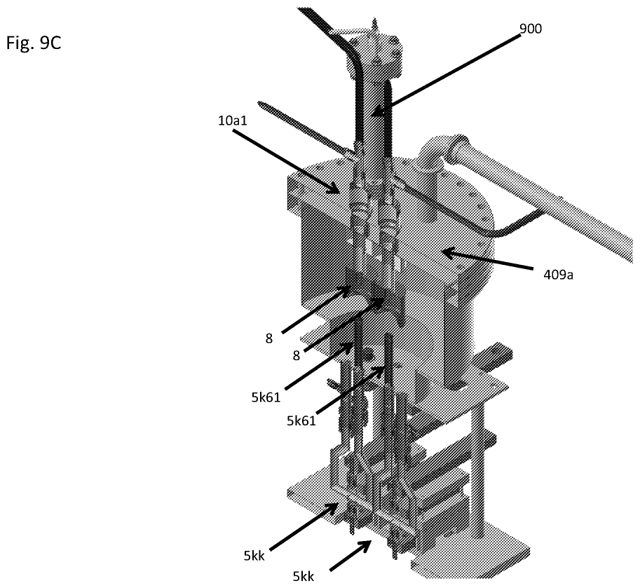

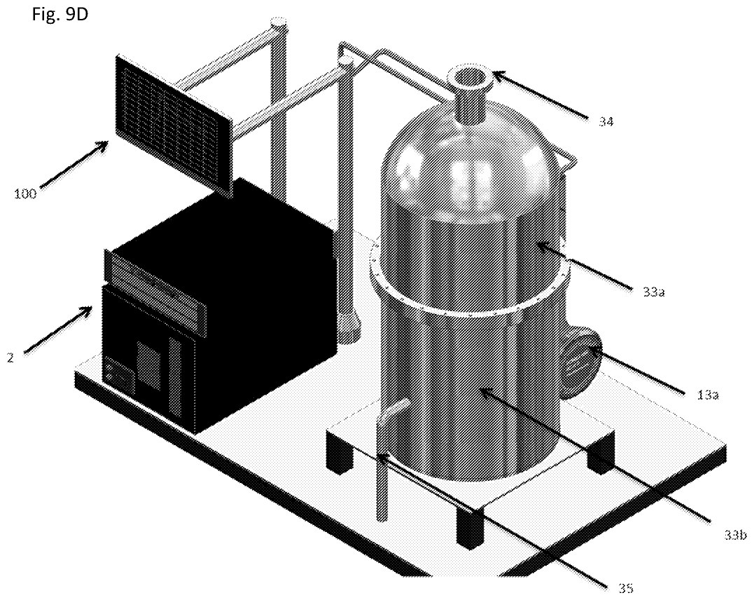

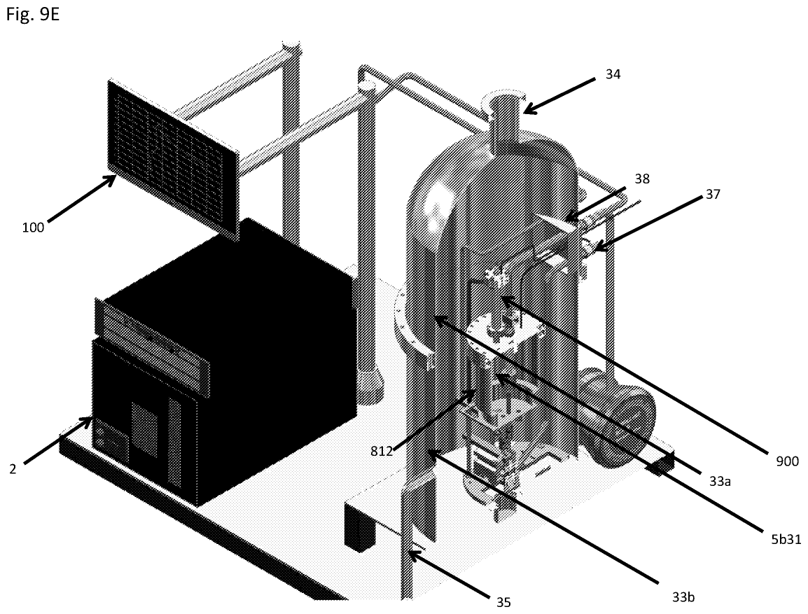

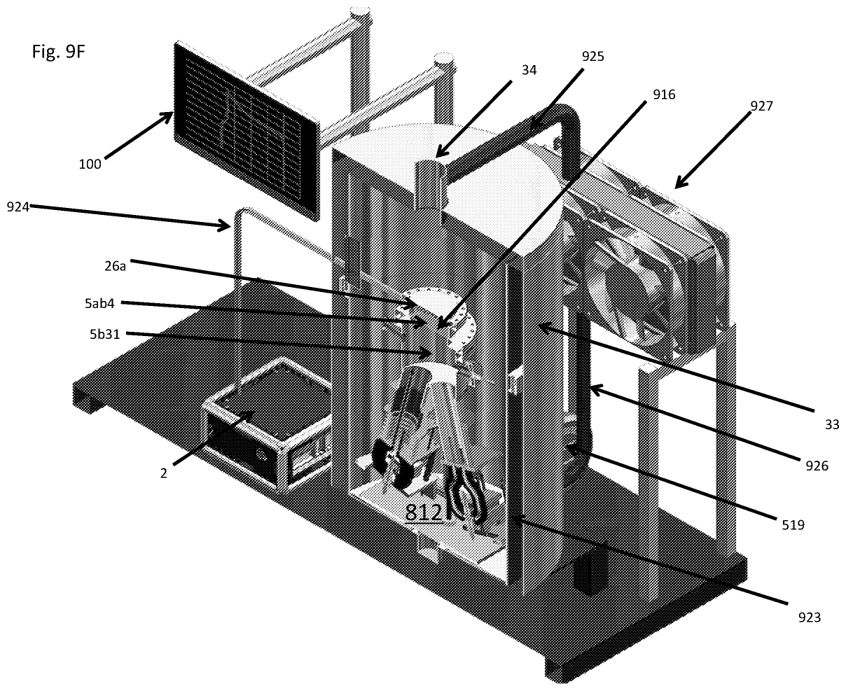

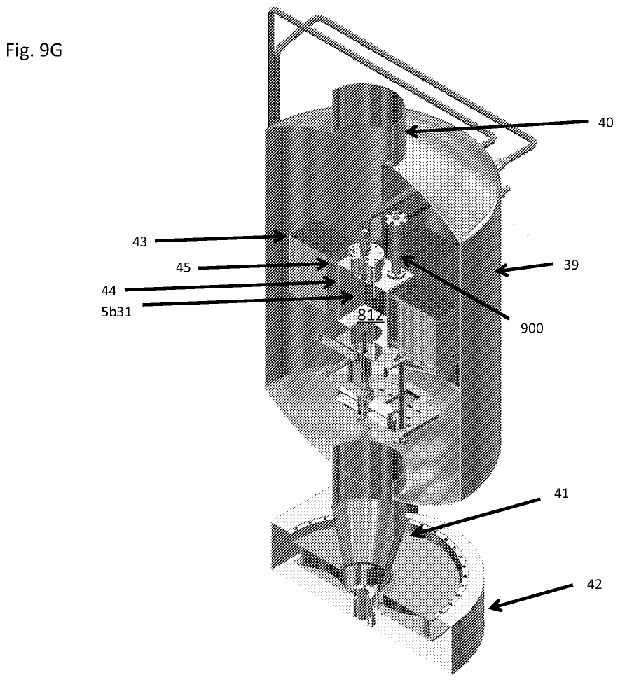

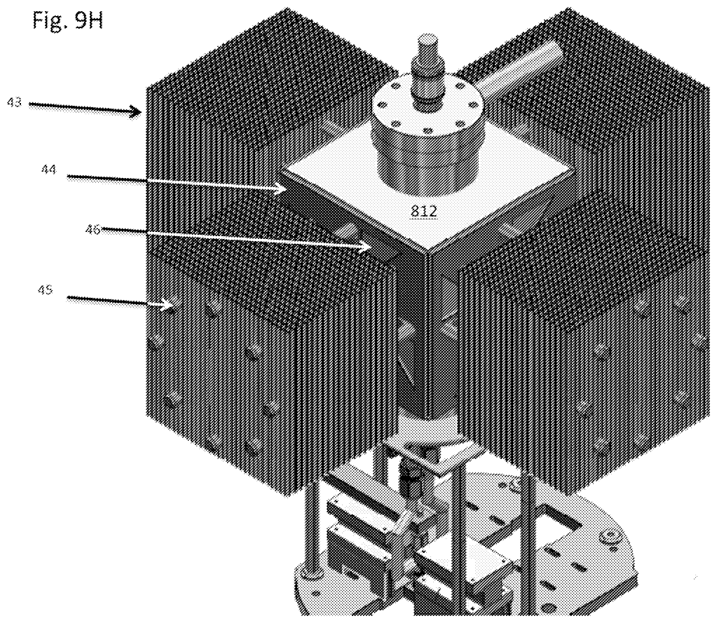

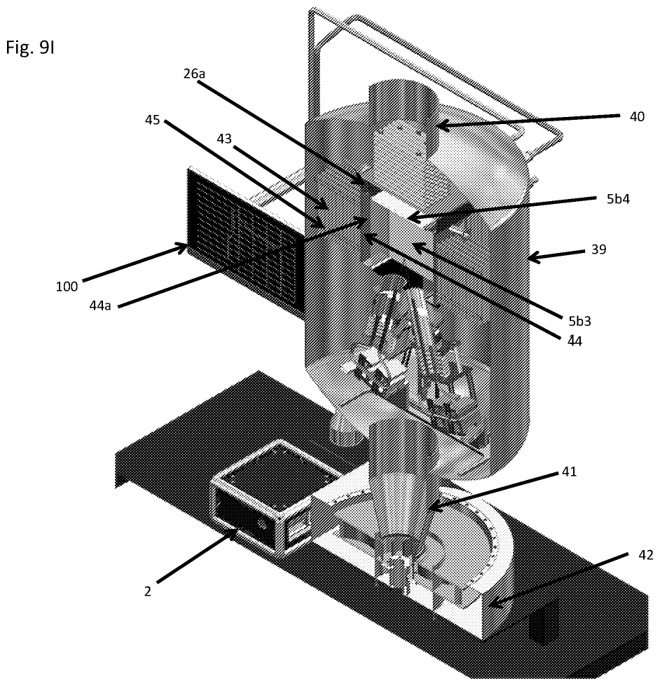

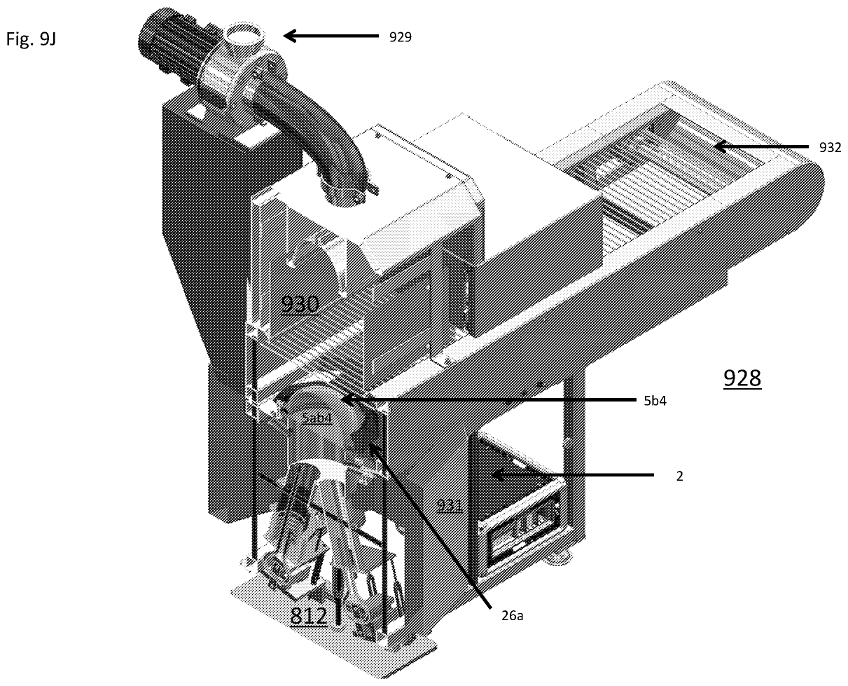

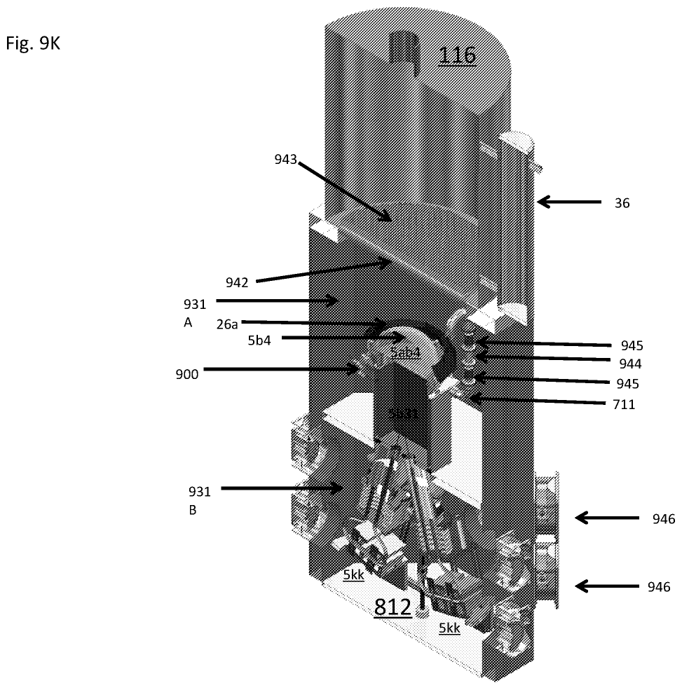

In an embodiment, the SunCell may comprise an electrostatic precipitation system (ESP) system shown in FIG. 9K. The ESP system may comprise two separated electrical breaks 945 in the vacuum line 711 close to the reaction cell chamber 5b31 to electrically isolate a positive vacuum line section 944 that is positively polarized. The positive section may comprise positive lead on the vacuum line, and a component of the SunCell such as the reaction cell chamber 5b31 may comprise a negative lead. The leads may be connected to a high voltage power supply such that the positive section is positively biased and the SunCell component is negatively bias or at ground. The voltage applied to the positive section may be in at least one range of about 10 V to 10 MV, 50 V to 1 MV, and 100 V to 100 kV with a corresponding positive section diameter in at least one range about 0.1 mm to 1 m, 1 mm to 10 cm, and 1 mm to 5 cm. The tube may be flattened such that the cross-sectional area for vacuum pumping remains similar to that of connected sections of vacuum line such as those of the electrical breaks 945. The corresponding electric field may be in the range of about 1000 V/m to 108 V/m wherein the gas pressure in the tube may be in the range of about 0.1 milliTorr to 10 atm. The plasma in the reaction cell chamber may charge oxide particles such as gallium or tin oxide particles negatively, and such particles that flow through the vacuum line may be electrostatically attracted to the positively changed walls of the isolated positively polarized vacuum line section. The vacuum line to the positive section may at least one of comprise an electrical insulator or be lined with an electrical insulator to prevent the charged particles from losing charge before entering the positive vacuum line section. ESP accumulated particles may fall back into the reaction cell chamber by gravity or be forced back by means such as a gas jet such as a hydrogen or argon gas jet.

In an exemplary tested embodiment, the reaction cell chamber was maintained at a pressure range of about 1 to 2 atm with 4 ml/min H₂O injection. The DC voltage was about 30 V and the DC current was about 1.5 kA. The reaction cell chamber was a 6-inch diameter stainless steel sphere such as one shown in FIG. 1 that contained 3.6 kg of molten gallium. The electrodes comprised a 1-inch submerged SS nozzle of a DC EM pump and a counter electrode comprising a 4 cm diameter, 1 cm thick W disc with a 1 cm diameter lead covered by a BN pedestal. The EM pump rate was about 30-40 ml/s. The gallium was polarized positive with a submerged nozzle, and the W pedestal electrode was polarized negative. The gallium was well mixed by the EM pump injector. The SunCell® output power was about 85 kW measured using the product of the mass, specific heat, and temperature rise of the gallium and SS reactor.

In another tested embodiment, 2500 sccm of H₂ and 25 sccm O₂ was flowed through about 2 g of 10% Pt/Al₂O₃ beads held in an external chamber in line with the H₂ and O₂ gas inlets and the reaction cell chamber. Additionally, argon was flowed into the reaction cell chamber at a rate to maintain 50 Torr chamber pressure while applying active vacuum pumping. The DC voltage was about 20 V and the DC current was about 1.25 kA. The SunCell® output power was about 120 kW measured using the product of the mass, specific heat, and temperature rise of the gallium and SS reactor.

In an embodiment, the recirculation system or recirculator such as the noble gas recirculatory system capable of operating at one or more of under atmospheric pressure, at atmospheric pressure, and above atmospheric pressure may comprise (i) a gas mover such as at least one of a vacuum pump, a compressor, and a blower to recirculate at least one gas from the reaction cell chamber, (ii) recirculation gas lines, (iii) a separation system to remove exhaust gases such as hydrino and oxygen, and (iv) a reactant supply system. In an embodiment, the gas mover is capable of pumping gas from the reaction cell chamber, pushing it through the separation system to remove exhaust gases, and returning the regenerated gas to the reaction cell chamber. The gas mover may comprise at least two of the pump, the compressor, and the blower as the same unit. In an embodiment, the pump, compressor, blower or combination thereof may comprise at least one of a cryopump, cryofilter, or cooler to at least one of cool the gases before entering the gas mover and condense at least one gas such as water vapor. The recirculation gas lines may comprise a line from the vacuum pump to the gas mover, a line from the gas mover to the separation system to remove exhaust gases, and line from the separation system to remove exhaust gases to the reaction cell chamber that may connect with the reactant supply system. An exemplary reactant supply system comprises at least one union with the line to the reaction cell chamber with at least one reaction mixture gas make-up line for at least one of the noble gas such as argon, oxygen, hydrogen, and water. The addition of reactant O₂ with H₂ may be such that O₂ is a minor species and essentially forms HOH catalyst as it is injected into the reaction cell chamber with excess H₂. A torch may inject the H₂ and O₂ mixture that immediately reacts to form HOH catalyst and excess H₂ reactant. The reactant supply system may comprise a gas manifold connected to the reaction mixture gas supply lines and an outflow line to the reaction cell chamber.

The separation system to remove exhaust gases may comprise a cryofilter or cryotrap. The separation system to remove hydrino product gas from the recirculating gas may comprise a semipermeable membrane to selectively exhaust hydrino by diffusion across the membrane from the recirculating gas to atmosphere or to an exhaust chamber or stream. The separation system of the recirculator may comprise an oxygen scrubber system that removes oxygen from the recirculating gas. The scrubber system may comprise at least one of a vessel and a getter or absorbent in the vessel that reacts with oxygen such as a metal such as an alkali metal, an alkaline earth metal, or iron. Alternatively, the absorbent such as activated charcoal or another oxygen absorber known in the art may absorb oxygen. The charcoal absorbent may comprise a charcoal filter that may be sealed in a gas permeable cartridge such as one that is commercially available. The cartridge may be removable. The oxygen absorbent of the scrubber system may be periodically replaced or regenerated by methods known in the art. A scrubber regeneration system of the recirculation system may comprise at least one of one or more absorbent heaters and one or more vacuum pumps. In an exemplary embodiment, the charcoal absorbent is at least one of heated by the heater and subjected to an applied vacuum by the vacuum pump to release oxygen that is exhausted or collected, and the resulting regenerated charcoal is reused. The heat from the SunCell® may be used to regenerate the absorbent. In an embodiment, the SunCell® comprises at least one heat exchanger, a coolant pump, and a coolant flow loop that serves as a scrubber heater to regenerate the absorbent such as charcoal. The scrubber may comprise a large volume and area to effectively scrub while not significantly increasing the gas flow resistance. The flow may be maintained by the gas mover that is connected to the recirculation lines. The charcoal may be cooled to more effectively absorb species to be scrubbed from the recirculating gas such as a mixture comprising the noble gas such as argon. The oxygen absorbent such as charcoal may also scrub or absorb hydrino gas. The separation system may comprise a plurality of scrubber systems each comprising (i) a chamber capable of maintaining a gas seal, (ii) an absorbent to remove exhaust gases such as oxygen, (iii) inlet and outlet valves that may isolate the chamber from the recirculation gas lines and isolate the recirculation gas lines from the chamber, (iv) a means such as a robotic mechanism controlled by a controller to connect and disconnect the chamber from the recirculation lines, (v) a means to regenerate the absorbent such as a heater and a vacuum pump wherein the heater and vacuum pump may be common to regenerate at least one other scrubber system during its regeneration, (v) a controller to control the disconnection of the nth scrubber system, connection of the n+1th scrubber system, and regeneration of the nth scrubber system while the n+1th scrubber system serves as an active scrubber system wherein at least one of the plurality of scrubber systems may be regenerated while at least one other may be actively scrubbing or absorbing the desired gases. The scrubber system may permit the SunCell® to be operated under closed exhaust conditions with periodic controlled exhaust or gas recovery. In an exemplary embodiment, hydrogen and oxygen may be separately collected from the absorbent such as activated carbon by heating to different temperatures at which the corresponding gases are about separately released.

In an embodiment comprising a reaction cell chamber gas mixture of a noble gas, hydrogen (H₂), and oxygen (O₂) wherein the partial pressure of the noble gas of the reaction cell chamber gas exceeds that of hydrogen, the oxygen partial pressure may be increased to compensate for the reduced reaction rate between hydrogen and oxygen to form HOH catalyst due to the reactant concentration dilution effect of the noble gas such as argon. In an embodiment, the HOH catalyst may be formed in advance of combining with the noble gas such as argon. The hydrogen and oxygen may be caused to react by a recombiner or combustor such as a recombiner catalyst, a plasma source, or a hot surface such as a filament. The recombiner catalyst may comprise a noble metal supported on a ceramic support such as Pt, Pd, or Ir on alumina, zirconia, hafnia, silica, or zeolite power or beads, another supported recombiner catalyst of the disclosure, or a dissociator such as Raney Ni, Ni, niobium, titanium, or other dissociator metal of the disclosure or one known in the art in a form to provide a high surface area such as powder, mat, weave, or cloth. An exemplary recombiner comprises 10 wt % Pt on Al₂O₃ beads. The plasma source may comprise a glow discharge, microwave plasma, plasma torch, inductively or capacitively coupled RF discharge, dielectric barrier discharge, piezoelectric direct discharge, acoustic discharge, or another discharge cell of the disclosure or known in the art. The hot filament may comprise a hot tungsten filament, a Pt or Pd black on Pt filament, or another catalytic filament known in the art.

The inlet flow of reaction mixture species such as at least one of water, hydrogen, oxygen, air, and a noble gas may be continuous or intermittent. The inlet flow rates and an exhaust or vacuum flow rate may be controlled to achieve a desired pressure range. The inlet flow may be intermittent wherein the flow may be stopped at the maximum pressure of a desired range and commenced at a minimum of the desire range. In a case that reaction mixture gases comprise high pressure noble gas such as argon, the reaction cell chamber may be evacuated, filled with the reaction mixture, and run under about static exhaust flow conditions wherein the inlet flows of reactants such as at least one of water, hydrogen, and oxygen are maintained under continuous or intermittent flow conditions to maintain the pressure in the desired range. Additionally, the noble gas may be flowed at an economically practical flow rate with a corresponding exhaust pumping rate, or the noble gas may be regenerated or scrubbed and recirculated by the recirculation system or recirculator. In an embodiment, the reaction mixture gases may be forced into the cell by an impeller or by a gas jet to increase the reactant flow rate through the cell while maintaining the reaction cell pressure in a desired range.

In an embodiment, the reaction cell chamber reaction cell mixture is controlled by controlling the reaction cell chamber pressure by at least one means of controlling the injection rate of the reactants and controlling the rate that excess reactants of the reaction mixture and products are exhausted from the reaction cell chamber 5b31. In an embodiment, the SunCell® comprises a pressure sensor, a vacuum pump, a vacuum line, a valve controller, and a valve such as a pressure-activated valve such as a solenoid valve or a throttle valve that opens and closes to the vacuum line from the reaction cell chamber to the vacuum pump in response to the controller that processes the pressure measured by the sensor. The valve may control the pressure of the reaction cell chamber gas. The valve may remain closed until the cell pressure reaches a first high setpoint, then the value may be activated to be open until the pressure is dropped by the vacuum pump to a second low setpoint which may cause the activation of the valve to close. In an embodiment, the controller may control at least one reaction parameter such as the reaction cell chamber pressure, reactant injection rate, voltage, current, and molten metal injection rate to maintain a non-pulsing or about steady or continuous plasma.

In an embodiment, the SunCell® comprises a pressure sensor, a source of at least one reactant or species of the reaction mixture such as a source of H₂O, H₂, O₂, air, and noble gas such a argon, a reactant line, a valve controller, and a valve such as a pressure-activated valve such as a solenoid valve or a throttle valve that opens and closes to the reactant line from the source of at least one reactant or species of the reaction mixture and the reaction cell chamber in response to the controller that processes the pressure measured by the sensor. The valve may control the pressure of the reaction cell chamber gas. The valve may remain open until the cell pressure reaches a first high setpoint, then the value may be activated to be close until the pressure is dropped by the vacuum pump to a second low setpoint which may cause the activation of the valve to open.

In an embodiment, the SunCell® may comprise an injector such as a micropump. The micropump may comprise a mechanical or non-mechanical device. Exemplary mechanical devices comprise moving parts which may comprise actuation and microvalve membranes and flaps. The driving force of the micropump mat be generated by utilizing at least one effect form the group of piezoelectric, electrostatic, thermos-pneumatic, pneumatic, and magnetic effects. Non-mechanical pumps may be unction with at least one of electro-hydrodynamic, electro-osmotic, electrochemical, ultrasonic, capillary, chemical, and another flow generation mechanism known in the art. The micropump may comprise at least one of a piezoelectric, electroosmotic, diaphragm, peristaltic, syringe, and valveless micropump and a capillary and a chemically powered pump, and another micropump known in the art. The injector such as a micropump may continuously supply reactants such as water, or it may supply reactants intermittently such as in a pulsed mode. In an embodiment, a water injector comprises at least one of a pump such as a micropump, at least one valve, and a water reservoir, and may further comprise a cooler or an extension conduit to remove the water reservoir and valve for the reaction cell chamber by a sufficient distance, either to avoid over heating or boiling of the preinjected water.

The SunCell® may comprise an injection controller and at least one sensor such as one that records pressure, temperature, plasma conductivity, or other reaction gas or plasma parameter. The injection sequence may be controlled by the controller that uses input from the at least one sensor to deliver the desired power while avoiding damage to the SunCell® due to overpowering. In an embodiment, the SunCell® comprises a plurality of injectors such as water injectors to inject into different regions within the reaction cell chamber wherein the injectors are activated by the controller to alternate the location of plasma hot spots in time to avoid damage to the SunCell®. The injection may be intermittent, periodic intermittent, continuous, or comprise any other injection pattern that achieves the desired power, gain, and performance optimization.

In an embodiment, the SunCell® comprises a source of hydrogen such as hydrogen gas and a source of oxygen such as oxygen gas. The source of at least one of hydrogen and oxygen sources comprises at least one or more gas tanks, flow regulators, pressure gauges, valves, and gas lines to the reaction cell chamber. In an embodiment, the HOH catalyst is generated from combustion of hydrogen and oxygen. The hydrogen and oxygen gases may be flowed into the reaction cell chamber. The inlet flow of reactants such as at least one of hydrogen and oxygen may be continuous or intermittent. The flow rates and an exhaust or vacuum flow rate may be controlled to achieve a desired pressure. The inlet flow may be intermittent wherein the flow may be stopped at the maximum pressure of a desired range and commenced at a minimum of the desire range. At least one of the H₂ pressure and flow rate and O₂ pressure and flow rate may be controlled to maintain at least one of the HOH and H₂ concentrations or partial pressures in a desired range to control and optimize the power from the hydrino reaction. In an embodiment, at least one of the hydrogen inventory and flow many be significantly greater than the oxygen inventory and flow. The ratio of at least one of the partial pressure of H₂ to O₂ and the flow rate of H₂ to O₂ may be in at least one range of about 1.1 to 10,000, 1.5 to 1000, 1.5 to 500, 1.5 to 100, 2 to 50 and 2 to 10. In an embodiment, the total pressure may be maintained in a range that supports a high concentration of nascent HOH and atomic H such as in at least one pressure range of about 1 mTorr to 500 Torr, 10 mTorr to 100 Torr, 100 mTorr to 50 Torr, and 1 Torr to 100 Torr. In an embodiment, at least one of the reservoir and reaction cell chamber may be maintained at an operating temperature that is greater than the decomposition temperature of at least one of gallium or tin oxyhydroxide and gallium or tin hydroxide. The operating temperature may be in at least one range of about 200° C. to 2000° C., 200° C. to 1000° C., and 200° C. to 700° C. The water inventory may be controlled in the gaseous state in the case that gallium or tin oxyhydroxide and gallium or tin hydroxide formation is suppressed.

In an embodiment, the SunCell® comprises a gas mixer to mix at least two gases such as hydrogen and oxygen that are flowed into the reaction cell chamber. In an embodiment, the micro-injector for water comprises the mixer that mixes hydrogen and oxygen wherein the mixture forms HOH as it enters the reaction cell chamber. The mixer may further comprise at least one mass flow controller, such as one for each gas or a gas mixture such as a premixed gas. The premixed gas may comprise each gas in its desired molar ratio such as a mixture comprising hydrogen and oxygen. The H₂ molar percent of a H₂—O₂ mixture may be in significant excess such as in a molar ratio range of about 1.5 to 1000 times the molar percent of O₂. The mass flow controller may control the hydrogen and oxygen flow and subsequent combustion to form HOH catalyst such that the resulting gas flow into the reaction cell chamber comprises hydrogen in excess and HOH catalyst. In an exemplary embodiment, the H₂ molar percentage is in the range of about 1.5 to 1000 times the molar percent of HOH. The mixer may comprise a hydrogen-oxygen torch. The torch may comprise a design known in the art such as a commercial hydrogen-oxygen torch. In exemplary embodiments, O₂ with H₂ are mixed by the torch injector to cause O₂ to react to form HOH within the H₂ stream to avoid oxygen reacting with the molten metal such as gallium, tin, or cell components. Alternatively, a H₂—O₂ mixture comprising hydrogen in at least ten times molar excess is flowed into the reaction cell chamber by a single flow controller versus two supplying the torch.

The reaction of the O₂ with excess H₂ may form about 100% nascent water as an initial product compared to bulk water and steam that comprise a plurality of hydrogen-bonded water molecules. In an embodiment, the tin in the presence of hydrogen is maintained at a temperature of greater than 300° C. such that the tin may have a low reactivity to consume the HOH catalyst by forming tin oxide. Gallium may be maintained below 100° C. such that the gallium may have a low reactivity to consume the HOH catalyst by forming gallium oxide. In an exemplary embodiment, the SunCell® is operated under the conditions of high flow rate H₂ with trace O₂ flow such as more than 99% H₂/1% O₂ wherein the reaction cell chamber pressure may be maintained low such as in the pressure range of about 1 to 30 Torr, and the flow rate may be controlled to produce the desired power wherein the theoretical maximum power by forming H₂(¼) may be about 1 kW/30 sccm. Any resulting metal oxide (e.g., gallium or tin oxide) may be reduced by in situ hydrogen plasma and electrolytically reduction. In an exemplary embodiment capable of generating a maximum excess power of 75 kW wherein the vacuum system is capable of achieving ultrahigh vacuum, the operating conditions comprise a low operating pressure such as about 1-5 Torr, and high H₂ flow such as about 2000 sccm with trace HOH catalyst supplied as about 10-20 sccm oxygen through a torch injector.

In an embodiment, the SunCell® components or surfaces of components that contact the metal such as at least one of the reaction cell chamber walls, the top of the reaction cell chamber, inside walls of the reservoir, and inside walls of the EM pump tube may be coated with a coating that does not form an alloy readily with gallium or tin such as a ceramic such as Mullite, BN, or another of the disclosure, or a metal such as W, Ta, Re, Nb, Zr, Mo, TZM, or another of the disclosure. In another embodiment, the surfaces may be clad with a material that does not readily form an alloy with gallium or tin such as carbon, a ceramic such as BN, alumina, zirconia, quartz, or another of the disclosure, or a metal such as W, Ta, Re, or another of the disclosure. In an embodiment, at least one of the reaction cell chamber, reservoir, and EM pump tube may comprise Nb, Zr, W, Ta, Re, Mo, or TZM. In an embodiment, SunCell® components or portions of the components such as the reaction cell chamber, reservoir, and EM pump tube may comprise a material that does not form an alloy except when the temperature of contacting gallium or tin exceeds an extreme such as at least one extreme of over about 400° C., 500° C., 600° C., 700° C., 800° C., 900° C., and 1000° C. The SunCell® may be operated at a temperature wherein portions of components do not reach a temperature at which gallium or tin alloy formation occurs. The SunCell® operating temperature may be controlled with cooling by cooling means such as a heat exchanger or water bath. The water bath may comprise impinging water jets such as jets off of a water manifold wherein at least one of the number of jets incident on the reaction chamber and the flow rate or each jet are controlled by a controller to maintain the reaction chamber within a desired operating temperature range. In an embodiment such as one comprising water jet cooling of at least one surface, the exterior surface of at least one component of the SunCell® may be clad with insulation such as carbon to maintain an elevated internal temperature while permitting operational cooling. In an embodiment wherein the SunCell® is cooled by means such as at least one of suspension in a coolant such as water or subjected to impinging coolant jets, the EM pump tube is thermally insulated to prevent the injection of cold liquid metal into the plasma to avoid decreasing the hydrino reaction rate. In an exemplary thermal insulation embodiment, the EM pump tube 5k6 may be cast in cement-type material that is a very good thermal insulator (e.g., the cement-type material may have a thermal conductivity of less than 1 W/mK or less than 0.5 W/mK or less than 0.1 W/mK). The surfaces that form a gallium or tin alloy above a temperature extreme achieved during SunCell® operation may be selectively coated or clad with a material that does not readily form an alloy with gallium or tin. The portions of the SunCell® components that both contact gallium or tin and exceed the alloy temperature for the component's material such as stainless steel may be clad with the material that does not readily form an alloy with gallium or tin. In an exemplary embodiment, the reaction cell chamber walls may be clad with W, Ta, Re, Mo, TZM, niobium, vanadium, or zirconium plate, or a ceramic such as quartz, especially at the region near the electrodes wherein the reaction cell chamber temperature is the greatest. The cladding may comprise a reaction cell chamber liner 5b31a. The liner may comprise a gasket or other gallium or tin impervious material such as a ceramic paste positioned between the liner and the walls of the reaction cell chamber to prevent gallium or tin from seeping behind the liner. The liner may be attached to the wall by at least one of welds, bolts, or another fastener or adhesive known in the art.

In an embodiment, the bus bas such as at least one of 10, 5k2, and the corresponding electrical leads from the bus bars to at least one of the ignition and EM pump power supplies may serve as a means to remove heat from the reaction cell chamber 5b31 for applications. The SunCell® may comprise a heat exchanger to remove heat from at least one of the bus bars and corresponding leads. In a SunCell® embodiment comprising a MHD converter, heat lost on the bus bars and their leads may be returned to the reaction cell chamber by a heat exchanger that transfers heat from the bus bars to the molten silver that is returned to the reaction cell chamber from the MHD converter by the EM pump.

In an embodiment, the side walls of the reaction cell chamber such as the four vertical sides of a cubic reaction cell chamber or walls of a cylindrical cell may be coated or clad in a refractory metal such as W, Ta, or Re, or covered by a refractory metal such as W, Ta, or Re liner. The metal may be resistant to alloy formation with gallium or tin. The top of the reaction cell chamber may be clad or coated with an electrical insulator or comprise an electrically insulating liner such as a ceramic. Exemplary cladding, coating, and liner materials are at least one of BN, gorilla glass (e.g., https://en.wikipedia.org/wiki/Gorilla_Glass-aluminosilicate sheet glass available from Corning), quartz, titania, alumina, yttria, hafnia, zirconia, silicon carbide, graphite such as pyrolytic graphite, silicon carbide coated graphite, or mixtures such as TiO₂-Yr₂O₃—Al₂O₃. The top liner may have a penetration for the pedestal 5c1 (FIG. 1). The top liner may prevent the top electrode 8 from electrically shorting to the top of the reaction cell chamber. In an embodiment, the top flange 409a (FIGS. 7A-C) may comprise a liner such as one of the disclosure or coating such as a ceramic coating such as Mullite, ZTY, Resbond, or another of the disclosure or a paint such as VHT Flameproof™. In an embodiment shown in FIGS. 7F-H, the SunCell comprises a top flange baseplate 409a sealed with a gasket such as a copper, silver-plated copper, or tantalum gasket or O-ring to a mating flange 409e such as a Conflat flange. The flanges may be coated with a coating such as Flameproof paint, alumina, CrC, TiN, Ta, or another of the disclosure that prevents alloy formation with the molten metal. The gasket or O-ring such as Ta ones may be alloy-formation resistant. The top flange baseplate 409a may further comprise a top liner. The top liner may comprise a thermal insulation puck such as a Macor, quartz, or Flameproof-painted carbon puck on the top flange to protect the top flange from failing due to thermal damage. The puck may be sufficiently thick such as in the range of 0.1 cm to 10 cm thick to prevent the thermal damage. The gasket may be coated with a coating such as Flameproof paint or another of the disclosure to protect the gasket from alloy formation with the molten metal. In an embodiment, the flanges may be replaced by flat metal plates (no bolt holes) such as annuluses around the perimeter of each joined component. The plates may be welded together on the outer edges to form a seam. The seam may be cut or ground off to separate the two plates.

In an embodiment, the SunCell® comprises a baseplate 409a heat sensor, an ignition power source controller, an ignition power source, and a shut off switch which may be connected, directly, or indirectly to at least one of the ignition power source controller and the ignition power source to terminate ignition when a short occurs at the baseplate 409a and it overheats. In an embodiment, the ceramic liner comprises a plurality of sections wherein the sections provide at least one of expansion gaps or joints between sections and limit heat gradients along the length of the plurality of the sections of the liner. In an embodiment, the liner may be suspended above the liquid metal level to avoid a steep thermal gradient formed in the case that a portion of the liner is submerged in the gallium or tin. The liner sections may comprise different combinations of materials for different regions or zones having different temperature ranges during operation. In an exemplary embodiment of a liner comprising a plurality of ceramic sections of at least two types of ceramic, the section in the hottest zone such as the zone in proximity to the positive electrode may comprise SiC or BN, and at least one other section may comprise quartz.

In an embodiment, the reaction cell chamber 5b31 comprises internal thermal insulation (also referred to herein as a liner) such as at least one ceramic or carbon liner, such as a quartz, BN, alumina, zirconia, hafnia, or another liner of the disclosure. In some embodiments, the reaction cell chamber does not comprise a liner such as a ceramic liner. In some embodiments, the reaction cell chamber walls may comprise a metal that is maintained at a temperature below that for which alloy with the molten metal occurs such as below about 400° C. to 500° C. in the case of stainless steel such as 347 SS such as 4130 alloy SS or Cr—Mo SS or W, Ta, Mo, Nb, Nb(94.33 wt %)-Mo(4.86 wt %)-Zr(0.81 wt %), Os, Ru, Hf, Re, or silicide coated Mo. In an embodiment such as one wherein the reaction cell chamber is immersed in a coolant such as water, the reaction cell chamber 5b31 wall thickness may be thin such that the internal wall temperature is below the temperature at which the wall material such as 347 SS such as 4130 alloy SS, Cr—Mo SS, or Nb—Mo(5 wt %)-Zr(1 wt %) forms an alloy with the molten metal such as gallium or tin. The reaction cell chamber wall thickness may be at least one of about less than 5 mm, less than 4 mm, less than 3 mm, less than 2 mm, and less than 1 mm. The temperature inside of the liner may be much higher such as in at least one range of about 500° C. to 6000° C., 500° C. to 3400° C., 500° C. to 2500° C., 500° C. to 1000° C., and 500° C. to 1500° C. In an exemplary embodiment, the reaction cell chamber and reservoir comprise a plurality of liners such as a BN inner most liner that may comprise a W, Ta, or Re inlay and may be segmented, and one or more concentric outer quartz liners. The baseplate liner may comprise an inner BN plate and at least one other ceramic plate, each with perforations for penetrations. In an embodiment, penetrations may be sealed with a cement such as a ceramic one such as Resbond or a refractory powder that is resistant to molten metal alloy formation such as W powder in the case of molten gallium or tin. An exemplary baseplate liner is a moldable ceramic insulation disc. In an embodiment, the liner may comprise a refractory or ceramic inlay such as a W or Ta inlay. The ceramic inlay may comprise ceramic tiles such as ones comprising small-height semicircular rings stacked into a cylinder. Exemplary ceramics are zirconia, yttria-stabilized-zirconia, hafnia, alumina, and magnesia. The height of the rings may be in the range of about 1 mm to 5 cm. In another embodiment, the inlay may comprise tiles or beads that may be held in place by a high temperature binding material or cement. Alternatively, the tiles or beads may be embedded in a refractory matrix such as carbon, a refractory metal such as W, Ta, or Mo, or a refractory diboride or carbide such as those of Ta, W, Re, Ti, Zr, or Hf such as ZrB₂, TaC, HfC, and WC or another of the disclosure.

In an exemplary embodiment, the liner may comprise segmented rings with quartz at the molten metal surface level, and the balance of the rings may comprise SiC. The quartz segment may comprise beveled quartz plates that form a ring such as a hexagonal or octagonal ring. In another exemplary embodiment, the reaction cell chamber wall may be painted, carbon coated, or ceramic coated, and the liner may comprise carbon with an inner refractory metal liner such as one comprising Nb, Mo, Ta, or W. A further inner liner may comprise a refractory metal ring such as a hexagonal or octagonal ring at the gallium or tin surface such as one comprising beveled refractory metal plates such as one comprising Nb, Mo, Ta, or W plates.

Thermal insulation may comprise a vacuum gap. The vacuum gap may comprise a space between a liner with smaller diameter than that of the reservoir and reaction cell chamber wall wherein reaction cell chamber pressure is low such as about below 50 Torr. To prevent plasma from contacting the reaction cell chamber wall, the reaction cell chamber may comprise a cap or lid such as a ceramic plug such as a BN plug. The hydrino reaction mixture gas lines may supply the reaction cell chamber, and a vacuum line may provide gas evacuation. The vacuum gap may be evacuated by a separate vacuum line connection or by a connection to the vacuum provided by the reaction cell chamber or its vacuum line. To prevent hot gallium or tin from contacting the reservoir wall the reservoir wall may comprise a liner such as at least one quartz liner that has a height from the base of the reservoir to just above the gallium or tin level wherein the liner displaces the molten gallium or tin to provide thermal insulation from contact of hot gallium or tin with the wall.

The cell wall may be thin to enhance the permeation of molecular hydrino product to avoid product inhibition. The liner may comprise a porous material such as BN, porous quartz, porous SiC, or a gas gap to facilitate the diffusion and permeation of the hydrino product from the reaction cell chamber. The reaction cell chamber wall may comprise a material that is highly permeable to molecular hydrino such as Cr—Mo SS such as 4130 alloy SS.

In an embodiment, at least one SunCell® component such as the walls the reaction cell chamber 5b31, the walls of the reservoir 5c, the walls of the EM pump tube 5k6, the baseplate 5kk1, and the top flange 409a may be coated with a coating such one of the disclosure such as a ceramic that at least one of resists alloy formation with the molten metal and resists corrosion with at least one of O₂ and H₂O. The thermal expansion coefficient of the coating and the coated component may be about matched such as in at least one range of a factor of about 0.1 to 10, 0.1 to 5, and 0.1 to 2. In the case of a ceramic coating that has a low thermal expansion coefficient, a coated metal such as Kovar or Invar having a similar thermal expansion coefficient is selected for the coated component.

In an embodiment, the EM pump tube 5k6 and EM bus bars 5k2 that are attached to the EM pump tube 5k6 have about a match in thermal coefficient of expansion. In an exemplary embodiment, the EM pump tube sections connected to the EM pump bus bars 5k2 comprise Invar or Kovar to match the low coefficient of thermal expansion of W bus bars.

In an embodiment, at least one component comprising a liner may be cooled by a cooling system. The cooling system may maintain a component temperature below that at which an alloy forms with the molten metal such as gallium or tin. The cooling system may comprise a water bath into which the component is immersed. The cooling system may further comprise water jets that impinge on the cooled component. In an exemplary embodiment, the component comprises the EM pump tube, and the water bath immersion and water jet cooling of the EM pump tube can be implemented with minimum cooling of the hot gallium or tin pumped by the EM pump by using an EM pump tube liner having a very low thermal conductivity such as one comprising quartz.

### Formation of Nascent Water and Atomic Hydrogen

In an embodiment, the reaction cell chamber further comprises a dissociator chamber that houses a hydrogen dissociator such as Pt, Pd, Ir, Re, or other dissociator metal on a support such as carbon, or ceramic beads such as Al₂O₃, silica, or zeolite beads, Raney Ni, or Ni, niobium, titanium, or other dissociator metal of the disclosure in a form to provide a high surface area such as powder, mat, weave, or cloth. In an embodiment the SunCell® comprises a recombiner to catalytically react supplied H₂ and O₂ to HOH and H that flow into the reaction cell chamber 5b31. The recombiner may further comprise a controller comprising at least one of a temperature sensor, a heater, and a cooling system such a as heat exchanger that senses the recombiner temperature and controls at least one of the cooling system such as a water jet and the heater to maintain the recombiner catalyst in a desire operating temperature range such as one in the range of about 60° C. to 600° C. The upper temperature is limited by that at which the recombiner catalyst sinters and loses effective catalyst surface area.

The H₂O yield of the H₂/O₂ recombination reaction may not be 100%, especially under flow conditions. Removing the oxygen to prevent an oxide coat from forming may permit the reduction of the ignition power by a range of about 10% to 100%. The recombiner may comprise a means to remove about all of the oxygen that flows into the cell by converting it to H₂O. The recombiner may further serve as a dissociator to form H atoms and HOH catalyst that flow through a gas line to the reaction cell chamber. A longer flow path of the gas in the recombiner may increase the dwell time in the recombiner and allow the O₂ to H₂ reaction to go more to completion. However, the longer path in the recombiner and the gas line may allow more undesirable H recombination and HOH dimerization. So, a balance of the competing effects of flow path length is optimized in the recombiner, and the length of the gas line from the recombiner/dissociator to the reaction cell chamber may be minimized.

In an embodiment, the supply of a source of oxygen such as O₂, air, or H₂O to the reaction cell chamber results in the increase in the oxygen inventory of the reaction cell chamber. In the case that gallium or tin is the molten metal, the oxygen inventory may comprise at least one of gallium or tin oxide, H₂O, and O₂. The oxygen inventory may be essential for the formation of the HOH catalyst for the hydrino reaction. However, an oxide coat on the molten metal such as gallium or tin oxide on liquid gallium or tin may result in the suppression of the hydrino reaction and the increase in the ignition voltage at a fixed ignition current. In an embodiment, the oxygen inventory is optimized. The optimization may be achieved by flowing oxygen intermittently with a controller. Alternatively, oxygen may be flowed at a high rate until an optimal inventory is accumulated, and then the flow rate may be decreased to maintain the desired optimal inventory at a lower flow rate that balances the rate that the oxygen inventory is depleted by removal from the reaction cell chamber and reservoir by means such as evacuation by a vacuum pump. In an exemplary embodiment, the gas flow rates are about 2500 sccm H₂/250 sccm O₂ for about 1 minute to load an about 100-cc reaction cell chamber and an about 1 kg gallium or tin reservoir inventory, then and about 2500 sccm H₂/5 sccm O₂ thereafter. An indication that an oxide layer is not forming or is being consumed is a decrease in ignition voltage with time at constant ignition current wherein the voltage may be monitored by a voltage sensor, and the oxygen flow rate may be controlled by a controller.

In an embodiment, the SunCell® comprises an ignition power parameter sensor and an oxygen source flow rate controller that senses at least one of the ignition voltage at a fixed current, the ignition current at a fixed voltage, and the ignition power and changes the oxygen source flow rate in response to the power parameter. The oxygen source may comprise at least one of oxygen and water. In an exemplary embodiment, the oxygen source controller may control the oxygen flow into the reaction cell chamber based on the ignition voltage wherein the oxygen inventory in the reaction cell chamber is increased in response to the voltage sensed by the ignition power parameter sensor below a threshold voltage and decreased in response to the voltage sensed above a threshold voltage.

To increase the recombiner yield, the recombiner dwell time, surface area, and catalytic activity may be increased. A catalyst with higher kinetics may be selected. The operating temperature may be increased.

In another embodiment, the recombiner comprise as hot filament such as a noble metal-black coated Pt filament such as Pt-black-Pt filament. The filament may be maintained at a sufficiently elevated temperature to maintain the desired rate of recombination by resistive heating maintained by a power supply, temperature sensor, and controller.

In an embodiment, the H₂/O₂ recombiner comprises a plasma source such as a glow discharge, microwave, radio frequency (RF), inductively or capacitively-coupled RF plasma. The discharge cell to sever as the recombiner may be high vacuum capable. An exemplary discharge cell 900 shown in FIGS. 9A-C and 8C-8L comprises a stainless-steel vessel or glow discharge plasma chamber 901 with a Conflat flange 902 on the top with a mating top plate 903 sealed with a copper, silver-plated copper, or tantalum gasket or O-ring. The flanges may be coated with a coating such as Flameproof paint, alumina, CrC, TiN, Ta, or another of the disclosure that prevents alloy formation with the molten metal. The gasket or O-ring such as Ta ones may be alloy-formation resistant. In an embodiment, the flanges may be replaced by flat metal plates (no bolt holes) such as annuluses around the perimeter of each joined component. The plates may be welded together on the outer edges to form a seam. The seam may be cut or ground off to separate the two plates. The top plate may have a high voltage feedthrough 904 to an inner tungsten rod electrode 905. The cell body may be grounded to serve as the counter electrode. The top flange may further comprise at least one gas inlet 906 for hydrino reaction mixture gases such as at least one of H₂, O₂, air, H₂O, and a noble gas (e.g., Ar), or mixtures thereof (e.g., H₂/O₂, H₂/air, H₂/H₂O, H₂/noble gas, O₂/noble gas, H₂/O₂/H₂O, H₂/O₂/noble gas, H₂/H₂O/noble gas, O₂/H₂O/noble gas, H₂/O₂/H₂O/noble gas, H₂/O₂/air, H₂/air/H₂O, H₂/air/noble gas, H₂/O₂/air/H₂O, H₂/O₂/air/noble gas, H₂/O₂/air/H₂O/noble gas). To increase the desired yield of HOH catalyst production while adding argon to the hydrino reaction mixture, hydrogen gas and oxygen gas may be flowed through the discharge cell, and argon may be flowed through a separate gas inlet into the reaction cell chamber 5b31. The bottom plate 907 of the stainless-steel vessel may comprise a gas outlet to the reaction cell chamber. The glow discharge cell further comprises a power source such as a DC power source with a voltage in the range of about 10 V to 5 kV and a current in the range of about 0.01 A to 100 A. The glow discharge breakdown and maintenance voltages for a desired gas pressure, electrode separation, and discharge current may be selected according to Paschen's law. The glow discharge cell may further comprise a means such as a spark plug ignition system to cause gas breakdown to start the discharge plasma wherein the glow discharge plasma power operates at a lower maintenance voltage which sustains the glow discharge. The breakdown voltage may be in the range of about 50 V to 5 kV, and the maintenance voltage may be in the range of about 10 V to 1 kV. The glow discharge cell may be electrically isolated from the other SunCell® components such as the reaction cell chamber 5b31 and the reservoir 5c to prevent shorting of the ignition power. Pressure waves may cause glow discharge instabilities that create variations in the reactants flowing into the reaction cell chamber 5b31 and may damage the glow discharge power supply. To prevent back pressure waves due to the hydrino reaction from propagating into the glow discharge plasma chamber, the reaction cell chamber 5b31 may comprise a baffle such as one threaded into a BN sleeve on the electrode bus bar where the gas line from the glow discharge cell enters the reaction cell chamber. The glow discharge power supply may comprise at least one surge protector element such as a capacitor. The length of the discharge cell and the reaction cell chamber height may be minimized to reduce the distance from the glow discharge plasma to the positive surface of the gallium or tin, to increase the concentration of atomic hydrogen and HOH catalyst by reducing the distance for possible recombination.

The glow discharge cell may be replaced by other sources of atomic hydrogen such as one that works by thermally dissociating hydrogen in an electron bombardment heated fine tungsten capillary (thermal hydrogen cracker) wherein by bouncing along the hot walls, the molecular hydrogen is cracked to atomic hydrogen. The atomic hydrogen source may be one know in the art such as the exemplary commercial atomic hydrogen source of H-flux Atomic Hydrogen Source by Tec Tra (https://tectra.de/sample-preparation/atomic-hydrogen-source/#:˜:text=H%2Dflux%20Atomic%20Hydrogen%20Source,is%20cracked%20to%20atomic%20hydrogen).

In an embodiment, the area of the connection between the source of at least one of atomic H and HOH catalyst such as a plasma cell and reaction cell chamber 5b31 may be minimized to avoid atomic H wall recombination and HOH dimerization. The plasma cell such as the glow discharge cell may connect directly to an electrical isolator such as a ceramic one such as one from Solid Seal Technologies, Inc. that connects directly to the top flange 409a of the reaction cell chamber. The electrical isolator may be connected to the discharge cell and the flange by welds, flange joints, or other fasteners known in the art. The inner diameter of the electrical isolator may be large such as about the diameter of the discharge cell chamber such as in the range of about 0.05 cm to 15 cm. In another embodiment wherein the SunCell® and the body of the discharge cell are maintained at the same voltage such as at ground level, the discharge cell may be directly connected to the reaction cell chamber such as at top flange 409a of the reaction cell chamber. The connection may comprise a weld, flange joint, or other fastener known in the art. The inner diameter of the connection may be large such as about the diameter of the discharge cell chamber such as in the range of about 0.05 cm to 15 cm.

The output power level can be controlled by the hydrogen and oxygen flow rate, the discharge current, the ignition current and voltage, and the EM pump current, and the molten metal temperature. The SunCell® may comprise corresponding sensors and controllers for each of these and other parameters to control the output power. The molten metal such as gallium or tin may be maintained in the temperature range of about 200° C. to 2200° C. In an exemplary embodiment comprising an 8 inch diameter 4130 Cr—Mo SS cell with a Mo liner along the reaction cell chamber wall, a glow discharge hydrogen dissociator and recombiner connected directly the flange 409a of the reaction cell chamber by a 0.75 inch OD set of Conflat flanges, the glow discharge voltage was 260 V; the glow discharge current was 2 A; the hydrogen flow rate was 2000 sccm; the oxygen flow rate was 1 sccm; the operating pressure was 5.9 Torr; the gallium or tin temperature was maintained at 400° C. with water bath cooling; the ignition current and voltage were 1300 A and 26-27V; the EM pump rate was 100 g/s, and the output power was over 300 kW for an input ignition power of 29 kW corresponding to a gain of at least 10 times.

In an embodiment, the recombiner such as a glow discharge cell recombiner may be cooled by a coolant such as water. In an exemplary embodiment, the electrical feedthrough of the recombiner may be water cooled. The recombiner may be submerged in an agitated water bath for cooling. The recombiner may comprise a safety kill switch that senses a stray voltage and terminates the plasma power supply when the voltage goes above a threshold such as one in the range of about 0V to 20V (e.g., 0.1V to 20V).

In an embodiment, the SunCell® comprises as a driven plasma cell such as a discharge cell such as a glow discharge, microwave discharge, or inductively or capacitively coupled discharge cell wherein the hydrino reaction mixture comprises the hydrino reaction mixture of the disclosure such as hydrogen in excess of oxygen relative to a stoichiometric mixture of H₂ (66.6%) to O₂ (33.3%) mole percent. The driven plasma cell may comprise a vessel capable of vacuum, a reaction mixture supply, a vacuum pump, a pressure gauge, a flow meter, a plasma generator, a plasma power supply, and a controller. Plasma sources to maintain the hydrino reaction are given in Mills Prior Applications which are incorporated by reference. The plasma source may maintain a plasma in a hydrino reaction mixture comprising a mixture of hydrogen and oxygen having a deficit of oxygen compared to a stoichiometric mixture of H₂ (66.6%) to O₂ (33.3%) mole percent. The oxygen deficit of the hydrogen-oxygen mixture may be in the range of about 5% to 99% from that of a stoichiometric mixture. The mixture may comprise mole percentages of about 99.66% to 68.33% H₂ and about 0.333% to 31.66% O₂. These mixtures may produce a reaction mixture upon passage through the plasma cell such as the glow discharge sufficient to induce the catalytic reaction as described herein upon interaction with a biased molten metal in the reaction cell chamber.

In an embodiment, the reaction mixture gases formed at the outflow of the plasma cell may be forced into the reaction cell by velocity gas stream means such as an impeller or by a gas jet to increase the reactant flow rate through the cell while maintaining the reaction cell pressure in a desired range. High velocity gas may pass through the recombiner plasma source before being injected into the reaction cell chamber.

In an embodiment, the plasma recombiner/dissociator maintains a high concentration of at least one of atomic H and HOH catalyst in the reaction cell chamber by direct injection of the atomic H and HOH catalyst into the reaction cell chamber from the external plasma recombiner/dissociator. The corresponding reaction conditions may be similar to those produced by very high temperature in the reaction cell chamber that produce very high kinetic and power effects. An exemplary high temperature range is about 2000° C.-3400° C. In an embodiment, the SunCell® comprises a plurality of recombiner/dissociators such as plasma discharge cell recombiner/dissociators that inject at least one of atomic H and HOH catalyst wherein the injection into the reaction cell chamber may be by flow.

In another embodiment, the hydrogen source such as a H₂ tank may be connected to a manifold that may be connected to at least two mass flow controllers (MFC). The first MFC may supply H₂ gas to a second manifold that accepts the H₂ line and a noble gas line from a noble gas source such as an argon tank. The second manifold may output to a line connected to a dissociator such as a catalyst such as Pt/Al₂O₃, Pt/C, or another of the disclosure in a housing wherein the output of the dissociator may be a line to the reaction cell chamber. The second MFC may supply H₂ gas to a third manifold that accepts the H₂ line and an oxygen line from an oxygen source such as an O₂ tank. The third manifold may output to a line to a recombiner such as a catalyst such as Pt/Al₂O₃, Pt/C, or another of the disclosure in a housing wherein the output of the recombiner may be a line to the reaction cell chamber.

Alternatively, the second MFC may be connected to the second manifold supplied by the first MFC. In another embodiment, the first MFC may flow the hydrogen directly to the recombiner or to the recombiner and the second MFC. Argon may be supplied by a third MFC that receives gas from a supply such as an argon tank and outputs the argon directly into the reaction cell chamber.

In another embodiment, H₂ may flow from its supply such as a H₂ tank to a first MFC that outputs to a first manifold. O₂ may flow from its supply such as an O₂ tank to a second MFC that outputs to the first manifold. The first manifold may output to recombiner/dissociator that outputs to a second manifold. A noble gas such as argon may flow from its supply such as an argon tank to the second manifold that outputs to the reaction cell chamber. Other flow schemes are within the scope of the disclosure wherein the flows deliver the reactant gases in the possible ordered permutations by gas supplies, MFCs, manifolds, and connections known in the art.

In an embodiment, the SunCell® comprises at least one of a source of hydrogen such as water or hydrogen gas such as a hydrogen tank, a means to control the flow from the source such as a hydrogen mass flow controller, a pressure regulator, a line such as a hydrogen gas line from the hydrogen source to at least one of the reservoir or reaction cell chamber below the molten metal level in the chamber, and a controller. A source of hydrogen or hydrogen gas may be introduced directly into the molten metal wherein the concentration or pressure may be greater than that achieved by introduction outside of the metal. The higher concentration or pressure may increase the solubility of hydrogen in the molten metal. The hydrogen may dissolve as atomic hydrogen wherein the molten metal such as gallium or tin or Galinstan may serve as a dissociator. In another embodiment, the hydrogen gas line may comprise a hydrogen dissociator such as a noble metal on a support such as Pt on Al₂O₃support. The atomic hydrogen may be released from the surface of the molten metal in the reaction cell chamber to support the hydrino reaction. The gas line may have an inlet from the hydrogen source that is at a higher elevation than the outlet into the molten metal to prevent the molten metal from back flowing into the mass flow controller. The hydrogen gas line may extend into the molten metal and may further comprise a hydrogen diffuser at the end to distribute the hydrogen gas. The line such as the hydrogen gas line may comprise a U section or trap. The line may enter the reaction cell chamber above the molten metal and comprise a section that bends below the molten metal surface. At least one of the hydrogen source such as a hydrogen tank, the regulator, and the mass flow controller may provide sufficient pressure of the source of hydrogen or hydrogen to overcome the head pressure of the molten metal at the outlet of the line such as a hydrogen gas line to permit the desired source of hydrogen or hydrogen gas flow.

In an embodiment, the SunCell® comprises a source of hydrogen such as a tank, a valve, a regulator, a pressure gauge, a vacuum pump, and a controller, and may further comprise at least one means to form atomic hydrogen from the source of hydrogen such as at least one of a hydrogen dissociator such as one of the disclosure such as Re/C or Pt/C and a source of plasma such as the hydrino reaction plasma, a high voltage power source that may be applied to the SunCell® electrodes to maintain a glow discharge plasma, an RF plasma source, a microwave plasma source, or another plasma source of the disclosure to maintain a hydrogen plasma in the reaction cell chamber. The source of hydrogen may supply pressurized hydrogen. The source of pressurized hydrogen may at least one of reversibly and intermittently pressurize the reaction cell chamber with hydrogen. The pressurized hydrogen may dissolve into the molten metal such as gallium or tin. The means to form atomic hydrogen may increase the solubility of hydrogen in the molten metal. The reaction cell chamber hydrogen pressure may be in at least one range of about 0.01 atm to 1000 atm, 0.1 atm to 500 atm, and 0.1 atm to 100 atm. The hydrogen may be removed by evacuation after a dwell time that allows for absorption. The dwell time may be in at least one range of about 0.1 s to 60 minutes, 1 s to 30 minutes, and 1 s to 1 minute. The SunCell® may comprise a plurality of reaction cell chambers and a controller that may be at least one of intermittently supplied with atomic hydrogen and pressured and depressurized with hydrogen in a coordinated manner wherein each reaction cell chamber may be absorbing hydrogen while another is being pressurized or supplied atomic hydrogen, evacuated, or in operation maintaining a hydrino reaction. Exemplary systems and conditions for causing hydrogen to absorb into molten gallium or tin are given by Carreon [M. L. Carreon, “Synergistic interactions of H₂ and N₂ with molten gallium or tin in the presence of plasma”, Journal of Vacuum Science & Technology A, Vol. 36, Issue 2, (2018), 021303 pp. 1-8; https://doi.org/10.1116/1.5004540] which is herein incorporated by reference. In an exemplary embodiment, the SunCell® is operated at high hydrogen pressure such as 0.5 to 10 atm wherein the plasma displays pulsed behavior with much lower input power than with continuous plasma and ignition current. Then, the pressure is maintained at about 1 Torr to 5 Torr with 1500 sccm H₂+15 sccm O₂ flow through 1 g of Pt/Al₂O₃ at greater than 90° C. and then into the reaction cell chamber wherein high output power develops with additional H₂ outgassing from the gallium or tin with increasing gallium or tin temperature. The corresponding H₂ loading (gallium or tin absorption) and unloading (H₂ off gassing from gallium or tin) or may be repeated.

In an embodiment, the source of hydrogen or hydrogen gas may be injected directly into molten metal in a direction that propels the molten metal to the opposing electrode of a pair of electrodes wherein the molten metal bath serves as an electrode. The gas line may serve as an injector wherein the source of hydrogen or hydrogen injection such as H₂ gas injection may at least partially serve as a molten metal injector. An EM pump injector may serve as an additional molten metal injector of the ignition system comprising at least two electrodes and a source of electrical power.

In an embodiment, the SunCell® comprises a molecular hydrogen dissociator. The dissociator may be housed in the reaction cell chamber or in a separate chamber in gaseous communication with the reaction cell chamber. The separate housing may prevent the dissociator from failing due to being exposed to the molten metal such as gallium or tin. The dissociator may comprise a dissociating material such as supported Pt such as Pt on alumina beads or another of the disclosure or known in the art. Alternatively, the dissociator may comprise a hot filament or plasma discharge source such as a glow discharge, microwave plasma, plasma torch, inductively or capacitively coupled RF discharge, dielectric barrier discharge, piezoelectric direct discharge, acoustic discharge, or another discharge cell of the disclosure or known in the art. The hot filament may be heated resistively by a power source that flows current through electrically isolated feedthrough the penetrate the reaction cell chamber wall and then through the filament.

In another embodiment, the ignition current may be increased to increase at least one of the hydrogen dissociation rate and the plasma ion-electron recombination rate. In an embodiment, the ignition waveform may comprise a DC offset such as one in the voltage range of about 1 V to 100 V with a superimposed AC voltage in the range of about 1 V to 100 V. The DC voltage may increase the AC voltage sufficiently to form a plasma in the hydrino reaction mixture, and the AC component may comprise a high current in the presence of plasma such as in a range of about 100 A to 100,000 A. The DC current with the AC modulation may cause the ignition current to be pulsed at the corresponding AC frequency such as one in at least one range of about 1 Hz to 1 MHz, 1 Hz to 1 kHz, and 1 Hz to 100 Hz. In an embodiment, the EM pumping is increased to decrease the resistance and increase the current and the stability of the ignition power.

In an embodiment, a high-pressure glow discharge may be maintained by means of a microhollow cathode discharge. The microhollow cathode discharge may be sustained between two closely spaced electrodes with openings of approximately 100 micron diameter. Exemplary direct current discharges may be maintained up to about atmospheric pressure. In an embodiment, large volume plasmas at high gas pressure may be maintained through superposition of individual glow discharges operating in parallel. The plasma current may be at least one of DC or AC.

In an embodiment, the atomic hydrogen concentration is increased by supplying a source of hydrogen that is easier to dissociate than H₂O or H₂. Exemplary sources are those having at least one of lower enthalpies and lower free energies of formation per H atom such as methane, a hydrocarbon, methanol, an alcohol, another organic molecule comprising H.

In an embodiment, the dissociator may comprise the electrode 8 such as the one shown in FIG. 1. The electrode 8 may comprise a dissociator capable of operating at high temperature such as one up to 3200° C. and may further comprise a material that is resistant to alloy formation with the molten metal such as gallium or tin. Exemplary electrodes comprise at least one of W and Ta. In an embodiment, the bus bar 10 may comprise attached dissociators such as vane dissociators such as planar plates. The plates may be attached by fasting the face of an edge along the axis of the bus bar 10. The vanes may comprise a paddle wheel pattern. The vanes may be heated by conductive heat transfer from the bus bar 10 which may be heated by at least one of resistively by the ignition current and heated by the hydrino reaction. The dissociators such as vanes may comprise a refractory metal such as Hf, Ta, W, Nb, or Ti.

### Molten Metal

In an alternative embodiment, the SunCell® comprises a coolant flow heat exchanger comprising the pumping system whereby the reaction cell chamber is cooled by a flowing coolant wherein the flow rate may be varied to control the reaction cell chamber to operate within a desired temperature range. The heat exchanger may comprise plates with channels such as microchannel plates. In an embodiment, the SunCell® comprises a cell comprising the reaction cell chamber 531, reservoir 5c, pedestal 5c1, and all components in contact with the hydrino reaction plasma wherein one or more components may comprise a cell zone. In an embodiment, the heat exchanger such as one comprising a flowing coolant may comprise a plurality of heat exchangers organized in cell zones to maintain the corresponding cell zone at an independent desired temperature.

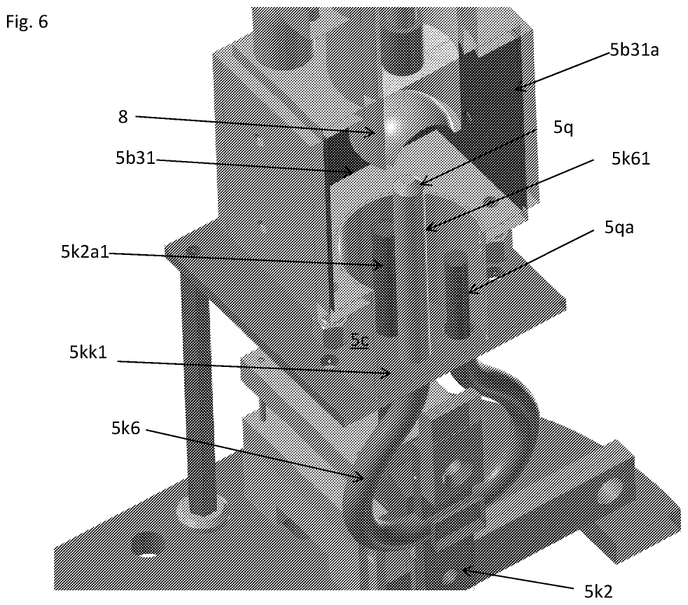

In an embodiment such as one shown in FIG. 6, the SunCell® comprises thermal insulation or a liner 5b31a fastened on the inside of the reaction cell chamber 5b31 at the molten gallium or tin level to prevent the hot gallium or tin from directly contacting the chamber wall. The thermal insulation may comprise at least one of a thermal insulator, an electrical insulator, and a material that is resistant to wetting by the molten metal such as gallium or tin. The insulation may at least one of allow the surface temperature of the gallium or tin to increase and reduce the formation of localized hot spots on the wall of the reaction cell chamber that may melt the wall. In addition, a hydrogen dissociator such as one of the disclosure may be clad on the surface of the liner. In another embodiment, at least one of the wall thickness is increased and heat diffusers such a copper blocks are clad on the external surface of the wall to spread the thermal power within the wall to prevent localized wall melting. The thermal insulation may comprise a ceramic such as BN, SiC, carbon, Mullite, quartz, fused silica, alumina, zirconia, hafnia, others of the disclosure, and ones known to those skilled in the art. The thickness of the insulation may be selected to achieve a desired area of the molten metal and gallium or tin oxide surface coating wherein a smaller area may increase temperature by concentration of the hydrino reaction plasma. Since a smaller area may reduce the electron-ion recombination rate, the area may be optimized to favor elimination of the gallium or tin oxide film while optimizing the hydrino reaction power. In an exemplary embodiment comprising a rectangular reaction cell chamber, rectangular BN blocks are bolted onto to threaded studs that are welded to the inside walls of the reaction cell chamber at the level of the surface of the molten gallium or tin. The BN blocks form a continuous raised surface at this position on the inside of the reaction cell chamber.

In an embodiment (FIG. 1 and FIG. 6), the SunCell® comprises a bus bar 5k2ka1 through a baseplate of the EM pump at the bottom of the reservoir 5c. The bus bar may be connected to the ignition current power supply. The bus bar may extend above the molten metal level. The bus bar may serve as the positive electrode in addition to the molten metal such as gallium or tin. The molten metal may heat sink the bus bar to cool it. The bus bar may comprise a refractory metal that does not form an alloy with the molten metal such as W, Ta, or Re in the case that the molten metal comprises gallium or tin. The bus bar such as a W rod protruding from the gallium or tin surface may concentrate the plasma at the gallium or tin surface. The injector nozzle such as one comprising W may be submerged in the molten metal in the reservoir to protect it from thermal damage.

In an embodiment (FIG. 1), such as one wherein the molten metal serves as an electrode, the cross-sectional area that serves as the molten electrode may be minimized to increase the current density. The molten metal electrode may comprise the injector electrode. The injection nozzle may be submerged. The molten metal electrode may be positive polarity. The area of the molten metal electrode may be about the area of the counter electrode. The area of the molten metal surface may be minimized to serve as an electrode with high current density. The area may be in at least one range of about 1 cm² to 100 cm², 1 cm² to 50 cm², and 1 cm² to 20 cm². At least one of the reaction cell chamber and reservoir may be tapered to a smaller cross section area at the molten metal level. At least a portion of at least one of the reaction cell chamber and the reservoir may comprise a refractory material such as tungsten, tantalum, or a ceramic such as BN at the level of the molten metal. In an exemplary embodiment, the area of at least one of the reaction cell chamber and reservoir at the molten metal level may be minimized to serve as the positive electrode with high current density. In an exemplary embodiment, the reaction cell chamber may be cylindrical and may further comprise a reducer, conical section, or transition to the reservoir wherein the molten metal such as gallium or tin fills the reservoir to a level such that the gallium or tin cross sectional area at the corresponding molten metal surface is small to concentrate the current and increase the current density. In an exemplary embodiment (FIG. 7A), at least one of the reaction cell chamber and the reservoir may comprise an hourglass shape or a hyperboloid of one sheet wherein the molten metal level is at about the level of the smallest cross-sectional area. This area may comprise a refectory material or comprise a liner 5b31a of a refractory material such as carbon, a refractory metal such as W, Ta, or Re, or a ceramic such as BN, SiC, or quartz. In exemplary embodiment, the reaction cell chamber may comprise stainless steel such as 347 SS such as 4130 alloy SS and liner may comprise W or BN. In an embodiment, the reaction cell chamber comprises at least one plasma confinement structure such as an annular ring centered on the axis between the electrodes to confine plasma inside of the ring. The rings may be at least one of shorted with the molten metal and walls of the reaction cell chamber and electrically isolated by at least one electrically insulating support.

### Reaction Cell or Chamber Configurations

In an embodiment, the reaction cell chamber may comprise a tube reactor (FIGS. 7B-C) such as one comprising a stainless-steel tube vessel 5b3 that is vacuum or high-pressure capable. The pressure and reaction mixture inside if the vessel may be controlled by flowing gases through gas inlet 710 and evacuating gases through vacuum line 711. The reaction cell chamber 5b31 may comprise a liner 5b31a such as a refractory liner such as a ceramic liner such as one comprising BN, quartz, pyrolytic carbon, or SiC that may electrically isolate the reaction cell chamber 5b31 from the vessel 5b3 wall and may further prevent gallium or tin alloy formation. Alternatively, a refractory metal liner such as W, Ta, or Re may reduce gallium or tin alloy formation. The EM bus bars 5k2 may comprise a material, coating, or cladding that is electrically conductive and resists formation of a gallium or tin alloy. Exemplary materials are Ta, Re, Mo, W, and Ir. Each bus bar 5k2 may be fastened to the EM pump tube by a weld or fastener such as a Swagelok that may comprise a coating comprising a ceramic or a gallium or tin alloy-resistant metal such as at least one of Ta, Re, Mo, W, and Ir.

In an embodiment, the liner (e.g., the liner of the EM pump, the reaction cell liner) comprises a hybrid of a plurality of materials such as a plurality of ceramics or a ceramic and a refractory metal. The ceramic may be one of the disclosure such as BN, quartz, alumina, zirconia, hafnia, or a diboride or carbide such as those of Ta, W, Re, Ti, Zr, or Hf such as ZrB₂, TaC, HfC, and WC. The refractory metal may be one of the disclosure such as W, Ta, Re, Ir, or Mo. In an exemplary embodiment of a tubular cell (FIGS. 7B-C), the liner comprises a BN tube with a recessed band at the region where the plasma is most intense wherein a W tube section with a slightly larger diameter than the diameter of the BN tube liner is held in the recessed band of the BN liner. In an exemplary embodiment, the liner of a refractory metal tube-shaped reaction cell chamber 5b31 such as one comprising niobium or vanadium and coated with a ceramic such as zirconia-titania-yttria (ZTY) to prevent oxidation comprises an inner BN tube with at least one refractory metal or ceramic inlay such as a W inlay at a desired position such as at the position of where the plasma due to the hydrino reaction is most intense.

In an embodiment, the ceramic liner, coating, or cladding of at least one SunCell® component such as the reservoir, reaction cell chamber, ignition feedthrough, and EM pump tube may comprise at least one of a metal oxide, alumina, zirconia, yttria stabilized zirconia, magnesia, hafnia, silicon carbide, zirconium carbide, zirconium diboride, silicon nitride (Si₃N₄), a glass ceramic such as Li₂O×Al₂O₃×nSiO₂ system (LAS system), the MgO×Al₂O₃×nSiO₂ system (MAS system), the ZnO×Al₂O₃×nSiO₂ system (ZAS system). At least one SunCell® component such as the reservoir, reaction cell chamber, EM pump tube, liner, cladding, or coating may comprise a refractory material such as at least one of graphite (sublimation point=3642° C.), a refractory metal such as tungsten (M.P.=3422° C.) or tantalum (M.P.=3020° C.), niobium, niobium alloy, vanadium, a ceramic, a ultra-high-temperature ceramic, and a ceramic matrix composite such as at least one of borides, carbides, nitrides, and oxides such as those of early transition metals such as hafnium boride (HfB₂), zirconium diboride (ZrB₂), hafnium nitride (HfN), zirconium nitride (ZrN), titanium carbide (TiC), titanium nitride (TiN), thorium dioxide (ThO₂), niobium boride (NbB₂), and tantalum carbide (TaC) and their associated composites. Exemplary ceramics having a desired high melting point are magnesium oxide (MgO) (M.P.=2852° C.), zirconium oxide (ZrO) (M.P.=2715° C.), boron nitride (BN) (M.P.=2973° C.), zirconium dioxide (ZrO₂) (M.P.=2715° C.), hafnium boride (HfB₂) (M.P.=3380° C.), hafnium carbide (HfC) (M.P.=3900° C.), Ta₄HfC₅ (M.P.=4000° C.), Ta₄HfC₅TaX₄HfCX₅(4215° C.), hafnium nitride (HfN) (M.P.=3385° C.), zirconium diboride (ZrB₂) (M.P.=3246° C.), zirconium carbide (ZrC) (M.P.=3400° C.), zirconium nitride (ZrN) (M.P.=2950° C.), titanium boride (TiB₂) (M.P.=3225° C.), titanium carbide (TiC) (M.P.=3100° C.), titanium nitride (TiN) (M.P.=2950° C.), silicon carbide (SiC) (M.P.=2820° C.), tantalum boride (TaB₂) (M.P.=3040° C.), tantalum carbide (TaC) (M.P.=3800° C.), tantalum nitride (TaN) (M.P.=2700° C.), niobium carbide (NbC) (M.P.=3490° C.), niobium nitride (NbN) (M.P.=2573° C.), vanadium carbide (VC) (M.P.=2810° C.), and vanadium nitride (VN) (M.P.=2050° C.), and a turbine blade material such as one or more from the group of a superalloy, nickel-based superalloy comprising chromium, cobalt, and rhenium, one comprising ceramic matrix composites, U-500, Rene 77, Rene N5, Rene N6, PWA 1484, CMSX-4, CMSX-10, Inconel, IN-738, GTD-111, EPM-102, and PWA 1497. The ceramic such as MgO and ZrO may be resistant to reaction with H₂.

In an embodiment, at least one of each reservoir 5c, the reaction cell chamber 5b31, and the inside of the EM pump tube 5k6 are coated with a ceramic or comprise a ceramic liner such as such as one of BN, quartz, carbon, pyrolytic carbon, silicon carbide, titania, alumina, yttria, hafnia, zirconia, or mixtures such as TiO₂-Yr₂O₃—Al₂O₃, or another of the disclosure. An exemplary carbon coating comprises Aremco Products Graphitic Bond 551RN and an exemplary alumina coating comprises Cotronics Resbond 989. In an embodiment, the liner comprises at least two concentric clam shells such as two BN clam shell liners. The vertical seams of the clam shell (parallel with the reservoir) may be offset or staggered by a relative rotational angle to avoid a direct electrical path from the plasma or molten metal inside of the reaction cell chamber to the reaction cell chamber walls. In an exemplary embodiment, the offset is 90° at the vertical seams wherein the two sections of the clam shell permit the liners to thermally expand without cracking, and the overlapping inner and outer liners block plasma from electrically shorting to the reaction chamber wall due to relative offset of the sets of seams of the concentric clam shell liners. Another exemplary embodiment comprises a clam shell inner liner and a full outer liner such as a BN clam shell inner and a carbon or ceramic tube outer liner. In a further embodiment of the plurality of concentric liners, at least the inner liner comprises vertically stack sections. The horizontal seams of the inner liner may be covered by the outer liner wherein the seams of the inner liner are at different vertical heights from those of the outer, in the case that the outer liner also comprises vertically stacked sections. The resulting offsetting of the seams prevents electrical shorting between at least one of the molten metal and plasma inside of the reaction cell chamber and the reaction cell chamber walls.

The liner comprises an electrical insulator that is capable of high temperature operation and has good thermal shock resistance. Machinability, the ability to provide thermal insulation, and resistance to reactivity with the hydrino reactants and the molten metal are also desirable. Exemplary liner materials are at least one of BN, AlN, Sialon, and Shapal. Silicon nitride (Si₃N₄), silicon carbide, Sialon, Mullite, and Macor may serve a thermal insulation circumferential to the BN inner liner. The liner may comprise a porous type of the liner material such as porous Sialon. Further exemplary liners comprise at least one of SiC-carbon glazed graphite with a Ta or W inlay or inner BN liner to protect it from the hydrino plasma, pyrolytic-coated carbon, SiC—C composite, silicon nitride bonded silicon carbide, yttria stabilized zirconia, SiC with a Ta or W inlay. The liner may be at least one of horizontally and vertically segmented to reduce thermal shock. The lined component such as at least one of the reaction cell chamber 5b31 and reservoir 5c may be ramped in temperature at a rate that avoids liner thermal shock (e.g. the shock produced by the plasma heating too rapidly to produce thermal gradients and differential expansion-based stresses in the liner that leads to failure) of the liner such as a SiC liner. The temperature ramp rate may be in the range of about 1° C./minute to 200° C./s. The segmented sections may interlock by a structural feature on juxtaposed sections such as ship lapping or tongue and groove. In an embodiment, the interlocking of the segments, each comprising an electrical insulator, prevents the plasma from electrically shorting to reaction cell chamber wall 5b31. In another embodiment, the liner may comprise a porous ceramic such a sporous SiC, MgO, fire brick, ZrO₂, HfO₂, and Al₂O₃ to avoid thermal shock. The liner may comprise a plurality or stack of concentric liner materials which in combination provide the desired properties of the liner. The inner most layer may possess chemical inertness at high temperature, high thermal shock resistance and high temperature operational capability. The outer layers may provide electrical and thermal insulation and resistance to reactivity at their operating temperature. In an exemplary embodiment, quartz is operated below about 700° C. to avoid reaction with gallium or tin to gallium or tin oxide. Exemplary concentric liner stacks to test are from inside to outside: BN—SiC—Si₃N₄ wherein quartz, SiC, SiC-coated graphite, or SiC—C composite may replace Si₃N₄ and AlN, Sialon, or Shapal may replace BN or SiC.

In an embodiment, the liner may comprise a housing that is circumferential to the reaction cell chamber 5b31. The walls of the housing may comprise a ceramic or coated or clad metal of the disclosure. The housing may be filled with a thermally stable thermal insulator. In an exemplary embodiment, the housing comprises a double-walled BN tube liner comprising an inner and outer BN tube with a gap between the two tubes and BN end-plate seals at the top and bottom of the gap to form a cavity wherein the cavity may be filled with silica gel or other high-temperature-capable thermal insulator such as an inner quartz tube.

In an embodiment comprising a plurality of concentric liners, at least one outer concentric liner may at least one of (i) serve as a heat sink and (ii) remove heat from the juxtaposed inner liner. The outer liner may comprise a material with a high heat transfer coefficient such as BN or SiC. In an exemplary embodiment, the inner most liner may comprise BN that may be segmented and the corresponding outer liner may comprise SiC that may be segmented and stacked such that the seams of the inner most and outer liner segments are offset or staggered.

In an embodiment, the reaction cell chamber plasma may short to the reaction cell chamber wall rather then connect to the reservoir gallium or tin surface due to gallium or tin boiling that increases the total pressure between the reservoir gallium or tin and the electrode 8 to a point that a plasma cannot form. The ignition voltage may increase as the pressure increases until the resistance is lower through the lower-pressure bulk gas to the reaction chamber wall. In an embodiment, the gallium or tin vaporization can be sensed by a rise in ignition voltage at constant ignition current. A controller can reduce the ignition power, change the gas pressure, decrease the recombiner plasma power, or increase the EM pumping and gallium or tin mixing in response to the voltage rise to decrease the vaporization. In another embodiment, the controller may at least one of apply the ignition current intermittently to suppress the gallium or tin boiling wherein the hydrino reaction plasma may sustain during a portion of the duty cycle with the ignition off and cause argon to flow into the reaction cell chamber from a source to suppress gallium or tin boiling by increasing the pressure while avoiding reduction in H atom concentration. In an embodiment such as that shown in FIGS. 9A-B, the EM pump 5kk comprises a plurality of stages or pumps to increase the molten metal agitation to prevent the formation of a local hot spot that could boil. In an embodiment shown in FIG. 9C, the SunCell® may comprise a plurality of EM pump assemblies 5kk with a plurality of molten metal injectors 5k61, each with a corresponding counter electrode 8. In an embodiment, an EM pump may inject molten gallium or tin to at least one counter electrode 8 through a plurality of injection electrodes 5k61. The plurality of electrode pairs may increase the current while reducing the plasma resistance to increase the hydrino reaction power and gain. Elevated pressure due to gallium or tin boiling from excessive local gallium or tin surface heating may also be reduced. In an embodiment shown in FIGS. 9A-C further comprising a plurality EM pump injectors 5k61 and counter electrodes 8, each EM pump injector electrode and counter electrode may comprise an independently controlled corresponding EM pump power supply and ignition power supply. In an embodiment, the plurality of electrode pairs comprises a refractory metal plate electrode such as a W plate electrode such as a W disc for a cylindrical reaction cell chamber with multiple injectors or multiple injector nozzles per injector pump tube to inject molten metal at a plurality of separated contact positions on the plate wherein the contact positions serve as a corresponding plurality of separated electrodes.

In an embodiment, the feedthrough 10al may comprise the electrode bus bar 10 potted with a potting compound or adhesive capable of binding metals and operating at high temperature such as 300° C. to 2000° C. Exemplary potting adhesives are Cotronics Resbond 907GF, 940HT, 940LE, 940HE, 940SS, 903 HP, 908, or 904 zirconia adhesive, a zirconium oxide coating such as Aremco Ultra-Temp 516 comprising ZrO₂— ZrSiO₄, and Durabond as such as RK454. In an embodiment, the conductor of the feedthrough 10al, the electrode bus bar 10, and the electrode 8 may comprise the same conductor such as tungsten or tantalum. The feedthrough 10a1 may comprise a ceramic isolator brazed to the center conductor and a housing by a high temperature braze such as one of the disclosure wherein the housing is fastened to the flange plate 409a (FIGS. 7A-7C and 7F-7H) by means such as an adhesive or weld. The braze may have a high melting point such a greater than 600° C. Exemplary brazes are Cu(72)-Ag(28) alloy, copper, ABA, gold ABA, PdNiAu alloy (AMS 4785 M.P.=1135° C.) or Paloro or a similar braze such as one at the link: https://www.morganbrazealloys.com/en-gb/products/brazing-alloys/precious-brazing-filler-metals/. In another embodiment, at least one of the conductor of the feedthrough 10al, the electrode bus bar 10, and the electrode 8 may comprise different conductors such as copper and W ones where the connections between these components may comprise at least one of threads, welds, and braze. An exemplary braze between copper and W is silver solder.

The vacuum line 711 may comprise a section containing a material such as metal wool such as SS wool or a ceramic fiber such as one comprising at least one of Alumina, silicate, zirconia, magnesia, and hafnia that has a large surface area; yet is highly diffusible for gases. The condensation material may condense gallium or tin and gallium or tin oxide which may be refluxed back into the reaction cell chamber while allowing gases such as H₂, O₂, argon, and H₂O to be removed by evacuation. The vacuum line 711 may comprise a vertical section to enhance the reflux of gallium or tin and gallium or tin products to the reaction cell chamber 5b31. In an embodiment, a gallium or tin additive such as at least one other metal, element, compound or material may be added to the gallium or tin to prevent boiling. The gallium or tin additive may comprise silver which may further form nanoparticles in the reaction cell chamber 5b31 to reduce the plasma resistance and increase the hydrino power gain.

Experimentally, the hydrino reaction power was increased with a SunCell® comprising a smaller diameter reaction cell chamber due to the increase in the plasma current density, plasma density, and corresponding plasma heating effect. With the innovation of the glow discharge recombiner, plasma concentration is not necessary since the discharge plasma produces the effect of high temperature including preparing an amount of nascent water which may be characterized as water having an internal energy sufficient to prevent the formation of hydrogen bonds. In an embodiment comprising a plasma recombiner such as a glow discharge recombiner, damage to the liner such as a BN liner is avoided by distancing the liner from the hydrino plasma. To achieve the distancing, the liner may comprise a larger diameter compared to the SunCell that generates similar power. In an embodiment, the liner such as a BN liner contacts the reaction cell chamber wall to improve heat transfer to an external water bath to prevent the BN from cracking. In an embodiment, the liner may be segmented and comprise a plurality of materials such as BN in the most intense plasma zone such as the zone between the molten metal surface and the counter electrode 8 and further comprise segments of at least one different ceramic such as SiC in other zones. Moreover, certain liners, such as BN may provide increased passivity of reaction products such as the hydrino to afford more efficient power generation.

At least one segment of the inner most liner such as a BN liner may comprise a desired thickness such as 0.1 mm to 10 cm thick to transfer heat at least radially from the molten metal such as gallium or tin to an external heat sink such as water coolant. In an embodiment, the liner such as a BN liner may make good thermal contact with at least one of the reservoir wall and reaction chamber wall. The diameter of the inner liner may be selected to remove it sufficiently from the center of the reaction cell chamber to reduce plasma damage to a desired extent. The diameter may be in the range of 0.5 cm to 100 cm. The liner may a refractory metal inlay such as a W inlay in the region where the plasma is the most intense. In an exemplary embodiment, an 8 cm diameter BN liner is in contact with circumferential reaction cell chamber and reservoir walls wherein the liner portion that is submerged in molten metal comprises perforations to permit molten metal to contact the reservoir wall to increase heat transfer to the reservoir wall and an external coolant such as a water or air coolant. In another exemplary embodiment, an inner but-end stacked BN segmented liner comprises perforations below the molten metal level and an outer concentric liner comprises a single piece SiC cylinder with notches cut in the bottom to allow radial molten metal flow and heat transfer.

In an embodiment, at least one of the inner or outer liners comprise a refractory metal such as W or Ta, and another comprises an electrical insulator such as a ceramic such as BN wherein the refractory metal liner may dissipate local hot spots by at least one of thermal conduction and heat sinking. In addition to removing thermal stress on the inner most liner that is exposed to the hydrino reaction plasma by transferring heat away from the inner most liner surface, the hydrino permeation rate may be higher in liner and reaction cell chamber materials with high heat transfer coefficients such as Cr—Mo SS versus 304 SS, or BN versus Sialon which may increase the hydrino reaction rate by reducing hydrino product inhibition. An exemplary SunCell® embodiment comprising concentric liner and reaction cell chamber wall components to facilitate hydrino product permeation and heat transfer to an external coolant such as a water bath comprises a BN inner most liner, a corresponding SiC outer liner, and a concentric Cr—Mo SS reaction cell chamber wall with good thermal contact between concentric components. In an embodiment wherein it is desired that heat be retained in the reaction cell chamber such as one comprising a heat exchanger such as a molten gallium or tin to air heat exchanger, the reaction cell chamber may comprise additional outer concentric thermal insulating liners such as quartz ones, and may further comprise a thermally insulating base such as one comprising a bottom quartz liner.

In an embodiment, the liner may comprise a refractory metal such as at least one of W, Ta, Mo, or Nb that is resistant to forming an alloy with gallium or tin. The metal liner may be in contact with the cell wall to increase the heat transfer to an external coolant such as water. In an embodiment, the horizontal distance from the circumferential edge of the electrode 8 to the reaction cell chamber 5b31 wall is greater than the vertical separation between the molten metal in the reservoir and the electrode 8 wherein at least one of the reaction cell chamber and the reservoir may optionally comprise a liner. In an exemplary embodiment, a centered W electrode 8 has a diameter of about 1 to 1.5 inches in a reaction cell chamber with a diameter in the range of about 6 to 8 inches wherein a W, Ta, Mo, or Nb liner is in contact with the reaction cell chamber wall. The reaction cell chamber with a diameter sufficient to avoid the formation of a discharge between the wall and electrode 8 may comprise no liner to improve at least one of heat transfer across the wall and hydrino diffusion through the wall to avoid hydrino product inhibition. In an embodiment such as one shown in FIGS. 9A-B, at least one of a portion of the reservoir and reaction cell chamber walls may be replaced with a material such as a metal such as Nb, Mo, Ta, or W that is resistant to gallium or tin alloy formation. The joints 911 with the other components of the cell such as the remaining portions of the reaction cell chamber 5b31 wall and reservoir wall may be bonded with a weld, braze, or adhesive such as a glue. The bond may be at a lip that overlaps the replacement section.

In an embodiment, the inner most liner may comprise at least one of a refractory material such as one comprising W or Ta and a molten metal cooling system. The molten metal cooling system may comprise an EM pump nozzle that directs at least a portion of the injected molten metal such as gallium or tin onto the liner to cool it. The molten metal cooling system may comprise a plurality of nozzles that inject molten metal to the counter electrode and further inject molten metal onto the walls of the liner to cool it. In an exemplary embodiment, the molten metal cooling system comprises an injector nozzle positioned in the central region of the reservoir such as the center of the reservoir or proximal thereto that may be submerged in the molten metal contained in the reservoir and an annular ring injector inside of the liner that comprises a series of apertures or nozzle to inject an annular spray onto the inner surface of the liner. The central injector and annular ring injector may be supplied by the same EM pump or independent EM pumps. The liner such as a BN or SiC liner may have a high heat transfer coefficient. The liner may be in close contact with the reaction cell chamber wall 5b31 that may be cooled to cool the liner. In exemplary embodiments, the reaction cell chamber wall 5b31 may be water or air cooled.

In an embodiment, the liner such as quartz liner is cooled by the molten metal such as gallium or tin. In an embodiment, the SunCell® comprises a multiple-nozzle molten metal injector or multiple molten metal injectors to spread the heat released by the hydrino reaction by agitation and distribution of the reaction on the molten metal surface. The multiple nozzles may distribute the power of the reaction to avoid localized excessive vaporization of the molten metal.

In an embodiment, a Ta, Re, or W liner may comprise a Ta, Re, or W vessel comprising walls such as a Ta, Re, or W cylindrical tube, a welded Ta, Re, or W baseplate and at least one fastened penetrating component such as at least one of a welded-in Ta, Re, or W EM pump tube inlet, and injector outlet, ignition bus bar, and thermocouple well. In another embodiment, the vessel may comprise a ceramic such as SiC, BN, quartz, or another ceramic of the disclosure wherein the vessel may comprise at least one boss that transitions to a penetrating component wherein the fastener may comprise a gasketed union such as one comprising a graphite gasket or another or the disclosure or a glue such as a ceramic to metal glue such as Resbond or Durabond of the disclosure. The vessel may have an open top. The vessel may be housed in a metal shell such as a stainless-steel shell. Penetrations such as the ignition bus bar may be vacuum sealed to the stainless-steel shell by seals such as a Swageloks or housings such as ones formed with flanges and a gaskets. The shell may be sealed at the top. The seal may comprise a Conflat flange 409e and baseplate 409a (FIGS. 7A-C). The flange may be sealed with bolts that may comprise spring loaded blots, disc spring washers, or lock washers. The vessel liner may further comprise an inner liner such as a ceramic liner such as at least one concentric BN or quartz liner. Components of the disclosure that comprise Re may comprise other metals that are coated with Re.

In an embodiment, the liner 5b31a may cover all of the walls of the reaction cell chamber 5b31 and the reservoir 5c. At least one of the reactant gas supply line 710 and vacuum line 711 may be mounted on the top flange 409a (FIGS. 7B-C). The vacuum line may be mounted vertically to further serve as a condenser and refluxer of metal vapor or another condensate that is desired to be refluxed. The vacuum line may further comprise an electrostatic precipitator to remove participles from gases from the reaction cell chamber wherein the trapped particles may be returned to the reaction cell chamber by gravity or a transport means such as an auger or other transporter know by those skilled in the art. The SunCell® may comprise a trap such as one on the vacuum line. An exemplary trap may comprise at least one elbow on the vacuum line to condense and reflux vaporized gallium or tin. The trap may be cooled by a coolant such as water. The liner may comprise components such as a base plate, a top or flange plate, and a tube body section or a plurality of stacked body sections. The components may comprise a carbon or a ceramic such as BN, quartz, alumina, magnesia, hafnia, or another ceramic of the disclosure. The components may be glued together or joined with gasketed unions. In an exemplary embodiment, the components comprise quartz that are glued together. Alternatively, the components comprise BN that comprise graphite gasketed unions.

In an embodiment, the temperature of the molten metal such as gallium or tin may be monitored by a thermocouple such as a high temperature thermocouple that may further be resistant to forming an alloy with the molten metal such as gallium or tin. The thermocouple may comprise W, Re, or Ta or may comprise a protective sheath such as a W, Re, Ta, or ceramic one. In an embodiment, the baseplate may comprise a thermocouple well for the thermocouple that protrudes into the molten metal and protects the thermocouple wherein heat transfer paste may be used to make good thermal contact between the thermocouple and the well. In an exemplary embodiment, a Ta, Re, or W thermocouple or a Ta, Re, or W tube thermowell is connected by a Swagelok to the baseplate of the reservoir. Alternatively, the thermocouple may be inserted in the EM pump tube, inlet side.

The top of the tube reactor (FIGS. 7A-C) may comprise a pedestal electrode 8 with feedthrough and bus bar 10 covered with an electrically insulating sheath 5c2 wherein the feedthrough is mounted in a baseplate 409a that is connected to the vessel 5b3 by flange 409e. The bottom of the vessel may comprise a molten metal reservoir 5c with at least one thermocouple port 712 to monitor the molten metal temperature and an injector electrode such as an EM pump injector electrode 5k61 with nozzle 5q. The inlet to the EM pump 5kk may be covered by an inlet screen 5qa1. The EM pump tube 5k6 may be segmented or comprise a plurality of sections fastened together by means such as welding wherein the segmented EM pump tube comprise a material or is lined, coated, or clad with a material such as Ta, W, Re, Ir, Mo, or a ceramic that is resistant to gallium or tin alloy formation or oxidation. In an embodiment, the feedthrough to the top electrode 8 may be cooled such as water cooled. An ignition electrode water cooling system (FIGS. 9A-B) may comprise inlet 909 and outlet water 910 cooling lines. In another embodiment, the baseplate 409a may comprise a standoff to move the feedthrough further from the reaction cell chamber 5b31 in order to cool it during operation.

In an embodiment, the liner may comprise a thinner upper section and a thicker lower section with a taper in between sections such that liner has a relatively larger cross-sectional area at one or more regions such as the region the houses the upper electrode 8 and a smaller cross-sectional area at the level of the gallium or tin to increase the current density at the gallium or tin surface. The relative ratio of the cross-sectional area at the top versus bottom section may be in the range of 1.01 to 100 times.

In an embodiment, the SunCell® may be cooled by a medium such as a gas such as air or a liquid such as water. The SunCell® may comprise a heat exchanger that may transfer heat (e.g., heat of the reaction cell chamber) to a gas such as air or a liquid such as water. In an embodiment, the heat exchanger comprises a closed vessel such as a tube that houses the SunCell® or a hot portion thereof such as the reaction cell chamber 5b31. The heat exchanger may further comprise a pump that causes water to flow through the tube. The flow may be pressurized such that steam production may be suppressed to increase the heat transfer rate. The resulting superheated water may flow to a steam generator to form steam, and the steam may power a steam turbine. Or, the steam may be used for heating.

In an embodiment of an air-cooled heat exchanger, the SunCell® heat exchanger may comprise high surface area heat fins on the hot outer surfaces and a blower or compressor to flow air over the fins to remove heat from the SunCell® for heating and electricity production applications. In another air-cooled heat exchanger embodiment, the molten metal such a gallium or tin is pumped outside of the reservoir 5c by an EM pump such as 5ka and through a heat exchanger and then pumped back to the reservoir 5c in a closed loop.

In an embodiment wherein the heat transfer across the reaction cell chamber wall is at least partially by a conductive mechanism, the heat transfer across the wall to a coolant such as air or water is increased by at least one of increasing the wall area, decreasing the wall thickness, and selecting a reaction cell chamber wall comprising a material such as nickel or a stainless steel such as chromium molybdenum steel that has a higher thermal conductivity than alternatives such as 316 stainless steel.

In an embodiment (FIGS. 7A-D), the heat exchanger may comprise the SunCell® reservoir 5c, EM pump assembly 5kk, and EM pump tube 5k6 wherein the EM pump tube section between its inlet and the section comprising the EM pump tube bus bars 5k2 is extended to achieve a desired area of at least one loop or coil conduit in a coolant bath such as a water bath, molten metal bath, or molten salt bath. Multiple loops or coil may be fed from at least one supply manifold, and the molten metal flow may be collected to return to the EM pump by at least one collector manifold. The loop or coil conduits and manifolds may comprise material resistant to alloy formation with the molten metal such as gallium or tin and possess a high heat transfer coefficient. Exemplary conduit materials are Cr—Mo SS, tantalum, niobium, molybdenum, and tungsten. The conduit may be coated or painted to prevent corrosion. In an exemplary embodiment, the EM pump tube and heat exchanger conduit comprises Ta that is coated with a CrN, a ceramic such as Mullite or ZTY, or a paint such as VHT Flameproof™ to prevent corrosion with water, and the EM pump bus bars 5k2 comprise Ta. In another exemplary embodiment, the EM pump tube and heat exchanger conduit comprises Nb that is coated with a CrN, a ceramic such as Mullite or ZTY, or a paint such as VHT Flameproof™ to prevent corrosion with water, and the EM pump bus bars 5k2 comprise Nb.

In an embodiment, the SunCell® comprises at least one component such as the reaction cell chamber and the reservoir comprising a wall metal such as 4130 CrMo SS, Nb, Ta, W, or Mo with a high heat transfer coefficient, a sufficiently thin wall, and a sufficiently large area to provide sufficient heat loss to a thermal sink such as a water bath to maintain a desired molten metal temperature during the production of a desired amount of power. An external heat exchanger may not be necessary. The wall thickness may be in the range of about 0.05 mm to 5 mm. The wall area and thickness may be calculated from the conduction heat transfer equation using the bath and desire molten metal temperature as the thermal gradient. The external surfaces of the SunCell® may be coated with a paint such as VHT Flameproof®, a ceramic such as Mullite, or an electroplated corrosion-resistant metal such as SS, Ni, or chrome to prevent corrosion with a coolant of the thermal sink such as water of the water bath.

In an embodiment, the nozzle 5q may be replaced with a plurality of nozzles, or the nozzle may have a plurality of openings such as those of a shower head to disperse the injected gallium or tin from multiple orifices toward the counter electrode. Such configurations may facilitate the formation of a plasma at higher molten metal injection rates such as those required to maintain a high flow rate in the single loop conduit of the heat exchanger that is in series with the EM pump injection system comprising the EM pump tube, and its inlet and injection outlet.

### Heat Exchanger

In an embodiment shown in FIGS. 9D-E, the SunCell 812 is cooled in a coolant reservoir that may be closed to comprise a pressure vessel with an upper removable section 33a and a lower section 33b with electrical feedthroughs 37 and penetrations 38. The feedthroughs may comprise ceramic ones such as Solid Sealing Technology, Inc. #FA10775, thermoplastic ones such as Teflon ones or potted epoxy boiler feedthroughs such as ones potted with a Coltronics potting compound such as Resbond such as 940SS. The coolant may comprise water. The vessel may comprise a boiler. At least one wall of the boiler such as the top may comprise a coolant outlet 34 and a valve. The valve such as an iris or butterfly valve may control at least one of the steam flow rate and the boiler pressure. The boiler may further comprise a water make-up line 35 and corresponding make-up water pump. In an embodiment, the boiler further comprises pressure vessel feedthroughs for electrical connections 37 for the ignition, the EM pump, the plasma discharge cell 900 currents, and sensors such as temperature, gas flow, gas pressure, and power sensors as well as penetrations 38 for the vacuum line and reactant gas lines. The power of the SunCell may be controlled by controlling at least one of the ignition current, the hydrogen flow rate, the oxygen flow rate, the water vapor flow rate, the EM pumping rate, the reaction cell chamber pressure, the reaction cell chamber temperature, and the plasma cell 900 parameters such as voltage, current, and waveform. The power of the SunCell may be controlled to control at least one of the steam flow rate and the boiler pressure. The SunCell may comprise at least an internal and an external resistive heater to melt the molten metal. The heater may comprise a plurality of independently controlled zones. The heater may be a resistive one such as a Nichrome or Kanthal element resistive heater or an inductively coupled heater. The heater may be powered by one or more of the SunCell, a capacitor bank, and a battery. In an exemplary embodiment, the SunCell® comprises a kiln heater that may be lowered onto the SunCell reversibly to melt the molten metal and then be removed. The kiln may comprise sheet metal panels at the bottom of the kiln to house and support thermal insulation for the bottom of the kiln. The panels may be easily removable. In an exemplary embodiment, the panels are attached to a sheet metal housing of the kiln by magnets.

In a boiler and heated-air power system embodiment shown in FIG. 9F, the SunCell 812 is housed in a boiler pressure vessel 33 comprising an insulation jacket 923, a first steam outlet 34, a recirculating steam outlet 925, a steam return 926, a steam and hot water to air heat exchanger 927, and a water return pump. The steam may flow from the boiler 33, through the line 925 to the heat exchanger 927, and return through return line 926 to the boiler 33 as at least one of cooler steam or hot water. At least some of the boiler steam and hot water thermal power may be transferred to a gaseous coolant such as air by the heat exchanger 927. The SunCell 812 may comprise an inner window 5ab4 and a PV converter 26a, in a chamber 916 to convert light emitted from the hydrino plasms in the reaction cell chamber 5b31 into electricity. The electricity may power at least one parasitic load required to operate the SunCell. The loads may comprise the EM pump power supply, the ignition power supply, the vacuum pump power supply, the make-up water pump power supply, the steam recirculating pump power supply, and the glow discharge power supply. The DC electricity may flow from the PV converter through power cable 924 to the power conditioner and supply 2 which may supply at least one of the parasitic loads. In an exemplary embodiment, the loads and power supplies are DC. The vacuum pump 519, the make-up water pump, and the steam recirculating pump may each comprise a DC motor.

The SunCell power system may comprise a startup oven comprising at least one heating element and insulation that may at least partially house the SunCell and heat it to at least one of (i) melt the molten metal and (ii) heat SunCell components such as the PV window, reaction cell chamber, reservoir, EM pump tube, and EM pump injectors to prevent solidification of the molten metal. The startup oven may comprise an external power source, temperature sensors, and a controller to control the temperature of the oven. The boiler may comprise the heater such as the startup oven. The walls of the boiler such as at least one of 33a and 33b comprise heating elements such as one or more Nichrome or Kanthal resistive heater elements and thermal insulation such as high temperature capable insulation that may be hermetically sealed such as in a housing such as a stainless-steel housing. The housing may comprise a boiler double wall. The boiler performing as an oven may melt the molten metal in the SunCell during SunCell startup. To increase the heating rate of the internal components of the SunCell, the SunCell may be filled with a gas with a high heat transfer capability such as helium or hydrogen and/or the exterior surfaces of the SunCell may be coated with a coating with a high emissivity such as black ceramic paint such as Flameproof paint. When the SunCell reaches at least one of a desired temperature and power, the heater and oven power may be discontinued, and the boiler filled with water by the water make-up line 35 and corresponding water pump to perform as a boiler. In an embodiment, the boiler further comprises a heat exchanger such as at least one of a cooling tower and a forced air exchanger such as a radiator. The boiler and external heat exchanger may serve to at least one of cool the SunCell, cool the PV converter, provide steam to a load, and provide heated air to a load. In an embodiment, at least one SunCell component such as the electromagnetic pump magnets 5k4 or the electromagnetic pump assembly 5kk may penetrate the oven/boiler wall such as the bottom wall and may be at least one of heated and cooled externally to the oven/boiler.

In an embodiment, a high reaction cell chamber 5b31 wall temperature such as one in the range of 150° C. to 2000° C. increases the hydrino permeation rate which was found to be important to increasing the hydrino reaction rate by reducing product inhibition. The wall temperature may be regulated, for example, by alteration (e.g., increase or decrease) of the reaction rate, leveraging thermal insulation and/or cooling in the device for appropriate heat transfer to maintain a desired temperature during operation. Similarly, a high reaction cell chamber 5b31 temperature such as one in the range of 150° C. to 3000° C. may also increases the hydrino reaction rate. In an embodiment, the SunCell such as the one shown FIGS. 8A-8L is partially submerged in a coolant such as water to provide selective cooling via enhanced heat transfer from the submerged part of the SunCell such as the reservoirs 5c and EM pump tubes 5k6. The reservoirs 5c can be made arbitrarily long with a corresponding arbitrary tin inventory to serve as the cooling pathway. The boiler such as shown in FIGS. 9D-9F can be lined with heater coils or the cell wrapped with heat tape. In an embodiment, the boiler vessel 33 without water can serve as an oven to melt the molten metal to permit the SunCell to be started, then the boiler tank 33 can be partially filled with coolant to maintain high reaction cell chamber and wall temperatures while cooling occurs through the reservoirs and EM pump tubes that may be extended in length to provide addition surface area for heat transfer from the internal molten metal to the coolant.

In an embodiment to reduce product inhibition, the hydrino reaction may be paused to permit time for hydrino reaction products to be removed from the reaction cell chamber 5b31 by at least one mechanism such as permeation and vacuum pumping. The hydrino reaction may be paused by at least one method to control the hydrino reaction rate such as at least one of pausing the ignition power, the EM pumping, and flow of at least one reactant, and addition of an inert gas, and another means of the disclosure.

In another embodiment of SunCell comprising dual molten metal injectors, the ignition power supply may provide resistive heating to start the SunCell. At least one exterior surface of the SunCell such as one electrically isolated from break reservoir EM pump assembly 914a (FIG. 8G) by the electrical break 913 or an exterior surface of the break reservoir EM pump assembly 914a, may comprise at least one electrical lead connection. Exemplary exterior surfaces are an exterior wall of at least one of the reaction cell chamber 5b31 and the reservoir 5c above or below the electrical break 913. The electrical lead connection may be connected to a voltage terminal of the ignition power supply wherein the opposite polarity ignition power supply voltage terminal may be connected to a lead to at least one of the molten metal of the reservoir EM pump assembly and the reservoir EM pump assembly 915a. The ignition power may be flowed through the SunCell from one lead to other of opposite polarity to resistively heat to resistively heat the SunCell or portions thereof including the molten metal reservoirs and molten metal therein.

Following a desired amount of resistive heating such as one that achieves melting of the molten metal, the ignition power may be connected between leads of oppositive molten metal injectors. The SunCell may comprise a resistive/ignition switch that switches connection between resistive heating and ignition power by connecting the corresponding leads. In another embodiment, the resistive heating may be powered by a power supply other than the ignition power supply. In an exemplary embodiment, rather than apply ignition power, the ignition power source is used to melt the tin and heat the SunCell, then the ignition power is applied to start the hydrino reaction plasma.

In a general embodiment such as one comprising a boiler, an air heat exchanger, or a thermophotovoltaic converter design of the disclosure, the SunCell may comprise reversible insulation such as a vacuum jacket, a pressure gauge, a gas supply such as a hydrogen or helium supply, a vacuum pump, and a gas pressure controller wherein the gas pressure in the jacket is controlled to control the level of insulation. Other components such as the EM pump tube may comprise a ceramic insulation or an equivalent. In another embodiment, an EM pump such as 5ka may pump the molten metal into a storage reservoir such as one external to the reservoir 5c. The storage reservoir may comprise the EM pump and further comprise a controller, a temperature sensor, a heater, and a heater power supply such as a battery or capacitor bank to power the heater. The heater may melt the molten metal that is then pumped or siphoned into the reservoir 5c to allow the SunCell to startup. In an embodiment, the molten metal may be at least one of pumped into or out of the storage reservoir through a connection to the EM pump tube 5k6.

In a boiler embodiment such as one shown FIGS. 9D-E, the SunCell may undergo startup with no water in the boiler tank. The heater may heat the SunCell, and the water may then be pumped into the boiler tank after the SunCell has reached a desired operating temperature such as one above the melting point of the molten metal such as tin, silver, copper, or alloys thereof. In an embodiment, the SunCell may comprises dual molten metal injectors 5k61 each in a reservoir 5c (FIGS. 8F-8L) wherein each serves as an ignition a current carrying electrode that may further comprise at least one of an electrical break 913 that may comprise a thermally insulating liner, electrical break flanges 914, reservoir flanges 915, EM pump tube assembly 5kk, EM pump tube 5k6, EM bus bars 5k2, EM pump magnets 5k4, and an inlet riser 5qa. The SunCell may further comprise a vacuum line 711, a discharge cell 900 and body 901, a gas inlet such as one that passes through an electrical feedthrough 906a (FIGS. 8J-8L), reaction cell chamber 5b31, top flanges 26e that may comprise a solid plate or inner PV window flanges, a PV chamber 916, an inner PV window 5ab4, a seat for the inner PV window 26e 1, and an outer PV window 5b4. In an exemplary embodiment, the positive lead of the glow discharge power supply connects to a gas line extension of a feedthrough-gas inlet 906a, and the negative lead is attached to the discharge cell flange 906b or chamber 901 or the reaction cell chamber 5b31 wherein the negative connection may be indirect by connecting to a gas line such as argon gas line 906 (FIG. 8C) that is in electrical contact with the discharge cell flange 906b. The discharge cell body 901 may be mounted on the reaction cell chamber 5b31 directly as shown in FIG. 8G, or by a connection such as an elbow that permits the discharge cell body to be oriented in another desired direction such as vertically. In an embodiment comprising a top flange 409a such as the one shown in FIG. 9A, the discharge cell 900 may be mounted on the top flange 409a in a desired orientation such as vertically. The boiler water may be added after the SunCell is operating to maintain a temperature sufficient to maintain the molten metal in the molten state. The boiler water may cool at least one of the electrical break 913, EM bus bars with feedthroughs 5k2, and EM pump magnets 5k4.

At least the EM pump tubes 5k6 may be thermally insulated to prevent the molten metal inside from solidifying. The insulation may comprise ceramic fiber or other high temperature thermal insulation material that may be hermetically sealed in a housing such as a SS housing that may be joined together and to the EM pump tube by at least one of welding and metal glue such as at least one of J-B Weld 37901, Cotronics Resbond 940SS, and Cotronics Resbond 907GF to provide the seal. Alternatively, the EM pump may be clad with insulation such as carbon. In an exemplary embodiment, the thermal insulation may comprise two carbon clam shells that have a milled-out channel for the EM pump tube wherein the blocks may be glued to the pump tube and glued to each other to form a hermetic seal. The glue may comprise carbon glue or another such an oxide-based glue such as Resbond to prevent carbide formation of the pump tube. Alternatively, the exterior of the EM pump tube 5k6 may be coated with coating such as Flameproof paint or another of the disclosure that avoids carbide formation which is permissive of using carbon glue such as Aremco Products Graphitic Bond 551RN. The carbon insulation may be coated at least externally and internally. The coating such as Flameproof paint or another of the disclosure may prevent at least one of oxidation and carbide formation. In another embodiment, the EM pump tube 5k6 may comprise a thermally insulating liner such as a carbon, BN, ceramic, or quartz one.

In an embodiment, the EM pump tube 5k6 may comprise heat transfer blocks comprising a highly thermal conductive material such as copper that encases the EM pump to spread heat from one hot section of the EM pump tube to a cooler section. The heat transfer blocks may transfer heat to the section of the EM pump tube that is covered the EM magnets 5k4.

In an exemplary heat exchanger 813 embodiment shown in FIGS. 7E-G, the components that contact molten gallium or tin comprise carbon, and the components that contact air coolant comprise stainless steel. Conduit liners 801a, manifolds or bonnets 802, heat exchanger inlet line 803, and heat exchanger outlet line 804 comprise carbon, and conduits 801, distributors 805, shell 806, external coolant inlet 807, external coolant outlet 808, and baffles 809 comprise stainless steel. Each stainless-steel conduit 801 is welded to the corresponding distributor 805 at each end. The distributors 805 are welded to the shell 806 such that air coolant only contacts stainless-steel. The bonnets 802, inlet 803 and outlet 804 are inside of a stainless-steel housing 806a that has a welded-in inlet 803c line and welded-in outlet line 804c connected to the carbon heat exchanger inlet line 803 and outlet line 804 inside of the housing 806a wherein the connections comprise gasketed flanged unions. The gaskets may comprise carbon. Each distributors 805 may comprise two pieces, one outer piece 805a comprising carbon glued to the ends of the liners 801a and an inner piece comprising stainless steel welded to the housing 806a and the shell 806. The line 803 from the gallium or tin circulation EM pump 810 and the return line 804 to the reservoir 5c may comprise an expansion joint such as a bellows or spring-loaded joint.

In an exemplary embodiment shown in FIGS. 7E-G, the components that contact molten gallium or tin comprise carbon, and the components that contact air coolant comprise stainless steel. Conduit liners 801a, manifolds or bonnets 802, heat exchanger inlet line 803, and heat exchanger outlet line 804 comprise carbon, and conduits 801, distributors 805, shell 806, external coolant inlet 807, external coolant outlet 808, and baffles 809 comprise stainless steel. Each stainless-steel conduit 801 is welded to the corresponding distributor 805 at each end. The distributors 805 are welded to the shell 806 such that air coolant only contacts stainless-steel. The bonnets 802, inlet 803 and outlet 804 are inside of a stainless-steel housing 806a that has a welded-in inlet 803c line and welded-in outlet line 804c connected to the carbon heat exchanger inlet line 803 and outlet line 804 inside of the housing 806a wherein the connections comprise gasketed flanged unions. The gaskets may comprise carbon. Each distributors 805 may comprise two pieces, one outer piece 805a comprising carbon glued to the ends of the liners 801a and an inner piece comprising stainless steel welded to the housing 806a and the shell 806. The line 803 from the gallium or tin circulation EM pump 810 and the return line 804 to the reservoir 5c may comprise an expansion joint such as a bellows or spring-loaded joint.

In an embodiment, the thermal power such as the steam output from the heat exchanger may be used for air conditioning, cooling loads such as servers and others, and refrigeration by mating the SunCell output to an absorption chiller such as one made by Trane (https://www.trane.com/commercial/asia-pacific/ph/en/products-systems/equipment/chillers/absorption-liquid-chillers/single-stage-chillers.html).

In an embodiment, the SunCell may comprise a direct wall heat exchanger. The SunCell 812 may be placed in cowling 39 (FIGS. 9G-H) for directed air flow over the outer surfaces to remove heat. At least one surface of the SunCell such as the walls of at least one of the walls of the reaction cell chamber and the reservoir maybe at least partially covered with a wall heat transfer means to increase the effective wall surface area to increase the heat transfer rate to air flowed over or through the wall heat transfer means. The heat transfer means may comprise a heat spreader and a heat exchanger. Exemplary heat transfer means are fins, heat pipes, vapor chambers, and channel plates such as ones comprising spiral air channels comprising a high surface area material with high heat transfer such as aluminum or copper shot. Exemplary heat pipes are molten salt heat pipes and sodium, potassium or cesium heat pipes that may comprise compatible metals such as Alloy 600 or Hayes 230. The heat exchanger may comprise heat pipes of any orientation and may comprise a heat transport system to permit the heat pipes to be oriented and arranged in desire positions and orientations. The direct wall heat exchanger may further comprise a blower or compressor 42 to flow air through the wall heat transfer means.

The heat exchange may further comprise at least one of one or more vapor chambers, loop thermosyphons, thermal spreaders, and transport heat pipe assemblies. The heat spreader may comprise a heat transfer block of the appropriate geometry to connect to the surface of the walls of at least one of the reaction cell chamber and the reservoir. The spreader may comprise a material with a high heat transfer coefficient such as a copper or aluminum one. The thermal power produced by the SunCell may also be spread to a larger area to facilitate the transfer to air by increasing the geometric area of at least one of the reaction cell chamber and reservoir. In an exemplary embodiment, the power density transferred across at least one of the reaction cell chamber and the reservoir walls is matched to the capacity of an external heat exchanger to transfer the power to air by increasing at least one dimension of SunCell to increase the wall surface area.

In an embodiment of a direct heat exchanger shown in FIGS. 9G-H, the SunCell 518 is housed in cowling 39, and the heat exchanger comprises heat pipes 45 mounted perpendicularly on the outer walls of the reaction cell chamber such as a reaction cell chamber 5b31 having cubic or rectangular geometry. The heat pipes 45 may be mounted at their base in a cold plate 44 such as a copper or aluminum plate or heat spreader 44 such as a vapor chamber that may have a larger surface area than the wall area to which it is mounted. The heat spreader may extend along an axis parallel to the SunCell. The cold plate or heat spreader 44 may comprise channels, grooves, or open areas 46 for hydrino diffusion through the reaction cell chamber wall to vent from the reaction cell chamber 5b31. The heat exchanger may further comprise coolant heat transfer elements such as fins 43 to transfer heat from the heat pipes 45 to a flowing coolant such as air or water. In an embodiment, the coolant such as air or water may be flowed through an inlet 41 by a blower or compressor 42 or a water pump 42, respectively. The coolant flow may be contained in cowling 39 and flowed out an outlet 40. In an embodiment, the heat exchanger further comprises cowling feedthroughs for electrical connections for the ignition, the EM pump, the plasma discharge cell 900 currents, and sensors such as temperature, gas flow, gas pressure, and power sensors as well as penetrations for the vacuum line and reactant gas lines. The heat exchanger may comprise a controller of the blower or water pump wherein the outlet coolant temperature is controlled by controlling the coolant flow rate. The heat pipe may be selected such that it initiates the transport of heat when the reaction cell chamber wall temperature is a desired temperature such as one in the range of about 100° C. to 3000° C. In an exemplary embodiment, the working fluid of the heat pipe may comprise an alkali metal such that it transports heat as the wall approaches the boiling point of the alkali metal.

In an embodiment of a SunCell 812 comprising a heat pipe air heat exchanger shown in FIGS. 9G-H, the reaction cell chamber 5b31 may comprise a refractory metal such as stainless steel such as CrMo steel, niobium, tantalum, titanium, iron, nickel, or molybdenum that is coated with a graphite or ceramic coating to prevent alloy formation with the molten metal such as tin or gallium. The ceramic coating may comprise Flameproof paint, Mullite, ZTY, or other similar coating of the disclosure or one known in the art. The reaction cell chamber may further comprise at least one liner to protect the coating from plasma damage such as a liner that has a high melting point and is resistant to forming an alloy with the molten metal such as one comprising quartz, carbon, a ceramic such as BN or SiC, or a refractory metal such as W or Ta. The EM pump tube may comprise a high-temperature thermal insulator and molten metal alloy resistant coating or a liner such as a quartz liner. In an embodiment, the EM pump tube may be selectively cooled by an EM pump tube cooler such as one comprising a heat exchanger such as one comprising a liquid or gaseous coolant.

In an embodiment to transfer heat generated by the hydrino reaction predominantly by radiation such as one shown in FIG. 91, the SunCell may comprise at least one PV window 5b4 wherein each window transmits light from the reaction cell chamber 5b31 and any chamber formed by the PV window(s) to irradiate an absorber 44 that transfers heat to a heat exchanger such as one comprising heat pipes 45 and heat exchanger fins 43. The SunCell may comprise at least one mirror to reflect emission transmitted through at least one PV window to at least one absorber 44. In an embodiment, the coolant such as air or water may be flowed through an inlet 41 by a blower or compressor 42 or a water pump 42, respectively. The coolant flow may be contained in cowling 39 and flowed out an outlet 40. In an embodiment, the SunCell comprises a gap 44a between the PV window(s) 5b4 and the optical power absorber(s) 44 wherein the geometrical area of absorber(s) 44 is greater than the area of the PV window(s) to spread intense emitted optical power over a larger area absorber(s).

In an embodiment, the EM pump is capable of operating at high temperature such as in the range of about 200° C. to 1500° C. In an embodiment, the EM pump comprises a metal pump tube 5k6 with welded in EM pus bars 5k2 where at least one of inside of the pump tube and at least the portion of the bus bars that contacts the molten metal are coated with a coating with at least one property of a high electrical conductivity, resistance to alloy formation with the molten metal, oxidation resistance, and high temperature stability. The conductivity of the coating may be in the range of about 1000 micro-ohm cm to 1 micro-ohm cm. The stable temperature of the coating may be above 100° C. The alloy resistance of the coating may regard resistance associated with forming an alloy with at least one of gallium, indium, tin, copper, and silver. The oxidation resistance of the coating may regard resistance associated with oxidation from at least one of oxygen and water to at least a temperature of 100° C. The EM bus bar coating may be applied before or after the EM bus bars are welded to the EM pump tube. The coating may comprise at least one of a nitride, carbide, or boride. Exemplary conductive coatings are carbon slurry such as one comprising Aremco Products Graphitic Bond 551RN or spray coating, vanadium carbide thermal diffusion coating, thermo-chemical boriding/borinizing (DHB) coating, TiCN, titanium nitride, or carbide CVD coating, advanced HVOF CoreGard™ (Praxair) coatings, salt bath nitriding coat, gas nitriding coat, ion plasma nitriding coat, chrome, chrome carbide, tantalizing coating, thermo-chemical tantalizing coating, aluminizing coating, platinum aluminide diffusion coating, thermo-chemical aluminizing coating, ZrN, TiN, WC, VC, thermal-chemical CrC coating, CrC or Al coating such as diffusion coating such as at least one of diffused slurry, pack diffusion, and vapor phase diffusion, CrC, CrN, AlTiN, TiAlN, AlTiCN, TiAlSiCN, TiB₂, and ZrB₂. The coating may be applied by a plasma vapor deposition, physical vapor deposition, HVOF method, thermal spray, thermal diffusion, chemical vapor deposition (CVD), thermo-chemical, chemical deposition, electrochemical deposition, electroplating, and other methods known in the art. The coating of the EM pump tube may comprise a tantalum coat such as one applied by tantalizing using a method such as thermo-chemical deposition. In an embodiment, the Ta coated EM pump tube may comprise at least one of stainless-steel tube 5k6 and stainless-steel EM bus bars 5k2 that may be welded in. The coating of the EM pump tube may comprise a nonconductive material such as a ceramic such as Flameproof paint while the coating of the EM bus bars may comprise a conductive coating such as TiN or a conductor such as Ta or W that may be further resistant to alloy formation with the molten metal. In an exemplary embodiment, the EM pump tube comprises Flameproof paint coated stainless steel (SS) and the EM bus bars comprise TiN coated SS welded into the SS pump tube. In a further exemplary embodiment, the EM pump tube comprises Flameproof paint coated stainless steel (SS) and the EM bus bars comprise two sections, an electrode section in contact with the molten metal and a fastener section connected to the EM pump tube. The EM bus bars may comprise W or Ta rods fastened to a SS fastener welded into the SS pump tube. The W or Ta rods may be fastened to SS by a fastener comprising a screw joint such as a Ta or W male-threaded rod screwed into a welded-in SS stub having corresponding female threads. In another embodiment, the fastener comprises a SS collar welded to the pump tube with the Ta or W rod penetrating the collar to the inside of the EM pump tube. The opposite end of the rod may be welded or brazed to the SS collar. Alternatively, the Ta or W rod may be partially clad with stainless steel wherein a stainless-steel clad portion is welded to the EM pump tube such that an unclad W section protrudes into the pump tube and a fully clad EM bus bar protrudes external to the EM pump tube. The EM pump tube may be coated before or after the EM bus bars are fastened. The pump tube may be selectively coated without coating the EM bus bars by selective application of the coating using gravity, centrifugal forces, gas pressure, electrostatic forces, a bellows, or another selective application method known in the art or by using a masking method such as one of the disclosure.

In an embodiment such as one shown in FIGS. 6, 8A-8L, and 13, the reservoir baseplate 5kk1 may be conductive and serve as the ignition electrode. An exemplary baseplate ignition electrode comprises a metal such as stainless steel coated with a conductive coating such as a carbide such as CrC, a nitride such as TiN, or a boride such as TiB₂ or ZrB₂ that at least one of protects the baseplate from alloy formation with the molten metal and oxidation. A bus bar may connect from a terminal of the ignition power source directly to the baseplate ignition electrode and/or the ignition reservoir bus bar 5k2al. In an embodiment, the injector tube 5k61 comprises at least one of an oxide-coating free, highly conductive metal such as W or Ta and a thin wall such one having a thickness in the range of 0.1 mm to 5 mm to reduce the electrical resistance of the ignition current between the molten metal in the reservoir and the molten metal in the injector tube. The diameter of the injector tube may be increased to decrease the electrical resistance across the tube wall. Exemplary injector tube 5k61 diameters are in the range of about 1 mm to 10 cm.

In an embodiment, the reaction cell chamber may replace the PV window of the SunCell comprising the inverted Y geometry. The external heat exchanger such as one shown in FIGS. 9G-H may be mounted to the walls of the reaction cell chamber. In an exemplary embodiment, the reaction cell chamber walls may comprise a metal such as CrMo steel coated with a ceramic such as Flameproof paint wherein the reaction cell chamber comprises a refractory liner such as a quartz, SiC, or W liner.

### Thermophotovoltaic Converter

A test of single junction Group III/V semiconductor PV conversion of 1207° C. blackbody emission with infrared light recycling was reported by Z. Omair, et al., “Ultraefficient thermophotovoltaic power conversion by band-edge spectral filtering”, PNAS, Vol, 116, No. 3, (2019), pp. 15356-15361 which is incorporated by reference in its entirety. Omair et al., achieved 30% conversion efficiency and projected an efficiency of 50% with mirror, PV, blackbody emissivity, view factor, series resistance, and other improvements. The thermophotovoltaic (TPV) conversion efficiency for 3000K SunCell emission by a single junction concentrator silicon PV cell operating at 120° C. was calculated to be 84% with a practical expectation of 50%. In an embodiment, the SunCell® comprises a thermophotovoltaic (TPV) converter comprising at least one photovoltaic cell and at least one blackbody radiator or emitter. The blackbody radiator for thermophotovoltaic conversion with light recycling comprises one or more of (i) at least one of the outer walls of a SunCell component and (ii) the hydrino plasma in the reaction cell chamber that emits light through the PV window to the PV converter. The SunCell component having an outer wall that serves as a blackbody radiator may comprise at least one of the reaction cell chamber and reservoir comprising a refractory material that is resistant to alloy formation with the molten metal such as a wall comprising Mo, Ta, W, Nb, Ti, Cr, Zr alloys and internally coated such as VHT Flameproof paint or similar ceramic paint or ceramic coated steel or stainless steel or refractory metal. Alternatively, the wall may comprise at least one of carbon, quartz, fused silica, and a ceramic such as alumina, hafnia, zirconia, silicon carbide, boron nitride (BN), and another of the disclosure. In an embodiment, the blackbody radiator may comprise a filter to block emission of infrared light to the TPV cell. The TPV cell may comprise at least one of a filter such as an infrared filter on the front surface and a mirror on the back surface such as an infrared mirror. The photons that enter the PV cell having energy below the cell's band gap may be reflected back to the SunCell such as to at least one of the SunCell component wall and the reaction cell chamber through the PV window to recycle the corresponding low-energy photons.

Due to reflections and multiple reflections of plasma and recycled light by the molten metal inside of the reaction cell chamber, the percentage the direct plasma emission, stray plasma and SunCell component emission such as wall, molten metal, and positive electrode emission, and recycled light that may exit the chamber or be transmitted through a PV window may be 100%. In an embodiment, at least one of the reaction cell chamber and the reservoirs may be thermally insulated such that the power transferred from the SunCell through the PV window to a load such as a PV converter, oven absorber, or boiler absorber is dominated by radiation. The percent of hydrino reaction power radiated is function of the molten metal emissivity which is typically in the range of about 0 to 0.3 and the reaction cell chamber wall temperature which may be in the range of 500° C. to 3500° C. The percentage of radiation transmitted may increase with deceased molten metal emissivity and increased reaction cell chamber wall temperature. In an exemplary embodiment comprising an upper transparent half dome PV window connected to a lower reaction cell chamber, the transmission through the PV window was calculated to be about 100% with a plasma blackbody temperature of 3000K, a molten metal emissivity of 0.3, and a reaction cell chamber wall temperature of 1700° C.

In an embodiment (FIGS. 9A-C) to increase the thermal insulation to achieve a desired molten metal operating temperature such as one in the range of about 300° C. to 3000° C., the reaction cell chamber diameter is increased to accommodate a thicker liner such as a carbon liner with a W inner liner and optionally a polygon of W plates that lines at least the most intense plasma zone. In an embodiment, the top of the reaction cell chamber 5b31 comprises a partial cover to reduce the size of the top plate 409a and the corresponding flange seal 409e. The top of the reaction cell chamber may comprise a welded cylinder in the center of a welded annulus that is capped with a flange 409e to a mating plate 409a having a feedthrough for the ignition electrode 8.

In an embodiment, the liner may comprise at least one of graphite, pyrolytic graphite, BN, and ceramic coated graphite, pyrolytic graphite, or BN. In an exemplary embodiment, the coating may comprise at least one of a high temperature ceramic paint, Flameproof paint, or Resbond 907GF, 940HT, 940LE, 940HE, 940SS, 903 HP, 908, or 904 zirconia adhesive, and a zirconium oxide coating such as Aremco Ultra-Temp 516 comprising ZrO₂— ZrSiO₄. In an exemplary embodiment shown in FIGS. 8C-D, the dual injector reservoirs 5c comprise carbon lined, Flameproof or other ceramic coated tubes, and the reaction cell chamber 5b31 comprises a carbon lined, Flameproof or other ceramic coated chamber with a tungsten liner in the reaction cell chamber plasma zone. At least one of the carbon and W liners may be coated with a ceramic such as one of the disclosure such as a high temperature ceramic paint, Flameproof paint, or Resbond 907GF, 940HT, 940LE, 940HE, 940SS, 903 HP, 908, or 904 zirconia adhesive, or a zirconium oxide coating such as Aremco Ultra-Temp 516 comprising ZrO₂— ZrSiO₄.

In an embodiment, the SunCell may comprise dual reservoirs and injector electrodes that inject molten metal such that the injected molten metal streams intersect to form a plasma. In an embodiment, at least reaction cell chamber wall may be transparent to at least one of visible and infrared light. The reactions cell chamber walls may comprise a PV window. The SunCell may comprise a reaction cell chamber with a polygonal shape such as a square, rectangle, pentagon, hexagon, etc. The surface of the reaction cell chamber may be clad with PV cells such a thermophotovoltaic (TPV) cells wherein a gap may exist between the reaction cell chamber walls and the PV cells. In an embodiment, at least one window or filter comprises a means such as surface texture or a quarter wave plate to reduce reflection. In another embodiment, the SunCell may further comprise a PV window comprising a chamber connected to the reaction cell chamber by a joint such as a flanged joint. The TPV cells may surround the PV window to receive plasma emission and convert it into electricity. The TPV cell may reflect light such as infrared light that is not converted into electricity back to the plasma to be recycled.

In an embodiment, the molten metal may comprise tin. The reaction cell chamber temperature may be maintained above a temperature at which the reaction of tin with water vapor to form tin oxide is thermodynamically unfavorable wherein water is supplied to the hydrino reaction as part of the hydrino reaction mixture such as one comprising at least two of hydrogen, oxygen, and water vapor. In an exemplary embodiment wherein the hydrino reaction mixture comprises water vapor, the reaction cell chamber is maintained above 875K. Addition of molecular or atomic hydrogen as part of the hydrino reaction mixture decreases the temperature at which the reaction of tin with water vapor to form tin oxide is thermodynamically unfavorable.

In an embodiment, the SunCell comprises a water injector such as sources of hydrogen and a source of oxygen and a recombiner such as a plasma cell, recombiner catalyst such as a noble metal on a support such as alumina, or another recombiner of the disclosure. The source of hydrogen and oxygen may be corresponding gases supplied by gas lines, mass flow controllers, valves, flow and pressure sensors, a computer, and other systems of the disclosure. Alternatively, water may be supplied as a water vapor gas. The water vapor gas may be controllably flowed into at least one of the reaction cell chamber and molten metal by a mass flow controller from a water tank maintained at a desired pressure for the mass flow controller operation. The water vapor pressure may be controlled by controlling the temperature of a water vapor source such as a closed water tank. In an exemplary embodiment, the water vapor mass flow controller such as at least one of MKS model #1150, 1152m, and 1640 (https://www.mksinst.com/c/vapor-mass-flow-controllers https://ccrprocessproducts.com/product/1640a-mass-flow-controller-mks/) comprises one that senses the difference in inlet and outlet pressure and uses that data to control the water vapor flow rate.

In an exemplary embodiment shown in FIGS. 8C-D, the SunCell for thermophotovoltaic (TPV) conversion with light recycling comprises an inverted Y geometry wherein the inverted “V” portion of the inverted Y geometry comprises the two injection reservoirs 5c that connect to a reaction cell chamber 5b31, and the straight portion of the inverted Y geometry comprises a blackbody radiator or a PV window 5b4. The inverted V portion may further comprise at least one of a glow discharge cell 900 connected to the reaction cell chamber 5b31 with a gas inlet for reactant gases such as H₂ and O₂ gas and a vacuum line 711 connected to a vacuum pump to evacuate the reaction cell chamber. The glow discharge cell may comprise a flange at the top to provide access to at least the discharge electrode for replacement. At least one of the glow discharge cell 900 and vacuum line 711 may be tilted upward to avoid filling with molten metal and may be lined with a liner such as one of the disclosure that avoids formation of an alloy with the molten metal. The glow discharge cell liner may be electrically conductive or comprise a partial liner with a portion of the non-lined cell wall serving as an electrode.

The straight portion PV window may comprise a rectangular cavity with an opening to the reaction cell chamber. Alternatively, the PV window may comprise a flat plate that covers the reaction cell chamber. The plate may comprise a window in a housing that may be sealed with a gasket such as one by Rayotek. The window may be metalized and brazed or welded to the housing. The window may be glued to the housing by a glue such as one of the disclosure. Alternatively, the window may comprise a flat plate that is glued to a flange on top of the reaction cell chamber. The glue may be one of the disclosure. Exemplary glues or adhesives are Cotronics Resbond 907GF, 940HT, 940LE, 940HE, 940SS, 903 HP, 908, or 904 zirconia adhesive, a zirconium oxide coating such as Aremco Ultra-Temp 516 comprising ZrO₂— ZrSiO₄, and Durabond as such as RK454. In an embodiment, at least one flat panel PV denser receiver array is positioned flat and parallel to a rectangular PV window face or the flat plate window to receive the light emission from inside of the PV window cavity or the reaction cell chamber. A gap may separate each dense receiver array from the corresponding PV window face or plate.

The V portion of the inverted Y geometry may comprise a refractory metal such as Mo, Ta, W, Nb, Ti, Cr, and internally coated steel, stainless steel, or a refractory metal. The coating may comprise a high-temperature ceramic paint such as VHT Flameproof paint or similar ceramic paint or a ceramic coating such as Mullite. The PV window may comprise quartz, sapphire, MgF₂, aluminum oxynitride, or other PV window of the disclosure. In an embodiment, the PV window may comprise a heater to preheat it to prevent the molten metal from solidifying. In an exemplary embodiment, the PV window such as a quartz, sapphire, aluminum oxynitride, or MgF₂ PV window may be preheated with heater such as resistive heater, hydrogen-oxygen flame heater, or a plasma recombination reaction heater.

In an embodiment, the dual injectors may be aligned to cause the corresponding injected molten metal streams to intersect. Considering that the bases of the reservoirs, the reservoirs, and the intersecting metal streams form a triangle with the apex at the point of streams intersection, apex angle may be increased by increasing the base length to avoid mutual Lorentzian deflection of the intersecting streams (e.g. the stream trajectories are made more linear with less arc shape).

The V and straight portion may be joined by a seal such as a gasketed seal 26d (FIG. 8C). The gasket may comprise carbon, and the seal 26d may comprise bolted flanges. Alternatively, the seal and union 26d between the inverted V and straight portions may comprise a glue (FIG. 8D). In an embodiment, the high temperature windows such as those by Rayotek (https://rayoteksightwindows.com/products/high-temp-sight-glass-windows.html) may be connected to form a plasma chamber or cavity wherein the windows comprise the PV window for plasma emission to the PV converter with light recycling. The connection may be achieved by welding the edges of the windows to form a polygonal cavity that may be further welded to the reaction cell chamber at a bottom opening of the cavity.

In an inverted Y geometry embodiment, the SunCell® comprises a metal dual injector cell that comprises the inverted V geometry section such as a stainless-steel one (FIGS. 8A-D) wherein all metal surfaces in contact with the molten metal such as those of the EM pump tubes, the reservoirs, and the reaction cell chamber are coated with Flameproof paint to provide electrical isolation. The coating may be achieved by liquid dipping or aerosol application. In an embodiment, electrical isolation of the ignition electrode 8 that supplies power from an ignition power source to the molten metal contained in the reservoir 5c may penetrate the reservoir such as the reservoir baseplate 5kk1 by way of a feedthrough 912. The feedthrough 912 may comprise a metal such as stainless-steel steel such as 347 SS operated less than 400° C., W, or Ta that resists alloy formation with the molten metal. In another embodiment, the feedthrough may comprise copper connected to a metal such as stainless-steel steel such as 347 SS operated less than 400° C., W, or Ta that resists alloy formation with the molten metal wherein the copper may be coated with a ceramic coating such as Flameproof paint or one of the disclosure to protect the copper from alloy formation with the molten metals such as gallium or tin. In an embodiment, the SunCell further comprises at least one ignition feedthrough 912, a heat exchanger, a coolant such as water, a circulating pump, a temperature sensor, a flow meter, a controller, and feedthrough inlet and outlet lines to cool each feedthrough. In an exemplary embodiment, each feedthrough is water cooled.

In an embodiment, the feedthrough 912 (FIGS. 8C-D) may comprise the ignition electrode 8 potted with a potting compound or adhesive capable of binding metals and operating at high temperature such as 300° C. to 2000° C. Exemplary potting adhesives are Cotronics Resbond 907GF, 940HT, 940LE, 940HE, 940SS, 903 HP, 908, or 904 zirconia adhesive, a zirconium oxide coating such as Aremco Ultra-Temp 516 comprising ZrO₂—ZrSiO₄, and Durabond as such as RK454.

In an embodiment, at least one of the ignition electrodes 8 and the EM pump electrodes 5k30 (FIG. 8D) may comprise at least one of electrical feedthroughs, electrodes potted in a potting compound or adhesive such as one of the disclosure, a coated electrode fastened with a Swagelok or similar fastener, and an electrode fastened with a Swagelok or similar fastener and isolated by an insulating ferrule such as a Teflon, graphite, or BN ferrule. The electrode coating may comprise a ceramic coating such as a Flameproof paint coating or an oxide coating. The oxide coat such as tungsten oxide or tantalum oxide may be formed by heating an electrode in air, electrodeposition, sputtering, or by anodizing the electrode. The electrode may not be coated on conduction surfaces that are desired to be electrically conductive such as ones connected to the ignition power supply or the EM pump bus bar 5k2a that connect the EM pump electrode to the source of EM pump electrical power and ones that make contact with the molten metal in the reservoir 5c. The coating may be selectively removed from the conduction surfaces such as the inside of the EM pump tube following application of the coating such as Flameproof paint, or the application of the coating may be avoided on the conductive surfaces by a mask for example. The mask may be one known in the art. The mask may comprise wax that may be removed by melting the wax. The mask may comprise a metal such as tin that may be removed by melting the metal. The mask may comprise a glass or ceramic that may be removed by breaking the mask by means such as mechanically shaking the EM pump tube with added ball bearings inside. The mask may also be broken by at least one step of wetting it and freezing it by means such as immersion in a cryogenic liquid such as liquid nitrogen. In an alternative embodiment, the mask may comprise a water, acid, or base soluble material such as an inorganic compound or metal such as NaCl, CaCO₃ or metal, and metal oxide, respectively, that may be removed by the corresponding solvent. The mask may comprise paper. The mask may comprise a solvent-soluble tape such as a water-soluble tape to mask the EM pump bus bars for coating the inside of the EM pump tube. The paper or water-soluble tape may be removed following coating the inner surfaces of the EM pump tube by methods such as mechanical or pneumatic removal, dissolving the paper with acid such as HCl, dissolving the water-soluble tape with water, or oxidizing the paper or tape to CO₂. An exemplary combustion method is to add a flammable liquid such as lighter fluid and apply an ignition spark or flame. In an embodiment, any undesired tungsten oxide that forms on surfaces that are desired to be conductive such as electrode surfaces that are desired to be in contact with the molten metal may be removed by strong base such as heated saturated alkali hydroxide such as NaOH.

In an embodiment, the electrically insulating coating that is further resistant to alloy formation with the molten metal comprises a paint such a Flameproof paint. In steps involving heating the paint to cure it, the reaction cell chamber may be closed or sealed and heated under vacuum or an inert atmosphere to avoid oxidation of the EM bus bar electrodes such as ones that are masked to avoid being coated with the paint. The paint may be dispersed by ultrasound, pressure, vapor or aerosolization with electrostatic deposition, and other methods known by those skilled in the art of applying a full coverage to molten-metal-exposed surfaces.

In an embodiment, the EM pump tube may comprise feedthrough collars to which the feedthroughs are welded. The EM pump tube may be coated with a coating such a Flameproof paint before the feedthroughs are welded to the pump tube. A gap between the center electrode of a feedthrough and its weldable housing may be at least one of coated with a coating such as alumina, an aluminizing coating, a thermo-chemical aluminizing coating, Flameproof paint and potted with a ceramic such as Cotronics Resbond 940 HT, Cotronics Resbond 940SS, Sauereisen Electrotemp Cement such as https://www.sauereisen.com/wp-content/uploads/8.pdf or https://www.sauereisen.com/ceramic-assembly/product-index/, or another ceramic of the disclosure wherein surfaces that may be in contact with the molten metal inside the EM pump tube may be coated with at least one of Flameproof paint and the potting material as well.

In an embodiment, the electrodes such as the ignition electrode and the EM pump bus bars may be coated to prevent oxidation during exposure to air such as in the case of loading the cell with molten metal. The coating may be at least one of electrically conductive, resistant to oxidation at the melting temperature of the molten metal, and removable. The coating may comprise a carbide such as tungsten carbide that serves as an oxidation resistant, conductive coating. The tungsten carbide coating may be applied by the HVOF process (https://www.asbindustries.com/tungsten-carbide-coatings) or another method known in the art. The coating may comprise a metal such as the molten metal such as tin that may be removed by melting. The metal such as nickel, copper, zinc, or silver may form an alloy with the molten metal to be removed. The metal coating may be applied by dipping in the metal melt, electroplating, vapor deposition, and other coating processes known in the art.

In an embodiment, at least one of the inlet risers, injection EM pump tubes, reservoir or reservoirs, and reaction cell chamber may comprise an electrical insulator or be coated or lined with an electrical insulator such as one of the disclosure to prevent shorting between dual reservoirs, injectors, and ignition power sources. Exemplary embodiments comprise at least one of (i) internally and externally Flameproof painted inlet risers and injection EM pump tubes, (ii) W inlet risers and injection EM pump tubes that are oxidized to form an electrical insulating tungsten oxide coat, and (iii) at least one of the reaction cell chamber 5b31 and reservoir or reservoirs 5c comprising a tungsten liner that comprises an electrically insulating tungsten oxide coat.

An exemplary coated electrode is an oxidized tungsten electrode with conductive surfaces on the ends wherein the tungsten electrode is oxidized in air at high temperature with a mask on the ends that is removed when desired. Alternatively, the entire electrode is oxidized, and the oxidized layer is removed from the electrodes by etching or by mechanical abrasion. The abrasion may be performed mechanically. In another embodiment, the electrode such as an electrode with an insulating coat may be fastened with ferrules that at least one of form an insulating oxide coat and are soft such that they do not damage the electrically insulating coat on the electrode such as a ceramic one or an oxide one such as a W or Ta coat. Exemplary ferrules comprise brass, aluminum, copper, silver and tantalum. An exemplary oxide coated ferrule is anodized aluminum one. Another exemplary oxide coated ferrule is oxidized stainless steel.

In alternative embodiments of a means to electrically isolate the ignition electrodes of a SunCell comprising dual injectors: (i) at least one reservoir may comprise an isolation joint such as such as flanged joint comprising an insulating gasket and isolated bolts such as ceramic bolts or bolts comprising insulating bushings and (ii) at least one of the reaction cell chamber and at least one reservoir comprises an electrical insulating wall section (an isolator, or electrical break) such as a ceramic one such as a ceramic of the disclosure such as alumina, SiC, BN, or quartz that electrically isolates the two reservoirs from each other wherein (a) the reservoir isolator may comprise a ceramic tube with a flange on each end that mates two reservoir sections or mates to a reservoir section and the reaction cell chamber such as a flanged electrical isolator or electrical break such as the exemplary CF Flanged Vacuum Ceramic Break, https://www.lesker.com/newweb/feedthroughs/ceramicbreaks_vacuum.cfm?pgid=cf further comprising at least one of gaskets to mate to matching flanges of the reservoir and a liner such as a ceramic liner such as one of the disclosure that may at least one of protect the gaskets and the electrical break from alloy formation with the molten metal and thermal shock, respectively, (b) the reservoir isolator may comprise a ceramic tube with a weldable metal ring on each end such as a Kovar or Invar ring to mate the two reservoir sections or a reservoir section and the reaction cell chamber by welding such as an exemplary Weldable Vacuum Ceramic Break, https://www.lesker.com/newweb/feedthroughs/ceramicbreaks_vacuum.cfm?pgid=weld, and (c) the reservoir isolator may comprise a ceramic tube with a wet seal on each end that mates to two reservoir sections or mates to a reservoir section and the reaction cell chamber. In an embodiment, the electrical break comprises a ceramic cylinder such as an alumina cylinder that is plated first with Mo—Mn alloy and then Ni that is brazed to Kovar that is plated with Ni. The braze may have a high melting point such a greater than 600° C. Exemplary brazes are Cu(72)-Ag(28) alloy, copper, ABA, gold ABA, PdNiAu alloy (AMS 4785 M.P.=1135° C.) or Paloro or a similar braze such as one at the link: https://www.morganbrazealloys.com/en-gb/products/brazing-alloys/precious-brazing-filler-metals/.

In an embodiment, both reservoirs of the dual injector SunCell shown in FIGS. 8C-8L comprise an electrical break that at least one of (i) isolates the ignition voltage of one reservoir from that of the other until the molten metal streams injected from each reservoir intersect and at least partially isolates the EM pump power supply of one reservoir from that of the other and (ii) may also at least partially isolate the ignition power supply from the EM pump power supplies. In another embodiment, at least two power supplies of the ignition power supply, the EM pump power supply of a first reservoir, and the EM pump power supply of the second reservoir has a capability of operating about autonomously of at least one other power supply. Each power supply may be one known in the art or one modified with voltage and current fluctuation suppressant reactance to negate fast voltage and current ignition transients to allow about independent power supply operation. Exemplary suppressant reactance comprises at least one capacitor bank in parallel or at least one inductor in series with the EM pump power supply.

In an embodiment, the reservoir comprising an electrical break may be sufficiently long to remove the electrical break sufficiently far from the reaction cell chamber that it does not overheat. In an embodiment, the electrical break may comprise at least one inner liner comprising a thermal insulator such that the break can be maintained below its failure temperature while the molten metal temperature inside of the liner may be higher. The electrical break may be coated with at least one coating such as CrC, alumina, TiN, WC, or another of the disclosure to avoid at least one of oxidation such as on the outside and alloy formation such as on the inside. The metal to ceramic union braze of the electrical break may be covered with potting material such as Resbond 940SS or another of the disclosure. In an exemplary embodiment, the molten metal comprises silver and the liner comprises at least one refractory material such as carbon, BN, quartz, alumina, moldable or castable ceramic, ceramic beads such as alumina beads that may further comprise a binder such as Resbond, a refractory metal, and other liners of the disclosure. The liner may fill the reservoir except for channels for the EM pump inlet and outlet. The height of the electrical break and liner may be minimized to allow for thermal conduction through the channels to maintain molten metal across the break and liner. In an embodiment, the electrical break may be externally cooled. The EM pump tube brace may comprise the electrical break liner of the disclosure.

In embodiment comprising an electrical isolator to electrically isolate the ignition electrodes of a SunCell comprising dual injectors, at least one reservoir may comprise an electrical break comprising a ceramic reservoir wall section that may further comprise a ceramic-metal union on each end to mate to the reservoir wall at each end. In an embodiment, the reservoir molten metal level is a desired level below the top of the ceramic portion of the isolator on the reaction cell chamber side. In an exemplary embodiment, the reservoir molten metal level is a desired level below the top of the ceramic-metal union of the electrical break on the reaction cell chamber side. The height of the inlet riser inlet may be adjusted to match to the desired level to control the maximum molten metal level at the desired level. The electric break may comprise an internal thermal insulation puck with a hole for molten to flow to at least one of a molten metal reservoir or a lower portion of the molten metal reservoir, an inlet riser to the EM pump tube, and an ignition bus bar on the EM pump side of the puck. An injection EM pump and electrode may penetrate through the insulation puck to the reaction cell chamber side to inject molten metal to a counter electrode.

In an embodiment, the rate of molten metal inflow to the inlet riser is faster than the rate of molten metal injection by the nozzle. At least one of the sizes of the inlet riser opening and the injection nozzle may be selected to achieve the desired greater flow rate at the former over that at the latter.

In an embodiment, each reservoir may comprise a drain plug to allow for the gravity-facilitated removal of molten metal from the bottom of the reservoirs during serving and maintenance. In an embodiment, the inlet riser may comprise a strainer such as a metal screen to protect the EM pump and nozzle form being blocked by debris flowing into the inlet riser.

The reservoir on the EM pump side of the electrical break may be increased in length to increase the reservoir molten metal inventory. The length of the reservoir may be increased on the reaction cell chamber side of the break to move the electrical break further from the plasma to lower its operating temperature. In another embodiment, the electrical break may be capable of high temperature such as one between 450° C. and 1500° C. wherein the braze of the break is selected to have a melting point above the operating temperature. An exemplary high temperature electrical break comprises at least one of Kovar and niobium and a compatible high-temperature braze such as Paloro-3V, a similar braze such as one at the link: https://www.morganbrazealloys.com/en-gb/products/brazing-alloys/precious-brazing-filler-metals/, or another of the disclosure.

The electrical break may comprise a ceramic (e.g. 97% alumina), a weld adapter flange circumferential about the ceramic insulator such as one comprising Cu/Ni (e.g. 70%-30%) or Fe/Ni (e.g. 50%-50%), and a Conflat flange (e.g. 304 stainless-steel) brazed or welded circumferentially to the weld adapter flange. The electrical break may further comprise a bellows or S-flange (diaphragm) between the CF flange and the weld adapter flange.

The maximum molten metal inventory of the two reservoirs 5c is such that maximum molten level in the electrical break side comprising the initial filled volume and the volume of the molten metal above the lowest height of the inlet riser of the reservoir opposite the electrical break reservoir does not exceed the height of the ceramic of the electrical break.

In an exemplary embodiment having a reservoir electrical break, an unoxidized inner-most W liner may be used with a middle carbon liner, and outer W liner or cladding in the reaction cell chamber. The liner may cover at least one of the reaction cell chamber 5b31 walls, the floor of the reaction cell chamber, and the reservoirs 5c. The reaction cell. chamber floor liner 5b31b may comprise conduits or groves to channel the molten metal away from the corresponding injected molten metal stream when flowing from the injector 5k61 back to the reservoir 5c. In an exemplary embodiment, each reservoir injector 5k61 is located away for the center of the reaction cell chamber in its reservoir and the grooves of the floor liner 5b31b direct molten metal return flow to the sides of the reservoir, and alternatively, the center-facing side of the reservoir. In another embodiment, the injectors 5k61 extend above the top of the reservoirs and reaction cell chamber floor liner 5b31b such that the returning molten metal streams cannot interfere with the injected streams.

In an embodiment, at least a portion of the EM pump tube such as that comprising the EM bus bars is electrically isolated as an electrical path through the wall of the corresponding reservoir by electrical breaks on the inlet and outlet portions of the EM pump tube 5k6 wherein at least the surfaces not isolated by the electrical break may comprise an electrical insulating coating such as Flameproof paint. The electrical break may comprise the gas line type such as MPF Products Inc.; Product No: A0573-2-W https://mpfpi.com/shop/uhv-breaks/10kv-uhv-breaks/a0573-1-w/. In an embodiment, at least one pair of EM bus bar electrodes may be fastened and sealed to the EM pump tube by a compression fitting such as one by Swagelok.

In an embodiment, the EM pump of at least one reservoir comprises a single electrical break comprising a divider or separator to form two channels, one serving as at least a portion of the inlet EM pump tube and one as at least a portion of the injector EM pump tube. The separator may comprise an electrical insulator such as a ceramic or metal coated with an electrical insulator. The separator may be connected to a structure such as the reservoir or a portion of the EM pump tube on one side of the electric break only. The attachment may comprise an extension of the injector EM pump tube. Exemplary separators comprise a ceramic such as alumina bonded to the ceramic of the electrical break and a metal extension of injector EM pump tube that is coated with an electrical insulator such as Flameproof paint.

In an embodiment, the electrical isolation of the two reservoirs is not 100%, but is sufficient such that the parasitic shorting current between the dual reservoir electrodes is tolerable such as less than 25% of the total current supplied to the ignition electrodes 8 wherein the parasitic current is determined by the relative resistance of the parasitic path to the ignition current path. The relative resistance may be predominantly determined by the resistance of the electrode penetrations into the EM pump tube and the reservoir as well as the integrity of the coating or liner on the inner surfaces of the EM pump, reservoir, and reaction cell chamber.

The top of the inverted V geometry section may comprise the reaction cell chamber 5b31. A PV window cavity 5b4 comprising the straight section such as a cubic, rectangular, polygonal, or hemispherical cavity may be attached to the top of the reaction cell chamber 5b31 by flanges 26d on the top of the reaction cell chamber and the PV window. The flange joint 26d (FIG. 8C) may be sealed by a gasket such as a vermiculite, graphite, ceramic, tin electroplated vermiculate, or other high temperature, high vacuum capable gasket. The flanges and gasket may be sealed with bolts or clamps. In an embodiment shown in FIG. 8D, the gasket is replaced by a high-temperature capable adhesive such as Resbond 907GF, 940HT, 940LE, 940HE, 940SS, 903 HP, 908, or 904 zirconia adhesive, a zirconium oxide coating such as Aremco Ultra-Temp 516 comprising ZrO₂— ZrSiO₄, or Durabond as such as RK454. In an embodiment, the reaction cell chamber flange 26d may comprise a ceramic coated metal such as an aluminosilicate coated stainless steel flange, or the flange of the union may be uncoated.

In an embodiment, the adhesive may comprise a plurality of adhesives such as one specialized for metal that is coated on the metal flange and one that is specialized for and coated on the quartz or ceramic of the PV window flange. An exemplary adhesive union comprises Durabond 954 on the stainless steel or Ta flange and Resbond on the quartz flange of the PV window wherein the two adhesives bond to form the adhesive union 26d. In an alternative embodiment, the joint portion of the PV window such as the flange is metalized by means known in the art, and the metalized joint is brazed, welded, or glued to the matching flange of the reaction cell chamber.

In an exemplary embodiment, the PV window comprises quartz tube with one end closed and the other end open such as the quartz cavity by MTI (https://www.mtixtl.com/EQ-OTGE214.aspx). Rather than possessing a flange, the open end of the cavity may comprise a straight wall (e.g., in the case of a cylindrical cavity) or straight walls that insert in a recessed or counter bored groove in the reaction cell chamber flange 26d. Alternatively, the PV window wall or walls may fit tightly inside or outside of the reaction cell chamber flange to form the joint. The PV window 5b4 may be sealed to the reaction cell chamber flange 26d with a glue or adhesive such as at least one of Resbond 940LE, 940HT, and Resbond 904 or another of the disclosure.

The metal may have a low coefficient of thermal expansion or comprise expansion joist, cavities, holes, or other cavity structures to prevent the bonded surface of the glued union form expansion excessively to avoid seal failure. The inverted V-side flange may comprise Invar, Kovar, super or other SS weldable metal or W, Mo, or Ta or alloys that has a low coefficient of thermal expansion. A Ta flange may be diffusion bonded to SS using a pure Ni, Fe, or Cu insert. The Ta flange may have an extension such as a cylinder that is bonded to the dual molten metal reservoir-injectors such as ones comprising stainless steel to comprise at least part of the reaction cell chamber 5b31.

In an embodiment, the reaction cell chamber may comprise a thermal insulation insert internal to the flanged joint to lower the operating temperature of the joint. The insulation may comprise quartz, a ceramic such as SiC or BN, graphite, or pyrolytic graphite. The graphite, pyrolytic graphite, or BN may be coated with a ceramic coating such as Flameproof paint, or Resbond 907GF, 940HT, 940LE, 940HE, 940SS, 903 HP, 908, or 904 zirconia adhesive, or a zirconium oxide coating such as Aremco Ultra-Temp 516 comprising ZrO₂—ZrSiO₄. The reaction cell chamber may comprise a liner such as one comprising graphite, pyrolytic graphite, or BN. The liner may be coated with a ceramic coating such as Flameproof paint, or Resbond 907GF, 940HT, 940LE, 940HE, 940SS, 903 HP, 908, or 904 zirconia adhesive, or a zirconium oxide coating such as Aremco Ultra-Temp 516 comprising ZrO₂— ZrSiO₄. The liner may further comprise the joint insulation. In an embodiment, the flange joint than comprise the top of the liner such as a carbon liner glued or gasket sealed to the PV window flange wherein the liner may be glued to the top of the reaction cell chamber to make a vacuum-tight seal. The glue may comprise one or more of the glues or adhesives of the disclosure or another suitable one known in the art.

In an embodiment, the graphite liner comprises at least one electrical insulating break to prevent shorting between injector electrodes. The breaks may comprise transverse sections of the liner bonded together with high temperature capable, electrically insulating adhesive such as a ceramic one such as Resbond. In an embodiment, the electrically insulating adhesive may be replaced by electrically insulating washers such as ones comprising quartz or a ceramic such as silica-alumina fiber insulation, BN, SiC, carbon, Mullite, quartz, fused silica, alumina, zirconia, hafnia, others of the disclosure, and ones known to those skilled in the art. The liner may be coated with a ceramic coating such as one of the disclosure to prevent electrical shorting. The carbon liner may be further bonded to the reservoirs and the reaction cell chamber with an electrically insulating adhesive to prevent molten metal from flowing behind the liner and electrically shorting the two injector electrodes.

In a further embodiment, the joint may comprise a heat exchanger such as a water-cooling loop to cool the joint to lower its operating temperature. The coolant may be cooled by second heat exchanger. The coolant may be recirculated by a pump. The lower operating temperature may decrease any difference in thermal expansion of the mating flanges of the joint between the reaction cell chamber and the PV window that may cause the joint to fail.

In an embodiment, the PV window inserts into a counter bored receptacle in top of the reaction cell chamber to form a barrier for the flow of molten metal from the reaction cell chamber. The receptacle may be part of the reaction cell chamber flange. In an exemplary embodiment, the receptacle may be a tongue and groove type, or inverted step type. The inner portion of the PV window may overlap the inner portion of the reaction cell chamber flange. The receptacle may be sealed by a packing such as a graphite packing or an adhesive such as one of the disclosure.

In an embodiment, the PV window comprises a high temperature (e.g. 1200° C.-2000° C.) sight glass window such as one by Rayotek (https://rayoteksightwindows.com/products/high-temp-sight-glass-windows.html#prettyPhoto). A flat Rayotek window may be modified to an annulus of the window material such as a quartz or sapphire annulus mounted in its housing. A PV window chamber such as a quartz or sapphire one may be fused or glued to the annulus of matching material. The window may comprise plates welded into a cubic or rectangular open-ended cavity that is joined to the top of the reaction cell chamber at the open-end. The metal surfaces of each window housing may be coated with at least one of ceramic, quartz, carbon, or a coating such as ceramic coating such as one of the disclosure. In another embodiment, the window may comprise a cavity of similar design as a Rayotek window such as a rectangular or ceramic cavity such as one shown in FIG. 8C wherein the housing is welded to the top of the reaction cell chamber. The window may be jointed to the top of the reaction cell chamber by a weld, glue, or flanged joint.

In an embodiment, the PV window comprises a means such as a mirror such as a dichroic mirror or filter to reflect light of wavelengths that have significantly higher energy than the band gap to the PV cells of the PV converter 26a. In an embodiment, the reflected light has energy in at least one range of about 10%-1000% higher, 10%-500% higher, and 10%-100% higher. In another embodiment, at least one of the reaction cell chamber and the PV window may comprise a means to down convert the energy of the light such as a phosphor.

The joint and PV window may be contained in a vacuum-tight housing comprising a window chamber such as a vacuum chamber that further houses the PV converter. The housing may be fastened to the top of the reaction cell chamber by a faster or joint. The fastener or joint may comprise a weld. The housing may have penetrations for a vacuum line to a vacuum pump and for the electrical lines and cooling lines of the PV converter. About equal pressure may be maintained on both sides of the window (vent) by controlling the vacuum pumps of the window chamber and the reaction cell chamber. In an embodiment, an overpressure may be maintained in the window chamber relative to the reaction cell chamber to cause the widow to be held against the top of the reaction cell chamber on a window seat or flange. Alternatively, the window and the reaction cell chamber vacuum lines may be joined and then connected to a single vacuum pump. In another embodiment, the window seal may be leaky to allow the pressure to equilibrate on both sides of the window. The vacuum-tight housing may comprise a vacuum sealable opening such as a flanged port, gate valve, or door. In a further embodiment, the window and the reaction cell chambers may comprise a tube such as a gas line that connects the two chambers such that the gas pressure may dynamically equalize between the two connected chambers.

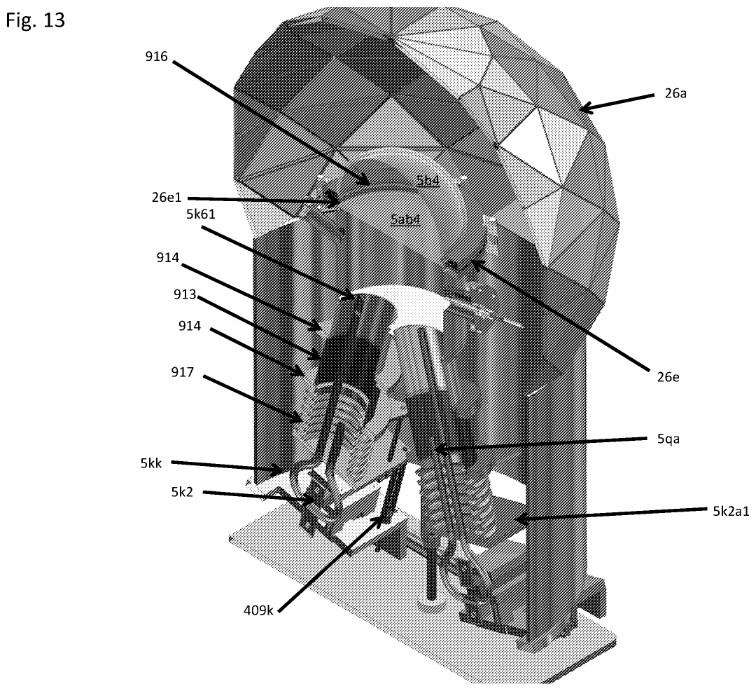

In an embodiment shown in FIGS. 8F-8L and 13, the SunCell comprises dual molten metal injectors 5k61 each in a reservoir 5c wherein each serves as an ignition a current carrying electrode. In an embodiment, at least one of the dual molten metal injectors 5k61 may comprise a plurality of at least one of injectors 5k61 or nozzles 5q per corresponding reservoir 5c. At least one dual molten metal injector 5k61 in a reservoir 5c may further comprise an electrical break 913 that may comprise a thermally insulating liner and electrical break flanges 914. The SunCell may further comprise reservoir flanges 915. The dual molten metal injector 5k61 each in a reservoir 5c may further comprise an EM pump tube assembly 5kk, EM pump tube 5k6, EM bus bars 5k2, EM pump magnets 5k4, and an inlet riser 5qa. The SunCell may further comprise a vacuum line 711 connected to a vacuum pump, that may comprise a screen or filter to remove at least one of molten metal such as tin, gallium, or silver, and the corresponding oxides. To clean the vacuum line screen of adhered material such as at least one of metal oxide and metal, the vacuum line 711 may comprises a gas jet back flush such as at least one gas nozzle on the pump side of a vacuum screen to apply a pulsed gas jet such as argon gas jet through the screen to blow the adhered material back towards the reaction cell chamber 5b31.

The SunCell may further comprise a discharge cell 901, reaction cell chamber 5b31, top flanges 26e that may comprise a solid plate or inner PV window flanges, a PV window chamber 916, an inner PV window 5ab4, a seat for the inner PV window 26e1, and an outer PV window 5b4. The inner PV window 5ab4 may be semi-sealed (e.g., tight to molten metal, but not necessarily tight to vacuum) wherein a vacuum seal is provided by the PV window flange 26d, the inner PV window flange 26e, the vacuum-tight housing or chamber 916 that houses the semi-sealed window 5ab4 that is joined to a support 26e 1 on top of the reaction cell chamber 5b31. In an exemplary embodiment, the window 5ab4 may comprise a Rayotek window comprising a gasket seal to its housing that is not vacuum tight. Alternatively, the exemplary window 5ab4 may comprise flat plate or cavity window clamped, glued, or fixed by a gasketed joint or union to a support on the top of the reaction cell chamber 5b31 such as to an inner PV window flange support 26e 1. Exemplary clamps are C-clamps between the support 26e 1 and the window 5ab4. The inner PV window 5ab4 may be connected to the inner PV window flange support 26e 1 at a counter sunk fixture. At least one of the electrical break flanges 914, the reservoir flanges 915, the inner PV window flanges 26e, and the PV window flanges 26d may provide access to the interior of at least one of the reservoirs 5c, reaction cell chamber 5b31, and inner PV window 5ab4.

In an embodiment shown in FIGS. 8J-8L and 13, the outer PV window 5b4 may comprise a PV window flange 26d that is sealed with a gasket and fasteners 26d 1. In an exemplary embodiment, the PV window comprises fused silica, quartz, sapphire, or aluminum oxynitride in the form of a half dome with a precision milled or lapped flange of the same material as the window wherein the window may be sealed with a Graphoil, vermiculite, or ceramic fiber gasket, a metal ring on top of the flange, and clamps 26dl. The PV window dome 5b4 may further be sealed with an adhesive such as Resbond 940SS.

In an embodiment, the PV seal comprises a structure bound to the window seat and an adhesive that bonds to the seat, the structure, and the PV window. In an embodiment, the flange on which the PV window is attached comprises a faster or anchoring structure comprising protrusions such as metal screws, rods, or mesh that is embedded in an adhesive such as Resbond 940SS or another of the disclosure, wherein the adhesive further bonds the PV window to the faster or anchoring structure and seat. In an exemplary embodiment, the faster or anchoring structure comprises stainless steel mesh or screen welded to the seat for the inner PV window 26e 1 wherein Resbond 940SS, Resbond 903HP, or Resbond 908HP encases the mesh or screen and seals to the seat, and further bonds to the inner PV window 5ab4 such as a fuse silica window or another one of the disclosure.

In an embodiment having tin as the molten metal, the SunCell comprises a means to prevent at least one of the PV windows 5b4 and 5ab4 (FIG. 8F-8L) from being opacified by at least one of tin metal and tin oxide. In an embodiment, the PV window comprises a means such as a window temperature controller to maintain the PV window temperature above the melting point of at least one of tin (MP 232° C.) and tin oxide such as SnO (MP 1080° C.) and SnO₂ (MP 1630° C.). The window temperature controller may comprise at least one of a heater or chiller, a temperature sensor, and a controller to maintain a desired PV window temperature such as one in at least one range of 200° C. to 2500° C., 232° C. to 2000° C., 232° C. to 1800° C., and 232° C. to 1650° C. The heater or chiller may comprise a stream of heated or cooled air applied to the window. In the latter case, the PV window may be heated by the hydrino plasma. In another embodiment, the PV window may be cleaned of tin oxide by hydrogen reduction. The reducing hydrogen reactant may comprise hydrogen gas flowed into the reaction cell chamber wherein the hydrogen pressure is controlled using the hydrogen source, flow controller, pressure and flow gauges, lines, and computer to achieve the reduction. At least one of the hydrogen pressure and PV window temperature may be controlled to provide conditions that are thermodynamically favorable for the reduction of tin oxide by hydrogen. The hydrogen pressure may be in the range of 1 milliTorr to 10 atm. The PV window temperature may be in at least one range of 100° C. to 2500° C., 232° C. to 2000° C., 232° C. to 1800° C., and 232° C. to 1650° C. The hydrogen reaction may occur intermittently at a different hydrogen pressure than on desired to optimize the hydrino reaction rate. The PV window may be cleaned by the hydrino reaction plasma. The PV window may be cleaned by injection of molten tin onto the window surface. The injection may be by the injector EM pumps or independent EM pumps. The EM pump or pumps that clears the window may comprise a raster injector having a raster mechanism that scans the injection over the window surface. The raster mechanism may comprise an actuator such as a mechanical, electromagnetic, screw jack, stepper motor, linear motor, thermal, electric, pneumatic, hydraulic, magnetic, solenoidal, piezoelectric, shape memory polymer, photopolymer or other actuator known in the art to move or rotate the direction of the injected molten metal stream. In another embodiment, the window may comprise at least one of a coating that resists tin oxide adherence such as a carbon coating, a spinning window, a mechanical scraper, and a gas jet such as ones of the disclosure.

In an exemplary embodiment, the PV window such as at least one of 5ab4 and 5b4 is cleaned by injecting molten metal onto the inner surface from at least one nozzle with a plurality of ejection apertures or orifices such as one to inject tin to an opposing stream and another to inject tin onto the PV window to clean it of debris such as metal oxide and metal. The molten metal injected onto the window may further provide additional cooling, and, in some embodiments, may prevent or decrease structural deformations of the window associated with overheating (e.g., warping, cracking, decreases in transparency) or undergoing any structural deformations associated with overheating (e.g., warping, cracking). In an embodiment, the window maintains a steady state temperature due to radiative heat loss at its operating blackbody temperature that balances the optical power and thermal power that is absorbs to heat it.

In an embodiment, the size of each nozzle aperture is selected such that the ejection flow rate avoids EM pump cavitation that can cause instabilities or failure to pump. The aperture diameter may be selected to provide some back pressure to prevent the pumping cavitation or instabilities. In an embodiment, the injected molten metal stream velocity may be high such that the intersection of the streams causes molten metal to splatter onto the PV window to at least one of clean and cool it.

In an embodiment, each EM injector tube 5k61 comprises a structural supporting brace to the corresponding reservoir wall at a position below the electrical break of the reservoir comprising an electrical break, and the brace position is discretionary within the non-electrical break reservoir. In an exemplary embodiment, the brace may comprise a block of ceramic insulation such as BN or Macor ceramic with penetrations for the EM pump inlet and EM injector tube 5k61. Alternatively, the brace may comprise a plurality of bolts threaded through the reservoir wall whose lengths may be individually adjusted to brace the EM injector tube 5k61 into a desired position such as one that achieves the intersection of the two molten metal streams to cause plasma ignition.

In an embodiment, the SunCell® such as one comprising dual molten metal injectors comprises an injector alignment mechanism or aligner such as an actuator such as a mechanical, electromagnetic, screw jack, stepper motor, linear motor, thermal, electric, pneumatic, hydraulic, magnetic, solenoidal, piezoelectric, shape memory polymer, photopolymer or other actuator known in the art to move or rotate at least one of the nozzle 5q, the injector 5k61, reservoir 5c, break reservoir EM pump assembly 914a (FIG. 8G), and the EM pump assembly 5kk. The aligner may cause the corresponding molten metal stream injected from the aligned nozzle to change to a desired direction to achieve alignment with the opposing stream injected by the opposing injector resulting in intersection of the molten metal streams. The aligner may comprise a sensor such as an ignition current or voltage sensor and a controller such as a computer to automatically align the aligned injector to maintain the stream intersection. The aligner may comprise a mechanical linkage such as a gear system to rotate the nozzle 5q to achieve alignment wherein the nozzle may comprise a non-symmetrical aperture. The aligner may comprise at least one mechanical push-pull rod connected to the injector 5k61 or nozzle 5q that mechanically moves the injector 5k61 or nozzle 5q. The rod may penetrate the reservoir 5c through a conduit to a drive mechanism wherein at least one of the conduit and drive is hermetically sealed. The drive mechanism may comprise at least one of a threaded rod collar and a means to rotate the rod, and a pneumatic, hydraulic, and piezoelectric actuator or other actuator of the disclosure to push or pull the rod.

In another embodiment of SunCell comprising dual molten metal injectors, the EM pump assembly 5kk may be mounted to a slide table 409c (FIGS. 8B-8L and 13) with supports 409k to mount and align the corresponding slanted EM pump assemblies 5kk and reservoirs 5c. The SunCell supports 409k, may comprise turnbuckles that are adjustable to any height and may lock with locknuts. The supports 409k may be electrically isolated from the slide table 409c by electrical isolators such as ceramic washers. The washers may be at the base of the supports 409k. The SunCell may comprise an electrical break 913 (FIGS. 8G-8L and 13) that electrically isolates the break EM pump assembly 914a from the reaction cell chamber 5b31, reservoir section above the break, the opposing reservoir 5c, and the reservoir EM pump assembly 915a. At least one of the reaction cell chamber 5b31, reservoir section above the break, the opposing reservoir 5c, and the reservoir EM pump assembly 915a may be at least one of further supported and rigidly attached to the slide table 409c independently of the support of the break EM pump assembly 914a. An exemplary rigid support on each side of the reaction cell chamber is reaction cell chamber support 918 shown in FIGS. 8H-8L and 13. In an embodiment, the support 918 may comprise a pressure controller such as a deformable bushing or spring 922 at the base 409c end to maintain a desired support pressure as the SunCell components contract and expand. The reservoir comprising the electrical break 913 may further comprise a flexible reservoir section such as a welded-in or flange-connected bellows 917 (e.g. such as https://www.mcmaster.com/bellows/expansion-joints-with-butt-weld-ends/https://www.mcmaster.com/bellows/expansion-joints-with-butt-weld-ends/or https://www.mcmaster.com/bellows/high-temperature-all-metal-expansion-joints-with-flanged-ends/) or a braided hose (e.g. https://www.mcmaster.com/bellows/extreme-temperature-air-and-steam-hose-with-male-threaded-fittings/). The flexible section may comprise a material such as tantalum or be coated with a coating such as a Flameproof paint, chrome, chromium carbide, alumina, tantalum, TiN, or another coating of the disclosure that protects the flexible section such as a bellows from alloy formation with the molten metal. The flexible section may comprise a liner such as a thermal insulator such as one comprising BN, Macor, quartz, alumina, zirconia, or another of the disclosure to protect the flexible section from overheating. The liner may be sectional, segmented, or loose fitting to permit flexibility. The flexible section 917 may be connected above or below the electrical break 913. The aligner may comprise at least one tilt system to selectively tilt the cylindrical axis of the bellows by compression of one side and extension of the opposite side of the flexible section. The tilt system may comprise a means to extend or contract the length of the supports 409k of the break EM pump assembly 914a to cause the corresponding injector EM pump tube 5k61 and nozzle 5q to change its direction. In an embodiment, the tilt system comprises a plurality of length-adjustable supports 409k to permit the alignment to occur in a plurality of azimuthal as well as vertical directions. The tilt system of the aligner may comprise an actuator such as a mechanical, screw jack, stepper motor, linear motor, thermal, electric, pneumatic, hydraulic, magnetic, solenoidal, piezoelectric actuator, shape memory polymer, photopolymer or other actuator known in the art to adjust the length of the supports 409k. In an exemplary embodiment, the aligner comprises (i) a bellows such as one butt-end-welded to the break 913 or a break flange 914 on one end and butt-end-welded to the reservoir 5c on the other end, (ii) four turnbuckle supports 409k electrically isolated from the slide table 409c by ceramic washers at their bases, and (iii) a mechanical means to rotate each turnbuckle to cause the nozzle position adjustment by adjusting the length of the turnbuckles wherein the reaction cell chamber 5b31 and reservoir 5c without the electrical break are rigidly supported to allow independent motion of the break EM pump assembly 914a. An exemplary rigid support is reaction cell chamber support 918 shown in FIGS. 8H-8L and 13. The mechanical means to rotate each turnbuckle may comprise a fixed gear on each turnbuckle, each with a mating gear and a motor such as a servomotor to rotate the mating gear to cause a length change of the turnbuckle. The rotation may be controlled by a computer that receives ignition current and voltage data from corresponding sensors. Alternatively, the aligner comprises a tilt system comprising at least one actuator such as one of the disclosure to change the length of one or more of the supports 409k to cause the alignment.

In another embodiment, the aligner comprises a flexible section such as a bellows in the reservoir 5c between the reaction cell chamber 5b31 and the reservoir EM pump assembly 915a and a tilt system to selectively tilt the cylindrical axis of the bellows by compression of one side an extension of the opposite side of the bellows wherein at least the reaction cell chamber 5b31, the reservoir section 5c above the bellows, the opposing reservoir 5c, and the break EM pump assembly 914a may be at least one of further supported and rigidly attached to the slide table 409c to permit independent motion of the reservoir EM pump assembly 915a below the bellows. An exemplary rigid support is reaction cell chamber support 918 shown in FIGS. 8H-8L and 13. The tilt system may comprise at least one support 409k capable of adjustable length to tilt the bellows to cause the alignment. An exemplary tilt system is an actuator such as one of the disclosure to cause the length adjustment to achieve the alignment.

In alternative embodiment, the aligner comprises the flexible section such as a bellows 917 and a contraction tilt system wherein the tilt of the bellows by the tilt system is achieved by contraction of one side of the bellows rather than compression and lengthening of the opposite side of the bellows. An exemplary contraction tilt system shown in FIGS. 8H-8L and 13 comprises a flexible section such as a bellows 917 and a contraction or clamping device that may span the bellows 917 along its cylindrical axis and fastened to the bellows at opposite ends. An exemplary contraction tilt system comprises a frame 920 at the electrical break end of the bellows and a moveable frame 920a at the opposite end, and a plurality of contraction elements such as screws 921 that span the frames wherein the contraction or shortening of a screw 921 causes the bellows to contract or shorten on the side of the shortened screw and lengthen on the opposite side with the lengthening of the corresponding screws 921. The contraction element may comprise an actuator such as one of the disclosure. The actuator may be attached on the outside of the bellows wherein the inside may serve as a section of the corresponding reservoir 5c.

In an embodiment, the aligner comprises a flexible section of the injector EM pump tube 5k61 such as a bellows and a system to tilt the injector EM pump tube 5k61. The tilt system may comprise a linkage such as a mechanical linkage and a system to move the linkage such as a mechanical, screw jack, stepper motor, linear motor, thermal, electric, pneumatic, hydraulic, magnetic, solenoidal, piezoelectric actuator, shape memory polymer, photopolymer or other actuator known in the art to move the linkage.

In an embodiment, at least one of the reservoir, electrical break, and bellows may comprise a magnetic material such as one having a high Curie temperature such as steel (Curie Temperature 770° C.). The magnetic material such as steel may serve as a magnetic circuit to trap ignition current flux and flux caused by reservoir eddy or image currents wherein the flux trapping acts to prevent a magnetic pinch effect instability in the molten metal stream. In an embodiment, at least one of the reservoir, electrical break, and bellows may comprise a magnetic material cladding, collar, or cover such as one comprising magnetic steel. In another embodiment, at least one of the reservoir, electrical break, and bellows may comprise an electrical insulator or a material having low or no electrical conductivity which may prevent the formation of eddy or image currents and the corresponding magnetic flux that may interfere with molten metal injection by the EM pumps.

In an embodiment, the nozzles 5q each comprise an outlet orifice such as one on opposing sides to produce streams that form about a straight horizontal line or a linear connected molten metal stream to avoid mutual Lorentzian deflection. In an embodiment, each injection tube of the EM pumps 5k61 may comprise a section that angles the opposing nozzles to produce about a linear connected stream to avoid mutual Lorentzian deflection.

In an embodiment shown in FIG. 8L, the nozzle 5q comprises an opening that is about centered on the end of the injector section of the EM pump tube 5k61 such that the corresponding molten metal stream is ejected parallel to the injector section of the EM pump tube 5k61. In an embodiment, each injector tube may comprise a plurality (e.g., two, three, four) of nozzles 5q, and/or each reservoir 5c may comprise be in fluid communication with a plurality of injector tubes 5k61. The height of the injector section of the EM pump tube 5k61 in the reservoir 5c may be adjusted such that the nozzle is within the reservoir to protect it from damage by exposure to more intense plasma in the reaction cell chamber 5b31. In an embodiment, the nozzle may be submerged in the molten metal pool of the reservoir. The reservoirs and the corresponding injector sections of the EM pump tubes 5k61 of two such injectors and nozzles of a dual injector SunCell may be angled relative to each other such that the ejected molten metal streams follow trajectories 941 that intersect in the reaction cell chamber 5b31. The reservoirs 5c may form an inverted V connected to the reaction cell chamber 5b31 and the PV window 5ab4 and 5b4. The angle between the reservoirs comprising the legs of the inverted V may be in the range of about 1° to 179°. The region where the reservoirs 5c connect to the reaction cell chamber 5b31 may comprise a heat spreader to prevent this area from overheating. The heat spreader may be a thickening of the walls of at least one of the reservoirs and the floor of the reaction cell chamber. The heat spreader may comprise a metal collar around the exterior top potions of the reservoirs. Exemplary heat spreaders comprise stainless steel or copper.

In an embodiment to further prevent overheating of the upper section of the reservoirs, the reaction cell chamber 5b31 may serve as a receptable for an insert. The insert may comprise the reaction cell chamber floor liner 5b31b and sections of the reservoirs 5c in connection with the reaction cell chamber 5b31. The insert may comprise a refractory material such as at least one comprising ceramic, carbon, quartz, a refractory metal such as tungsten, and another refractory material of the disclosure or known in the art. The insert may comprise a composite of materials. The insert may comprise a plurality of parts that may be fastened together. The fastener may comprise glue, braze, weld, bolts, screws, clamps, or another fastener of the disclosure or known in the art. In the case of glued carbon parts, an exemplary glue comprises Aremco Products Graphitic Bond 551RN. The reservoirs may comprise metal tubes of any desired cross section geometry (e.g. circular, square, or rectangular), fastened to at least one of the base of the reaction cell chamber and each other. The corresponding fastener may comprise welds. The metal may comprise stainless steel or another of the disclosure. In the case that the tubes are partially fastened to each other (e.g. as shown in FIGS. 8A and 8B except that the apex is cut off in cross section and connected to at least one of the reaction cell chamber 5b31 and the PV window or PV window chamber), the fasteners such as welds may be above the electrical break 913 of each reservoir to maintain electrical isolation of the molten metal injector electrodes. The insert may comprise the reservoir liner. In an exemplary embodiment, the insert comprises a thick carbon block liner that inserts in to the reaction cell chamber at the floor to form the reaction cell chamber floor liner 5b31b wherein the block comprises two tubes machined into the carbon block having the diameter of the reservoirs angled to the vertical to align with stainless steel reservoir tubes of about the same cross sectional dimension that are either attached to the base of the reaction cell chamber or to each other above the electric break 913 of each reservoir. The angle may be in the range of about 5° to 85° to the vertical. The thickness of the block may be in the range of about 1 mm to 100 mm. In an embodiment, the walls of the reaction cell chamber taper or converge towards the PV window to increase the plasma current density and hydrino reaction power. The converging reaction cell chamber may be connected to at least one of a PV window and a PV window chamber of the disclosure. The converging plasma may cause a gas pressure increase to cause plasma flow into the region of the PV window 5ab4 and 5b4 or PV window chamber 916 to increase the optical power transfer to the PV converter 26a.

In an embodiment, there is intense plasma and light emission from the entire reaction cell chamber volume and the reservoirs at the nozzles, but the current density is highest at the nozzles in the reservoirs due to a relatively small cross-sectional area of the reservoirs and nozzles compared to that of the reaction cell chamber. The hydrino power scales non-linearly with current, but in an embodiment, hydrino reactant diffusion limitations set in. In an embodiment, the inlet for the flow of the hydrino reactants such as at least one of hydrogen, oxygen, and H₂O is positioned to establish a diffusional limitation at the nozzle to limit the power produced there to prevent the nozzles from melting.

In an embodiment, the nozzles 5q are oriented in the direction of the injector EM pump tube further comprising an extended height reaction cell chamber 5b31 to permit the molten metal streams to intersect within the reaction cell chamber 5b31 that may further comprise at least a portion of any cavity formed by the PV window 5b4. In an embodiment, at least one of the reaction cell chamber and the PV window may comprise a geometry comprising the vertical portion of an inverted Y. This section may comprise any desired geometrical horizontal cross section such as a circle or a square. The reaction cell chamber may comprise a liner 5b31a such as one comprising at least one of carbon and W. In an embodiment, at least a portion one or more side walls of the reaction cell chamber 5b31 may comprise a PV window. In an exemplary embodiment shown in FIGS. 8C-8D and 8L, the PV window may comprise a transparent rectangular or cubic chamber such as one comprising quartz or sapphire that is connected to the reaction cell chamber 5b31 by a union such as one comprising a lapped quartz or sapphire flange mated to a matching metal flange. In an further exemplary embodiment, the corresponding PV chamber formed by the PV window(s) may comprise the reaction cell chamber 5b31 shown in FIG. 8L wherein the union is at the base where the reservoirs connect to the reaction cell chamber. The union may be sealed with a gasket such as a graphite gasket and clamps or by glue or adhesive. In an alternative embodiment, the rectangular or cubic chamber may comprise a frame with quartz or sapphire window panels that are sealed with gaskets or glued or adhered to the frame such as a metal frame. In either embodiment, the glue or adhesive may comprise one of the disclosure such as at least one of Resbond 940SS, 989, 905, 940LE, and 907. The adhesive may comprise a composite such as a plurality of layers to allow adhesion to the frame and adhesion to the window by corresponding layers of different adhesives. In an embodiment, the base or frame may comprise an anchor such as a metal screen welded or soldered to the base or frame wherein the adhesive is applied to the anchor and to the window such as a quartz or sapphire window.

In an embodiment, the anchor comprises a thin metal annulus comprising a cylinder with a collar or flange at each end of the cylinder. The annulus may be welded vacuum tightly to the base or frame, and the opposite collar of the annulus may be glued to the PV window. The annulus may comprise at least one expansion means such as at least one circumferential pleat in the cylinder or anulus wall. The glue union may comprise multiple layers such as Resbond 940 SS on the base or frame side and Resbond 989 on the window side of the corresponding glue union. In an embodiment, the thermal coefficient of expansion of the flange, the glue, and the window are about matched for the operating temperature range. In an exemplary embodiment, a sapphire window is glued to a selected stainless-steel (SS) flange having a matched similar coefficient of expansion. In an embodiment, the SS may comprise Kovar or Invar. The glue or adhesive may comprise one of the disclosure such as at least one of Resbond 940SS, 989, 905, 940LE, and 907. The glue union may be replaced with a suitable braze such as one that is capable of high temperature operation such as one of the disclosure. The operating temperature may be in the range of about 300° C. to 2000° C. In an embodiment, the temperature of the glued or brazed PV window is ramped up and down very slowly to prevent thermal shock. The temperature ramp rate may be in the range of about 10° C./hour to 2000° C./hour.

In an embodiment, the EM pump pressure may be increased to cause molten metal to be injected on the surface of at least one of a top 5ab4 and 5b4 and side windows of the PV cavity to clean the windows of material such as metal oxide such as tin oxide or gallium oxide.

The nozzle may comprise a refractory cladding or coating that may also comprise an electrical insulator or have a low electrical conductivity. In an embodiment, at least one of the nozzle, coating, or cladding may comprise at least one of a refractory metal or a ceramic, W, Ta, carbon, ceramic-coated carbon, BN, zirconia, alumina, hafnia, Resbond potting compound such as Resbond 940 HT or 940SS, and another ceramic or combination options of the disclosure.

The hydrino reaction may at least one of propagate and self-sustain on a very hot surface such as a metallic surface such as the injected molten metal such as tin, gallium, or silver, or a metallic liner or injector part that may be in the temperature range of about 500° C. to 3500° C. The liner may comprise a part that protrudes into the reaction cell chamber that is selectively heated to serve as the hot surface. The hot surface may reduce or eliminate the need for at least one of application of an external electric field and an ignition current. In an embodiment, at least one of the nozzles 5q and the reaction cell chamber 5b31 liner such as at least one of the wall liner and the reaction cell chamber bottom or base liner such may serve as the as the hot surface such as a metallic surface such as a W, Ta, or other refractory metal surface such as one of the disclosure. In an alternative embodiment, the hot surface such as the liner may comprise a ceramic such as an electrically conductive ceramic such as a metal nitride, carbide, or diboride coating such as such as a WC, TiB₂, ZrB₂, or TiN coating on a refractory liner substrate material such as carbon. Exemplary coatings are hafnium boride (HfB₂) (M.P.=3380° C.), tungsten carbide (WC) (M.P.=2785° C.-2830° C.), hafnium carbide (HfC) (M.P.=3900° C.), Ta₄HfC₅ (M.P.=4000° C.), Ta₄HfC₅TaX₄HfCX₅(4215° C.), hafnium nitride (HfN) (M.P.=3385° C.), zirconium diboride (ZrB₂) (M.P.=3246° C.), zirconium carbide (ZrC) (M.P.=3400° C.), zirconium nitride (ZrN) (M.P.=2950° C.), titanium boride (TiB₂) (M.P.=3225° C.), titanium carbide (TiC) (M.P.=3100° C.), titanium nitride (TiN) (M.P.=2950° C.), silicon carbide (SiC) (M.P.=2820° C.), tantalum boride (TaB₂) (M.P.=3040° C.), tantalum carbide (TaC) (M.P.=3800° C.), tantalum nitride (TaN) (M.P.=2700° C.), niobium carbide (NbC) (M.P.=3490° C.), niobium nitride (NbN) (M.P.=2573° C.), vanadium carbide (VC) (M.P.=2810° C.). In an exemplary embodiment, the reaction chamber 5b31 liner may comprise a W floor plate 5b31b and W plate wall segments such as ones to form a rectangle, cube, hexagon, octagon, or other polygon that may further comprise electrical insulators such as ceramic strips between the W plates to isolate them to avoid an electrical path between juxtaposed W plates and then to one of the nozzles. Alternatively, the wall liner may at least partially comprise an electrical insulator or a material having a low electrical conductivity such as carbon, ceramic coated carbon, quartz, a ceramic such as one of the disclosure, or a conductor such W or Ta coated with a nonconductive coating such as a ceramic coating.

In an embodiment of a dual molten metal injector SunCell such as one shown in FIGS. 8A-8L, the pumping rate of one EM pump is increased relative to the rate of the opposing EM pump to cause the corresponding dominant injected molten metal stream to impinge on a surface such as a metal part such as a reaction cell chamber side wall to create the heated surface to initiate the hydrino reaction in the reaction cell chamber. Once the hydrino reaction is initiated, the EM pumps may be set to be balanced in EM pumping rate. Alternatively, in an embodiment of a SunCell having an electrical break in only one of its two reservoirs, the dominant injected molten metal stream impinges on a liner surface that is constantly at the opposing polarity of that of the dominant injected molten metal stream to create the hot surface to initiate the hydrino reaction wherein the EM pumping rates may be balanced thereafter.

In an embodiment, at least one set of flanges such as 914 and 915 shown in FIGS. 8H-8L and 13 as well as other flanges such as 26d, 26e, and 902 may be replaced by flat metal plates (no bolt holes) such as annuluses around the perimeter of each joined component. The plates may be welded together on the outer edges to form a seam. The seam may be cut or ground off to separate the two plates.

In an embodiment, the injector EM pump tube 5k61 such as a one that is at least one of refractory and resistant to alloy formation with the molten metal such as a W or Ta one may comprise a tube fastener to fasten the tube to a collar on the EM pump baseplate 5kk 1. The fastener may comprise a weld. The fastener may comprise a weld. The fastener may comprise a compression fitting. Alternatively, the fastener may comprise an adhesive or potting compound such as one of the disclosure such as a ceramic such as Cotronics Resbond 940SS that may have a similar thermal expansion coefficient as stainless steel, Cotronics Resbond 940 HT, or Sauereisen Electrotemp Cement. In another embodiment, the fastener comprises EM pump tube and collar annuli such as washers on each wherein the annuli may be welded on the edges to fasten the tube. Alternatively, the EM pump tube may comprise an annulus to secure the tube to the collar welded to the baseplate using a cover such as a carbon plate that pushes the annulus against the baseplate. The plate may be glued to the baseplate or held in place by at least one fastener. The components such as the collar, annulus, and fasteners may be coated with a tin alloy resistant coating such as one of the disclosure such as CrC, alumina, or Ta.

At least one of the EM pump tubes 5k6, reservoirs 5c, and reaction cell chamber 5b31 may be coated with a coating that protects the underlying metal from alloy formation with the molten metal. Exemplary coating are oxides, carbides, diborides, nitrides, a ceramic one such as Flameproof paint, and another of the disclosure. At least one of the EM pump tubes 5k6, reservoirs 5c, and reaction cell chamber 5b31 such as at least one of the walls and base may be lined with a liner. An exemplary liner is carbon or a ceramic such as alumina such as 96+% alumina or FG995 Alumina circumferential to a tungsten liner. The carbon may be coated with an electrical insulator such as Flameproof paint, ZrO₂, or Resbond 907GF. The reservoir 5c and reaction cell chamber 5b31 may have a polygonal cross section such as a square or rectangular cross section. The liner such as one comprising at least one of carbon and tungsten may comprise plates of the liner material that may be beveled together at plate intersections.

In embodiments of the disclosure, the coatings of SunCell components such as the reaction cell chamber, the inlet riser, the reservoirs, and EM pump tube may comprise one manufactured by ZYP coatings such as yttrium oxide, hafnium-titanium oxide, zirconium oxide, YAG, 3Y₂O₃-5Al₂O₃, and aluminum oxide. At least one ZYP coating may substitute for Flameproof paint.

At least one of the reaction cell chamber 5b31 and the PV window chamber 916 may further comprise at least one structural support to support the weight of at least one of the reaction cell chamber 5b31 and the PV window chamber 916 such as at least one column or turnbuckle 409k that may be attached to table 409c.

In an embodiment, the PV window comprises at least one blower or compressor and at least one jet to cool the PV by high velocity gas flow over the window surface. The gas such as helium or hydrogen may be selected such that it is inert, transparent to the emitted radiation, and has a high heat transfer capability.

In an embodiment, the PV window may be positioned in the center of a sphere with light recycling capable PV covering the inside of the sphere. Alternatively, the PV window may be positioned in the center of an annulus comprising a plane mirror at the bottom of a hemisphere comprising light recycling capable PV covering the inside of the hemisphere. The mirror may comprise a polished metal, ceramic such as Accuflect (Accuratus), or other reflector known in the art capable of reflecting substantially all wavelengths emitted by the SunCell such as light in the wavelength range of about 200 nm-5000 nm.

In an embodiment such as one shown in FIGS. 8L, the reaction cell chamber walls may be operated at high temperature to serve as a blackbody radiator to the PV cells of the PV converter 26a. The PV cells of the PV converter 26a may each comprise an infrared backing or bottom layer mirror to perform light recycling to the blackbody radiator walls. The reaction cell chamber walls may comprise a refractory material such as niobium that enables operation at the high temperature such as in the range of about 1000° C. to 3500° C. The walls may be coated with a coating of the disclosure such as alumina or CrC to suppress at least one of oxidation and alloy formation with the molten metal.

In an embodiment, the molten metal such as gallium or tin is flowed through a heat exchanger such as a tube in shell type that comprises a thermophotovoltaic converter. The molten metal such as gallium or tin may be pumped through the tubes that radiate to TPV cells mounted inside of the shell.

In an embodiment, the intense blackbody radiation emitted by the hydrino plasma through the PV window may be directly used as at least one of a radiative heater, a light source, and a directed energy weapon. The directed energy such as intense light emission may destroy or melt incoming projectiles such as missiles and bullets.

In an embodiment, a composition of matter comprising hydrino or molecular hydrino comprises a coating that provides stealth to a coated object since hydrino comprises dark matter that does not absorb or emit visible light.

In an embodiment, the molten metal may comprise any known metal or alloy such as tin, gallium, Galinstan, silver, copper, Ag—Cu alloy such as 71.9% Ag/28.1% Sn, and Ag—Sn alloy such as 50% Ag/50% Sn melt. The SunCell may comprise a PV window to allow at least one of plasma and blackbody light to be emitted from the reaction cell chamber to a PV converter. In an embodiment, the reaction cell chamber comprises gas to cause the blackbody temperature to be more uniform. The gas may comprise a noble gas such as argon. The gas pressure may be high to better distribute the temperature.

The molten metal may comprise a metal such as tin that resists wetting of a PV window preventing opacification of the window. The PV window may comprise a transparent material that may be at least one of resistant to high temperature and resistant to tin wetting. The window may comprise at least one of quartz, zerodur (lithium aluminosilicate glass-ceramic), ULE (titania-silica binary glass with zero coefficient of thermal expansion (CTE)), sapphire, aluminum oxynitride, MgF₂, glass, Pyrex, and other such windows known in the art. The window may be capable of operating at high temperature such as in the range of about 200° C. to 1800° C. and may serve as a blackbody radiator in addition to transmitting plasma emission from inside of the reaction cell chamber. Suitable exemplary high temperature-capable windows are those of Rayotek's High Pressure, High Temperature Sight Glass Windows (HTHP) (https://rayoteksightwindows.com/products/high-temp-sight-glass-windows.html).

In an embodiment, the PV window is at least one of cleaned and cooled with at least one of a gas blanket, gas jet, high-pressure jet, or gas knife from a source such as a gas nozzle or injector, a gas source, and a flow and pressure controller such as a pressure sensor, a valve, and a computer which may operate during plasma generation. The gas may comprise at least one of a noble gas such as argon and steam. In an embodiment, a window cleaner comprises a waterjet that may be pulsed wherein the excess water may be pumped off as steam. In an embodiment, the gas jet may comprise steam. The window may comprise a local vacuum port connected to a vacuum pump to remove steam before it flows into the reaction cell chamber. The window may further comprise a baffle such as a gate valve to close of the window from the reaction cell chamber to permit the steam to be selectively pumped off by the local vacuum port and vacuum pump. In an embodiment, the window may comprise a molten metal pump such as an electromagnetic pump to inject the molten metal such as gallium, tin, silver, copper, or alloys thereof onto the inner surface of window to clean it.

In an embodiment, the molten metal comprises tin. In an embodiment, the PV window comprises a conducting transparent coating such as indium tin oxide. A bias may be applied to the window by a voltage source to repel adhering particles such as tin and SnO particles. In an embodiment, the window is plasma cleaned by a source of plasma such as a glow discharge source. In an embodiment, at least one of the window or a housing for the window may further comprise an electrode of the glow discharge. In an embodiment, the PV window is in proximity to the glow discharge cell 900 (FIG. 9A) that provides HOH and atomic H to the reaction cell chamber 5b31. The discharge cell may be at least one of position or angled such that atomic hydrogen formed in the discharge cell from supplied molecular hydrogen flows over the surface of the PV window. The atomic hydrogen may react with tin or tin oxide to form volatile SnH₄ to clean the PV window. In an embodiment, the outlet of the discharge cell may comprise a baffle or deflector to cause the flow of atomic hydrogen from the outlet of the discharge cell to be incident on the PV window. The baffle or divertor may comprise a material that a low hydrogen recombination coefficient or low capacity for recombination such as glass, quartz, or a ceramic such as alumina or BN.

In an embodiment, the window is cooled to at least (i) reduce the heating of the PV converter and (ii) permit the formation of volatile stannane to clean the window wherein the stannane decomposes in the reaction cell chamber having a temperature above the thermal decomposition temperature of stannane. Additionally, the window temperature may be maintained above the melting point of tin such as above 235° C. In an embodiment the molten tin temperature such as that in at least one of the reaction cell chamber and the reservoir is maintained above one or more of the stannane decomposition temperature and the temperature at which hydrogen substantially desorbs from molten tin. The hydrogen may be hydrino reactant from the reaction cell chamber. In an embodiment, the temperature of the window is maintained above the hydrogen reduction temperature of tin oxide wherein hydrogen may be gaseous an in at least one form of molecular and atomic. At least one of the reaction cell chamber and the reservoir may be maintained in a temperature range of about 235° C. to 3500° C.

In an embodiment, the power generation system (called SunCell) comprises at least one plasma cell comprising (i) a discharge plasma generation cell 900 that generates a water/hydrogen mixture to be directed towards the molten metal cell through the discharge plasma generation cell and (ii) a discharge plasma ignition cell that creates a discharge plasma in the reaction cell chamber 5b31 wherein at least one of the plasma cells causes the ignition of a hydrino plasma in the reaction cell chamber 5b31 wherein the hydrino plasma comprises a plasma that is at least partially powered and sustained by the hydrino reaction. In these embodiments, the discharge plasma generation cell such as a glow discharge cell induces the formation of a first plasma from a gas (e.g., a gas comprising a mixture oxygen and hydrogen); wherein effluence of the discharge plasma generation cell is directed towards any part of the molten metal circuit (e.g., the molten metal, the anode, the cathode, an electrode submerged in a molten metal reservoir, either of two molten metal reservoirs, either of two injector molten metal electrodes). In these embodiments, the discharge plasma ignition cell such as a glow discharge cell induces a discharge in the reaction cell chamber such as a gas discharge to cause ignition of the hydrino reaction in the reaction cell chamber. The electrodes of the discharge plasma ignition may comprise the ignition electrodes. The electrodes of the discharge cell may comprise at least one of the anode, the cathode, an electrode submerged in a molten metal reservoir, either of two molten metal reservoirs, either of two injector molten metal electrodes, the reservoir, the reaction cell chamber, and an independent discharge plasma ignition electrode that penetrates the reaction cell chamber through an electrical isolating connector such as a feedthrough. The discharge plasma ignition electrode may be a metal such as Ta, W, or a coated metal such as a carbide or nitride coated stainless steel electrode that resists alloy formation with the molten metal.

In an exemplary embodiment (FIGS. 8F-G), a tungsten discharge plasma ignition electrode may penetrate the reaction cell chamber near one of the metal streams of an injector electrode 5k6. The electrode may penetrate the reaction cell chamber wall through a feedthrough. The SunCell may comprise a high voltage power supply that may comprise the one that powers the discharge plasma generation cell. The power supply may apply a high voltage to the discharge plasma generation cell to cause a gas glow discharge to ignite the hydrino plasma. One electrode may comprise the ignition bus bar 5k2al. In an exemplary embodiment wherein the reaction cell chamber 5b31 is grounded, the positive discharge electrode lead from the high voltage discharge power supply may be connected to the ignition bus bar 5k2al in a reservoir 5c comprising the electrical break 913, and the negative discharge electrode lead from the high voltage discharge power supply may be connected to the other ignition bus bar 5k2al. In an alternative embodiment, the discharge plasma generation cell 900 serves as the discharge plasma generation cell 900 and the discharge plasma ignition cell. In that case, an electrode of the discharge plasma generation cell such as the positive electrode may extend through the discharge plasma generation cell into the reaction cell chamber.

In an embodiment, the light to electricity converter comprises the photovoltaic converter of the disclosure comprising photovoltaic (PV) cells that are responsive to a substantial wavelength region of the light emitted from the cell such as that corresponding to at least 10% of the optical power output. In an embodiment, the PV cells are concentrator cells that can accept high intensity light, greater than that of sunlight such as in the intensity range of at least one of about 1.5 suns to 75,000 suns, 10 suns to 10,000 suns, and 100 suns to 2000 suns. The concentrator PV cells may comprise c-Si that may be operated in the range of about 1 to 1000 Suns. The silicon PV cells may be operated at a temperature that performs at least one function of improving the bandgap to better match the blackbody spectrum and improving the heat rejection and thereby reducing the complexity of the cooling system. In an exemplary embodiment, concentrator silicon PV cells are operated at 100 to 500 Suns at about 130° C. to provide a bandgap of about 0.84 V to match the spectrum of a 3000° C. blackbody radiator. The PV cells may comprise a single junction or a plurality of junctions such as triple junctions. The concentrator PV cells may comprise single junction Si or single junction Group III/V semiconductors or a plurality of layers such as those of Group III/V semiconductors such as at least one of the group of InGaP/InGaAs/Ge; InAlGaP/AlGaAs/GaInNAsSb/Ge; GaInP/GaAsP/SiGe; GaInP/GaAsP/Si; GaInP/GaAsP/Ge; GaInP/GaAsP/Si/SiGe; GaInP/GaAs/InGaAs; GaInP/GaAs/GaInNAs; GaInP/GaAs/InGaAs/InGaAs; GaInP/Ga(In)As/InGaAs; GaInP—GaAs-wafer-InGaAs; GaInP—Ga(In)As—Ge; and GaInP—GaInAs—Ge. The plurality of junctions such as triple or double junctions may be connected in series. In another embodiment, the junctions may be connected in parallel. The junctions may be mechanically stacked. The junctions may be wafer bonded. In an embodiment, tunnel diodes between junctions may be replaced by wafer bonds. The wafer bond may be electrically isolating and transparent for the wavelength region that is converted by subsequent or deeper junctions. Each junction may be connected to an independent electrical connection or bus bar. The independent bus bars may be connected in series or parallel. The electrical contact for each electrically independent junction may comprise grid wires. The wire shadow area may be minimized due to the distribution of current over multiple parallel circuits or interconnects for the independent junctions or groups of junctions. The current may be removed laterally. The wafer bond layer may comprise a transparent conductive layer. An exemplary transparent conductor is a transparent conductive oxide (TCO) such as indium tin oxide (ITO), fluorine doped tin oxide (FTO), and doped zinc oxide and conductive polymers, graphene, and carbon nanotubes and others known to those skilled in the art. Benzocyclobutene (BCB) may comprise an intermediate bonding layer. The bonding may be between a transparent material such a glass such as borosilicate glass and a PV semiconductor material. An exemplary two-junction cell is one comprising a top layer of GaInP wafer bonded to a bottom layer of GaAs (GaInP//GaAs). An exemplary four-junction cell comprises GaInP/GaAs/GaInAsP/GaInAs on InP substrate wherein each junction may be individually separated by a tunnel diode (/) or an isolating transparent wafer bond layer (//) such as a cell given by GaInP//GaAs//GaInAsP//GaInAs on InP. The PV cell may comprise InGaP//GaAs//InGaAsNSb//Conductive Layer//Conductive Layer//GaSb//InGaAsSb. The substrate may be GaAs or Ge. The PV cell may comprise Si—Ge—Sn and alloys. All combinations of diode and wafer bonds are within the scope of the disclosure. An exemplary four-junction cell having 44.7% conversion efficacy at 297-times concentration of the AM1.5d spectrum is made by SOITEC, France. The PV cell may comprise a single junction. An exemplary single junction PV cell may comprise a monocrystalline silicon cell such as one of those given in Sater et al. (B. L. Sater, N. D. Sater, “High voltage silicon VMJ solar cells for up to 1000 suns intensities”, Photovoltaic Specialists Conference, 2002. Conference Record of the Twenty-Ninth IEEE, 19-24 May 2002, pp. 1019-1022.) which is herein incorporated by reference in its entirety. Alternatively, the single junction cell may comprise GaAs or GaAs doped with other elements such as those from Groups III and V. In an exemplary embodiment, the PV cells comprise triple junction concentrator PV cells or GaAs PV cells operated at about 1000 suns. In another exemplary embodiment, the PV cells comprise c-Si operated at 250 suns. In an exemplary embodiment, the PV may comprise GaAs that may be selectively responsive for wavelengths less than 900 nm and InGaAs on at least one of InP, GaAs, and Ge that may be selectively responsive to wavelengths in the region between 900 nm and 1800 nm. The two types of PV cells comprising GaAs and InGaAs on InP may be used in combination to increase the efficiency. Two such single junction types cells may be used to have the effect of a double junction cell. The combination may be implemented by using at least one of dichroic mirrors, dichroic filters, and an architecture of the cells alone or in combination with mirrors to achieve multiple bounces or reflections of the light as given in the disclosure. In an embodiment, each PV cell comprises a polychromat layer that separates and sorts incoming light, redirecting it to strike particular layers in a multi-junction cell. In an exemplary embodiment, the cell comprises an indium gallium phosphide layer for visible light and gallium arsenide layer for infrared light where the corresponding light is directed. The PV cell may comprise a GaAs_{1-x-y}NₓBi_{y} alloy.

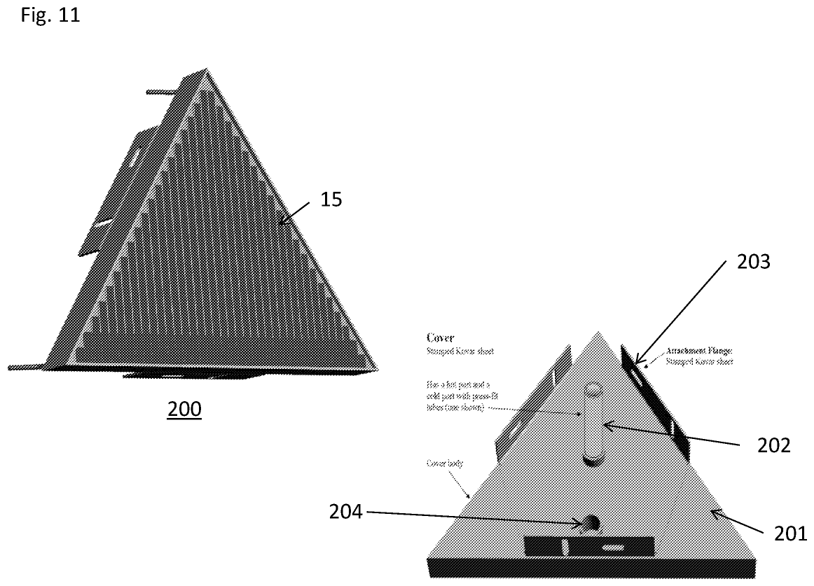

The PV cells may comprise silicon. The silicon PV cells may comprise concentrator cells that may operate in the intensity range of about 5 to 2000 Suns. The silicon PV cells may comprise crystalline silicon and at least one surface may further comprise amorphous silicon that may have a different bandgap than the crystalline Si layer. The amorphous silicon may have a wider bandgap than the crystalline silicon. The amorphous silicon layer may perform at least one function of causing the cells to be electro-transparent and preventing electron-hole pair recombination at the surfaces. The silicon cell may comprise a multijunction cell. The layers may comprise individual cells. At least one cell such as atop cell such as one comprising at least one of Ga, As, InP, Al, and In may be ion sliced and mechanically stacked on the Si cell such as a Si bottom cell. At least one of layers of multi-junction cells and cells connected in series may comprise bypass diodes to minimize current and power loss due to current mismatches between layers of cells. The cell surface may be textured to facilitate light penetration into the cell. The cell may comprise an antireflection coating to enhance light penetration into the cell. The antireflection coating may further reflect wavelengths below the bandgap energy. The coating may comprise a plurality of layers such as about two to 20 layers. The increased number of layer may enhance the selectivity to band pass a desired wavelength range such as light above the bandgap energy and reflect another range such as wavelengths below the bandgap energy. Light reflected from the cell surface may be bounced to at least one other cell that may absorb the light. The PV converter may comprise a closed structure such as a geodesic dome to provide for multiple bounces of reflected light to increase the cross section for PV absorption and conversion. The geodesic dome may comprise a plurality of receiver units 200 (FIG. 11) such as triangular units covered with PV cells 15. The dome may serve as an integrating sphere. The unconverted light may be recycled. Light recycling may occur through reflections between member receiver units such as those of a geodesic dome. The surface may comprise a filter that may reflect wavelengths below the bandgap energy of the cell. The cell may comprise a bottom mirror such as a silver or gold bottom layer to reflector un-absorbed light back through the cell. Further unabsorbed light and light reflected by the cell surface filter may be absorbed by a blackbody radiator and re-emitted to the PV cell wherein the blackbody radiation comprises at least one of a component of the SunCell such as at least one wall of the reaction cell chamber and the reservoir. In an embodiment, the PV substrate may comprise a material that is transparent to the light transmitted from the bottom cell to a reflector on the back of the substrate. An exemplary triple junction cell with a transparent substrate is InGaAsP (1.3 eV), InGaAsP (0.96 eV), InGaAs (0.73 eV), InP substrate, and copper or gold IR reflector. In an embodiment, the PV cell may comprise a concentrator silicon cell. The multijunction III-V cell may be selected for higher voltage, or the Si cell may be selected for lower cost. The bus bar shadowing may be reduced by using transparent conductors such as transparent conducting oxides (TCOs).

The PV cell may comprise perovskite cells. An exemplary perovskite cell comprises the layers from the top to bottom of Au, Ni, Al, Ti, GaN, CH₃NH₃SnI₃, monolayer h-BN, CH₃NH₃PbI₃₋ₓBrₓ, HTM/GA, bottom contact (Au).

The cell may comprise a multi p-n junction cell such as a cell comprising an AlN top layer and GaN bottom layer to converter EUV and UV, respectively. In an embodiment, the photovoltaic cell may comprise a GaN p-layer cell with heavy p-doping near the surface to avoid excessive attenuation of short wavelength light such as UV and EUV. The n-type bottom layer may comprise AlGaN or AlN. In an embodiment, the PV cell comprises GaN and AlₓGa₁₋ₓN that is heavily p-doped in the top layer of the p-n junction wherein the p-doped layer comprises a two-dimensional-hole gas. In an embodiment, the PV cell may comprise at least one of GaN, AlGaN, and AlN with a semiconductor junction. In an embodiment, the PV cell may comprise n-type AlGaN or AlN with a metal junction. In an embodiment, the PV cell responds to high-energy light above the band gap of the PV material with multiple electron-hole pairs. The light intensity may be sufficient to saturate recombination mechanisms to improve the efficiency.

The converter may comprise a plurality of at least one of (i) GaN, (ii) AlGaN or AlN p-n junction, and (iii) shallow ultra-thin p-n heterojunction photovoltaics cells each comprising a p-type two-dimensional hole gas in GaN on an n-type AlGaN or AlN base region. Each may comprise a lead to a metal film layer such as an Al thin film layer, an n-type layer, a depletion layer, a p-type layer and a lead to a metal film layer such as an Al thin film layer with no passivation layer due to the short wavelength light and vacuum operation. In an embodiment of the photovoltaic cell comprising an AlGaN or AlN n-type layer, a metal of the appropriate work function may replace the p-layer to comprise a Schottky rectification barrier to comprise a Schottky barrier metal/semiconductor photovoltaic cell.

In another embodiment, the converter may comprise at least one of photovoltaic (PV) cells, photoelectric (PE) cells, and a hybrid of PV cells and PE cells. The PE cell may comprise a solid-state cell such as a GaN PE cell. The PE cells may each comprise a photocathode, a gap layer, and an anode. An exemplary PE cell comprises GaN (cathode) cessiated/AlN (separator or gap)/Al, Yb, or Eu (anode) that may be cessiated. The PV cells may each comprise at least one of the GaN, AlGaN, and AlN PV cells of the disclosure. The PE cell may be the top layer and the PV cell may be the bottom layer of the hybrid. The PE cell may convert the shortest wavelength light. In an embodiment, at least one of the cathode and anode layer of the PE cell and the p-layer and the n-layer of a PV cell may be turned upside down. The architecture may be changed to improve current collection. In an embodiment, the light emission from the ignition of the fuel is polarized and the converter is optimized to use light polarization selective materials to optimize the penetration of the light into the active layers of the cell.

In an embodiment, the light emission from the hydrino plasma in the reaction cell chamber through the PV window to the PV converter may comprise predominantly ultraviolet light and extreme ultraviolet such as light in the wavelength region of about 10 nm to 300 nm. The PV cell may be response to at least a portion of the wavelength region of about 10 nm to 300 nm. The PV cells may comprise concentrator UV cells. The cells may be responsive to blackbody radiation. The blackbody radiation may be that corresponding to at least one temperature range of about 1000K to 6000K. The incident light intensity may be in at least one range of about 2 to 100,000 suns and 10 to 10,000 suns. The cell may be operated in a temperature range known in the art such as at least one temperature range of about less than 300° C. and less than 150° C. The PV cell may comprise a group III nitride such as at least one of InGaN, GaN, and AlGaN. In an embodiment, the PV cell may comprise a plurality of junctions. The junctions may be layered in series. In another embodiment, the junctions are independent or electrically parallel. The independent junctions may be mechanically stacked or wafer bonded. An exemplary multi-junction PV cell comprises at least two junctions comprising n-p doped semiconductor such as a plurality from the group of InGaN, GaN, and AlGaN. The n dopant of GaN may comprise oxygen, and the p dopant may comprise Mg. An exemplary triple junction cell may comprise InGaN//GaN//AlGaN wherein // may refer to an isolating transparent wafer bond layer or mechanical stacking. The PV may be run at high light intensity equivalent to that of concentrator photovoltaic (CPV). The substrate may be at least one of sapphire, Si, SiC, and GaN wherein the latter two provide the best lattice matching for CPV applications. Layers may be deposited using metalorganic vapor phase epitaxy (MOVPE) methods known in the art. The cells may be cooled by cold plates such as those used in CPV or diode lasers such as commercial GaN diode lasers. The grid contacts may be mounted on the front and back surfaces of the cells as in the case of CPV cells. In an embodiment, the surface of the PV cell such as one comprising at least one of GaN, AlN, and GaAlN may be terminated. The termination layer may comprise at least one of H and F. The termination may decrease the carrier recombination effects of defects. The surface may be terminated with a window such as AlN.

In an embodiment, at least one of the PV window and a protective window of the photovoltaic (PV) and photoelectric (PE) converter may be substantially transparent to the light to which it is responsive. The window may be at least 10% transparent to the responsive light. The window may be transparent to UV light. The window may comprise a coating such as a UV transparent coating on the PV or PE cells. The coating may be applied by deposition such as vapor deposition. The coating may comprise the material of UV windows of the disclosure such as a sapphire or MgF₂ window. Other suitable windows comprise LiF and CaF₂. Any window such as a MgF₂ window may be made thin to limit the EUV attenuation. In an embodiment, the PV or PE material such as one that is hard, glass-like such as GaN serves as a cleanable surface. The PV material such as GaN may serve as the window. In an embodiment, the surface electrodes of the PV or PE cells may comprise the window. The electrodes and window may comprise aluminum. The window may comprise at least one of aluminum, carbon, graphite, zirconia, graphene, MgF₂, an alkaline earth fluoride, an alkaline earth halide, Al₂O₃, and sapphire. The window may be very thin such as about 1 A to 100 A thick such that it is transparent to the UV and EUV emission from the cell. Exemplary thin transparent thin films are Al, Yb, and Eu thin films. The film may be applied by MOCVD, vapor deposition, sputtering and other methods known in the art.

In an embodiment, the cell may covert the incident light to electricity by at least one mechanism such as at least one mechanism from the group of the photovoltaic effect, the photoelectric effect, the thermionic effect, and the thermoelectric effect. The converter may comprise bilayer cells each having a photoelectric layer on top of a photovoltaic layer. The higher energy light such as extreme ultraviolet light may be selectively absorbed and converted by the top layer. A layer of a plurality of layers may comprise a UV window such as the MgF₂ window. The UV window may protect ultraviolet UV) PV from damage by ionizing radiation such as damage by soft X-ray radiation. In an embodiment, low-pressure cell gas may be added to selectively attenuate radiation that would damage the UV PV. Alternatively, this radiation may be at least partially converted to electricity and at least partially blocked from the UV PV by the photoelectronic converter top layer. In another embodiment, the UV PV material such as GaN may also convert at least a portion of the extreme ultraviolet emission from the cell into electricity using at least one of the photovoltaic effect and the photoelectric effect.

The photovoltaic converter may comprise PV cells that convert ultraviolet light into electricity. Exemplary ultraviolet PV cells comprise at least one of p-type semiconducting polymer PEDOT-PSS: poly(3,4-ethylenedioxythiophene) doped by poly(4-styrenesulfonate) film deposited on a Nb-doped titanium oxide (SrTiO3:Nb) (PEDOT-PSS/SrTiO3:Nb heterostructure), GaN, GaN doped with a transition metal such as manganese, SiC, diamond, Si, and TiO₂. Other exemplary PV photovoltaic cells comprise n-ZnO/p-GaN heterojunction cells.

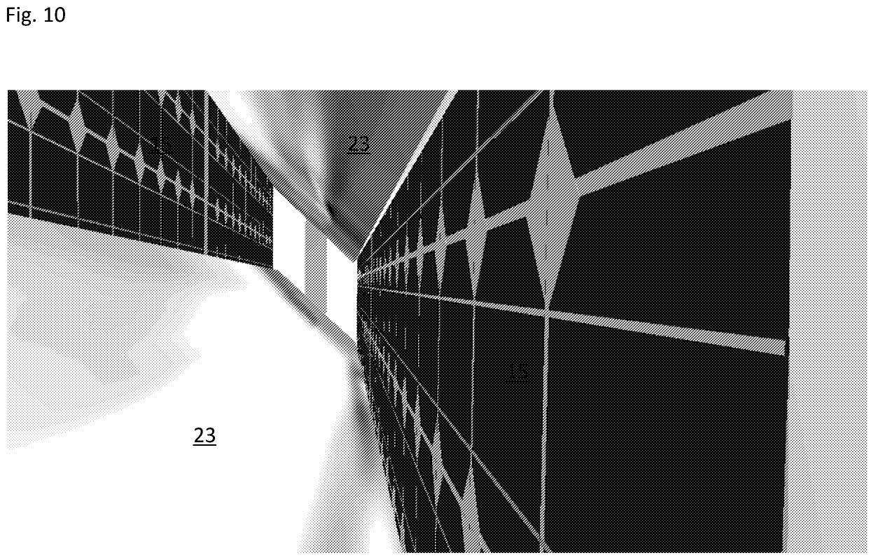

To convert the high intensity light into electricity, the generator may comprise an optical distribution system and photovoltaic converter 26a such as that shown in FIG. 10. The optical distribution system may comprise a plurality of semitransparent mirrors arranged in a louvered stack along the axis of propagation of light emitted from the cell wherein at each mirror member 23 of the stack, light is at least partially reflected onto a PV cell 15 such as one aligned parallel with the direction of light propagation to receive transversely reflected light. The light to electricity panels 15 may comprise at least one of PE, PV, and thermionic cells. The window to the converter may be transparent to the cell emitted light such as short wavelength light or blackbody radiation such as that corresponding to a temperature of about 1000K to 4000K wherein the power converter may comprise a thermophotovoltaic (TPV) power converter. The PV window or the window to the PV converter may comprise at least one of sapphire, aluminum oxynitride, LiF, MgF₂, and CaF₂, other alkaline earth halides such as fluorides such as BaF₂, CdF₂, quartz, fused quartz, UV glass, borosilicate, and Infrasil (ThorLabs). The semitransparent mirrors 23 may be transparent to short wavelength light. The material may be the same as that of the PV converter window with a partial coverage of reflective material such as mirror such as UV mirror. The semitransparent mirror 23 may comprise a checkered pattern of reflective material such as UV mirror such as at least one of MgF₂-coated Al and thin fluoride films such as MgF₂ or LiF films or SiC films on aluminum.

In an embodiment, the TPV conversion efficiency may be increased by using a selective emitter, such as ytterbium on the surface of the blackbody emitter 5b4c. Ytterbium is an exemplary member of a class of rare earth metals, which instead of emitting a normal blackbody spectrum emit spectra that resemble line radiation spectra. This allows the relatively narrow emitted energy spectrum to match very closely to the bandgap of the TPV cell.

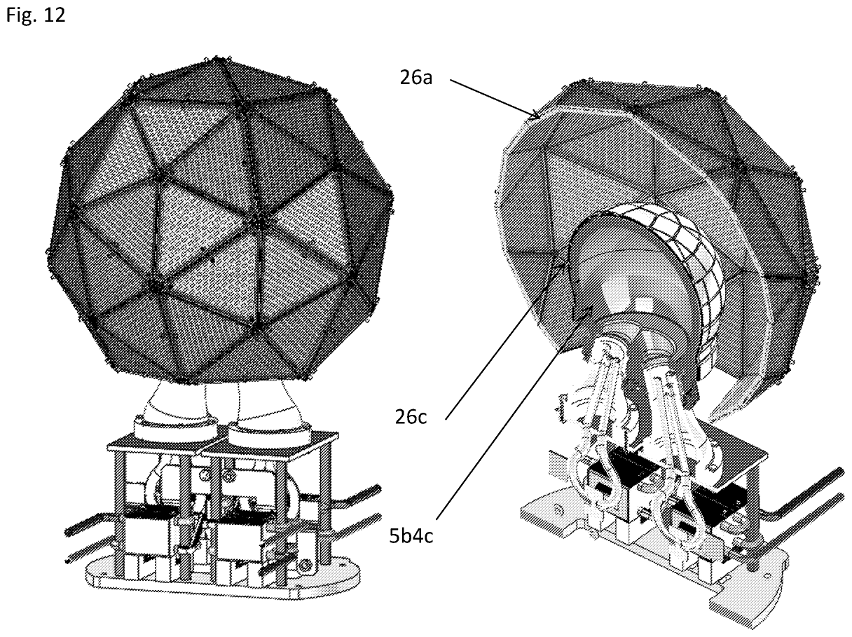

In an embodiment, the PV converter 26a (see, e.g., FIGS. 12-13) may comprise a plurality of triangular receiver units (TRU), each comprising a plurality of photovoltaic cells such as front concentrator photovoltaic cells, a mounting plate, and a cooler on the back of the mounting plate. The cooler may comprise at least one of a multichannel plate, a surface supporting a coolant phase change, and a heat pipe. The triangular receiver units may be connected together to form at least a partial geodesic dome. The TRUs may further comprise interconnections of at least one of electrical connections, bus bars, and coolant channels. In an embodiment, the receiver units and the pattern of connections may comprise a geometry that reduces the complexity of the cooling system. The number of the PV converter components such as the number of triangular receiver units of a geodesic spherical PV converter may be reduced. The PV converter may comprise a plurality of sections. The sections may join together to form a partial enclosure about the blackbody radiator 5b4c or PV window 5b4. At least one of the PV converter and the blackbody radiator 5b4c may be multi-faceted wherein the surfaces of the blackbody radiator and the receiver units may be geometrically matched. The PV window may also have a similar geometrical match with the PV converter 26a such as in the case of a partial dome PV window 5b4 (FIG. 13) and a partial geodesic dome PV converter 26a. For example, the PV window may be spherical or hemispherical and the PV converter may comprise multiple PV panels in a geodesic dome configuration and, optionally, the center of PV window sphere and the center of the geodesic dome are the same or nearly the same (e.g., within 1 cm). The PV converter enclosure may comprise at least one of triangular, square, rectangular, cylindrical, or other geometrical units. The blackbody radiator 5b4c or PV window 5b4 may comprise at least one of a square, a partial sphere, or other desirable geometry to irradiate the units of the PV converter. In an exemplary embodiment, the converter enclosure may comprise five square units about the blackbody radiator 5b4c or PV window 5b4 that may be spherical, rectangular, or a square. The converter enclosure may further comprise receiver units to receive light from the base of the blackbody radiator or PV window. The geometry of the base units may be one that optimizes the light collection. The enclosure may comprise a combination of squares and triangles. The enclosure may comprise atop square, connected to an upper section comprising four alternating square and triangle pairs, connected to six squares as the midsection, connected to at least a partial lower section comprising four alternating square and triangle pairs connected to a partial or absent bottom square.

A schematic drawing of a triangular element of the geodesic dense receiver array of the photovoltaic converter is shown in FIG. 11. The PV converter 26a in a geodesic dome (see, e.g., FIGS. 12-13) may comprise a dense receiver array comprised of triangular elements 200 each comprised of a plurality of concentrator photovoltaic cells 15 capable of converting the light from the blackbody radiator 5b4c or PV window 5b4 into electricity. The PV cells 15 may comprise at least one of GaAs P/N cells on a GaAs N wafer, InAlGaAs on InP, and InAlGaAs on GaAs. The cells may each comprise at least one junction. The triangular element 200 may comprise a cover body 201, such as one comprising stamped Kovar sheet, a hot port 202 and a cold port 204 such as ones comprising press fit tubes, and attachment flanges 203 such as ones comprising stamped Kovar sheet for connecting contiguous triangular elements 200.

In an embodiment comprising a thermal power source, the heat exchanger of the PV converter 26a comprises a plurality of heat exchanger elements 200 such as triangular elements 200 shown in FIG. 11 each comprise a comprising a hot coolant outlet 202 and a colder coolant inlet 204 and a means to absorb the light. The light may be from the blackbody radiator 5b4c such as the reaction cell chamber wall or the hydrino plasma through the PV window 5b4. The heat exchanger elements 200 may each transfer power not converted into electricity as heat into the coolant that is flowed through the element. At least one of the coolant inlet and outlet may attach to a common water manifold. The heat exchanger system may further comprise a coolant pump, a coolant tank, and a load heat exchanger such as a radiator and air fan that provides hot air to a load with air flow through the radiator.

The cooler or heat exchanger of each receiver unit may comprise at least one of a coolant housing comprising at least one coolant inlet and one coolant outlet, at least one coolant distribution structure such as a flow diverter baffle such as a plate with passages, and a plurality of coolant fins mounted onto the PV cell mounting plate. The fins may be comprised of a highly thermally conductive material such as silver, copper, or aluminum. The height, spacing, and distribution of the fins may be selected to achieve a uniform temperature over the PV cell area. The cooler may be mounted to a least one of mounting plate and the PV cells by thermal epoxy. The PV cells may be protected on the front side (illuminated side) by a clover glass or window. In an embodiment, the enclosure comprising receiver units may comprise a pressure vessel. The pressure of the pressure vessel may be adjusted to at least partially balance the internal pressure of the molten metal vapor pressure inside of the reaction cell chamber 5b31.

In an embodiment, the power of the SunCell may be sensed optically by a light power meter or a spectrometer capable of recording the plasma blackbody radiation and temperature. The recorded power such as that transmitted through the PV window 5b4 may be used by a controller to control the hydrino reaction conditions such as those of the disclosure to maintain a desired power output.

In an embodiment (FIGS. 12-13), the radius of the PV converter may be increased relative to the radius of the blackbody radiator 5b4c or PV window 5b4 to decrease the light intensity based on the inverse radius-squared dependency of the light power flux. Alternatively, the light intensity may be decreased by an optical distribution system comprising a series of semitransparent mirrors 23 along the blackbody radiator ray path (FIG. 10) that partially reflects the incident light to PV cells 15 and further transmits a portion of the light to the next member of the series. The optical distribution system may comprise mirrors to reduce the light intensity along a radial path, a zigzag path, or other paths that are convenient for stacking a series of PV cells and mirrors to achieve the desired light intensity distribution and conversion. In an embodiment, the blackbody radiator 5b4c or PV window 5b4 may have a geometry that is mated to the light distribution and PV conversion system comprising series of mirrors, lenses, or filters in combination with the corresponding PV cells. In an exemplary embodiment, the blackbody radiator or PV window may be square and to match a rectilinear light distribution and PV conversion system geometry.

The parameters of the cooling system may be selected to optimize the cost, performance, and power output of the generator. Exemplary parameters are the identity of the coolant, a phase change of the coolant, the coolant pressure, the PV temperature, the coolant temperature and temperature range, the coolant flow rate, the radius of the PV converter and coolant system relative to that of the blackbody radiator, and light recycling and wavelength band selective filters or reflectors on the front or back of the PV to reduce the amount of PV incident light that cannot be converted to electricity by the PV or to recycle that which failed to convert upon passing through the PV cells. Exemplary coolant systems are ones that perform at least one of i.) form steam at the PV cells, transport steam, and condense the steam to release heat at the exchange interface with ambient, ii.) form stream at the PV cells, condense it back to liquid, and reject heat from a single phase at the heat exchanger with ambient such as a radiator, and iii.) remove heat from the PV cells with microchannel plates and reject the heat at the heat exchanger with ambient. The coolant may remain in a single phase during cooling the PV cells.

The PV cell may be mounted to cold plates. The heat may be removed from the cold plates by coolant conduits or coolant pipes to a cooling manifold. The manifold may comprise a plurality of toroidal pipes circumferential around the PV converter that may be spaced along the vertical or z-axis of the PV converter and comprise the coolant conduits or coolant pipes coming off of it. In an embodiment, the heated coolant may be used to provide thermal power to a load. The cooling system may comprise at least one additional heat exchanger to cool the coolant and provide heat to the thermal load. The cooled coolant may be recirculated to the cold plate by a pump.

At least one of the reaction cell chamber, reservoirs, and EM pumps may be cooled by a coolant such as water. The coolant may be passively circulated through a heat exchanger or actively circulated by a pump to remove heat according to the disclosure. The passive circulation may comprise a steam formation and condensation heat transfer cycle. At least one of the PV cells and the PV window may be cooled by a circulating coolant. In an embodiment, the PV converter 26a comprises a dense receiver array of PV cells, a PV window, a housing that houses the PV converter, a coolant that is circulated through the housing by at least one pump, a heat exchanger, at least one temperature sensor, at least one flow sensor, and a heat exchanger to remove heat from at least one of the PC cells and the PV window. The coolant may have a low light absorption coefficient in the spectral region of the light emitted to or from the PV window wherein the light may be recycled. The coolant may comprise water. The coolant may comprise a molten salt selected for the operating temperature of at least one of the PV window and the PV cells and having a low absorption coefficient for the emitted or recycled light. The optical path length between the PV window and the PV cells may be minimized to reduce the absorption of the emitted or recycled light. A coolant flow rate may be maintained by the pump to cool the PV window to maintain a stable window temperature. In an alternative embodiment, the PV window is operated at a temperature at which the blackbody radiation to the PV cells provides sufficient cooling to maintain the operating temperature. In an embodiment, the PV window cavity is sufficiently large such that the light absorption by the PV window is a significant contributor to the heating of the PV window compared to plasma heating wherein the distance of the window walls from the plasma reduces the plasma heating.

In an embodiment, the light below the PV band gap may be recycled by being reflected from the PV cells, absorbed by the blackbody radiator 5b4c, and re-emitted as the blackbody radiation at the blackbody radiator's operating temperature such as in the range of about 1000 K to 4000 K. The blackbody radiator may comprise an external SunCell wall or a PV window and the hydrino reaction plasma. In an embodiment, the reflected radiation that is below the band gap may be transparent to the PV window such that it is absorbed by the reaction cell chamber 5b31 gases and plasma. The absorbed reflected power may heat the blackbody radiator to assist to maintain its temperature and thereby achieve recycling of the reflected below band gap light. In an embodiment comprising a blackbody radiator such as an external SunCell wall a high emissivity may be applied to the surface. The coating may comprise carbon, carbide, boride, oxide, nitride, or other refractory material of the disclosure. Exemplary coatings are graphite, ZrB₂, zirconium carbide, and ZrC composites such as ZrC—ZrB₂ and ZrC—ZrB₂—SiC. The coating may comprise a powder layer.

To facilitate a match of the radiative power density transferred from the SunCell to an acceptable operating power density of the thermophotovoltaic (TPV) cells, the power produced by the SunCell may also be spread over a larger surface area of the at least one of the reaction cell chamber and the reservoir by increasing the geometric area of at least one of the reaction cell chamber and reservoir. In an embodiment, a desired power density radiated by at least one of the reaction cell chamber and the reservoir walls is matched to the power produced by the SunCell by increasing at least one dimension of SunCell to increase the corresponding wall surface area. The TPV cells are selected to have high efficiency at the corresponding concentration of light emitted from the walls and made incident on the TPV cells. In an embodiment comprising a PV window wherein the concentration exceeds at least one of the capacity of the TPV cells or the cooling system of the TPV cells, the light concentration may be reduced to an appropriate level by placement of the TPV cells of the PV converter 26a at a larger distance from the PV window 5b4 such as shown in FIG. 8E. In an exemplary embodiment, the PV converter 26a may comprise a six-sided cubic or rectangular cavity that surrounds the PV window 5b4. A bottom panel of the PV converter may attach to the PV window flange 26d. The connection may comprise a thermal insulator between the PV panel and the flange connection. In an embodiment, the PV window comprising the straight geometry section of the inverted Y geometry SunCell may be increased in size to spread the light over a larger area. An exemplary PV geometry is a cylindrical or rectangular jug with a body having a larger cross section than the cross section of the joint with the flange of the invert V geometry section. In another embodiment, the thermal load on the PV window may be decreased by increasing its surface area by making it larger wherein the larger area increases the heat loss to maintain a desired window operating temperature.

In an embodiment, the TPV converter is housed in a chamber capable of at least one of vacuum, atmospheric, and above atmospheric pressure. The TPV converter may be maintained under a vacuum or an inert atmosphere such as a noble gas atmosphere such as an agon atmosphere. The chamber may comprise electrical feedthroughs for electrical connections for the ignition, the EM pump, and the plasma discharge cell 900 currents as well as others for sensors such as temperature, gas flow, gas pressure, optical power, and optical spectrum sensors.

In an embodiment, at least a portion of the power to operate at least one of the SunCell, boiler, and air heat exchanger of the disclosure such as at least one of the ignition power, EM pump power, vacuum pump power, controller power, chiller or cooler power, and blower power may be supplied by the SunCell thermophotovoltaic converter. In an exemplary embodiment of a SunCell-TPV-air heat exchanger system wherein the power to operate the SunCell is at least partially provided by TPV conversion of SunCell emission (FIGS. 9F and 9I), blackbody emission from at least one of the reaction chamber walls, the reservoir walls, and the PV window may be made incident on the PV converter and the remaining thermal power produced by the SunCell may be transferred to air by the air heat exchanger such as the one shown in FIGS. 9G-H or FIG. 7G. In a boiler ignition power supply embodiment, the PV window and PV converter to provide at least some electricity to serve as the ignition power source may be contained in a housing such as one that is at least one of water and airtight.

In an embodiment, an optical thermal power source comprises the SunCell 812 comprising a PV window 5b4 such as shown in FIGS. 2-5, 8A-8L, 13, and 9J wherein the load to be heated is directly or indirectly irradiated with at least one of the plasma, blackbody, UV, visible, and infrared emission from the SunCell. The radiation may be reflected to a desired location by at least one of one or more mirrors and lenses. The light may be introduced via a zigzag ray path using corresponding reflectors. In an embodiment shown in FIG. 9J, the radiation may be confined to a housing such as a thermal cavity such as one that is thermally insulated 930 of an oven system 928 such as one further comprising air circulator 929 and a conveyor 932. The thermal cavity may comprise an optical thermal oven. At least one of the oven walls may comprise a blackbody cavity or radiator. The SunCell 812 may comprise a heat lamp. The thermal insulation of the cavity walls may comprise high temperature capable thermal insulation such as a ceramic such as one of the disclosure such as alumina, silica, magnesia, hafnia, zirconia, BN, or graphite. The optical thermal oven may further comprise sensors such as thermal sensors and controls such as SunCell optical power output controls to control the internal temperature of the oven. The oven may comprise the SunCell startup oven 931. The startup oven 931 may melt the molten metal such as tin. The startup oven may be switched from heating up the SunCell during startup to an oven heated by the power from the SunCell after startup. The optical thermal oven may comprise more than one cavity such as one housing the SunCell 931 and another working oven chamber 930 that receives the light from the PV window 5b4 to be heated. The oven cavity housing the SunCell 931 may comprise the startup oven. In an embodiment comprising a plurality of chambers, one chamber 931 may house the SunCell and another may comprise a working chamber 930 that heats a desired material or objected placed in the working chamber. In an embodiment, the PV window may be at least partially covered by PV cells of a PV converter 26a to convert at least a portion of the plasma radiation to electricity. The electricity may be at least partially conditioned by power conditioner, supply, and controller 2 to be used to power parasitic loads such as the ignition power, EM pump power, controller power, glow discharge power, and the vacuum pump power. The optical power to thermally power industrial ovens and furnaces which together with the power from the boiler and its steam to air heat exchanger may serve many markets such as space and process heating, steam processing, cooking, grilling, baking, drying, curing, smelting, refining, synfuel production, ammonia production, desalination, purifying, and cement production.

In an embodiment, SunCell boiler shown in FIG. 9K comprises an oven or furnace such as the one shown in FIG. 9J to externally heat the boiler chamber 116 by the SunCell 812. External makeup water tank 36 may supply makeup water and dampen water turbulence in the boiler chamber 116. The SunCell boiler may comprise a SunCell 812 with a plasma window 5b4 and 5ab4 shown in FIGS. 8A-8L and FIG. 9J, a blackbody absorber 942 outside of the boiler chamber 116 such as at a wall or the base, and a heat exchanger 943 to transfer heat from the blackbody absorber 942 to the water inside of the boiler chamber 116 to produce at least one of heated water and steam. In an exemplary embodiment, the blackbody absorber 942 may comprise anodized metal such as one that has a high heat transfer coefficient such as anodized copper or aluminum. At least a portion of the SunCell such as the PV window 5b4 and 5ab4 may be housed in a chamber 931A. The chamber 931A may comprise a plurality of chambers such as one upper chamber 931A and another lower chamber 931B wherein the upper chamber is maintained hotter than the lower. The lower chamber may further comprise a means such as fans 946 to cool the EM pumps 5kk after the hydrino plasma has initiated wherein both chambers may serve as a heater oven to melt the molten metal to start the hydrino reaction. The heat exchanger 943 may comprise heat transfer rods such as copper or aluminum rods or heat pipes that penetrate the boiler cavity 116 wall and may further comprise heat transfer surfaces such as tubes or fins connected to the rods or heat pipes. In an exemplary embodiment, the SunCell window 5b4 transmits optical power to heat an absorber plate 942 at the base outside of the boiler tank 116 wherein the plate 942 comprises heat transfer fins 943 in the tank water on the opposite side of the tank base. In an alternative embodiment, at least one of the PV window such as 5b4 and a portion of the SunCell such as a portion of the reaction cell chamber 5b31 that may be thermally insulated may be inside of the boiler chamber 116 through a penetration in boiler chamber wall so that the boiler water may be heated by direct plasma radiation, and thermal convection and conduction.

The SunCell may comprise a PV converter 26a to power parasitic loads. The PV converter 26a such as the one shown in FIGS. 9J and 9K may be circumferential to the PV window 5ab4 and 5b4 to allow co-production of emitted optical power and electrical power. The SunCell may be operated with at least one of the walls of the reaction cell chamber and the reaction cell chamber 5b31 at high temperature such as in the range of about 110° C. to 3000° C. to maintain at least one of a high hydrino reaction rate and high hydrino reaction product permeability to the reaction chamber walls.

In another embodiment, the SunCell 812 such as one shown in FIG. 13 may comprise a PV converter 26a that outputs a major portion of the generated power by the Hydrino reaction as electricity. The boiler such as one shown in FIG. 9K may comprise an electric heating element that replaces the boiler blackbody absorber to water heat exchanger 943 and is powered by the electricity output by the SunCell.

In an embodiment, the PV window of the SunCell such as the PV window of the optical thermal oven may comprise a plurality of windows such as spatially separated panes such as the one shown in FIGS. 8I and 8L and 13 comprising an inner window or pane 5ab4 and an outer window or pane 5b4. The separated panes may form a cavity. The PV window may comprise a vacuum pump. The cavity may be differentially pumped by the vacuum pump to maintain at least a partial vacuum in the cavity. The differential pumping may mitigate any air leak. The outer pane may be at least partially vacuum capable. The inner pane may at least partially seal the molten metal and plasma from the cavity. In another embodiment, the SunCell may comprise a tank of inert gas such as argon, at least one valve, a flow controller, a pressure sensor, and a controller to maintain a desired pressure of gas in the cavity such as one above atmospheric pressure. In an embodiment, the oven may comprise a vacuum capable or tight vessel or cavity wherein the vacuum capable or tight oven may be connected to or comprise the chamber 916 (FIGS. 8G, 8I, and 8L). The chamber 916 may be maintained under vacuum by the differential vacuum pump or may be maintained at a desired pressure of a desired atmosphere such as an inert gas atmosphere.

In an embodiment, the optical power produced in the reaction cell chamber may be transmitted through the PV window to a photovoltaic converter of the disclosure and converted to electricity. The electricity may be used for any application of electricity known in the art such as exemplary applications or loads of the group of resistive heating, air conditioning, electric ovens, high temperature electric furnaces, electric arc furnaces, electric steam boilers, heat pumps, lighting, motive power trains, electric motors, appliances, power tools, computers, audio-video systems, and data centers. The SunCell may be made to any desired scale to meet any desired load demands, or the SunCell may be ganged to any desired scale. The PV converter may be designed to output a desire current and voltage range. The SunCell may comprise corresponding power conditioning systems for the applications such as at least one inverter, transformer, and DC-DC converter, and DC to DC voltage converter and regulator.

In an embodiment, the output power of the SunCell may be controlled to a desire level by controlling the parameters that determine the hydrino reaction rate such as those of the disclosure. The output power may be sensed by at least one of (i) the SunCell optical power sensed by an optical sensor such as a photodiode, (ii) the electrical power output of the PV converter 26a, and (iii) the thermal power sensed by a thermal sensor such as an optical pyrometer or a thermocouple. The output power is determined by the hydrino reaction rate which may be sensed by the intensity and the frequency of the sound produced by the hydrino reaction which may in the range of about 1 Hz to 30,000 Hz. The controlling parameters that determine the hydrino reaction rate such as those of the disclosure (e.g. H₂, O₂, H₂O flow rates, EM pumping rate, ignition current, operating temperature) may be altered based on at least one of the plasma sound and frequency to achieve a desire hydrino reaction rate.

In an embodiment, lack of gravity could be compensated by inertial forces or pressure differentials. Specifically, in an aerospace embodiment, the EM pump, pumps fast and powerfully enough to maintain the molten metal in the corresponding reservoir at a desired molten metal height level while also maintaining molten metal injection. In an embodiment, the EM pump uses inertial forces to overcome gravitational and centrifugal forces that may arise from motion of the SunCell. The EM pump may pump molten metal from the reaction cell chamber. The EM pump may transport molten metal to the reservoir and to the EM pump inlet to maintain injection flow through the injection portion of the EM pump 5k61. In another embodiment, the SunCell may be mounted on a gantry that is spun to create a centrifugal force in the direction of the base of each EM pump reservoir to replace the force of gravity for return molten metal flow. In another embodiment shown in FIGS. 8C-D, the SunCell for thermophotovoltaic (TPV) conversion with light recycling comprises an inverted Y geometry wherein the inverted “V” portion of the inverted Y geometry comprises the two injection reservoirs 5c that connect to a reaction cell chamber 5b31, and the straight portion of the inverted Y geometry comprises a blackbody radiator or a PV window 5b4. At least one of the hot plasma and the molten metal volumetric displacement of the reaction cell chamber gases may create a gas pressure gradient from the reaction cell chamber 5b31 and the PV window comprising a cavity that exerts a force on the molten metal to cause it to flow back to and be maintained in the reservoirs wherein the molten metal may pool due to surface tension.

### Neutrino Communication System

The hydrino molecule comprises two hydrogen isotope nuclei and two electrons in a single molecular orbital (MO). Uniquely the MO comprises a paired and unpaired electron (Mills GUT, Parameters and Magnetic Energies Due to the Spin Magnetic Moment of H₂(¼) section). To conserve spin angular momentum during the formation of a bond between two hydrino atoms, the bond energy must be released as a neutrino such as an electron neutrino of spin ½:

H(1/p)+H(1/p)→H₂(1/p)+νₑ (38)

Specifically, a neutrino comprises a photon having

$$\frac{ℏ}{2}$$

angular momentum in its electric and magnetic fields (Mills GUT, Neutrinos section). During the reaction of Eq. (38), the angular momentum of the reactants is conserved in the products wherein each of the two reacting hydrino atoms are electron spin ½, and the product molecular hydrino and electron neutrino are also each spin ½. The neutrino emission reaction (Eq. (38)) may be exploited for communication.

In an embodiment, a neutrino communication system and method comprise a neutrino emitter comprising a reaction system to form hydrinos wherein at least one of the hydrino reaction rate and rate of formation of molecular hydrino may be varied in time and intensity to cause a temporally modulated hydrino reaction with a concomitant time modulated neutrino emission. In an embodiment, the hydrino reaction rate may be modulated by controlling the ignition current, the EM pump current, and the flow of reactants. The modulation may comprise frequency-division multiplexing, amplitude modulation, and other methods known in the art to carry a plurality of separate communications, video, or data simultaneously. The neutrino communication system may further comprise a rate modifier of at least one of the hydrino reaction rate and rate of formation of molecular hydrino. The rate modifier may comprise at least one source of field and source of a beam such as at least one of a source of electric field, magnetic field, a beam of photons, and a beam of particles. The particle beam may comprise an electron beam. The beam of photons may comprise a laser such as a UV, visible, or infrared gas or diode laser. The rate modifier may comprise a window such as a photon or laser window or a particle beam window. The laser window may comprise the PV window. An exemplary electron beam window comprises a silicon nitride window. The rate modifier may be at least one of pulsed in time and modulated in intensity to cause a matching variation in the emission of neutrinos which encodes the communication information.

In an embodiment, the neutrino communication system comprises one or more of at least one transducer such as an audio or video transducer to produce a communication signal or data stream, a processor such as a computer, a data stream such as data stored or processed in a computer, at least one memory element to store and to provide a communication signal or data stream, a data stream and communication signal output from the processor, and a controller that receives the data stream and communication signal output from the processor and controls the hydrino reaction rate modifier.

In an embodiment, the hydrino reaction mixture may comprise a solid matrix comprising a source of (i) hydrogen such as at least one of hydrogen molecules, a hydride, or an organic compound, and (ii) a source of HOH catalyst such as water, hydroxide, peroxide, hydrogen, oxide, oxygen, superoxide, and a composition of matter comprising at least one of hydrogen and oxygen. The matrix such as a crystalline matrix such as an alkaline or alkaline earth halide, diamond, quartz, or another inorganic crystalline compound may be transparent to the laser such as a UV, visible, or infrared laser. The laser power may be sufficient to cause the hydrino reaction by illumination of the solid matrix comprising hydrino reactants.

In an embodiment, the reaction system to form hydrinos comprises (i) a reaction chamber containing a hydrino reaction mixture such as at least one of water vapor, hydrogen gas, and oxygen gas, (ii) a least one source of the reaction mixture such as a gas tanks, valves, lines, flow meters, pressure meters, pressure regulators, a controller, and a laser wherein at least one of the hydrino reaction rate and rate of formation of molecular hydrino may be varied in time and intensity or temporally modulated by laser pulses to cause a temporally modulated hydrino reaction with a concomitant time modulated neutrino emission. The laser may cause a temporally modulated plasma in the reaction mixture to cause the modulated hydrino reaction rate and neutrino emission communication signal.

The disclosure also includes a neutrino communication system and method of communication. These may comprise a neutrino receiver comprising a source of molecular hydrino having a bond energy equivalent to the bond energy of the hydrino molecule that emitted a neutrino during bond formation to comprise the emitter signal. A receiver molecular hydrino may absorb an incident neutrino to result in bond breakage to form two hydrino atoms. At least one of the conversion of a molecular hydrino to hydrino atoms and the resulting hydrino atoms from the absorption of a neutrino by a hydrino molecule may be monitored in time and concentration by a hydrino communication sensor. The sensor may comprise a superconducting quantum inference device (SQUID) such as a rf SQUID. The sensor may comprise a transformer such as a superconducting transformer coupled to a SQUID such as an rf-SQUID. An exemplary rf SQUID sensor of very high sensitivity comprises one by R. M. Weisskoff, et al., “rf SQUID detector for single-ion trapping experiments”, Journal of Applied Physics. Vol. 63, p. 4599 (1988); https://doi.org/10.1063/1.340137. The sensor may be magnetized to increase the sensor sensitivity. The SQUID sensor may be responsive to a high frequency communication signal from the emitter over a background of low frequency signal due to the relatively slow back reaction of hydrino atoms to hydrino molecules. The SQUID sensor may comprise at least one signal processing element and method such as ones known in the art for processing an input signal into an output communication signal. The processing element may comprise one or more of (i) at least one filter such as one of a high, low, and bandpass filter to select a desired signal or processed signal frequency band, (ii) a phase shifter to shift the phase of the signal, (iii) an amplifier to amplify the signal, (iv) a feedback circuit to suppress noise signals relative to the communication signal and stabilize the SQUID, (v) at least one inductor, capacitor, and resistor to provide at least one of a desired impedance, resonance frequency, and quality factor Q, (vi) a mixer, heterodyne, modulator, demodulator, or frequency shifter to shift at least one of the frequency and phase of the SQUID sensor signal, and (vii) a processor such as a computer to process the signal and output the communication signal. The SQUID sensor may be responsive to the flux change caused by the conversion of at least one hydrino molecule to corresponding hydrino atoms. The SQUID Josephson junction may comprise at least one hydrino molecule.

In another embodiment, the sensor may comprise a sensor of the hydrino atom such as one responsive to the hyperfine structure line regarding the electron-nuclear spin flip transition. The hyperfine structure sensor may comprise a source of electromagnetic radiation capable of producing a resonant absorption of the hydrino atom hyperfine transition, a detector of the absorption of the resonant electromagnetic radiation, and a processor. In an exemplary embodiment, the H(¼) hyperfine structure has a resonant frequency of about 21.4 cm⁻¹. In another embodiment, a hydrino atom sensor may comprise a sensor of at least one of the hydrino atom nuclear or electron spin flip in an applied magnetic field wherein the hydrino atom sensor or monitoring system comprises a source of magnetic field such as a permanent or electromagnet that applies a magnetic field to the hydrino atom, a source of electromagnetic radiation capable of producing a resonant absorption of the hydrino atom nuclear or electron spin flip transition at the applied magnetic field, a detector of the absorption of the resonant electromagnetic radiation, and a processor. In another embodiment, the sensor may comprise a sensor of the hydrino hydride ion such as one responsive to the emission from the binding of an electron to the corresponding hydrino atom to form the hydrino hydride ion. The sensor may comprise an optical detector capable of detecting at least one specific wavelength or band such as at least one photodiode and at least one filter. Alternatively, the sensor may comprise a spectrometer responsive to the hydrino hydride emission. The hydrino hydride ion (H) emission may correspond to the binding energy according to Eq. (19). In an exemplary embodiment wherein p=2 to p=24 in Eq. (19), the hydride ion binding energies are respectively 3, 6.6, 11.2, 16.7, 22.8, 29.3, 36.1, 42.8, 49.4, 55.5, 61.0, 65.6, 69.2, 71.6, 72.4, 71.6, 68.8, 64.0, 56.8, 47.1, 34.7, 19.3, and 0.69 eV. The emission may comprise continuum radiation with a cutoff of the binding energy and may further comprise fluxon linkage structure of the hydride ion emission.

Temporal variation and intensity of the sensor response may be processed by a processor to receive the communication in the transmitted neutrino signal. The signal processing may comprise heterodyne shifting, filtering, and other techniques known in the art to improve the signal to noise ratio and to reduce any background signal. An exemplary, source of molecular hydrino comprises molecular hydrino embedded in a crystalline compound such as KCl:H₂(¼) or GaOOH:H₂(¼). Another source comprises at molecular hydrino embedded in a lattice that serves as a source of electrons such as a metal lattice such as thin-film aluminum or zirconium wherein the source is at least partially transparent to hydrino hydride emission formed in the lattice during detection of neutrinos.

Neutrino emission may be directional such as line of sight. The line of sight may be through physical structures or even the Earth. The alignment of emitter and receiver may be determined by the locational information such as GPS coordinates of the emitter and receiver. In an embodiment, the communication system further comprises at least one of a steerable source of magnetic field and a steerable source of photons such as a laser to cause directional neutrino emission. The directionality may be achieved by magnetic alignment of at least one of the nuclear and electron spins of the hydrino atoms and the resulting molecular hydrino, and polarization of at least one of the electron and nuclear spins of at least one of the atoms and molecule. The polarization may be achieved by laser irradiation. In another embodiment, a further method of modulation of the neutrino emission is achieved by coupling the neutrino emission to a molecular hydrino excitation. The molecular hydrino excitation may comprise at least one of a hydrino molecular rotational, vibrational, spin flip, spin orbital coupling, fluxon linkage, and magnetic tilt energy transition during neutrino emission wherein the modulation may comprise at least one of an energy shift and a temporal modulation. The neutrino communication system may further comprise a neutrino emission modulation system to cause the resonant molecular hydrino excitation comprising at least one of a source of magnetic field such as a permanent or electromagnet, a source of electromagnetic radiation such as a source of radio frequency radiation, and a source of photons such as a laser. The modulation system may comprise at least one of an electron paramagnetic resonance (EPR) spectrometer and a Raman spectrometer. In an embodiment, the neutrinos may be polarized. The polarization may be achieved by applying a magnetic field to the reaction cell chamber wherein the emission signal modulation may be encoded by at least one of radio frequency, laser, or electron beam irradiation.

References herein to an Appendix or SubAppendix refer to the Appendix of U.S. App. No. 62/236,198, filed Aug. 23, 2021, which is hereby incorporated by reference in its entirety and, in particular, the spectroscopic measurements therein such as EPR and Raman of material produced by systems of the present disclosure and collected following thereof.

### EXAMPLES

### Example 1

Various modifications of a window were performed in order to enhance optical transmission of plasma light therethrough during system operation. A dual molten metal stream injection system of the present disclosure was used to identify suitable modifications to the window to ensure system operability. The system used 10-12 kg of molten tin that was continuously flowed from electrically separated reservoirs through two electromagnetic pumps and through corresponding nozzles in order to cross molten streams and form a closed electrical circuit.

In the first set of experiments a fused silica window was used. The kinetic energy imparted to the molten metal and molten metal oxide during plasma generation induced accumulation on the interior of the window. These defects inhibited optical transmission and thereby limited energy collection after limited operation. System operation resulted in melting and deformation of the fused silica during generation of the second plasma.

The PV window was modified in order to increase operability transmission through the PV window for ultimate energy collection by injecting tin onto its surface during generation of the second plasma from an electromagnetic pump in fluid communication with tin reservoirs.

By incorporating this change to the PV window and system setup, optical transmission through the PV window increased affording a consistently operating window where emission spectra could be measured. These modifications were found to work exceptionally well when tin was used as the molten metal in the second plasma forming reaction (e.g., as compared to gallium).

### Example 2

A dual molten metal stream injection system of the present disclosure was used to measure emitted spectra from the second plasma. The system used 10-12 kg of molten tin that was continuously flowed from electrically separated reservoirs through two electromagnetic pumps and through corresponding nozzles in order to cross molten streams and form a closed electrical circuit. Electromagnetic pump reservoirs were oppositely biased in order to flow current through the intersecting streams with an electrical supply set at constant current mode. Repeated tests were performed, for example, in some experiments, the input current was maintained at 790 A.

Hydrogen gas (H₂) and oxygen gas (O₂) were flowed into a glow discharge cell where the effluence was directed at intersecting biased molten tin streams. Hydrogen had a flow of 2000 sccm and oxygen had a flow of 30 sccm into the glow discharge cell to initiate the formation of a second plasma.

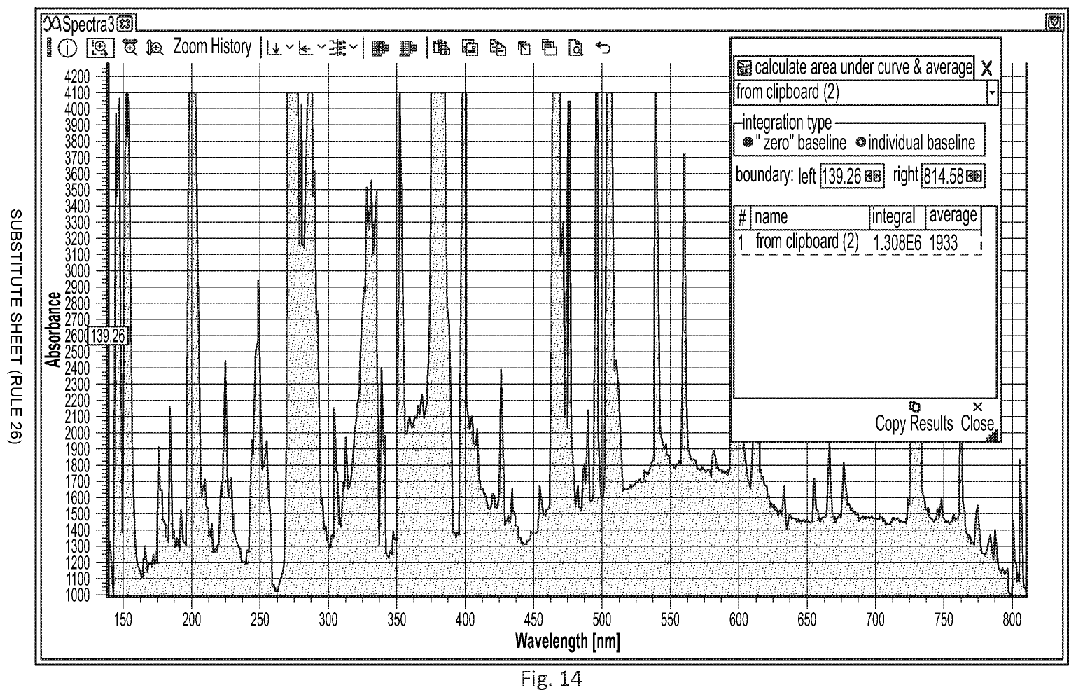

A Mightex UV-Vis_IR spectrometer was used to measure the emission spectra of the second plasma over the range of 180 nm to 800 nm with a 100 ms sampling time and 25 μm slit. The emission spectra of the second plasma were measured by employing the PV window modifications discussed in Example 1. FIG. 14 provides an emission spectra measured from the second plasma produced in the system during operation. As can be seen, the emission spectra includes some saturation features.

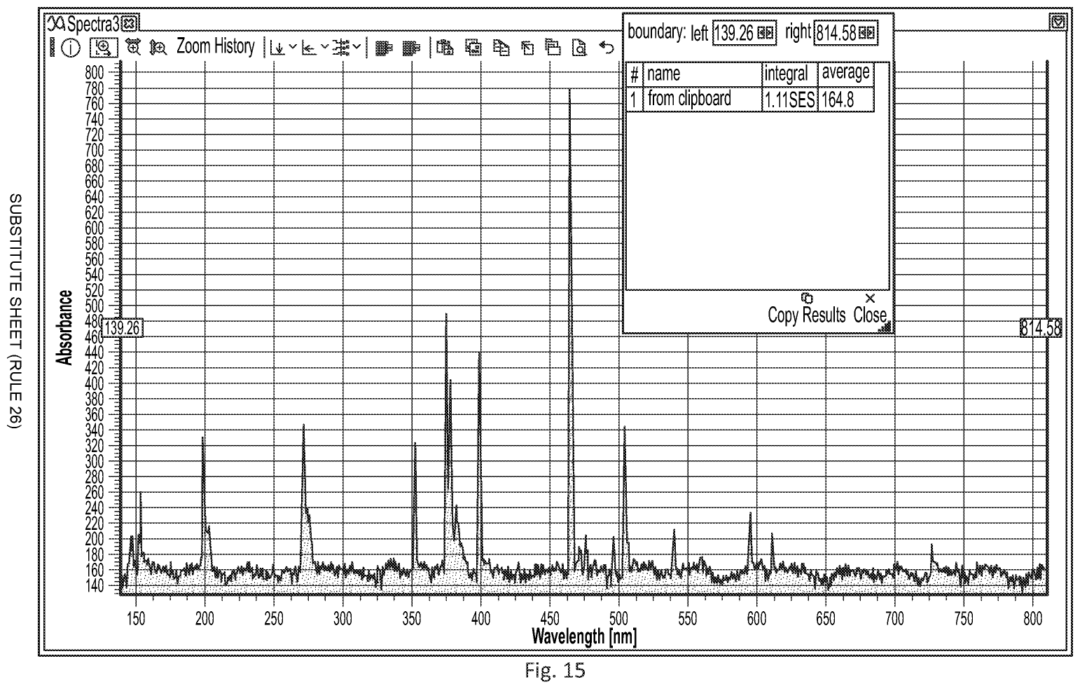

During a run, the concentration of nascent water and atomic hydrogen was reduced in the reaction cell severely mitigating the power output. FIG. 15 provides the emission spectra of the plasma produced in these limited reactant conditions where emission peaks from the plasma can be clearly identified. As can be seen, light output can be controlled by variation of the input reactant concentrations.

Delivery of hydrogen and trace oxygen to the glow discharge cell were discontinued and replaced by argon which was flowed at a rate to maintain a constant 5 Torr total pressure. The input current maintained at 790 A, but, when reactants were removed, the voltage increased from the initial 48 V (voltage during plasma generation) to 61 V with a corresponding decay in plasma light intensity. The integrated light intensity over the total wavelength range for the high Hydrino power interval at 36 kW input power was 11.7 times that of a low plasma power interval at 40 kW input power corresponding to a 470 kW optical power output in the former case. FIG. 14 was taken with a 36 kW input power provided across the biased streams resulting in 470 kW measured optical power output. Although the emission taken in FIG. 15 illustrate more than 11.7× less optical power output due to decreased H₂ concentrations, the input power was larger (in constant current scheme) at 40 kW. The lower output plasma required a higher voltage due to the decrease in plasma power output which helped drive the system.

### Example 3

A dual molten metal stream injection system of the present disclosure was used to measure emitted spectra from the second plasma. The system used 10-12 kg of molten tin that was continuously flowed from electrically separated reservoirs through two electromagnetic pumps and through corresponding nozzles in order to cross molten streams and form a closed electrical circuit. Electromagnetic reservoirs were oppositely biased in order to flow current through the intersecting streams with an electrical supply set at constant current mode.

The system comprised a first 6″ diameter PV window adjacent to the second plasma that employed the modifications identified in Example 1. A second window surrounded the first PV window to maintain the SunCell reaction cell chamber under vacuum and help direct light to a dense receiver array having an ensemble of concentrator phototovoltaic cells.

The thickness of the refractory liner in the system was adjusted in order to change the internal temperature of the system in system regions of the reaction cell. For example, regions of the system having the appropriate liner were able to reach 3000 K internal temperatures. These refractory lined reaction cell chambers operated as a blackbody cavity. Plasma generation transmits energy to these liners inducing blackbody radiation at a controlled temperature. At 3000K, the dense receiver array was matched to the blackbody light output therefore exploiting light recycling and increasing system efficiency.

Systems having refractory liners sufficient to operate at internal temperatures of 3000K-5000K were operated. These systems produced radiation having a power density of 4.6 to 35 MW/m². Leveraging dense receiver arrays and infrared light recycling is able to increase energy collection efficiencies by more than 50%.

1. A power generation system comprising:
a) at least one vessel capable of a maintaining a pressure below atmospheric comprising a reaction chamber;
b) two electrodes configured to allow a molten metal flow therebetween to complete a circuit;
c) a power source connected to said two electrodes to apply an ignition current therebetween when said circuit is closed;
d) a plasma generation cell (e.g., glow discharge cell) to induce the formation of a first plasma from a gas delivered thereto; wherein effluence of the plasma generation cell is directed towards the circuit (e.g., the molten metal, the anode, the cathode, an electrode submerged in a molten metal reservoir);
wherein when current is applied across the circuit, the effluence of the plasma generation cell undergoes a reaction to producing a second plasma and reaction products; and
e) a power adapter comprising a thermophotovoltaic converter configured to convert and/or transfer energy from the second plasma into mechanical, thermal, and/or electrical energy;
wherein energy from the second plasma is absorbed in a blackbody radiator to produce blackbody radiation and said blackbody radiation is converted in the thermophotovoltaic converter.

2. The power generation system according to claim 1, wherein said gas in the plasma generation cell comprises a mixture of hydrogen (H₂) and oxygen (O₂).

3. The power generation system according to claim 2, wherein the relative molar ratio of oxygen to hydrogen is from 0.01-50.

4. The power generation system according to claim 1, wherein said molten metal is tin.

5. The power generation system according to claim 1, wherein the power adapter is a thermophotovoltaic adapter comprising a photovoltaic converter in a geodesic dome, wherein the photovoltaic converter may comprise a receiver array comprised of triangular elements; and
wherein each triangular element comprises a plurality of concentrator photovoltaic cells capable of converting the blackbody radiation into electricity.

6-7. (canceled)

8. The power system according to claim 5, wherein the photons having an energy less than the bandgap of the photovoltaic cells are reflected back towards the plasma generation cell.

9. The power system according to claim 1, further comprising a PV window between a reaction cell comprising the second plasma and the thermophotovoltaic converter.

10. The power system according to claim 9, wherein tin does not wet the PV window.

11. (canceled)

12. The power system according claim 9, wherein the PV window comprises (or predominantly comprises) flat surfaces, the power adapter comprises a photovoltaic (PV) converter, and the PV converter comprises a flat dense receiver array panel to receive the plasma emission through the PV window with a geometry matching the PV window.

13. (canceled)

14. The power generation system of claim 1, wherein the reaction products do not wet the PV window.

15. (canceled)

16. The power generation system of claim 1, further comprising a reaction cell chamber connected to the reservoirs wherein the walls of at least one of the reservoirs and the reaction cell chamber are electrically isolated by at least one of a ceramic coating and a liner.

17-19. (canceled)

20. The power generation system of claim 1, wherein the molten metal flowing between the two electrodes is formed from dual molten metal injection systems independently in fluid communication with one or more molten metal reservoirs comprising the molten metal;
wherein each molten metal injection system comprises an electromagnetic pump and a nozzle, wherein each electromagnetic pump flows molten metal through the nozzle to form a stream of molten metal;
wherein said electrodes are in communication with the molten metal streams thereby forming dual molten metal streams of opposite polarity; and
wherein said complete circuit is formed by intersection the dual molten metal streams.

21. The power generation system of claim 20, wherein at least one reservoir comprises an electrical break to electrically isolate the electrodes from each other.

22. The power generation system of claim 20 further comprising a flexible element and at least one actuator to tilt the injector electrode of the reservoir to cause alignment of the molten metal streams.

23-25. (canceled)

26. The power generation system of claim 20, wherein the dual molten streams intersect in a chamber comprising a window and light produced from the second plasma or the blackbody radiation exits the window to heat a load.

27. (canceled)

28. The power generation system of claim 1, wherein said the second plasma reaction occurs in a reaction chamber comprising a PV window; and
wherein the molten metal or oxidized molten metal is removed from the PV and:
a) the PV window comprises at least one of quartz, sapphire, aluminum oxynitride, CaF₂, and MgF₂;
b) the PV window is heated above the melting point of an oxide of the molten metal (e.g., tin oxide);
c) hydrogen reduction of the oxide of the molten metal occurs by flowing hydrogen gas into the reaction chamber at a pressure sufficient to achieve said hydrogen reduction; and/or
d) the PV window has molten metal injected onto its surface during generation of the second plasma (e.g., from an electromagnetic pump).

29. The power generation system of claim 1, comprising at least one PV window and at least one thermal absorber wherein optical power from the second plasma reaction is transferred through the PV window to the thermal absorber by radiative power transfer, and said thermal absorber transmits thermal power from said radiative power transfer.

30-34. (canceled)

35. A system for removing a molten metal oxide from a PV window comprising;
a source of a deaccumulation material, wherein said deaccumulation material is directed towards said PV window; and
said deaccumulation material is hydrogen gas or molten metal of the molten metal oxide.

36. A method of forming a plasma producing ultraviolet light comprising:
a) forming a first plasma in a glow discharge cell from a gas directed thereto;
b) creating an electrically biased molten metal stream;
c) directing the effluence from the glow discharge cell towards the electrically biased molten metal stream to form a second plasma that produces ultraviolet light.
